(19) United States
(12) Patent Application Publication
(10) Pub. No.: US 2026/0259423 A1
(43) Pub. Date: Sep. 3, 2026

(54) REFLECTIVE MEMBER DRIVING DEVICE, CAMERA DEVICE, AND OPTICAL INSTRUMENT

(71) Applicant: LG INNOTEK CO., LTD., Seoul (KR)

(72) Inventor: Sung Guk LEE, Seoul (KR)

(21) Appl. No.: 18/877,692

(22) PCT Filed: Jun. 2, 2023
(86) PCT No.: PCT/KR2023/007573

§ 371 Date: Dec. 20, 2024

(30) Foreign Application Priority Data
Jun. 20, 2022 (KR) 10-2022-0075203
Jun. 29, 2022 (KR) 10-2022-0079616
Jul. 8, 2022 (KR) 10-2022-0084366

(51) Int. Cl. G02B 27/64; G03B 5/00; G03B 17/17; H04N 23/68

(52) U.S. Cl. CPC G02B 27/646; G03B 5/00; G03B 17/17; H04N 23/685; G03B 2205/0023; G03B 2205/0069

(57) ABSTRACT

The present embodiment relates to a reflective member driving device comprising: a housing; a holder being disposed inside the housing; a reflective member being disposed in the holder; a moving plate being disposed between the housing and the holder; a coil and a magnet for moving the holder against the housing; and an elastic member connecting the housing and the holder, wherein the moving plate is disposed in a first portion of the housing, and wherein the elastic member is disposed at an opposite side of the moving plate with respect to the first portion of the housing and is directly coupled to the holder.

### CROSS-REFERENCE TO RELATED APPLICATIONS

This application is the U.S. national stage application of International Patent Application No. PCT/KR2023/007573, filed Jun. 2, 2023, which claims the benefit under 35 U.S.C. § 119 of Korean Application Nos. 10-2022-0075203, filed Jun. 20, 2022; 10-2022-0079616, filed Jun. 29, 2022; and 10-2022-0084366, filed Jul. 8, 2022; the disclosures of each of which are incorporated herein by reference in their entirety.

### TECHNICAL FIELD

The present embodiment relates to a reflective member driving device, a camera device, and an optical apparatus.

### BACKGROUND ART

A camera device is a device that photographs a picture or video of a subject and is installed in an optical apparatus such as a smartphone, a drone, a vehicle, and the like.

In recent camera devices, in order to improve the quality of images in recent camera devices, optical image stabilization (OIS) function that compensates for image shaking caused by user movement, auto focus (AF) function that automatically adjusts the distance between the image sensor and the lens to align the focal length of the lens, and zoom function that increases or decreases the magnification of a distant subject through a zoom lens are being required

In addition, there are large restrictions on space for arranging camera actuators according to the needs of ultra-slim and subminiature camera modules, and the camera module itself comprising a lens or lens and image sensor may be difficult to ensure sufficient space for tilting or moving for the operation of OIS or the like. In addition, it is desirable for a high-pixel camera to increase the size of a lens in order to increase the amount of light being received, but there may be a limit to increasing the size of the lens due to the space occupied by the actuator.

In addition, since an additional magnet or the like is disposed to maintain the position of the reflective member, problems such as magnetic field interference and difficulty in reducing weight exist.

(Patent Literature 1) KR 10-2018-0096073 A

### DETAILED DESCRIPTION OF THE INVENTION

### Technical Subject

A first embodiment of the present invention is to provide a reflective member driving device in which an OIS function is implemented through the tilting of the reflective member.

Furthermore, it is intended to provide a reflective member driving device that maintains a moving plate in contact between a fixing unit and a moving unit through an elastic member.

A second embodiment of the present invention is to provide a camera actuator and a camera device that provide both a driving force and a suction force with one magnet.

In addition, the present invention may provide a camera actuator and a camera device in which the lubricating member is inhibited from moving to the tilting guide unit due to a collision.

A second embodiment of the present invention is to provide a camera actuator applicable to ultra-slim, subminiature, and high-resolution cameras.

A third embodiment of the present invention provides an actuator capable of reducing power consumption for OIS driving and enhancing the performance of OIS driving, a camera device comprising the same, and an optical apparatus.

The problem to be solved in the embodiment is not limited thereto, and it can be said that the solution to the problem described below or the purpose or effect that can be grasped from the embodiment is also comprised.

### Technical Solution

A reflective member driving device according to the present embodiment comprises: a housing; a holder being disposed inside the housing; a reflective member being disposed in the holder; a moving plate being disposed between the housing and the holder; a coil and a magnet for moving the holder against the housing; and an elastic member connecting the housing and the holder, wherein the moving plate may be pressed between the holder and the housing by the elastic member.

A reflective member driving device according to a first embodiment of the present invention comprises: a housing; a holder being disposed inside the housing; a reflective member being disposed in the holder; a moving plate being disposed between the housing and the holder; a coil and a magnet for moving the holder against the housing; and an elastic member connecting the housing and the holder, wherein the moving plate is disposed in a first portion of the housing, and wherein the elastic member is disposed at an opposite side of the moving plate with respect to the first portion of the housing and may be directly coupled to the holder.

The housing comprises a first surface facing a first direction, the holder comprises a protruding portion being protruded in the first direction, and the elastic member may be coupled to the first surface of the housing and the protruding portion of the holder.

The protruding portion of the holder may be protruded to an opposite side of the moving plate with respect to the first portion of the housing.

The elastic member comprises: an outer portion being coupled to the housing; an inner portion being coupled to the holder; and a connecting portion connecting the outer portion and the inner portion, wherein an optical axis of the light incident on the reflective member is a first optical axis, wherein an optical axis of the light emitted from the reflective member is a second optical axis, and wherein the inner portion may be disposed at a more inner side than the outer portion at a cross section cut by an imaginary plane comprising the first optical axis and the second optical axis.

In the cross section, the inner portion may be disposed at a more outer side than the moving plate.

The housing comprises a hole penetrating the housing in the first direction, and the protruding portion of the holder may pass through the hole of the housing.

The protruding portion of the holder comprises a first protruding portion being disposed at one side of the first portion of the housing and a second protruding portion being disposed at the other side of the first portion of the housing, and the elastic member may be coupled to the first protruding portion and the second protruding portion, respectively.

The first protruding portion of the holder comprises a first surface facing the first direction and a protrusion being formed on the first surface of the first protruding portion, and the elastic member may comprise a hole being coupled with the protrusion.

The protrusion of the first protruding portion of the holder comprises a first protrusion and a second protrusion being spaced apart from each other, wherein the elastic member may comprise a first portion being coupled to the first protrusion, a second portion being coupled to the second protrusion, and a third portion connecting the first portion and the second portion.

The first protruding portion may comprise a portion being overlapped with the first portion of the housing in a direction in which the first protruding portion faces the second protruding portion.

The elastic member may pull the holder in the first direction.

The reflective member driving device comprises a substrate in which the coil is disposed, the housing comprises a first housing in which the substrate is disposed and a second housing comprising the first portion of the housing, and the second housing is formed as a separate member from the first housing and may be coupled to the first housing.

A reflective member driving device according to a first embodiment of the present invention comprises: a housing; a holder being disposed inside the housing; a reflective member being disposed in the holder; a moving plate being disposed between the housing and the holder; a coil and a magnet for moving the holder against the housing; and an elastic member connecting the housing and the holder, wherein the housing comprises a first surface facing a first direction, wherein the holder comprises a protruding portion protruding more than the moving plate in the first direction, and wherein the elastic member is coupled with the first surface of the housing and the protruding portion of the holder.

A reflective member driving device according a the first embodiment of the present invention comprises: a housing; a holder being disposed inside the housing; a reflective member being disposed in the holder; a moving plate being disposed between the housing and the holder; a coil and a magnet for moving the holder against the housing; and an elastic member connecting the housing and the holder, wherein the holder comprises two protruding portions, wherein the moving plate is disposed between the two protruding portions, and wherein the elastic member may connect the two protruding portions of the holder and the housing.

The housing may comprise a hole through which the two protruding portions of the holder pass.

A camera device according to a first embodiment of the present invention may comprise: a printed circuit board; an image sensor being disposed on the printed circuit board; the reflective member driving device; and a lens being disposed in an optical path formed by the reflective member of the reflective member driving device and the image sensor.

An optical apparatus according to a first embodiment of the present invention may comprise: a main body; the camera device being disposed in the main body; and a display being disposed on the main body and outputting any one or more of a video and an image photographed by the camera device.

A camera actuator according to a second embodiment of the present invention comprises: a housing; a mover comprising a holder and an optical member being disposed in the holder; a driving unit comprising a magnet and a coil for moving the mover; a tilting guide unit being disposed between the housing and the mover; and a yoke portion being disposed adjacent to the magnet and not being overlapped with the tilting guide unit.

The yoke part may be disposed outside the tilting guide unit.

The yoke part may be positioned between the tilting guide unit and the magnet.

The magnet comprises a first magnet and a second magnet facing each other, and a third magnet positioned between the first magnet and the second magnet, wherein the coils comprises a first coil and a second coil facing each other, and a third coil positioned between the first coil and the second coil, and wherein the yoke part may comprise a first yoke corresponding to the first magnet and a second yoke corresponding to the second magnet.

The first yoke is overlapped with the first magnet along an optical axis but is not overlapped with the first coil along the optical axis, and the second yoke is overlapped with the second magnet along an optical axis but may not be overlapped with the second coil along the optical axis.

The first magnet and the second magnet are symmetrically disposed inside the holder, and the first yoke and the second yoke may be symmetrically disposed with respect to the holder.

The center of each of the first yoke and the second yoke may correspond to the center of each of the first magnet and the second magnet.

The first magnet and the first yoke may be disposed between the first coil and the optical member, and the second magnet and the second yoke may be disposed between the second coil and the optical member.

The first yoke and the second yoke may be disposed outside the optical member.

The first yoke and the second yoke may not be overlapped with the optical member in an optical axis direction.

A camera device according to a third embodiment of the present invention comprises: a housing; a holder being disposed inside the housing; an optical member being disposed inside the holder; a driving plate being disposed between the housing and the holder; an elastic member comprising one end coupled to the housing and the other end coupled to the holder; and a driving unit for tilting the holder, wherein the elastic member comprises at least a portion passing through the driving plate.

The driving plate may comprise an opening through which at least a portion of the elastic member passes.

The housing may comprise a first groove being formed in a side portion, the holder may comprise a second groove being formed on a side surface facing the side portion of the housing, one end of the elastic member is inserted into the first groove, and the other end of the elastic member may be inserted into the second groove.

The one end of the elastic member is coupled to the first groove and the other end of the elastic member may be coupled to the second groove by an adhesive.

The housing may comprise a protruding portion being protruded from the side portion of the housing toward the side surface of the holder, and the first groove may be formed in the protruding portion of the housing.

The housing may comprise a groove being formed in a side portion of the housing, and the actuator may comprise a ball member being disposed between the driving plate and the groove of the housing. The ball member may be in contact with the driving plate and the groove of the housing.

The housing may comprise a guide groove being disposed between an upper end of the side portion of the housing and the groove of the housing. The housing may comprise a partition wall formed between the bottom of the groove of the housing and the bottom of the guide groove.

The housing may comprise a protruding portion being protruded from the side portion of the housing and being disposed at an upper side of the driving plate. The elastic member may be a coil spring. The coil spring may comprise a plurality of coil springs being spaced apart from each other.

The actuator may comprise a ball member being disposed between the driving plate and the housing, and the housing may comprise a partition wall being disposed between the ball member and an upper surface of the housing.

An actuator according to another embodiment comprises: a housing comprising a first side portion, a second side portion, and a third side portion being disposed between the first side portion and the second side portion; a holder being disposed inside the housing; an optical member being disposed inside the holder; a magnet being disposed inside the holder; a coil being disposed in a first side portion of the housing to face the magnet and tilting the holder by interaction with the magnet; a driving plate being disposed between the third side portion of the housing and the holder; and an elastic member connecting the third side portion of the housing and the holder, wherein the separation distance between the elastic member and the center of the driving plate is smaller than the separation distance between the elastic member and the coil.

The separation distance between the elastic member and the reference line is smaller than the separation distance between the reference line and the coil, and the baseline may be a straight line parallel to the direction toward the driving plate from the third side portion of the housing and passing through the center of the driving plate.

An actuator according to another embodiment comprises: a housing comprising a first side portion, a second side portion, and a third side portion being disposed between the first side portion and the second side portion; a holder being disposed inside the housing; an optical member being disposed inside the holder; a magnet being disposed in the holder; a coil being disposed in a first side portion of the housing to face the magnet and tilting the holder by interaction with the magnet; a driving plate being disposed between the third side portion of the housing and the holder; and an elastic member comprising one end being coupled to the third side portion of the housing and the other end being coupled to the holder, wherein the driving plate comprises a penetrating hole through which at least a portion of the elastic member passes. The elastic member may be a coil spring.

An actuator according to another embodiment comprises: a housing comprising a first side portion, a second side portion, and a third side portion being disposed between the first side portion and the second side portion; a holder being disposed inside the housing; an optical member being disposed inside the holder; a magnet being disposed in the holder; a coil being disposed in a first side portion of the housing to face the magnet and tilting the holder by interaction with the magnet; a driving plate being disposed between the third side portion of the housing and the holder; a coil spring comprising one end being coupled to the third side portion of the housing and the other end being coupled to the side surface of the holder; and a ball member being disposed between the driving plate and the third side portion of the housing, wherein the housing comprises a groove formed in the side portion of the housing, wherein at least a portion of the ball member is disposed inside the groove of the housing, and wherein the housing comprises a guide groove being formed between an upper end of the side portion of the housing and the groove of the housing.

A camera device according to a third embodiment of the present invention comprises a first actuator and a second actuator, wherein the first actuator performs an auto focusing or zoom function, wherein the second actuator performs an optical image stabilizer (OIS) function, and wherein the second actuator is an actuator according to the embodiment.

### Advantageous Effects

Through a first embodiment of the present invention, it is possible to provide a two-axis tilt implementation structure for a reflective member.

In addition, a reflective member driving device having a minimized length in an optical axis direction of the image sensor can be provided.

In addition, a more stable holding force can be realized compared to the comparative example in which a magnet is used to keep the moving plate in contact between the fixed part and the moving unit. Furthermore, a cost reduction effect can be expected due to a reduction in the number of parts compared to the comparative example. In addition, driving performance can be enhanced by improving tolerance due to a decrease in the number of parts compared to the comparative example.

According to the second embodiment of the present invention, it is possible to implement a camera actuator and a camera device that provide both a driving force and a suction force with one magnet.

In addition, the present invention can implement a camera actuator and a camera device in which the lubricating member is inhibited from moving to the tilting guide unit due to collision.

In addition, the present invention can implement a camera actuator applicable to ultra-slim, subminiature, and high-resolution cameras.

In the third embodiment of the present invention, power consumption for OIS driving can be reduced and performance of OIS driving can be enhanced by disposing the elastic member away from the OIS coil, which is a source of electromagnetic force, and arranging it close to the rotation axis for OIS driving.

The various yet beneficial advantages and effects of the present invention are not limited to the above descriptions, and will be more easily understood in the process of describing specific embodiments of the present invention.

### BRIEF DESCRIPTION OF DRAWINGS

FIG. 1 is a perspective view of a camera device according to a first embodiment of the present invention.

FIG. 2 is a bottom perspective view of a camera device according to a first embodiment of the present invention.

FIG. 3 is a plan view of a camera device according to a first embodiment of the present invention.

FIG. 4 is a cross-sectional view viewed from A-A in FIG. 3.

FIG. 5 is an exploded perspective view of a camera device according to a first embodiment of the present invention.

FIG. 6 is a perspective view of a reflective member driving device according to a first embodiment of the present invention.

FIG. 7 is a perspective view of a reflective member driving device according to a first embodiment of the present invention viewed from a direction different from that of FIG. 6.

FIG. 8 is an exploded perspective view of a reflective member driving device according to a first embodiment of the present invention.

FIG. 9 is an exploded perspective view of a reflective member driving device according to a first embodiment of the present invention.

FIGS. 10 and 11 are diagrams for explaining a structure related to a moving plate of a reflective member driving device according to a first embodiment of the present invention.

FIG. 12 is a perspective view of some components of a reflective member driving device according to a first embodiment of the present invention.

FIG. 13 is an exploded perspective view illustrating the disassembled reflective member driving device of FIG. 12.

FIG. 14 is a cross-sectional view of a reflective member driving device according to a first embodiment of the present invention.

FIG. 15 is a front view of a reflective member driving device according to a first embodiment of the present invention.

FIG. 16 is a front view of a reflective member driving device according to a modified example.

FIG. 17 is a perspective view illustrating a fixing part of a reflective member driving device according to a first embodiment of the present invention.

FIG. 18 is a perspective view of the reflective member driving device of FIG. 17 viewed from another direction.

FIG. 19 is a perspective view of the reflective member driving device of FIG. 18 viewed from a different direction without the second substrate.

FIG. 20 is a perspective view of the reflective member driving device of FIG. 19 viewed from another direction.

FIG. 21 is a plan view of the reflective member driving device in the state of FIG. 19.

FIG. 22 is an exploded perspective view illustrating an exploded view of a first housing and a second housing of a reflective member driving device according to a first embodiment of the present invention.

FIG. 23 is a perspective view illustrating a moving unit of a reflective member driving device according to a first embodiment of the present invention.

FIG. 24 is a perspective view of a reflective member driving device of FIG. 23 viewed from another direction.

FIG. 25 is a plan view illustrating a driving unit of a reflective member driving device according to a first embodiment of the present invention.

FIG. 26 is a front view illustrating a driving device of a reflective member driving device according to a first embodiment of the present invention.

FIGS. 27 to 29 are views for explaining the tilt of a reflective member driving device according to a first embodiment of the present invention about an X-axis.

FIGS. 30 to 32 are views for explaining the tilt of a reflective member driving device according to a first embodiment of the present invention about a Y-axis.

FIG. 33 is a perspective view of a lens driving device according to a first embodiment of the present invention.

FIG. 34 is a perspective view of a lens driving device according to a first embodiment of the present invention, in which some components are omitted.

FIG. 35 is a perspective view of a lens driving device in the state illustrated in FIG. 34 viewed from another direction.

FIG. 36 is a perspective view of a lens driving device according to a first embodiment of the present invention, in which some components are omitted.

FIG. 37 is a perspective view of a state in which components such as a substrate and a coil are omitted in a lens driving device according to a first embodiment of the present invention.

FIG. 38 is a perspective view of a lens driving device illustrated in FIG. 37, in which the first lens and related components are omitted.

FIG. 39 is a perspective view and a partial enlarged view of a part of a lens driving device according to a first embodiment of the present invention.

FIG. 40 is a view for explaining the arrangement structure of a coil and a sensor of a lens driving device according to a first embodiment of the present invention.

FIG. 41 is a perspective view of a state in which the second housing is omitted in the lens driving device illustrated in FIG. 37.

FIG. 42 is a perspective view of a state in which a guide rail is omitted from the lens driving device illustrated in FIG. 41.

FIG. 43 is an enlarged view of a part of a lens driving device according to a first embodiment of the present invention.

FIG. 44 is a perspective view of a first moving unit and a second moving unit and related components of a lens driving device according to a first embodiment of the present invention.

FIG. 45 is a perspective view of a second moving unit and related components of a lens driving device according to a first embodiment of the present invention.

FIG. 46 is an exploded perspective view of a lens driving device according to a first embodiment of the present invention.

FIG. 47 is a perspective view of a second housing of a lens driving device according to a first embodiment of the present invention.

FIGS. 48 and 49 are exploded perspective views of some components of a lens driving device according to a first embodiment of the present invention.

FIG. 50 is a cross-sectional view of a lens driving device according to a first embodiment of the present invention.

FIGS. 51 to 53 are diagrams for explaining implementation of a zoom function and an autofocus function of a lens driving device according to a first embodiment of the present invention.

FIG. 54 is a perspective view of some components of a camera device according to a first embodiment of the present invention.

FIG. 55 is an exploded perspective view of an image sensor, a filter, and related components of a camera device according to a first embodiment of the present invention.

FIG. 56 is a perspective view of an optical apparatus according to a first embodiment of the present invention.

FIG. 57 is a perspective view of a camera module according to a second embodiment of the present invention;

FIG. 58 is an exploded perspective view of a camera module according to a second embodiment of the present invention;

FIG. 59 is a view viewed from A-A′ in FIG. 57;

FIG. 60 is a perspective view of a first camera actuator according to a second embodiment of the present invention;

FIG. 61 is an exploded perspective view of a first camera actuator according to a second embodiment of the present invention;

FIG. 62 is a perspective view of a first housing in a first camera actuator according to a second embodiment of the present invention;

FIG. 63 is a side view of a first housing in a first camera actuator according to a second embodiment of the present invention;

FIG. 64 is a cross-sectional view viewed from M-M′ in FIG. 63;

FIG. 65 is a cross-sectional view viewed from N-N′ in FIG. 63;

FIG. 66 is a perspective view of an optical member of a first camera actuator according to a second embodiment of the present invention;

FIG. 67 is a perspective view of a holder according to a second embodiment of the present invention;

FIG. 68 is a side view of a holder according to a second embodiment of the present invention;

FIG. 69 is another side view of a holder according to a second embodiment of the present invention;

FIG. 70 is a bottom view of a holder according to a second embodiment of the present invention;

FIG. 71 is another side view of a holder according to a second embodiment of the present invention;

FIG. 72 is a perspective view of a tilting guide unit of a first camera actuator according to a second embodiment of the present invention;

FIG. 73 is a perspective view in a direction different from that of FIG. 72;

FIG. 74 is a cross-sectional view viewed from F-F′ in FIG. 72;

FIG. 75 is a perspective view of a first camera actuator according to a second embodiment of the present invention;

FIG. 76a is a view viewed from B-B′ in FIG. 75;

FIG. 76b is a plan view of some components of a first camera actuator;

FIG. 76c is a side view of a portion of a first camera actuator;

FIG. 77 is a view viewed from O-O′ in FIG. 76a;

FIG. 78 is a view viewed from P-P′ in FIG. 76a;

FIG. 79 is a view viewed from C-C′ in FIG. 75;

FIG. 80 is a diagram illustrating a first driving unit of a first camera actuator according to a second embodiment of the present invention;

FIG. 81 is a perspective view of a first camera actuator according to a second embodiment of the present invention;

FIG. 82 is a view viewed from D-D′ in FIG. 81;

FIG. 83 is a perspective view of a first camera actuator according to a second embodiment of the present invention;

FIG. 84 is a view viewed from E-E′ in FIG. 83;

FIG. 85 is a perspective view of a second camera actuator according to a second embodiment of the present invention;

FIG. 86 is an exploded perspective view of a second camera actuator according to a second embodiment of the present invention;

FIG. 87 is a cross-sectional view viewed from E-E′ in FIG. 85;

FIG. 88 is a perspective view of a mobile terminal to which a camera module according to a second embodiment of the present invention is applied; and

FIG. 89 is a perspective view of a vehicle to which a camera module according to a second embodiment of the present invention is applied.

FIG. 90 is a perspective view of a camera device according to a third embodiment of the present invention.

FIG. 91 is an exploded perspective view of a camera device of FIG. 90.

FIG. 92 is a cross-sectional view of a camera device in the direction A-B of FIG. 90.

FIG. 93 is a perspective view of the second actuator illustrated in FIG. 90.

FIG. 94 is an exploded perspective view of a second actuator.

FIG. 95a is a front perspective view of a holder of FIG. 94.

FIG. 95b is a rear perspective view of a holder.

FIG. 95c is a bottom perspective view of a holder.

FIG. 96 is an exploded perspective view of a holder, driving plate, and elastic member. FIG. 97a is a first perspective view of the driving plate.

FIG. 97b is a second perspective view of a driving plate.

FIG. 98a is a perspective view of a holder, an optical member, a driving plate, and a rolling member.

FIG. 98b is a perspective view of an elastic member coupled to the holder of FIG. 98a.

FIG. 99a is a first perspective view of a housing;

FIG. 99b is a second perspective view of a housing.

FIG. 100a is a perspective view of a housing, a circuit board, a coil, a position sensor, an elastic member, a driving plate, and a rolling member.

FIG. 100b is a perspective view of the driving plate of FIG. 100a coupled to a housing;

FIG. 101 is a diagram for explaining the movement of the driving plate and the electromagnetic force according to the interaction between the magnets and the first to third coil units.

FIG. 102a is a cross-sectional view of a second actuator in the C-D direction of FIG. 93.

FIG. 102b is a cross-sectional view of a second actuator in the E-F direction of FIG. 93.

FIG. 103a is an enlarged view of a part of a housing, a rolling member, and an elastic member.

FIG. 103b is a partially enlarged view of a second actuator.

FIGS. 104a to 104d are views for explaining the assembly sequence of a second actuator.

FIG. 105 illustrates arrangement of elastic units according to another embodiment.

FIG. 106 illustrates the arrangement of other elastic members in another embodiment.

FIG. 107 is a cross-sectional view for explaining a relationship between an arrangement position of an elastic member and an OIS driving force according to a third embodiment of the present invention.

FIG. 108 illustrates an elastic member according to another embodiment.

FIG. 109 is a perspective view of a first actuator and an image sensing unit according to a third embodiment of the present invention.

FIG. 110a is a first separated perspective view of a first actuator and the image sensing unit of FIG. 109.

FIG. 110b is a second separated perspective view of a first actuator and an image sensing unit of FIG. 109.

FIG. 111a is a cross-sectional view at line a-b in a first actuator and an image sensing unit of FIG. 109.

FIG. 111b is a cross-sectional view at line c-d in a first actuator and an image sensing unit of FIG. 109.

FIG. 112 is an exploded perspective view of a first actuator;

FIG. 113a is an exploded perspective view of a second housing.

FIG. 113b is a perspective view of a body of a second housing;

FIG. 114a is a first perspective view of first and second guide units and a lens part.

FIG. 114b is a second perspective view of first and second guide units and a lens part.

FIG. 115 is an exploded perspective view of first and second magnets and a lens unit.

FIG. 116 is a functional block diagram of a camera device according to a third embodiment of the present invention.

FIG. 117 is a perspective view of a portable terminal according to a third embodiment of the present invention.

FIG. 118 illustrates a configuration diagram of a portable terminal illustrated in FIG. 117.

### [BEST MODE]

Hereinafter, preferred embodiments of the present invention will be described in detail with reference to the accompanying drawings.

However, the technical idea of the present invention is not limited to some embodiments to be described, but may be implemented in various forms, and within the scope of the technical idea of the present invention, one or more of the constituent elements may be selectively combined or substituted between embodiments.

In addition, the terms (comprising technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may comprise the plural form unless specifically stated in the phrase, and when described as “at least one (or more than one) of A and B and C”, it may comprise one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also comprise cases of being ‘connected’, ‘coupled’, or ‘interconnected’due that another component between that other components.

In addition, when described as being formed or arranged in “on (above)” or “below (under)” of each component, “on (above)” or “below (under)” means that it comprises not only the case where the two components are directly in contact with, but also the case where one or more other components are formed or arranged between the two components. In addition, when expressed as “on (above)” or “below (under)”, the meaning of not only an upward direction but also a downward direction with respect to one component may be comprised.

Hereinafter, a reflective member driving device according to a first embodiment of the present invention will be described with reference to the drawings.

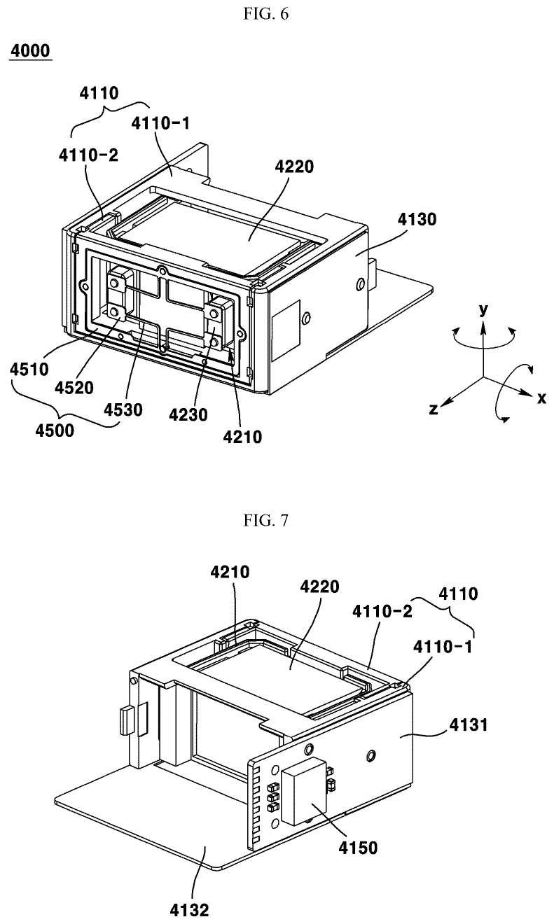

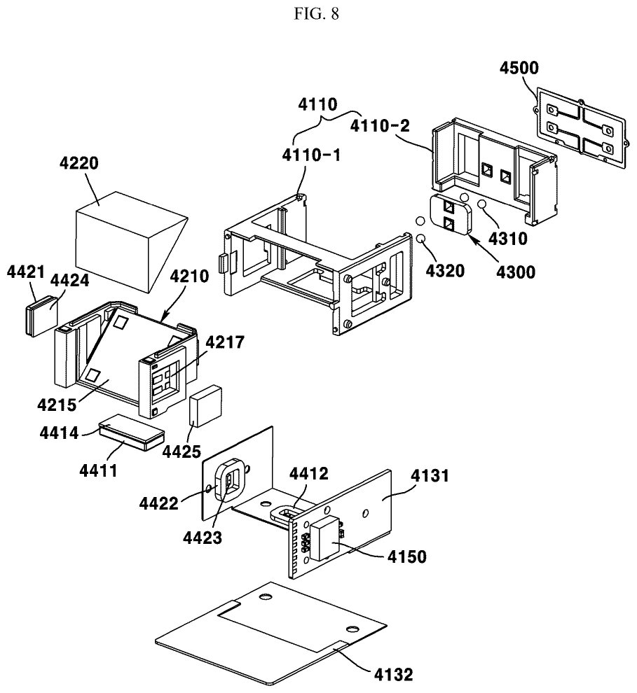

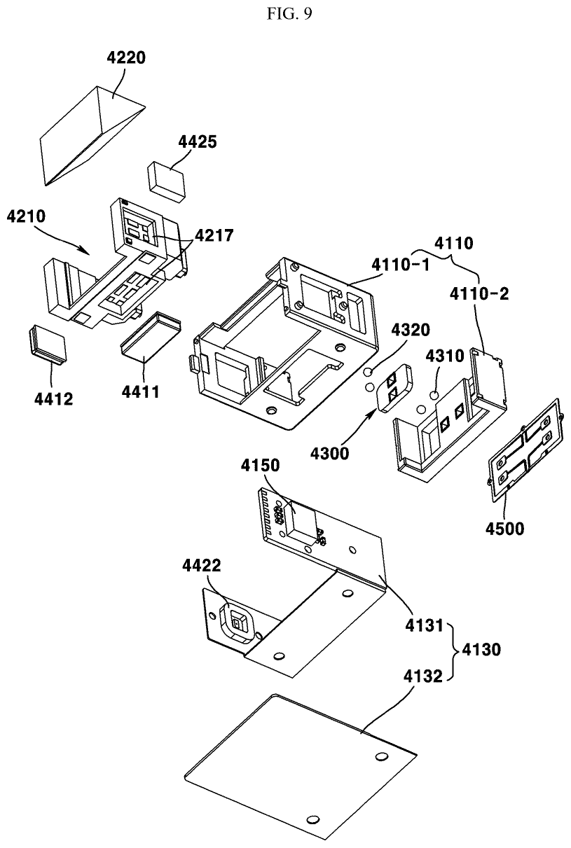

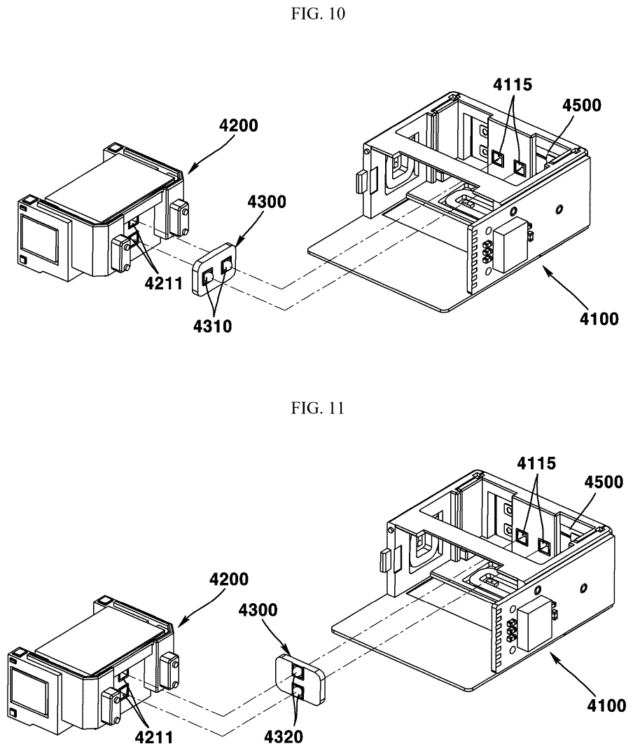

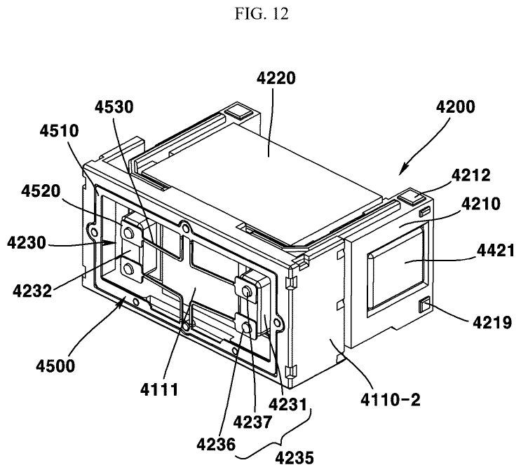

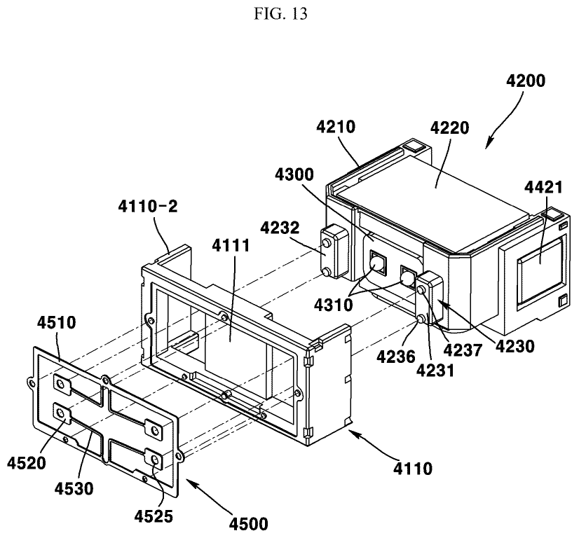

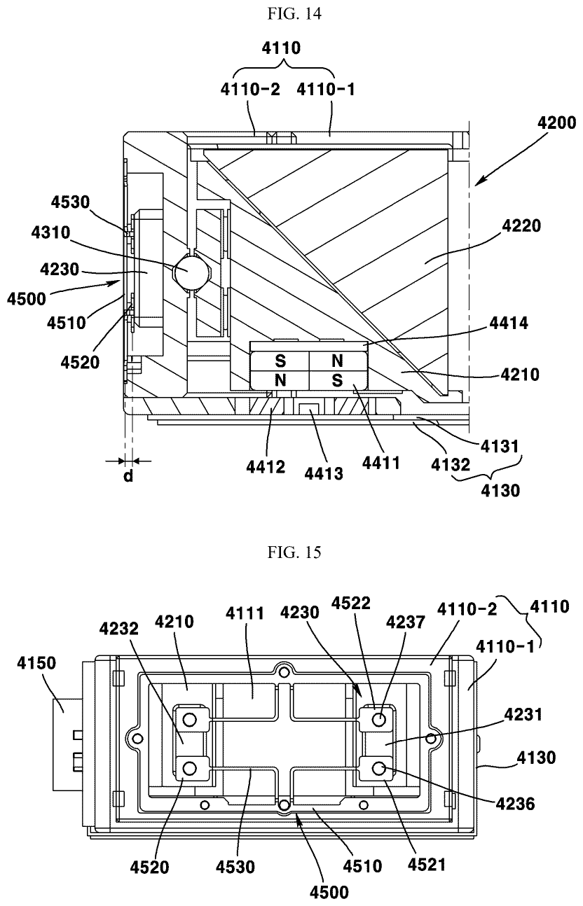

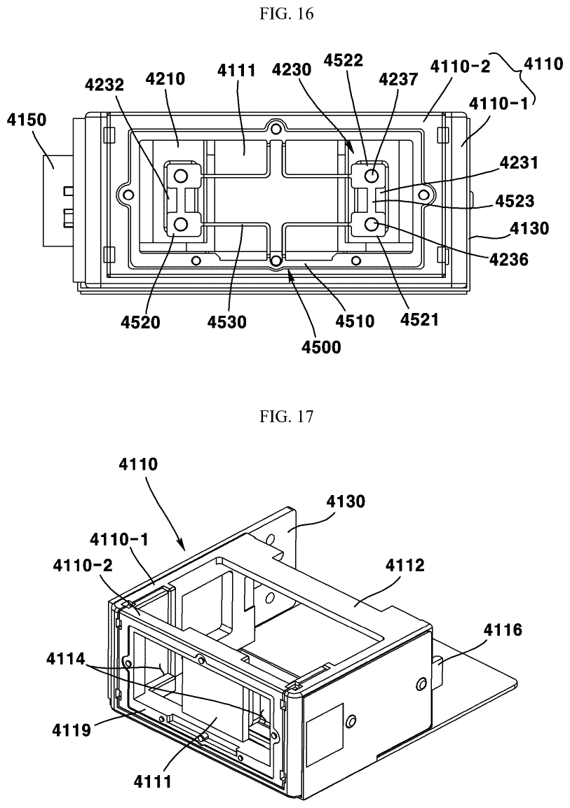

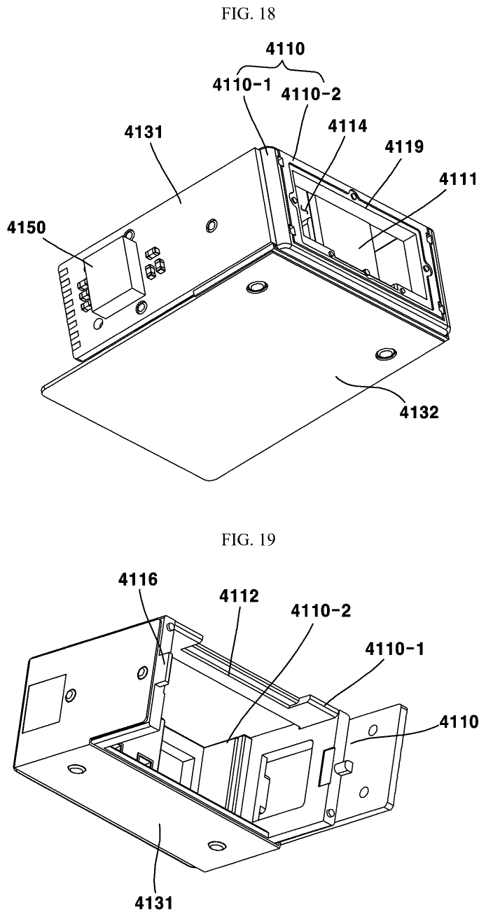

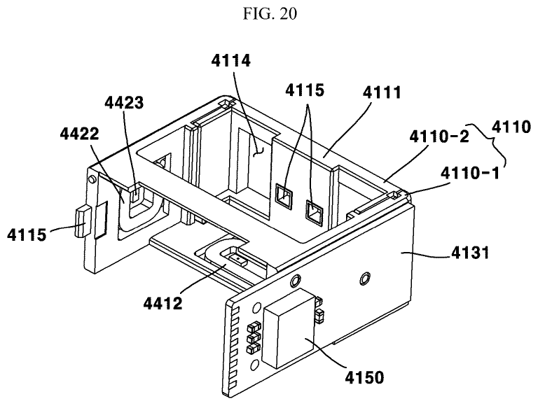

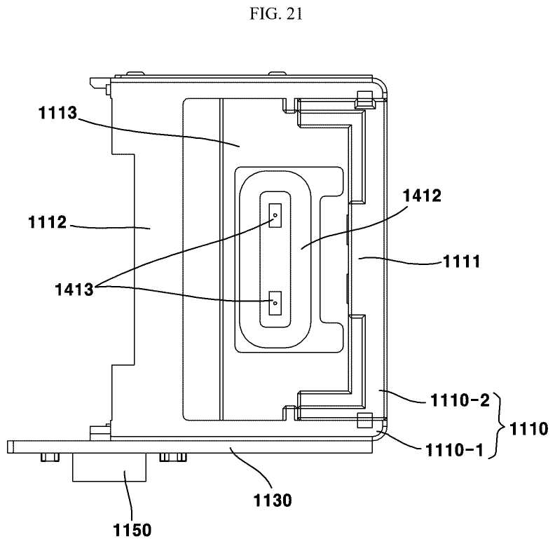

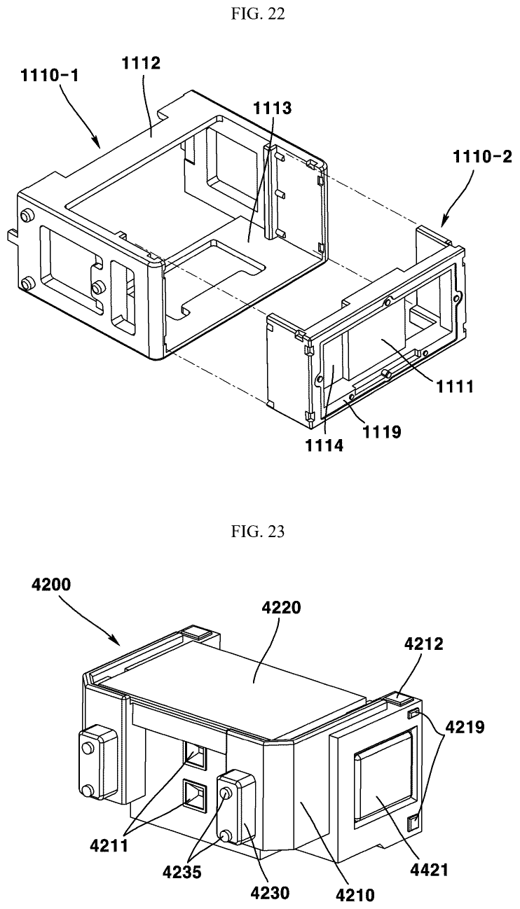

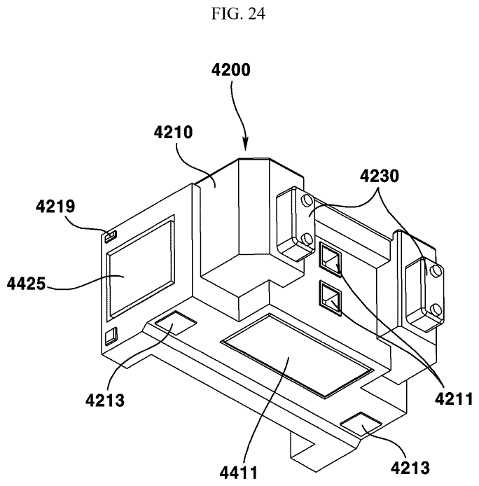

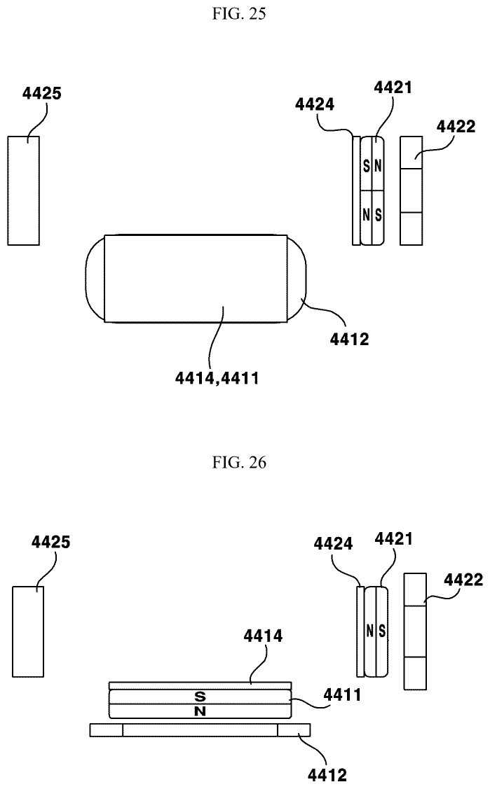

FIG. 6 is a perspective view of a reflective member driving device according to a first embodiment of the present invention; FIG. 7 is a perspective view of a reflective member driving device according to a first embodiment of the present invention viewed from a direction different from that of FIG. 6; FIG. 8 is an exploded perspective view of a reflective member driving device according to a first embodiment of the present invention; FIG. 9 is an exploded perspective view of a reflective member driving device according to a first embodiment of the present invention; FIGS. 10 and 11 are diagrams for explaining a structure related to a moving plate of a reflective member driving device according to a first embodiment of the present invention; FIG. 12 is a perspective view of some components of a reflective member driving device according to a first embodiment of the present invention; FIG. 13 is an exploded perspective view illustrating the disassembled reflective member driving device of FIG. 12; FIG. 14 is a cross-sectional view of a reflective member driving device according to a first embodiment of the present invention; FIG. 15 is a front view of a reflective member driving device according to a first embodiment of the present invention; FIG. 16 is a front view of a reflective member driving device according to a modified example; FIG. 17 is a perspective view illustrating a fixing part of a reflective member driving device according to a first embodiment of the present invention; FIG. 18 is a perspective view of the reflective member driving device of FIG. 17 viewed from another direction; FIG. 19 is a perspective view of the reflective member driving device of FIG. 18 viewed from a different direction without the second substrate; FIG. 20 is a perspective view of the reflective member driving device of FIG. 19 viewed from another direction; FIG. 21 is a plan view of the reflective member driving device in the state of FIG. 19; FIG. 22 is an exploded perspective view illustrating an exploded view of a first housing and a second housing of a reflective member driving device according to a first embodiment of the present invention; FIG. 23 is a perspective view illustrating a moving unit of a reflective member driving device according to a first embodiment of the present invention; FIG. 24 is a perspective view of a reflective member driving device of FIG. 23 viewed from another direction; FIG. 25 is a plan view illustrating a driving unit of a reflective member driving device according to a first embodiment of the present invention; and FIG. 26 is a front view illustrating a driving device of a reflective member driving device according to a first embodiment of the present invention.

The reflective member driving device 4000 may perform optical image stabilization (OIS) function. The reflective member driving device 4000 may perform a hand shake correction function. The reflective member driving device 4000 may move the reflective member 4220. The reflective member driving device 4000 may tilt the reflective member 4220. The reflective member driving device 4000 may tilt the reflective member 4220 about two axes. The reflective member driving device 4000 may tilt the reflective member 4220 around an X-axis and a Y-axis. The X-axis and Y-axis may be perpendicular to each other. The reflective member driving device 4000 may be a reflective member actuator. The reflective member driving device 4000 may be an OIS actuator. The reflective member driving device 4000 may be an OIS driving device. The reflective member driving device 4000 may be a prism driving device.

The reflective member driving device 4000 may comprise a fixing unit 4100. The fixing unit 4100 may be a relatively fixed part when the moving unit 4200 moves. The fixing unit 4100 may accommodate at least a part of the moving unit 4200. The fixing unit 4100 may be disposed outside the moving unit 4200.

The reflective member driving device 4000 may comprise a housing 4110. The fixing unit 410 may comprise a housing 4110. The housing 4110 may be disposed outside a holder 4210. The housing 4110 may accommodate at least a portion of the holder 4210. The housing 4110 may comprise an opening or a hole for securing a path of light in an upper plate and one of a side plates. The housing 4110 may comprise an upper plate, a lower plate, and a plurality of side plates.

The housing 4110 may comprise a first housing 4110-1. A substrate 4130 may be disposed in the first housing 4110-1. The housing 4110 may comprise a second housing 4110-2. The second housing 4110-2 may comprise a first portion 4111 of the housing 4110. The second housing 4110-2 may be formed as a separate member from the first housing 4110-1. The second housing 4110-2 may be coupled to the first housing 4110-1. The second housing 4110-2 may be disposed in the first housing 4110-1. The second housing 4110-2 may be fixed to the first housing 4110-1. The second housing 4110-2 may be coupled to the first housing 4110-1 with an adhesive.

The housing 4110 may comprise a first portion 4111. The first portion 4111 may be formed in a side plate of the housing 4110. A moving plate 4300 may be disposed in the first portion 4111. The first portion 4111 may be disposed between the holder 4210 and an elastic member 4500. A moving plate 4300 may be disposed in one side of the first portion 4111 and an elastic member 4500 may be disposed in the other side of the first portion 4111.

The housing 4110 may comprise a second portion 4112. The second portion 4112 may be disposed above holder 4210. The second portion 4112 may come into contact with the holder 4210 when the holder 4210 moves upward. The second portion 4112 may be overlapped with the holder 4210 in a moving direction of the holder 4210. The second portion 4112 may be an upper plate of the housing 4110.

The housing 4110 may comprise a third portion 4113. The third portion 4113 may be disposed below the holder 4210. The third portion 4113 may come into contact with the holder 4210 when the holder 4210 moves downward. The third portion 4113 may be overlapped with the holder 4210 in a moving direction. The third portion 4113 may be a lower plate of the housing 4110.

The housing 4110 may comprise a hole 4114. The hole 4114 may be a protruding portion passage hole. The hole 4114 may be formed in a side plate of the housing 4110. The hole 4114 may be formed in the first portion 4111 of the housing 4110. A protruding portion 4230 of the holder 4210 may be disposed in the hole 4114. The protruding portion 4230 of the holder 4210 may be disposed to pass through the hole 4114. The hole 4114 may be formed to be larger than a moving space of the protruding portion 4230 of the holder 4210 so as not to interfere with the protruding portion 4230 of the holder 4210. The hole 4114 may penetrate through the housing 4110 in a first direction.

The housing 4110 may comprise a groove 4115. The groove 4115 may be a first protrusion accommodating groove for the moving plate. A first ball 4310 of the moving plate 4300 may be disposed in the groove 4115. The groove 4115 may accommodate at least a portion of the first ball 4310 of the moving plate 4300. The groove 4115 may arrest the movement of the first ball 4310 of the moving plate 4300 except rotation. The groove 4115 may comprise an inclined surface being in contact with the first ball 4310 of the moving plate 4300. The inclined surface may comprise a plurality of inclined surfaces.

The groove 4115 may comprise a first groove. The first groove may be a 4-point contact groove. The first groove may be in contact with one of the two first balls 4310 of the moving plate 4300 at four points. Through this, the first groove of the housing 4110 may arrest the movement in four directions except for the rotation of protrusion of one of the first balls 4310 of the moving plate 4300.

The groove 4115 may comprise a second groove. The second groove may be a two-point contact groove. The second groove may be in contact with the other one of the two first balls 4310 of the moving plate 4300 at two points. Through this, the second groove of the housing 4110 can arrest the movement of one protrusion of the other one among the first balls 4310 of the moving plate 4300 in two directions. For example, the second groove of the housing 4110 may arrest the movement of the first ball 4310 of the moving plate 4300 in a left-to-right direction and may not arrest the movement in an up-and-down direction.

The housing 4110 may comprise a protruding portion 4116. The protruding portion 4116 may be coupled to a lens driving device 5000. The protruding portion 4116 may be formed in a side plate of the housing 4110. The protruding portion 4116 may be formed in a side of the housing 4110 facing the lens driving device 5000. The protruding portion 4116 may comprise a trapezoidal cross section. The protruding portion 4116 may be coupled to the housing 5110 of the lens driving device 5000. The protruding portion 4116 may be inserted into a first groove 5111 of the housing 5110 of the lens driving device 5000. The protruding portion 4116 may be coupled to the housing 5110 of the lens driving device 5000 by an adhesive.

The housing 4110 may comprise a groove 4119. The groove 4119 may be an elastic member accommodating groove. An elastic member 4500 may be disposed in the groove 4119. An outer portion 4510 of the elastic member 4500 may be disposed in the groove 4119. The groove 4119 may be concavely formed in an outer surface of the housing 4110. The recessed depth of the groove 4119 may be greater than the thickness of the elastic member 4500. A protrusion being coupled to the outer portion 4510 of the elastic member 4500 may be formed in the groove 4119. The outer portion 4510 of the elastic member 4500 may comprise a hole being coupled with a protrusion formed in the groove 4119 of the housing 4110.

The reflective member driving device 4000 may comprise a substrate 4130. The fixing unit 4100 may comprise a substrate 4130. The substrate 4130 may be a flexible printed circuit board (FPCB). The substrate 4130 may be a flexible printed circuit board. A substrate 4130 may be disposed in the housing 4110. Coils 4412 and 4422 may be disposed on the substrate 4130. Sensors 4413 and 4423 may be disposed on the substrate 4130. The substrate 4130 may be electrically connected to a substrate 6700. A driver IC 4170 may be disposed on the substrate 4130. A gyro sensor 4150 may be disposed on the substrate 4130. The substrate 4130 may be disposed to cover the lower surface and both side surfaces of the housing 4110. The substrate 4130 may comprise a shape bent twice.

The substrate 4130 may comprise a flexible substrate 4131. Coils 4412 and 4422 may be disposed on the flexible substrate 4131. The flexible substrate 4131 may be disposed between the housing 4110 and a SUS 4132. The flexible substrate 4131 may comprise a shape bent at least twice.

The substrate 4130 may comprise a SUS 4132. The reflective member driving device 4000 may comprise a SUS 4132. The fixing unit 4100 may comprise a SUS 4132. The SUS 4132 may be disposed on the substrate 4130. The SUS 4132 may be disposed on a lower surface of the substrate 4130. The SUS 4132 may reinforce the strength of the substrate 4130. However, as a modified embodiment, a separate substrate may be disposed instead of the SUS 4132.

The reflective member driving device 4000 may comprise a gyro sensor 4150. The fixing unit 4100 may comprise a gyro sensor 4150. The gyro sensor 4150 may detect shaking of the camera device 4010. The shaking detected by the gyro sensor 4150 may be offset through the handshake correction function. The gyro sensor 4150 may be disposed on the substrate 4130. The gyro sensor 4150 may be disposed on an outer surface of the substrate 4130.

The reflective member driving device 4000 may comprise a plate. The fixing unit 4100 may comprise a plate. A plate may be disposed to cover the opened portion of the housing 4110. The plate may be disposed to close the opened front of the housing 4110. The plate may be formed of a metal plate material.

The reflective member driving device 4000 may comprise a driver IC 4170. The fixing unit 4100 may comprise a driver IC 4170. The driver IC 4170 may be disposed on the substrate 4130. The driver IC 4170 may be electrically connected to the first coil 4412 and the second coil 4422. The driver IC 4170 may supply current to the first coil 4412 and the second coil 4422. The driver IC 4170 may control at least one of voltage and current being applied to each of the first coil 4412 and the second coil 4422. The driver IC 4170 may be electrically connected to the sensors 4413 and 4423. The driver IC 4170 may feedback-control the voltage and current being applied to the first coil 4412 and the second coil 4422 through the position of the reflective member 4220 detected by the sensors 4413 and 4423.

The reflective member driving device 4000 may comprise a moving unit 4200. The moving unit 4200 may move against the fixing unit 4100. The moving unit 4200 may be tilted with respect to the fixing unit 4100. The moving unit 4200 may be disposed inside the fixing unit 4100. At least a portion of the moving unit 4200 may be spaced apart from the fixing unit 4100. The moving unit 4200 may come into contact with the fixing unit 4100 when moving. Or, in an initial state, the moving unit 4200 may come into contact with the fixing unit 4100.

The reflective member driving device 4000 may comprise a holder 4210. The moving unit 4200 may comprise a holder 4210. The holder 4210 may be disposed inside the housing 4110. The holder 4210 is movable against the housing 4110. The holder 4210 can be tilted with respect to housing 4110. At least a portion of the holder 4210 may be spaced apart from the housing 4110. The holder 4210 may come into contact with the housing 4110. The holder 4210 may come into contact with the housing 4110 when moving. Or, the holder 4210 may come into contact with the housing 4110 in an initial state.

The holder 4210 may comprise a groove 4211. The groove 4211 may be a second protrusion accommodating groove of the moving plate. The second ball 4320 of the moving plate 4300 may be disposed in the groove 4211. The groove 4211 may accommodate at least a portion of the moving plate 4300. The groove 4211 may arrest the movement of a second ball 4320 of the moving plate 4300 except rotation. The groove 4211 may comprise an inclined surface being in contact with the second ball 4320 of the moving plate 4300. The inclined surface may comprise a plurality of inclined surfaces.

The groove 4211 may comprise a first groove. The first groove may be a 4-point contact groove. The first groove may be in contact with one of the two second balls 4320 of the moving plate 4300 at four points. Through this, the first groove of the holder 4210 can arrest the movement in four directions except for the rotation of protrusion of one of the second balls 4320 of the moving plate 4300.

The groove 4211 may comprise a second groove. The second groove may be a two-point contact groove. The second groove may be in contact with the other one of the two second balls 4320 of the moving plate 4300 at two points. Through this, the second groove of the holder 4210 can arrest the movement in two directions of the protrusion of the other one of the second balls 4320 of the moving plate 4300. For example, the second groove of the holder 4210 may arrest the movement of the second ball 4320 of the moving plate 4300 in an up-and-down direction and may not arrest the movement in a left-to-right direction.

The holder 4210 may comprise a first protrusion 4212. The first protrusion 4212 may be an upper stopper. The first protrusion 4212 may be formed in an upper surface of the holder 4210. The first protrusion 4212 may be protruded from an upper surface of the holder 4210. The first protrusion 4212 may be in contact with the housing 4110 when the holder 4210 moves upward. The first protrusion 4212 may be in contact with the second portion 4112 of the housing 4110 when the holder 4210 moves upward.

The holder 4210 may comprise a second protrusion 4213. The second protrusion 4213 may be a lower stopper. The second protrusion 4213 may be formed in a lower surface of the holder 4210. The second protrusion 4213 may be protruded from a lower surface of the holder 4210. The second protrusion 4213 may be in contact with the housing 4110 when the holder 4210 moves downward. The second protrusion 4213 may be in contact with the third portion 4113 of the housing 4110 when the holder 4210 moves downward.

The holder 4210 may comprise an adhesive accommodating groove 4214. The adhesive accommodating groove 4214 may accommodate an adhesive fixing the reflective member 4220 to the holder 4210. An adhesive accommodating groove 4214 may be formed in a surface in contact with the reflective member 4220. The adhesive may be disposed in the accommodating groove 4214.

The holder 4210 may comprise a groove 4215. The groove 4215 may be a separation space being provided between the groove 4215 and the reflective member 4220. The groove 4215 may be formed in a surface being in contact with the reflective member 4220. The contact area between the reflective member 4220 and the holder 4210 may be reduced by the groove 4215.

The holder 4210 may comprise a groove 4216. The groove 4216 may be a weight loss groove. The groove 4216 may be formed in the central portion of the holder 4210. The weight of the holder 4210 may be reduced by the groove 4216.

The holder 4210 may comprise a magnet accommodating groove 4217. Driving magnets 4411 and 4421 may be disposed in the magnet accommodating groove 4217. The magnet accommodating groove 4217 may be formed in a shape corresponding to the driving magnets 4411 and 4421. A magnet accommodating groove 4217 may be formed in a lower surface and both side surfaces of the holder 4210. The magnet accommodating groove 4217 may comprise a plurality of magnet accommodating grooves. The magnet accommodating groove 4217 may comprise a first magnet accommodating groove accommodating the first driving magnet 4411 and the yoke 4414. The magnet accommodating groove 4217 may comprise a second magnet accommodating groove accommodating the second driving magnet 4421 and the yoke 4424.

The holder 4210 may comprise a lateral stopper 4219. The lateral stopper 4219 may be formed at both side surfaces of the holder 4210. The lateral stopper 4219 may be protruded from the side surface of the holder 4210. The lateral stopper 4219 may come into contact with the housing 4110 when the holder 4210 moves laterally. The lateral stopper 4219 may come into contact with the side plate of the housing 4110 when the holder 4210 moves laterally.

The reflective member driving device 4000 may comprise a reflective member 4220. The moving unit 4200 may comprise a reflective member 4220. A reflective member 4220 may be disposed in the holder 4210. A reflective member 4220 may be disposed inside the holder 4210. The reflective member 4220 may be coupled to the holder 4210. The reflective member 4220 may be fixed to the holder 4210. The reflective member 4220 may be fixed to the holder 4210 by an adhesive. The reflective member 4220 may move integrally with the holder 4210. The reflective member 4220 may change the path of light. The reflective member 4220 may reflect light. The reflective member 4220 may comprise a prism. The reflective member 4220 may comprise a mirror. The reflective member 4220 may be formed in a triangular prism shape. The angle between a path of light incident on the reflective member 4220 and a path of light being emitted may be 90 degrees.

The reflective member driving device 4000 may comprise a protruding portion 4230. The moving unit 4200 may comprise a protruding portion 4230. The holder 4210 may comprise a protruding portion 4230. The protruding portion 4230 may be protruded from the holder 4210 in a first direction. The protruding portion 4230 may be protruded from a first surface of the holder 4210 facing a first direction. The protruding portion 4230 may be protruded forward. The protruding portion 4230 may be protruded outward. The protruding portion 4230 may be protruded toward the first portion 4111 of the housing 4110. The protruding portion 4230 may be protruded to the opposite side of the moving plate 4300 with respect to the first portion 4111 of the housing 4110. The protruding portion 4230 may be protruded more than the moving plate 4300 in a first direction. The protruding portion 4230 of the holder 4210 may pass through the hole 4114 of the housing 4110. The protruding portion 4230 may be protruded toward the elastic member 4500. The protruding portion 4230 may be coupled to the elastic member 4500. The protruding portion 4230 may be coupled to an inner portion 4520 of the elastic member 4500.

The protruding portion 4230 may comprise a first protruding portion 4231 and a second protruding portion 4232. The first protruding portion 4231 may be disposed at one side of the first portion 4111 of the housing 4110. The second protruding portion 4232 may be disposed at the other side of the first portion 4111 of the housing 4110. The elastic member 4500 may be coupled to the first protruding portion 4231. The elastic member 4500 may be coupled to the second protruding portion 4232. The elastic member 4500 may be coupled to each of the first protruding portion 4231 and the second protruding portion 4232.

In a direction in which the first protruding portion 4231 faces the second protruding portion 4232, the first protruding portion 4231 may comprise a portion being overlapped with the first portion 4111 of the housing 4110. In a direction in which the second protruding portion 4232 faces the first protruding portion 4231, the second protruding portion 4232 may comprise a portion being overlapped with the first portion 4111 of the housing 4110. The first protruding portion 4231, the first portion 4111 of the housing 4110, and the second protruding portion 4232 may be overlapped with one another in one direction. That is, the first protruding portion 4231, the first portion 4111 of the housing 4110, and the second protruding portion 4232 may be disposed on an imaginary straight line.

The holder 4210 may comprise a protrusion 4235. The protruding portion 4230 of the holder 4210 may comprise a protrusion 4235. The first protruding portion 4231 of the holder 4210 may comprise a protrusion 4235. The second protruding portion 4232 of the holder 4210 may comprise a protrusion 4235. The first protruding portion 4231 of the holder 4210 may comprise a first surface facing a first direction. At this time, the first direction may be an outward direction. The first protruding portion 4231 may comprise a protrusion 4235 being formed at a first surface of the first protruding portion 4231.

The protrusion 4235 may comprise a plurality of protrusions. The protrusion 4235 may comprise a plurality of protrusions being spaced apart from each other. The protrusion 4235 may comprise two protrusions. The protrusions 4235 may be formed on each of the first protruding portion 4231 and the second protruding portion 4232. The protrusion 4235 may comprise a first protrusion 4236 and a second protrusion 4237. The first protrusion 4236 and the second protrusion 4237 may be spaced apart from each other.

The reflective member driving device 4000 may comprise a moving plate 4300. The moving plate 4300 may be disposed between the housing 4110 and the holder 4210. The moving plate 4300 may guide the movement of the holder 4210 against the housing 4110. The moving plate 4300 may provide a tilt center of the holder 4210. That is, the holder 4210 may be tilted about the moving plate 4300. One side of the moving plate 4300 may be disposed in the holder 4210 and the other side may be disposed in the housing 4110. The moving plate 4300 may be in contact with the holder 4210 and the housing 4110. The moving plate 4300 may be disposed in the first portion 4111 of the housing 4110.

The moving plate 4300 may comprise a first ball 4310. The first ball 4310 may be disposed in the housing 4110. The first ball 4310 may be disposed in the moving plate 4300. The first ball 4310 may be disposed between the housing 4110 and the moving plate 4300. The first ball 4310 may come into contact with the housing 4110. The first ball 4310 may come into contact with the moving plate 4300. The first ball 4310 may be disposed in the groove 4115 of the housing 4110. The first ball 4310 may be disposed in the groove of the moving plate 4300. The first ball 4310 may provide a first axis tilt center for the holder 4210. The first ball 4310 may provide an X-axis tilt center for the holder 4210. The first ball 4310 may comprise two first balls. The two first balls may be spaced apart in an X-axis direction. The two first balls may be disposed on an X-axis. The holder 4210 may be tilted about the first ball 4310 of the moving plate 4300 by the first driving unit. The holder 4210 may be tilted in an up-and-down direction with respect to the first ball 4310 of the moving plate 4300 by the first driving unit.

The first ball 4310 may be formed as a protrusion being integrally formed with the moving plate 4300 in a modified embodiment. At this time, the first ball 4310 may be a first protrusion.

The moving plate 4300 may comprise a second ball 4320. The second ball 4320 may be disposed in the holder 4210. The second ball 4320 may be disposed in the moving plate 4300. The second ball 4320 may be disposed between the holder 4210 and the moving plate 4300. The second ball 4320 may come into contact with the holder 4210. The second ball 4320 may be in contact with the moving plate 4300. The second ball 4320 may be disposed in the groove 4211 of the holder 4210. The second ball 4320 may be disposed in the groove of the moving plate 4300. The second ball 4320 may provide a second axis tilt center perpendicular to the first axis for the holder 4210. The second ball 4320 may provide a Y-axis tilt center with respect to the holder 4210. The second ball 4320 may comprise two second balls. The two second balls may be spaced apart in a Y-axis direction. The two second balls may be disposed on a Y-axis. The holder 4210 may be tilted about the second ball 4320 of the moving plate 4300 by the second driving unit. The holder 4210 may be tilted in a left-to-right direction about the second ball 4320 of the moving plate 4300 as the center by the second driving unit.

The second ball 4320 may be formed as a protrusion being integrally formed with the moving plate 4300 in a modified embodiment. At this time, the second ball 4320 may be a second protrusion.

As a modified embodiment, the first ball 4310 of the moving plate 4300 provides a Y-axis tilt center to the holder 4210 and the second ball 4320 of the moving plate 4300 may provide an X-axis tilt center.

The reflective member driving device 4000 may comprise a driving unit. The driving unit may move the moving unit 4200 against the fixing unit 4100. The driving unit may tilt the moving unit 4200 against the fixing unit 4100. The driving unit may comprise a coil and a magnet. The driving unit may move the moving unit 4200 through electromagnetic interaction. As a modified embodiment, the driving unit may comprise a shape memory alloy (SMA). The driving unit may move the holder 4210 against the housing 4110. The coil and driving magnet may move the holder 4210 against the housing 4110.

The reflective member driving device 4000 may comprise a driving magnet. A driving magnet may be disposed in the holder 4210. A driving magnet may be disposed at an outer surface of the holder 4210. The driving magnet may be fixed to the holder 4210. The driving magnet may be fixed to the holder 4210 by an adhesive. The driving magnet may face the coil. The driving magnet may be disposed to face the coil. The driving magnet may be disposed at a position corresponding to the coil. The driving magnet may be in electromagnetic interaction with the coil. The driving magnet may be a 4 pole magnetized magnet. That is, each driving magnet may comprise two N poles and two S poles.

The driving magnet may comprise a plurality of magnets. The driving magnet may comprise a first driving magnet 4411 that tilts the reflective member 4220 about a first axis. The driving magnet may comprise a second driving magnet 4421 that tilts the reflective member 4220 about a second axis perpendicular to the first axis.

The reflective member driving device 4000 may comprise a coil. The coil may be in electromagnetic interaction with the driving magnet. The coil may be disposed on the substrate 4130. The coil may be disposed in the housing 4110.

The coil may comprise a first coil 4412 facing the first driving magnet 4411. The coil may comprise a second coil 4422 facing the second driving magnet 4421.

The driving unit may comprise a first driving unit. The first driving unit may tilt the moving unit 4200 against the fixing unit 4100 about a first axis. The first driving unit may tilt the moving unit 4200 against the fixing unit 4100 about an X-axis. The first driving unit may comprise a coil and a magnet. The first driving unit may move the moving unit 4200 through electromagnetic interaction. As a modified embodiment, the first driving unit may comprise a shape memory alloy (SMA).

The first driving unit may comprise a first driving magnet 4411. The first driving magnet 4411 may be disposed in the holder 4210. The first driving magnet 4411 may be disposed at a lower surface of the holder 4210. The first driving magnet 4411 may be fixed to the holder 4210. The first driving magnet 4411 may be fixed to the holder 4210 by an adhesive. The first driving magnet 4411 may move integrally with the holder 4210. The first driving magnet 4411 may be disposed to face the first coil 4412. The first driving magnet 4411 may face the first coil 4412. The first driving magnet 4411 may be disposed at a position corresponding to the first coil 4412. The first driving magnet 4411 may interact with the first coil 4412. The first driving magnet 4411 may interact with the first coil 4412 electromagnetically.

The first driving unit may comprise a first coil 4412. The first coil 4412 may be disposed on the substrate 4130. The first coil 4412 may be disposed in the housing 4110. The first coil 4412 may be disposed below the holder 4210. When a current is applied to the first coil 4412, an electromagnetic field is formed around the first coil 4412 and can interact with the first driving magnet 4411.

The reflective member driving device 4000 may comprise a first sensor 4413. The first sensor 4413 may comprise a Hall sensor. The first sensor 4413 may detect the first driving magnet 4411. The first sensor 4413 may detect the magnetic force of the first driving magnet 4411. The first sensor 4413 may detect the position of the holder 4210. The first sensor 4413 may detect the position of the reflective member 4220. The first sensor 4413 may detect an amount of tilt of the holder 4210 about an X-axis. The first sensor 4413 may detect a tilt of the reflective member 4220 about a first axis.

The reflective member driving device 4000 may comprise a yoke 4414. The yoke 4414 may be disposed between the first driving magnet 4411 and the holder 4210. The yoke 4414 may be formed in a shape corresponding to that of the first driving magnet 4411. The yoke 4414 may increase the interaction force between the first driving magnet 4411 and the first coil 4412.

The driving unit may comprise a second driving unit. The second driving unit may tilt the moving unit 4200 about a second axis with respect to the fixing unit 4100. The second driving unit may tilt the moving unit 4200 about a Y-axis with respect to the fixing unit 4100. The second driving unit may comprise a coil and a magnet. The second driving unit may move the moving unit 4200 through electromagnetic interaction. As a modified embodiment, the second actuator may comprise a shape memory alloy (SMA).

The second driving unit may comprise a second driving magnet 4421. The second driving magnet 4421 may be disposed in the holder 4210. The second driving magnet 4421 may be disposed at both side surfaces of the holder 4210. The second driving magnet 4421 may be fixed to the holder 4210. The second driving magnet 4421 may be fixed to the holder 4210 by an adhesive. The second driving magnet 4421 may move integrally with the holder 4210. The second driving magnet 4421 may be disposed to face the second coil 4422. The second driving magnet 4421 may face the second coil 4422. The second driving magnet 4421 may be disposed at a position corresponding to the second coil 4422. The second driving magnet 4421 may interact with the second coil 4422. The second driving magnet 4421 may interact with the second coil 4422 electromagnetically.

In a first embodiment of the present invention, the second driving magnet 4421 may be formed as a single magnet. However, as a modified embodiment, the second driving magnet 4421 may comprise two magnets being spaced apart from each other. The two magnets may be symmetrically disposed at an opposite side with respect to the reflective member 4220.

The second driving unit may comprise a second coil 4422. The second coil 4422 may be disposed on the substrate 4130. The second coil 4422 may be disposed in the housing 4110. The second coil 4422 may be disposed at both sides of the holder 4210. When a current is applied to the second coil 4422, an electromagnetic field is formed around the second coil 4422 and can interact with the second driving magnet 4421.

In a first embodiment of the present invention, the second coil 4422 may be formed as one coil. However, as a modified embodiment, the second coil 4422 may comprise two coils being spaced apart from each other. The two coils may be symmetrically disposed at an opposite side with respect to the reflective member 4220. The two coils may be disposed to electromagnetically interact with the two magnets, respectively. Meanwhile, the two coils may be electrically connected to each other.

The reflective member driving device 4000 may comprise a second sensor 4423. The second sensor 4423 may comprise a Hall sensor. The second sensor 4423 may detect the second driving magnet 4421. The second sensor 4423 may detect the magnetic force of the second driving magnet 4421. The second sensor 4423 may detect the position of the holder 4210. The second sensor 4423 may detect the position of the reflective member 4220. The second sensor 4423 may detect the amount of tilt of the holder 4210 about a Y-axis. The second sensor 4423 may detect tilt of the reflective member 4220 about a second axis.

The reflective member driving device 4000 may comprise a yoke 4424. The yoke 4424 may be disposed between the second driving magnet 4421 and the holder 4210. The yoke 4424 may be formed in a shape corresponding to that of the second driving magnet 4421. The yoke 4424 may increase the interaction force between the second driving magnet 4421 and the second coil 4422.

The reflective member driving device 4000 may comprise a dummy member 4425. The dummy member 4425 may be a weight member. The dummy member 4425 may be disposed at an opposite side of the second driving magnet 4421. The dummy member 4425 may be disposed to correspond to the second driving magnet 4421. The dummy member 4425 may have a weight corresponding to that of the second driving magnet 4421. The dummy member 4425 may have weaker magnetism than the second driving magnet 4421. The dummy member 4425 may be non-magnetic. The dummy member 4425 may comprise a portion that is non-magnetic or has weaker magnetism than the second driving magnet 4421. The dummy member 4425 may be formed with a corresponding weight to balance with the second driving magnet 4421 and disposed at an opposite side of the second driving magnet 4421. The dummy member 4425 may be disposed in the holder 4210.

In a first embodiment of the present invention, the dummy member 4425 may be disposed to improve bending in left and right driving. More specifically, in order to improve the bending of the left and right driving of the holder 4210, one of the two second driving magnets 4421 may be omitted and a dummy member 4425 may be disposed in its place. The dummy member 4425 may be a balance weight.

As a modified embodiment, the dummy member 4425 may be omitted and an additional second driving magnet 4421 may be disposed. At this time, a second coil 4422 facing the second driving magnet 4421 may be additionally disposed.

The reflective member driving device 4000 may comprise an elastic member 4500. The elastic member 4500 may be a back spring. The elastic member 4500 may pull the holder 4210 with the restoring force of the spring. The housing 4110 and the holder 4210 may be coupled by an elastic member 4500. In addition, the moving plate 4300 may be pressed by the elastic member 4500. The first embodiment of the present invention is a structure using a spring, and can implement a more stable holding force than magnet magnetic force.

The elastic member 4500 may connect the housing 4110 and the holder 4210. The elastic member 4500 may elastically connect the housing 4110 and the holder 4210. The holder 4210 may be movably disposed in the housing 4110 by the elastic member 4500. The elastic member 4500 may be disposed at an opposite side of the moving plate 4300 with respect to the first portion 4111 of the housing 4110.

The elastic member 4500 may be directly coupled to the holder 4210. The elastic member 4500 may be coupled to a first surface of the housing 4110 facing a first direction. The elastic member 4500 may be coupled to the protruding portion 4230 of the holder 4210. The elastic member 4500 may be coupled to the protruding portion 4230 being protruded in a first direction of the holder 4210. The elastic member 4500 may pull the holder 4210 in a first direction. The elastic member 4500 may pull the holder 4210 so that the moving plate 4300 is not separated between the housing 4110 and the holder 4210. At least a portion of the elastic member 4500 may have elasticity. The elastic member 4500 may comprise a portion having elasticity. The elastic member 4500 may be a leaf spring. The elastic member 4500 may comprise a fixing unit being coupled to the housing 4110 and the holder 4210 and a leg part connecting the two fixing units. The leg part may have elasticity.

A first embodiment of the present invention may comprise a structure for generating a holding force in the reflective member driving device 4000. In a comparative example, the holding force may be created using the magnetic force of the magnet. In a first embodiment of the present invention, the holding force can be created using the elasticity of the elastic member 4500 instead of the magnet. The holder 4210 may be maintained in a state of pressing the moving plate 4300 by the elastic member 4500. In a first embodiment of the present invention, in an initial state in which the holder 4210 does not move by the elastic member 4500, the moving plate 4300 may remain in contact with the holder 4210 and the housing 4110. Furthermore, even when the holder 4210 is moved by the elastic member 4500, the moving plate 4300 may maintain contact with the holder 4210 and the housing 4110. Through this, the moving plate 4300 may guide the movement of the holder 4210.

The elastic member 4500 may comprise an outer portion 4510. The outer portion 4510 may be coupled to the housing 4110. The outer portion 4510 may be disposed in the housing 4110. The outer portion 4510 may be fixed to the housing 4110. The outer portion 4510 may be attached to the housing 4110 with an adhesive. The outer portion 4510 may be disposed at an outer surface of the housing 4110. The outer portion 4510 may be disposed in the groove 4119 of the housing 4110. The distance between the outer portion 4510 and an image sensor 6400 may be longer than the distance between the inner portion 4520 and the image sensor 6400.

The elastic member 4500 may comprise an inner portion 4520. The inner portion 4520 may be coupled to the holder 4210. The inner portion 4520 may be disposed in the holder 4210. The inner portion 4520 may be fixed to the holder 4210. The inner portion 4520 may be attached to the holder 4210 with an adhesive. The inner portion 4520 may be coupled to the protruding portion 4230 of the holder 4210. The inner portion 4520 may be disposed in the protruding portion 4230 of the holder 4210. The inner portion 4520 may be fixed to the protruding portion 4230 of the holder 4210. The inner portion 4520 may be attached to the protruding portion 4230 of the holder 4210 with an adhesive. The inner portion 4520 may be coupled to an end of the protruding portion 4230 of the holder 4210. The inner portion 4520 may be coupled to an outer surface of the protruding portion 4230 of the holder 4210.

The inner portion 4520 may comprise a plurality of inner portions. The plurality of inner portions may comprise four inner portions. The four inner portions may be spaced apart from one another. The four inner portions may be disposed on one virtual plane. All four inner portions may be disposed in parallel.

An optical axis of light incident on the reflective member 4220 may be a first optical axis. An optical axis of light emitted from the reflective member 4220 may be a second optical axis. In a cross section cut by an imaginary plane comprising the first optical axis and the second optical axis, the inner portion 4520 may be disposed at a more inner side than the outer portion 4510. More specifically, in a cross section cut by an imaginary plane comprising the first optical axis and the second optical axis, the inner portion 4520 may be disposed inside the outer portion 4510 by a first distance (see d in FIG. 14). Through this, an outward preload may be applied to the holder 4525 coupled to the inner portion 4520. In cross section, the inner portion 4520 may be disposed at a more outer side than the moving plate 4300.

The elastic member 4500 may comprise a hole 4525. An inner portion 4520 of the elastic member 4500 may comprise a hole 4525. The hole 4525 may be coupled with the protrusion 4525 of the protruding portion 4230 of the holder 4210. The hole 4525 may be formed in a shape corresponding to the protrusion 4525 of the protruding portion 4230 of the holder 4210.

The elastic member 4500 may comprise a first portion 4521. The inner portion 4520 of the elastic member 4500 may comprise a first portion 4521. The first portion 4521 may be coupled with the first protrusion 4236.

The elastic member 4500 may comprise a second portion 4522. The inner portion 4520 of the elastic member 4500 may comprise a second portion 4522. The second portion 4522 may be coupled with the second protrusion 4237.

In a modified embodiment as illustrated in FIG. 16, the elastic member 4500 may comprise a third portion 4523. The inner portion 4520 of the elastic member 4500 may comprise a third portion 4523. The third portion 4523 may connect the first portion 4521 and the second portion 4522.

The elastic member 4500 may comprise a connecting portion 4530. The connecting portion 4530 may be an elastic portion. The connecting portion 4530 may be a leg part. The connecting portion 4530 may connect the outer portion 4510 and the inner portion 4520. The connecting portion 4530 may have elasticity. The connecting portion 4530 may elastically connect the outer portion 4510 and the inner portion 4520. The connecting portion 4530 may comprise a shape bent at least once.

The connecting portion 4530 may comprise a plurality of connecting portions. The plurality of connecting portions may be formed in a number corresponding to the plurality of inner portions. The plurality of connecting portions may comprise four connecting portions. The four connecting portions may connect one outer portion and four inner portions. The four outer portions may be spaced apart from one another. The four outer portions may have the same shape or symmetrical shapes.

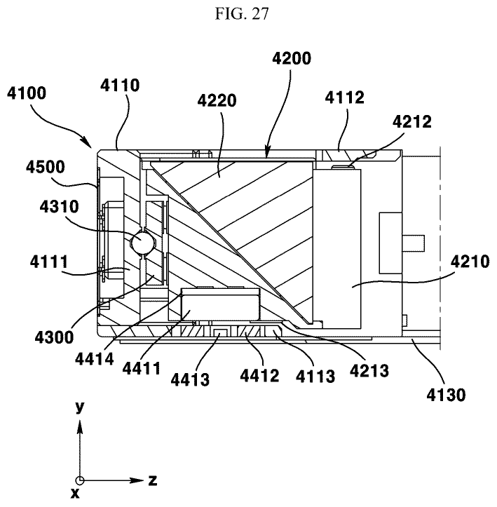

FIGS. 27 to 29 are views for explaining the tilt of a reflective member driving device according to a first embodiment of the present invention about an X-axis.

In a first embodiment of the present invention, the holder 4210 may be disposed between an upper plate and a lower plate of the housing 4110 in an initial state in which current is not supplied to the first driving unit. At this time, the holder 4210 may be spaced apart from both the upper plate and the lower plate of the housing 4110 (see FIG. 27).

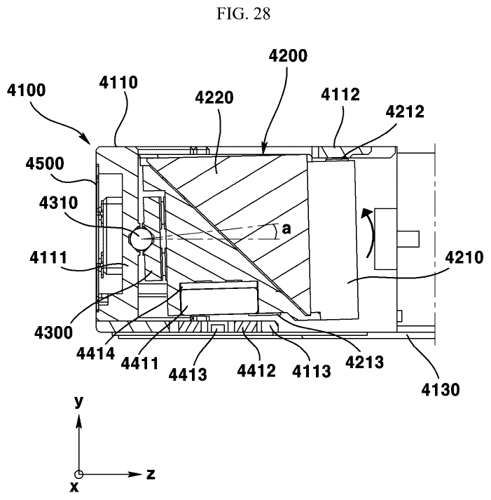

At this time, when a current in the first direction is applied to the first coil 4412, the holder 4210 may tilt upward about the first ball 4310 of the moving plate 4300 by the electromagnetic interaction between the first coil 4412 and the first driving magnet 4411 (see a in FIG. 28).

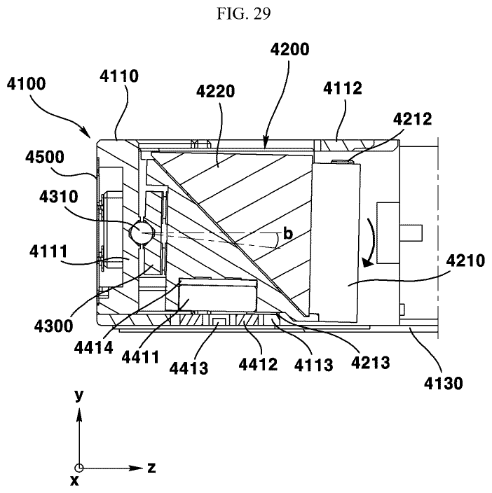

Meanwhile, when a current in a second direction opposite to the first direction is applied to the first coil 4412, the holder 4210 may tilt downward about the first ball 4310 of the moving plate 4300 by the electromagnetic interaction between the first coil 4412 and the first driving magnet 4411 (see b in FIG. 29).

That is, current is selectively applied to the first coil 4412 in both directions so that the holder 4210 may be tilted in an up-and-down direction about an X-axis with respect to the housing 4110. At this time, since the reflective member 4220 is also tilted along with the holder 4210, the optical path is changed so that shaking detected by the gyro sensor 4150 can be offset.

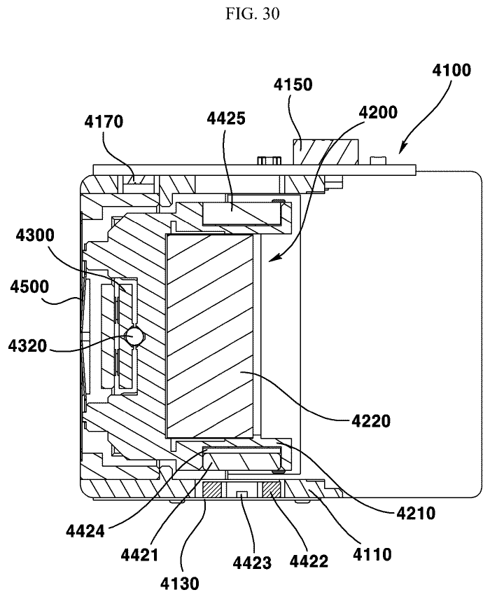

FIGS. 30 to 32 are views for explaining the tilt of a reflective member driving device according to a first embodiment of the present invention about a Y-axis.

In a first embodiment of the present invention, the holder 4210 may be disposed between both side plates of the housing 4110 in an initial state in which current is not supplied to the second driving unit. At this time, the holder 4210 may be spaced apart from both side plates of the housing 4110 (see FIG. 30).

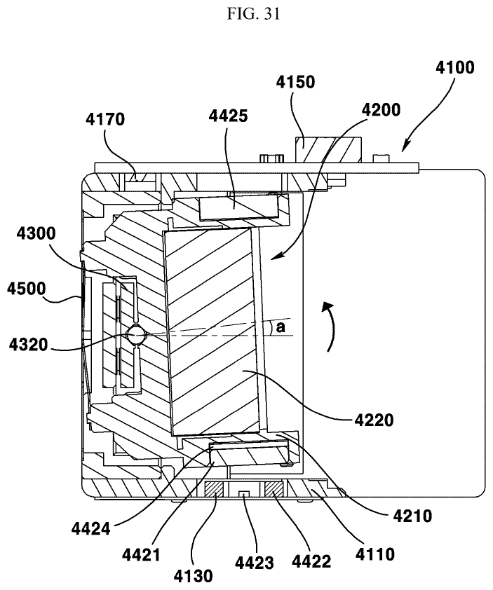

At this time, when the current in a first direction is applied to the second coil 4422, the holder 4210 may be tilted to one side about the second ball 4320 of the moving plate 4300 by the electromagnetic interaction between the second coil 4422 and the second driving magnet 4421 (see a in FIG. 31).

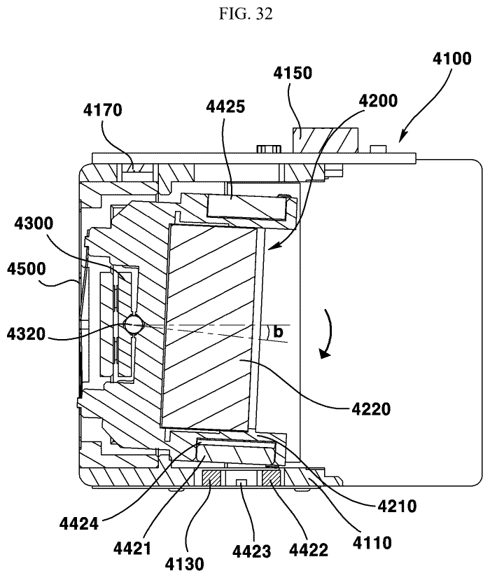

Meanwhile, when a current in a second direction opposite to a first direction is applied to the second coil 4422, the holder 4210 may be tilted to the other side about the second ball 4320 of the moving plate 4300 by the electromagnetic interaction between the second coil 4422 and the second driving magnet 4421 (see b in FIG. 32).

That is, as a current is selectively applied to the second coil 4422 in both directions, the holder 4210 may be tilted in a left-to-right direction against the housing 4110 about a Y-axis. At this time, since the reflective member 4220 is also tilted along with the holder 4210, the optical path is changed so that shaking detected by the gyro sensor 4150 can be offset.

In a first embodiment of the present invention, hand shake correction may be performed for X-axis tilt and Y-axis tilt, that is, 2-axis tilt.

Hereinafter, a lens driving device according to a first embodiment of the present invention will be described with reference to the drawings.

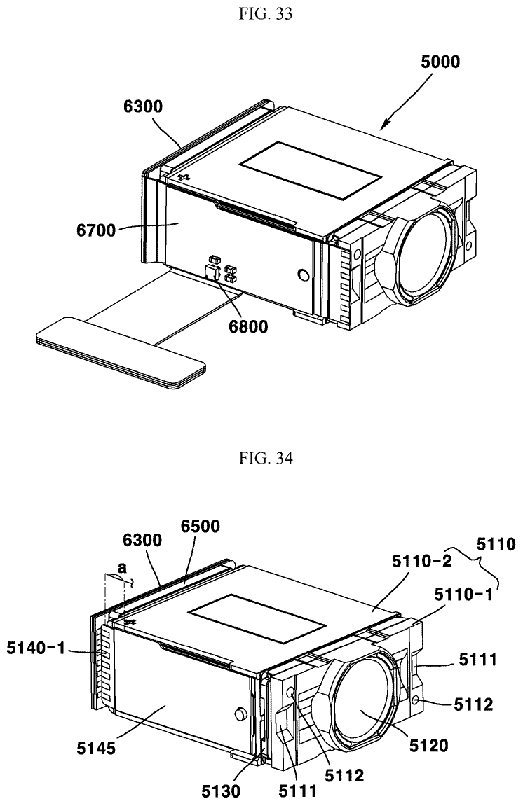

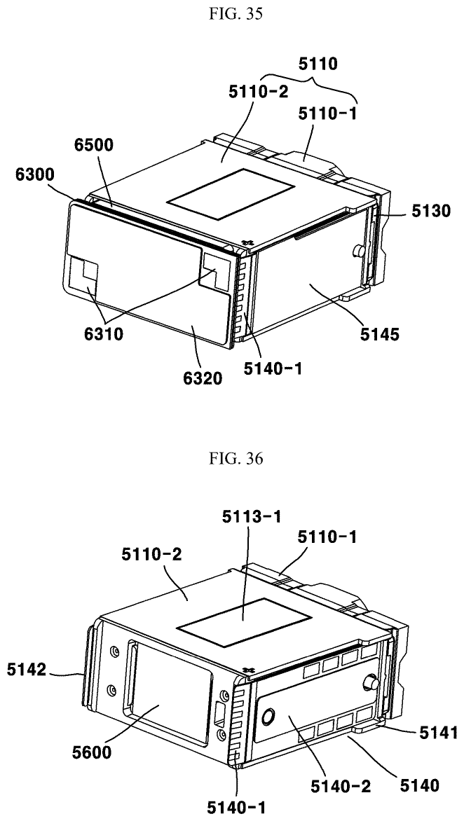

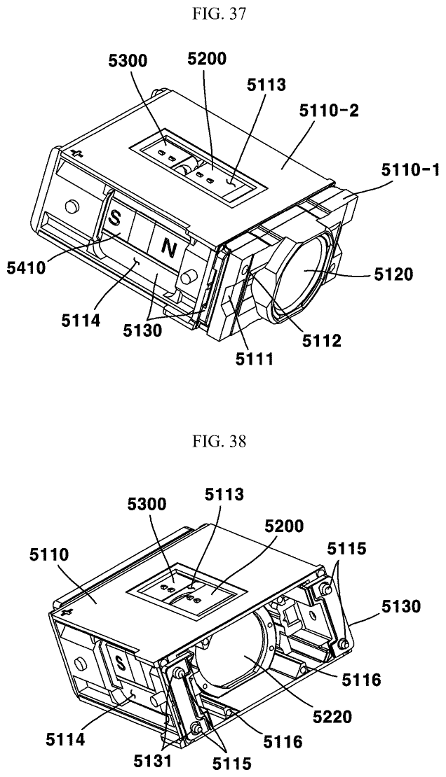

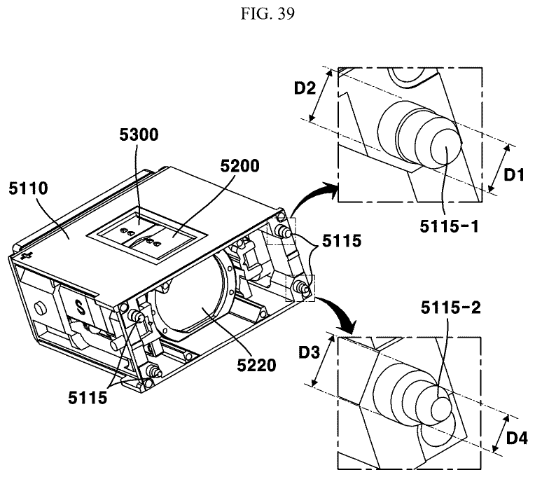

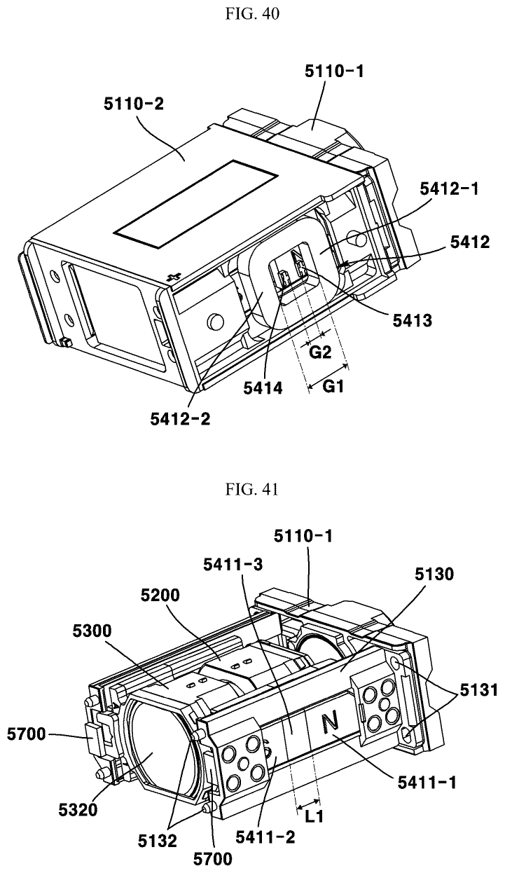

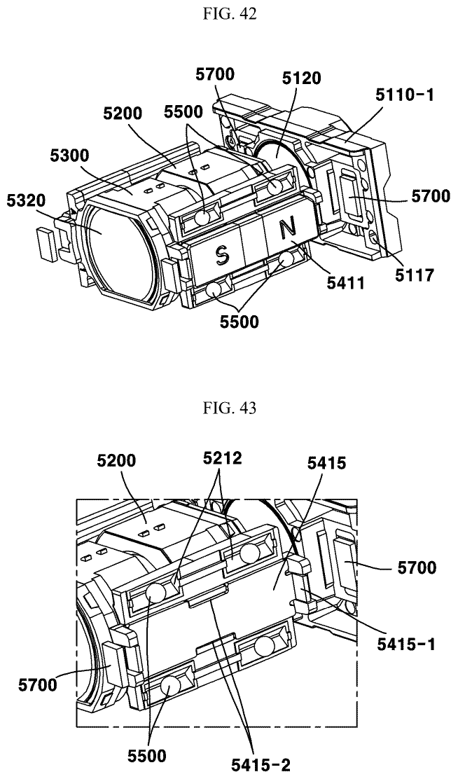

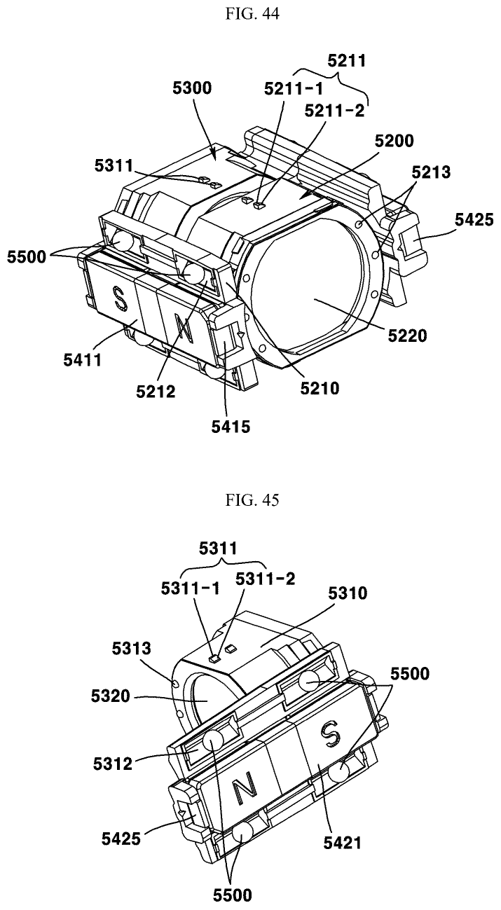

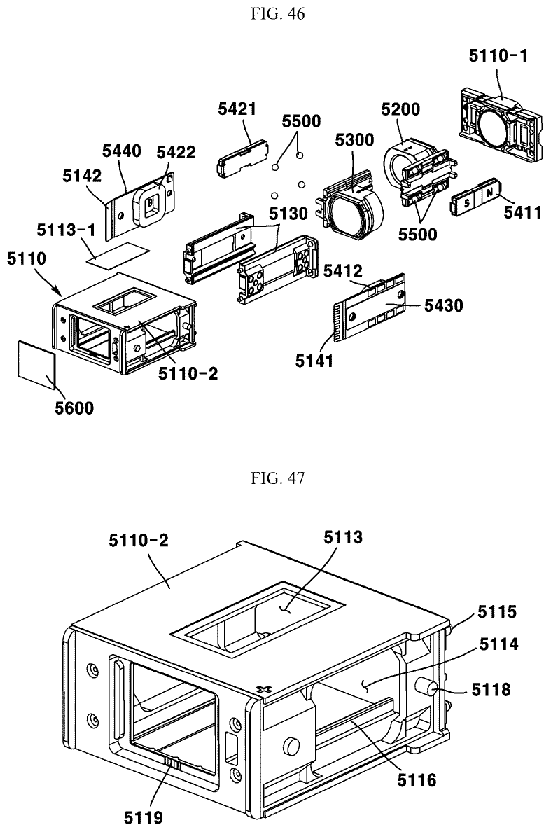

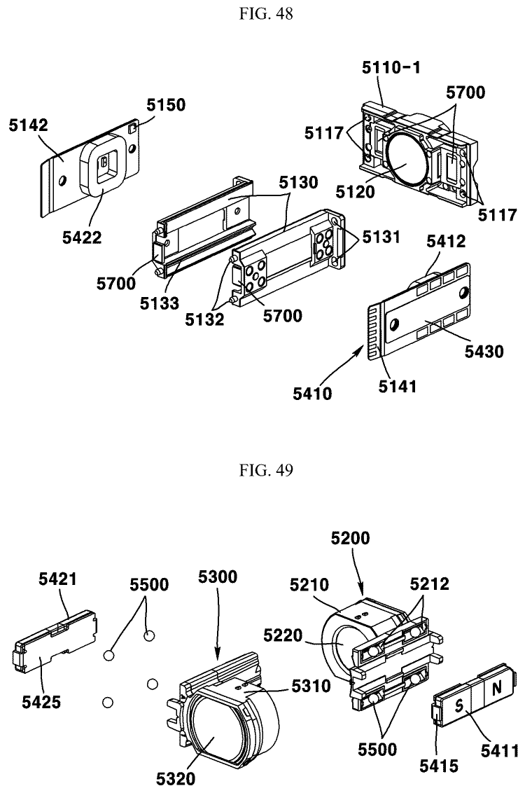

FIG. 33 is a perspective view of a lens driving device according to a first embodiment of the present invention; FIG. 34 is a perspective view of a lens driving device according to a first embodiment of the present invention, in which some components are omitted; FIG. 35 is a perspective view of a lens driving device in the state illustrated in FIG. 34 viewed from another direction; FIG. 36 is a perspective view of a lens driving device according to a first embodiment of the present invention, in which some components are omitted; FIG. 37 is a perspective view of a state in which components such as a substrate and a coil are omitted in a lens driving device according to a first embodiment of the present invention; FIG. 38 is a perspective view of a lens driving device illustrated in FIG. 37, in which the first lens and related components are omitted; FIG. 39 is a perspective view and a partial enlarged view of a part of a lens driving device according to a first embodiment of the present invention; FIG. 40 is a view for explaining the arrangement structure of a coil and a sensor of a lens driving device according to a first embodiment of the present invention; FIG. 41 is a perspective view of a state in which the second housing is omitted in the lens driving device illustrated in FIG. 37; FIG. 42 is a perspective view of a state in which a guide rail is omitted from the lens driving device illustrated in FIG. 41; FIG. 43 is an enlarged view of a part of a lens driving device according to a first embodiment of the present invention; FIG. 44 is a perspective view of a first moving unit and a second moving unit and related components of a lens driving device according to a first embodiment of the present invention; FIG. 45 is a perspective view of a second moving unit and related components of a lens driving device according to a first embodiment of the present invention; FIG. 46 is an exploded perspective view of a lens driving device according to a first embodiment of the present invention; FIG. 47 is a perspective view of a second housing of a lens driving device according to a first embodiment of the present invention; FIGS. 48 and 49 are exploded perspective views of some components of a lens driving device according to a first embodiment of the present invention; and FIG. 50 is a cross-sectional view of a lens driving device according to a first embodiment of the present invention.

The lens driving device 5000 may perform a zoom function. The lens driving device 5000 may perform a continuous zoom function. The lens driving device 5000 may perform an auto focus (AF) function. The lens driving device 5000 may move a lens. The lens driving device 5000 may move a lens along an optical axis. The lens driving device 5000 may move lenses formed in a plurality of groups by group. The lens driving device 5000 may move the second group lenses. The lens driving device 5000 may move the third group lenses. The lens driving device 5000 may be a lens actuator. The lens driving device 5000 may be an AF actuator. The lens driving device 5000 may be a zoom actuator. The lens driving device 5000 may comprise a voice coil motor (VCM).

The lens driving device 5000 may comprise a lens. Or, the lens may be described as a component of the camera device 4010 rather than a component of the lens driving device 5000. The lens may be disposed in an optical path formed by the reflective member 4220 of the reflective member driving device 4000 and the image sensor 6400. A lens may comprise a plurality of lenses. A plurality of lenses may form a plurality of groups. Lenses may form three groups. The lens may comprise first to third group lenses. A first group lens, a second group lens, and a third group lens may be sequentially disposed between the reflective member 4220 and the image sensor 6400. The first group lens may comprise a first lens 5120. The second group lens may comprise a second lens 5220. The third group lens may comprise a third lens 5320.

The lens driving device 5000 may comprise a fixing unit 5100. The fixing unit 5100 may be a relatively fixed part when the first moving unit 5200 and the second moving unit 5300 move.

The lens driving device 5000 may comprise a housing 5110. The fixing unit 5100 may comprise a housing 5110. The housing 5110 may be disposed outside the first holder 5210 and the second holder 5310. The housing 5110 may accommodate at least a portion of the first holder 5210 and the second holder 5310. The housing 5110 may comprise a front plate, a rear plate, and a plurality of connecting plates. At this time, the front plate may be referred to as an upper plate, the rear plate may be referred to as a lower plate, and the connecting plate may be referred to as a side plate.

The housing 5110 may comprise a first housing 5110-1. The first housing 5110-1 may form a front plate of the housing 5110. The first housing 5110-1 may be coupled to the first lens 5120. The first housing 5110-1 may be a cover. The first housing 5110-1 may be coupled to the reflective member driving device 4000. A first lens 5120 may be fixed to the first housing 5110-1.

The housing 5110 may comprise a second housing 5110-2. The second housing 5110-2 may form a rear plate and a connecting plate of the housing 5110. The second housing 5110-2 may be opened forward. The first housing 5110-1 may be coupled to the front of the second housing 5110-2. A portion of the guide rail 5130 may be disposed between the first housing 5110-1 and the second housing 5110-2.

The housing 5110 may comprise a first groove 5111. The first groove 5111 may be coupled to the protruding portion 4116 of the housing 4110 of the reflective member driving device 4000. The first groove 5111 may be formed in a shape corresponding to the protruding portion 4116 of the reflective member driving device 4000. An adhesive for coupling the reflective member driving device 4000 to the lens driving device 5000 may be disposed in the first groove 5111.

The housing 5110 may comprise a second groove 5112. The second groove 5112 may be coupled to the protrusion 4117 of the housing 4110 of the reflective member driving device 4000. A protrusion 4117 of the reflective member driving device 4000 may be inserted into the second groove 5112. The second groove 5112 may be formed in a shape corresponding to the protrusion 4117 of the reflective member driving device 4000. An adhesive for coupling the reflective member driving device 4000 to the lens driving device 5000 may be disposed in the second groove 5112.

The housing 5110 may comprise a first hole 5113. The first hole 5113 may expose the protrusion 5211 of the first holder 5210 and the protrusion 5311 of the second holder 5310. The first hole 5113 may be formed in the connecting plate of the housing 5110. In the testing phase of manufacturing, it can be confirmed whether the lens driving device 5000 is normally operating by checking the protrusion 5211 of the first holder 5210 being exposed through the first hole 5113 and the protrusion 5311 of the second holder 5310.

The housing 5110 may comprise a plate 5113-1. The plate 5113-1 may cover the first hole 5113. The plate 5113-1 may be disposed in the first hole 5113 to close the first hole 5113.

The housing 5110 may comprise a second hole 5114. The second hole 5114 may be a coil accommodating hole in which the first coil 5412 and the second coil 5422 are disposed. A first coil 5412 and a second coil 5422 may be disposed in the second hole 5114. The second hole 5114 may be larger than the first coil 5412 and the second coil 5422.

The housing 5110 may comprise a protrusion 5115. The protrusion 5115 may be formed in the second housing 5110-2. The protrusion 5115 may be formed by a two-step protrusion. The protrusion 5115 may be coupled with the guide rail 5130. The protrusion 5115 may be coupled with the first housing 5110-1. The guide rail 5130 may be coupled to the large-diameter portion of the protrusion 5115 and the first housing 5110-1 may be coupled to the small-diameter portion of the protrusion 5115.

The protrusion 5115 may comprise a first protrusion 5115-1. The first protrusion 5115-1 may comprise a first portion having a first diameter D2 and a second portion being protruded from the first portion and having a second diameter D1. The protrusion 5115 may comprise a second protrusion 5115-2. The second protrusion 5115-2 may comprise a third portion having a third diameter D3 and a fourth portion being protruded from the third portion and having a fourth diameter D4. At this time, the fourth diameter D4 may be smaller than the second diameter D1. Through this, the first protrusion 5115-1 may be more tightly coupled to the first housing 5110-1 than the second protrusion 5115-2.

The housing 5110 may comprise a guide protrusion 5116. The guide protrusion 5116 may be formed on an inner surface of the housing 5110. The guide protrusion 5116 may be formed in a shape corresponding to the shape of at least a portion of the first holder 5210 and the second holder 5310. Through this, the guide protrusion 5116 may guide the movement of the first holder 5210 and the second holder 5310 in an optical axis direction. At this time, the optical axis direction may be a Z-axis direction perpendicular to the X-axis and the Y-axis. The guide protrusion 5116 may be disposed in an optical axis direction. The guide protrusion 5116 may be extended in an optical axis direction.

The housing 5110 may comprise a groove 5117. The groove 5117 may be formed in the first housing 5110-1. The groove 5117 of the first housing 5110-1 may be coupled with the protrusion 5115 of the second housing 5110-2.

The housing 5110 may comprise a protrusion 5118. The protrusion 5118 may be coupled with the substrate 5140. The protrusion 5118 may be inserted into a groove in the substrate 5140. The protrusion 5118 may be formed in a size and shape corresponding to the groove of the substrate 5140.

The housing 5110 may comprise a vent hole 5119. The vent hole 5119 may be formed in the rear plate of the housing 5110. The vent hole 5119 may form a gap between the housing 5110 and a dummy glass 5600. Air may flow into the gap between the housing 5110 and the dummy glass 5600. Through the vent hole 5119, the gas being generated during the curing process of the adhesive can escape.

The lens driving device 5000 may comprise a first lens 5120. Or, the first lens 5120 may be described as a component of the camera device 4010 rather than a component of the lens driving device 5000. The fixing unit 5100 may comprise a first lens 5120. The first lens 5120 may be disposed on an optical axis. The first lens 5120 may be disposed between the reflective member 4220 and the image sensor 6400. The first lens 5120 may be disposed between the reflective member 4220 and the second lens 5220. The first lens 5120 may be disposed inside the first housing 5110-1. The first lens 5120 may be fixed to the first housing 5110-1. The first lens 5120 may remain fixed even when the second lens 5220 and the third lens 5320 move.

The first lens 5120 may be a first group lens. The first lens 5120 may comprise a plurality of lenses. The first lens 5120 may comprise three lenses.

The lens driving device 5000 may comprise a guide rail 5130. The fixing unit 5100 may comprise a guide rail 5130. The guide rail 5130 may be coupled between the first housing 5110-1 and the second housing 5110-2. The guide rail 5130 may guide the movement of the first holder 5210 and the second holder 5310. The rail 5130 may guide the first holder 5210 and the second holder 5310 to move in an optical axis direction. The guide rail 5130 may comprise a rail being disposed in an optical axis direction. The guide rail 5130 may comprise a rail being extended in an optical axis direction. The guide rail 5130 may comprise a rail being formed wherein the ball 5500 rolls thereon.

The lens driving device 5000 may comprise a substrate 5140. The fixing unit 5100 may comprise a substrate 5140. The substrate 5140 may be disposed on both side surfaces of the housing 5110. The substrate 5140 may be an FPCB. A first coil 5412 and a second coil 5422 may be disposed on the substrate 5140.

The substrate 5140 may comprise a first region 5140-1. The first region 5140-1 may be formed at an end of the substrate 5140. A terminal may be disposed in the first region 5140-1. The substrate 5140 may comprise a second region 5140-2. The first region 5140-1 of the substrate 5140 may be bent inward with respect to the second region 5140-2. Through this, it is possible to minimize the size of the printed circuit board 6300 while securing an arrangement region for soldering that connects the terminal of the board 5140 and the printed circuit board 6300. The first region 5140-1 may form an obtuse angle with the second region 5140-2.

The substrate 5140 may comprise a first substrate 5141. The first substrate 5141 may be disposed at one side of the housing 5110. A first coil 5412 may be disposed on the first substrate 5141. First and second Hall sensors 5413 and 5414 may be disposed on the first substrate 5141.

The substrate 5140 may comprise a second substrate 5142. The second substrate 5142 may be disposed on the other side of the housing 5110. The second substrate 5142 may be disposed at an opposite side of the first substrate 5141. A second coil 5422 may be disposed on the second substrate 5142. Third and fourth Hall sensors 5423 and 5424 may be disposed on the second substrate 5142.

The lens driving device 5000 may comprise a SUS 5145. The SUS 5145 may be disposed on substrate 5140. The SUS 5145 may reinforce the strength of the substrate 5140. The SUS 5145 may dissipate heat generated from the substrate 5140.

The lens driving device 5000 may comprise an EEPROM 5150. The EEPROM 5150 may be electrically connected to the first coil 5412 and the second coil 5422. The EEPROM 5150 may be used to control currents being applied to the first coil 5412 and the second coil 5422 before connecting the lens driving device 5000 to the driver IC 6900 in the manufacturing process. That is, the EEPROM 5150 may be used to test whether the lens driving device 5000 normally operates. The EEPROM 5150 may be disposed on an inner surface of the substrate 5140.

The lens driving device 5000 may comprise a first moving unit 5200. The first moving unit 5200 may move against the fixing unit 5100. At least a portion of the first moving unit 5200 may be disposed between the fixing unit 5100 and the second moving unit 5300. The first moving unit 5200 may move between the fixing unit 5100 and the second moving unit 5300.

The lens driving device 5000 may comprise a first holder 5210. The first moving unit 5200 may comprise a first holder 5210. The first holder 5210 may be disposed inside the housing 5110. The first holder 5210 may move against the housing 5110. At least a portion of the first holder 5210 may be spaced apart from the housing 5110. The first holder 5210 may be in contact with the housing 5110. The first holder 5210 may come into contact with the housing 5110 when moving. Or, the first holder 5210 may be in contact with the housing 5110 in an initial state.

The first holder 5210 may comprise a protrusion 5211. The protrusion 5211 may be a test protrusion. The protrusion 5211 may be formed on an outer surface of the first holder 5210. The protrusion 5211 may be protruded from the first holder 5210. The protrusion 5211 may be visible from the outside through the first hole 5113 of the housing 5110. The protrusion 5211 may be used when testing whether the lens driving device 5000 normally operates. The protrusion 5211 may comprise a flat surface 5211-1 and an inclined surface 5211-2.

The first holder 5210 may comprise a rail groove 5212. A ball 5500 may be disposed in the rail groove 5212. In the rail groove 5212, the ball 5500 can roll. The rail groove 5212 and the ball 5500 may be in contact with each other at two points. The rail grooves 5212 may be disposed in an optical axis direction. The rail groove 5212 may be extended in an optical axis direction.

The rail groove 5212 may comprise a plurality of rail grooves. The rail groove 5212 may comprise four rail grooves. The rail groove 5212 may comprise first to fourth rail grooves. One or more balls 5500 may be disposed in each of the plurality of rail grooves 5212.

The first holder 5210 may comprise a protrusion 5213. The protrusion 5213 may be formed on a surface of the first holder 5210 facing the first housing 5110-1. The protrusion 5213 may come into contact with the first housing 5110-1 when the first holder 5210 moves in a direction being closer to the first housing 5110-1. At this time, compared to the case where the protrusion 5213 is omitted, when the protrusion 5213 is formed, the contact area between the first holder 5210 and the first housing 5110-1 can be reduced. Through this, shock and noise being generated due to the contact between the first holder 5210 and the first housing 5110-1 can be minimized.

The lens driving device 5000 may comprise a second lens 5220. Or, the second lens 5220 may be described as a component of the camera device 4010 rather than a component of the lens driving device 5000. The first moving unit 5200 may comprise a second lens 5220. The second lens 5220 may be disposed in an optical axis. The second lens 5220 may be disposed between the reflective member 4220 and the image sensor 6400. The second lens 5220 may be disposed between the first lens 5120 and the third lens 5320. The second lens 5220 may be disposed inside the first holder 5210. The second lens 5220 may be coupled to the first holder 5210. The second lens 5220 may be fixed to the first holder 5210. The second lens 5220 may move against the first lens 5120. The second lens 5220 may move separately from the third lens 5320.

The second lens 5220 may be a second group lens. The second lens 5220 may comprise a plurality of lenses. The second lens 5220 may comprise two lenses.

The lens driving device 5000 may comprise a second moving unit 5300. The second moving unit 5300 may move against the fixing unit 5100. The second moving unit 5300 may move separately from the first moving unit 5200. The second moving unit 5300 may be disposed at a rear side of the first moving unit 5200. The second moving unit 5300 may move in directions approaching and away from the first moving unit 5200.

The lens driving device 5000 may comprise a second holder 5310. The second moving unit 5300 may comprise a second holder 5310. The second holder 5310 may be disposed inside the housing 5110. The second holder 5310 may move against the housing 5110. At least a portion of the second holder 5310 may be spaced apart from the housing 5110. The second holder 5310 may come into contact with the housing 5110. The second holder 5310 may come into contact with the housing 5110 when moving. Or, the second holder 5310 may come into contact with the housing 5110 in an initial state. The second holder 5310 may be in contact with the first holder 5210. The second holder 5310 may be spaced apart from the first holder 5210. The second holder 5310 may come into contact with the first holder 5210 when moving. Or, the second holder 5310 may be in contact with the first holder 5210 in an initial state.

The second holder 5310 may comprise a protrusion 5311. The protrusion 5311 may be a test protrusion. The protrusion 5311 may be formed on an outer surface of the second holder 5310. The protrusion 5311 may be protruded from the second holder 5310. The protrusion 5311 may be visible from the outside through the first hole 5113 of the housing 5110. The protrusion 5311 may be used when testing whether the lens driving device 5000 normally operates. The protrusion 5311 may comprise a flat surface 5311-1 and an inclined surface 5311-2.

The second holder 5310 may comprise a rail groove 5312. A ball 5500 may be disposed in the rail groove 5312. In the rail groove 5312, the ball 5500 may roll. The rail groove 5312 and the ball 5500 may be in contact with each other at two points. The rail groove 5312 may be disposed in an optical axis direction. The rail groove 5312 may be extended in an optical axis direction.

The rail groove 5312 may comprise a plurality of rail grooves. The rail groove 5312 may comprise four rail grooves. The rail groove 5312 may comprise first to fourth rail grooves. One or more balls 5500 may be disposed in each of the plurality of rail grooves 5312.

The second holder 5310 may comprise a protrusion 5313. The protrusion 5313 may be formed on a surface of the second holder 5310 facing the first holder 5210. The protrusion 5313 may come into contact with the first holder 5210 when the second holder 5310 moves in a direction being closer to the first holder 5210. At this time, compared to the case where the protrusion 5313 is omitted, the contact area between the second holder 5310 and the first holder 5210 can be reduced when the protrusion 5313 is formed. Through this, shock and noise being generated due to contact between the second holder 5310 and the first holder 5210 can be minimized.

The lens driving device 5000 may comprise a third lens 5320. Or, the third lens 5320 may be described as a component of the camera device 4010 rather than a component of the lens driving device 5000. The second moving unit 5300 may comprise a third lens 5320. The third lens 5320 may be disposed on an optical axis. The third lens 5320 may be disposed between the reflective member 4220 and the image sensor 6400. The third lens 5320 may be disposed between the second lens 5220 and the image sensor 6400. The third lens 5320 may be disposed inside the second holder 5310. The third lens 5320 may be coupled to the second holder 5310. The third lens 5320 may be fixed to the second holder 5310. The third lens 5320 may move against the first lens 5120. The third lens 5320 may move separately from the second lens 5220.

The third lens 5320 may be a third group lens. The third lens 5320 may comprise a plurality of lenses. The third lens 5320 may comprise two lenses.

The lens driving device 5000 may comprise a driving unit 5400. The driving unit 5400 may move at least some of the plurality of lenses. The driving unit 5400 may move the first moving unit 5200 and the second moving unit 5300 against the fixing unit 5100. The driving unit 5400 may comprise a coil and a magnet. The driving unit 5400 may move the first moving unit 5200 and the second moving unit 5300 through electromagnetic interaction. As a modified embodiment, the driver 5400 may comprise a shape memory alloy.

The driving unit 5400 may comprise a first driving unit 5410. The first driving unit 5410 may move the first moving unit 5200 against the fixing unit 5100. The first driving unit 5410 may move the first moving unit 5200 against the second moving unit 5300. The first driving unit 5410 may be used to drive a zoom function. Or, the first driving unit 5410 may be used to drive an auto focus function.

The first driving unit 5410 may comprise a first driving magnet 5411. The first driving magnet 5411 may be disposed in the first holder 5210. The first driving magnet 5411 may be disposed on a side surface of the first holder 5210. The first driving magnet 5411 may be coupled to the first holder 5210. The first driving magnet 5411 may be fixed to the first holder 5210. The first driving magnet 5411 may be fixed to the first holder 5210 by an adhesive. The first driving magnet 5411 may move integrally with the first holder 5210. The first driving magnet 5411 may face the first coil 5412. The first driving magnet 5411 may face the first coil 5412. The first driving magnet 5411 may be disposed at a position corresponding to the first coil 5412. The first driving magnet 5411 may interact with the first coil 5412. The first driving magnet 5411 may interact with the first coil 5412 electromagnetically.

The first driving magnet 5411 may comprise a first magnet portion 5411-1. The first magnet portion 5411-1 may have a first polarity. The first driving magnet 5411 may comprise a second magnet portion 5411-2. The second magnet portion 5411-2 may have a second polarity different from the first polarity. At this time, the first polarity may be an N pole and the second polarity may be an S pole. Conversely, the first polarity may be an S pole and the second polarity may be an N pole.

The first driving magnet 5411 may comprise a neutral portion 5411-3. The neutral portion 5411-3 may be disposed between the first magnet portion 5411-1 and the second magnet portion 5411-2. The neutral portion 5411-3 may have a neutral polarity. The neutral portion 5411-3 may be a non-magnetized portion.

The first driving unit 5410 may comprise a first coil 5412. The first coil 5412 may be disposed on the substrate 5140. The first coil 5412 may be disposed on the first substrate 5141. The first coil 5412 may be disposed in the housing 5110. The first coil 5412 may be disposed outside the first holder 5210. When a current is applied to the first coil 5412, an electromagnetic field is formed around the first coil 5412 and can interact with the first driving magnet 5411.

As a modified embodiment, the first coil 5412 may be disposed in the first holder 5210 and the first driving magnet 5411 may be disposed in the housing 5110.

The first coil 5412 may be formed in a ring shape. The first coil 5412 may be formed as a square ring or a circular ring. Even when the first coil 5412 is formed in a square ring shape, the corner portion may be formed to be curved. The first coil 5412 may comprise a first portion 5412-1 and a second portion 5412-2 having a gap G1 therebetween. First and second Hall sensors 5413 and 5414 may be disposed in the gap G1 of the first coil 5412.

The lens driving device 5000 may comprise a Hall sensor. The Hall sensor may detect the first driving magnet 5411. The Hall sensor may comprise a plurality of Hall sensors. The Hall sensor may comprise a first Hall sensor 5413 and a second Hall sensor 5414. The first Hall sensor 5413 and the second Hall sensor 5414 may be spaced apart from each other. The first Hall sensor 5413 and the second Hall sensor 5414 may be spaced apart such that a gap G2 is formed therebetween. The first Hall sensor 5413 and the second Hall sensor 5414 may detect the first driving magnet 5411. The first Hall sensor 5413 and the second Hall sensor 5414 may detect the magnetic force of the first driving magnet 5411. The first Hall sensor 5413 and the second Hall sensor 5414 may detect the position of the first holder 5210. The first Hall sensor 5413 and the second Hall sensor 5414 may detect the position of the second lens 5220.

The lens driving device 5000 may comprise a yoke 5415. The yoke 5415 may be disposed between the first driving magnet 5411 and the first holder 5210. The yoke 5415 may be formed in a shape corresponding to that of the first driving magnet 5411. The yoke 5415 may increase the interaction force between the first driving magnet 5411 and the first coil 5412.

The yoke 5415 may comprise an extended portion 5415-1. The extended portion 5415-1 may cover the front side surface and the rear side surface of the first driving magnet 5411. The yoke 5415 may comprise a groove 5415-2. The groove 5415-2 may be formed in the central portion of the body of the yoke 5415.

The driving unit 5400 may comprise a second driving unit 5420. The second driving unit 5420 may move the second moving unit 5300 against the fixing unit 5100. The second driving unit 5420 may move the second moving unit 5300 against the first moving unit 5200. The second driving unit 5420 may be used to drive an auto focus function. Or, the second driving unit 5420 may be used to drive a zoom function.

The second driving unit 5420 may comprise a second driving magnet 5421. The second driving magnet 5421 may be disposed in the second holder 5310. The second driving magnet 5421 may be disposed on a side surface of the second holder 5310. The second driving magnet 5421 may be coupled to the second holder 5310. The second driving magnet 5421 may be fixed to the second holder 5310. The second driving magnet 5421 may be fixed to the second holder 5310 by an adhesive. The second driving magnet 5421 may move integrally with the second holder 5310. The second driving magnet 5421 may face the second coil 5422. The second driving magnet 5421 may face the second coil 5422. The second driving magnet 5421 may be disposed at a position corresponding to the second coil 5422. The second driving magnet 5421 may interact with the second coil 5422. The second driving magnet 5421 may interact with the second coil 5422 electromagnetically.

The second driving unit 5420 may comprise a second coil 5422. The second coil 5422 may be disposed on the substrate 5140. The second coil 5422 may be disposed on the second substrate 5142. The second coil 5422 may be disposed in the housing 5110. The second coil 5422 may be disposed outside the second holder 5310. When a current is applied to the second coil 5422, an electromagnetic field is formed around the second coil 5422 and can interact with the second driving magnet 5421.

As a modified embodiment, the second coil 5422 may be disposed in the second holder 5310 and the second driving magnet 5421 may be disposed in the housing 5110.

The lens driving device 5000 may comprise a Hall sensor. The Hall sensor may detect the second driving magnet 5421. The Hall sensor may comprise a plurality of Hall sensors. The Hall sensor may comprise a third Hall sensor 5423 and a fourth Hall sensor 5424. The third Hall sensor 5423 and the fourth Hall sensor 5424 may be spaced apart from each other. The third Hall sensor 5423 and the fourth Hall sensor 5424 may be spaced apart such that a gap G2 is formed therebetween. The third Hall sensor 5423 and the fourth Hall sensor 5424 may detect the second driving magnet 5421. The third Hall sensor 5423 and the fourth Hall sensor 5424 may detect the magnetic force of the second driving magnet 5421. The third Hall sensor 5423 and the fourth Hall sensor 5424 may detect the position of the second holder 5310. The third Hall sensor 5423 and the fourth Hall sensor 5424 may detect the position of the third lens 5320.

The lens driving device 5000 may comprise a yoke 5425. The yoke 5425 may be disposed between the second driving magnet 5421 and the second holder 5310. The yoke 5425 may be formed in a shape corresponding to that of the second driving magnet 5421. The yoke 5425 may increase the interaction force between the second driving magnet 5421 and the second coil 5422.

The lens driving device 5000 may comprise a first yoke 5430. The first yoke 5430 may be disposed so that an attractive force acts between the first driving magnet 5411 and the first yoke 5430. The first yoke 5430 may be disposed in the housing 5110. The first yoke 5430 may be disposed on the substrate 5140. The first yoke 5430 may be disposed on the first substrate 5141. The first holder 5210 may press the ball 5500 toward the guide rail 5130 by the attractive force between the first driving magnet 5411 and the first yoke 5430. That is, the ball 5500 can be maintained between the first holder 5210 and the guide rail 5130 without being separated by the attractive force between the first driving magnet 5411 and the first yoke 5430.

The lens driving device 5000 may comprise a second yoke 5440. The second yoke 5440 may be disposed so that attractive force acts between the second driving magnet 5421 and the second yoke 5440. The second yoke 5440 may be disposed in the housing 5110. The second yoke 5440 may be disposed on the substrate 5140. The second yoke 5440 may be disposed on the second substrate 5142. The second holder 5310 may press the ball 5500 toward the guide rail 5130 by the attractive force between the second driving magnet 5421 and the second yoke 5440. That is, the ball 5500 can be maintained between the second holder 5310 and the guide rail 5130 without being separated by the attractive force between the second driving magnet 5421 and the second yoke 5440.

The lens driving device 5000 may comprise a ball 5500. The ball 5500 may guide the movement of the first holder 5210. The ball 5500 may be disposed between the first holder 5210 and the guide rail 5130. The ball 5500 may guide the movement of the second holder 5310. The ball 5500 may be disposed between the second holder 5310 and the guide rail 5130. The ball 5500 may be formed in a spherical shape. The ball 5500 may roll the rail groove 5212 of the first holder 5210 and the rail 5133 of the guide rail 5130. The ball 5500 may move in an optical axis direction between the rail groove 5212 of the first holder 5210 and the rail 5133 of the guide rail 5130. The ball 5500 may roll the rail groove 5312 of the second holder 5310 and the rail 5133 of the guide rail 5130. The ball 5500 may move in an optical axis direction between the rail groove 5312 of the second holder 5310 and the rail 5133 of the guide rail 5130. The ball 5500 may comprise a plurality of balls. A total of 8 balls 5500 may be provided: 4 balls in the first holder 5210 and 4 balls in the second holder 5310.

The lens driving device 5000 may comprise a dummy glass 5600. The dummy glass 5600 may be disposed in the housing 5110. The dummy glass 5600 may close the rear opening of the housing 5110. The dummy glass 5600 may be transparent to allow light to pass therethrough.

The lens driving device 5000 may comprise a Poron 5700. The Poron 5700 may be a shock absorbing member. The Poron 5700 can minimize shock and noise being generated by the movement of the first holder 5210 and the second holder 5310. The Poron 5700 may be disposed at a portion where the first holder 5210 collides with the housing 5110. The Poron 5700 may be disposed at a portion where the second holder 5310 collides with the housing 5110.

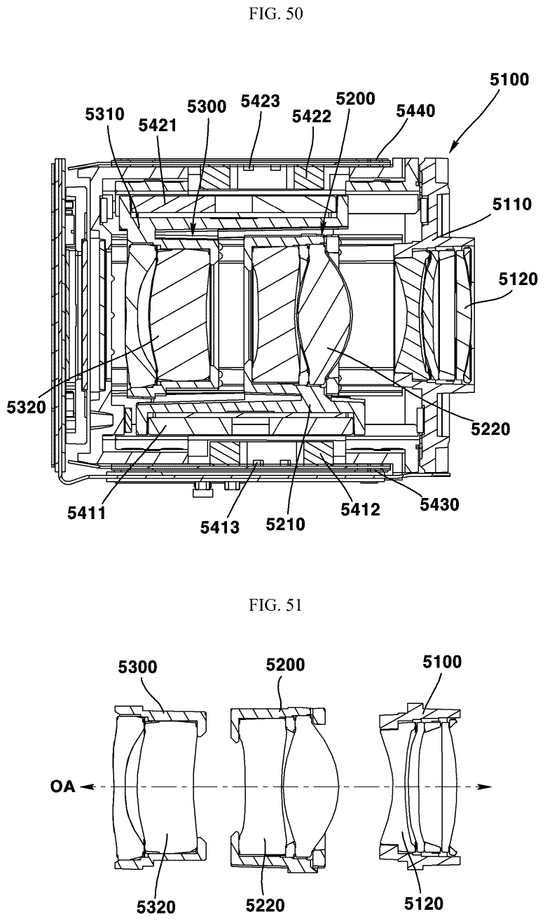

FIGS. 51 to 53 are diagrams for explaining implementation of a zoom function and an autofocus function of a lens driving device according to a first embodiment of the present invention.

In a first embodiment of the present invention, in an initial state in which current is not supplied to the driving unit 5400, the first lens 5120, the second lens 5220, and the third lens 5320 may be disposed while being aligned on an optical axis OA (see FIG. 51).

At this time, when a current is applied to the first coil 5412, the second lens 5220 may move along an optical axis OA due to electromagnetic interaction between the first coil 5412 and the first driving magnet 5411. (See a in FIG. 52). As the second lens 5220 moves while the first lens 5120 is fixed, a zoom function may be performed. When a current in a first direction is applied to the first coil 5412, the second lens 5220 may move in a direction closer to the first lens 5120. When a second direction opposite to the first direction is applied to the first coil 5412, the second lens 5220 may move in a direction away from the first lens 5120.

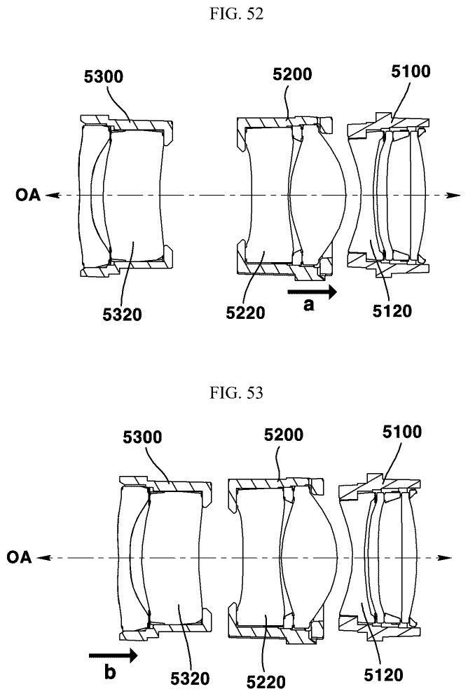

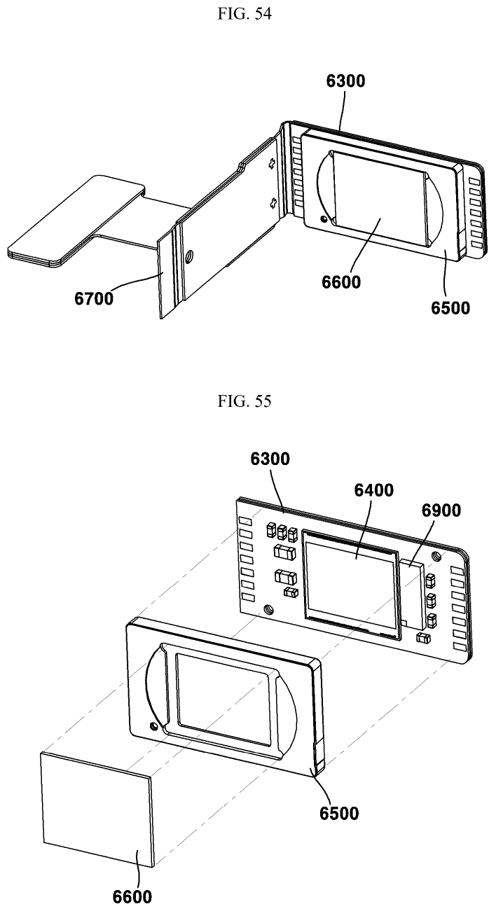

Meanwhile, when a current is applied to the second coil 5422, the third lens 5320 may move along an optical axis OA due to electromagnetic interaction between the second coil 5422 and the second driving magnet 5421 (See b in FIG. 53). An auto focus (AF) function may be performed by the relative movement of the third lens 5320 against the first lens 5120 and the second lens 5220. When current in a first direction is applied to the second coil 5422, the third lens 5320 may move in a direction getting closer to the first lens 5120. When a second direction opposite to the first direction is applied to the second coil 5422, the third lens 5320 may move in a direction getting away from the first lens 5120.

Hereinafter, a camera device according to a first embodiment of the present invention will be described with reference to the drawings.

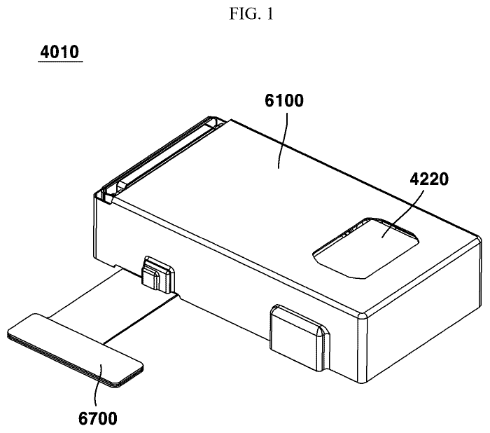

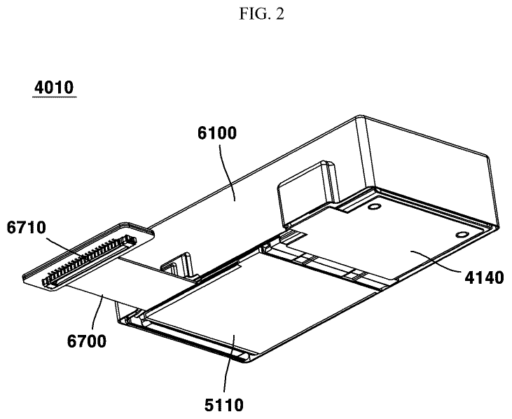

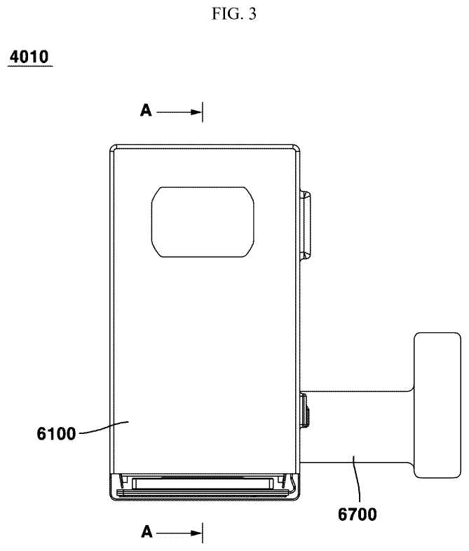

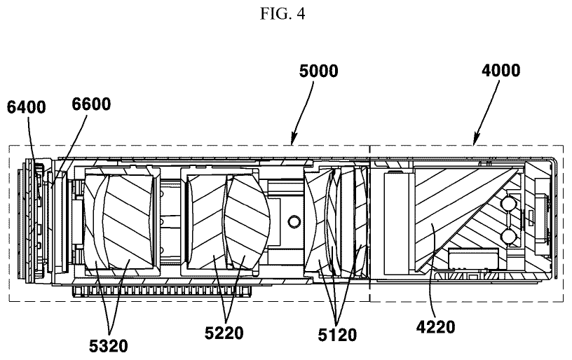

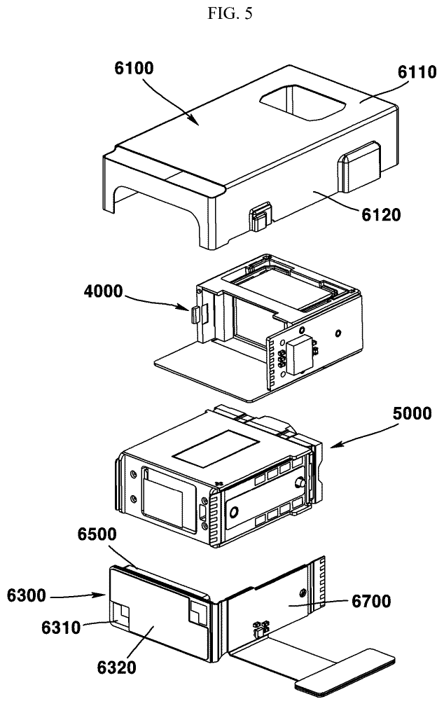

FIG. 1 is a perspective view of a camera device according to a first embodiment of the present invention; FIG. 2 is a bottom perspective view of a camera device according to a first embodiment of the present invention; FIG. 3 is a plan view of a camera device according to a first embodiment of the present invention; FIG. 4 is a cross-sectional view viewed from A-A in FIG. 3; FIG. 5 is an exploded perspective view of a camera device according to a first embodiment of the present invention. FIG. 54 is a perspective view of some components of a camera device according to a first embodiment of the present invention; and FIG. 55 is an exploded perspective view of an image sensor, a filter, and related components of a camera device according to a first embodiment of the present invention.

The camera device 4010 may comprise a cover member 6100. The cover member 6100 may be a ‘cover can’ or a ‘shield can’. The cover member 6100 may be disposed to cover the reflective member driving device 4000 and the lens driving device 5000. The cover member 6100 may be disposed outside the reflective member driving device 4000 and the lens driving device 5000. The cover member 6100 may cover the reflective member driving device 4000 and the lens driving device 5000. The cover member 6100 may accommodate the reflective member driving device 4000 and the lens driving device 5000. The cover member 6100 may be formed of a metal material. The cover member 6100 may block electromagnetic interference (EMI).

The cover member 6100 may comprise an upper plate 6110. The upper plate 6110 may comprise an opening or hole. Light may be incident through the opening or hole of the upper plate 6110. The opening or hole of the upper plate 6110 may be formed at a position corresponding to that of the reflective member 4220.

The cover member 6100 may comprise a side plate 6120. The side plate 6120 may comprise a plurality of side plates. The side plate 6120 may comprise four side plates. The side plate 6120 may comprise first to fourth side plates. The side plate 6120 may comprise first and second side plates being disposed opposite to each other, and third and fourth side plates being disposed opposite to each other.

The camera device 4010 may comprise a printed circuit board 6300 (PCB). The printed circuit board 6300 may be a substrate or a circuit board. A sensor base 6500 may be disposed on the printed circuit board 6300. The printed circuit board 6300 may be electrically connected to the reflective member driving device 4000 and the lens driving device 5000. The printed circuit board 6300 may comprise various circuits, elements, and control units to convert an image formed by the image sensor 6400 into an electrical signal and transmit the converted electrical signal to an external device.

The printed circuit board 6300 may comprise a marking portion 6310. The marking portion 6310 may be disposed on a rear surface of the printed circuit board 6300.

The camera device 4010 may comprise a SUS 6320. The SUS 6320 may be disposed on a rear surface of the printed circuit board 6300. The SUS 6320 may reinforce the strength of the printed circuit board 6300. The SUS 6320 may dissipate heat being generated in the printed circuit board 6300.

The camera device 4010 may comprise an image sensor 6400. The image sensor 6400 may be disposed on the printed circuit board 6300. Light passing through the lens and the filter 6600 may be incident on the image sensor 6400 to form an image. The image sensor 6400 may be electrically connected to the printed circuit board 6300. For example, the image sensor 6400 may be coupled to the printed circuit board 6300 by surface mounting technology (SMT). As another example, the image sensor 6400 may be coupled to the printed circuit board 6300 by flip chip technology. The image sensor 6400 may be disposed such that an optical axis coincides with a lens. An optical axis of the image sensor 6400 and an optical axis of the lens may be aligned. The image sensor 6400 may convert light irradiated onto an effective image area of the image sensor 6400 into an electrical signal. The image sensor 6400 may comprise one or more among a charge coupled device (CCD), a metal oxide semi-conductor (MOS), a CPD, and a CID.

The camera device 4010 may comprise a sensor base 6500. The sensor base 6500 may be disposed on the printed circuit board 6300. A filter 6600 may be disposed on the sensor base 6500. An opening may be formed in a portion of the sensor base 6500 where the filter 6600 is disposed so that light passing through the filter 6600 may be incident to the image sensor 6400.

The camera device 4010 may comprise a filter 6600. The filter 6600 may block light of a specific frequency band from entering the image sensor 6400 from light passing through the lens. The filter 6600 may be disposed between the lens and the image sensor 6400. A filter 6600 may be disposed on the sensor base 6500. The filter 6600 may comprise an infrared filter. The infrared filter may block light of an infrared region from being incident on the image sensor 6400.

The camera device 4010 may comprise a substrate 6700. The substrate 6700 may be connected to the printed circuit board 6300. The substrate 6700 may be extended from the printed circuit board 6300. The substrate 6700 may comprise terminals being electrically connected to the reflective member driving device 4000. The substrate 6700 may comprise an extended portion being extended outward.

The camera device 4010 may comprise a connector 6710. The connector 6710 may be disposed on the substrate 6700. The connector 6710 may be disposed on a lower surface of an extended portion of the board 6700. For example, the connector 6710 may be connected to a power supply unit of a smart phone.

The camera device 4010 may comprise a temperature sensor 6800. The temperature sensor 6800 may detect temperature. The temperature detected by the temperature sensor 6800 may be used for more accurate control of any one or more among a handshake correction function, an auto focus function, and a zoom function.

The camera device 4010 may comprise a driver IC 6900. The driver IC 6900 may be electrically connected to the lens driving device 5000. The driver IC 6900 can be described as one component of the lens driving device 5000. The driver IC 6900 may be electrically connected to the first coil 5412 and the second coil 5422 of the lens driving device 5000. The driver IC 6900 may supply current to the first coil 5412 and the second coil 5422 of the lens driving device 5000. The driver IC 6900 may control at least any one of voltage or current applied to each of the first coil 5412 and the second coil 5422 of the lens driving device 5000. The driver IC 6900 may be electrically connected to the Hall sensors 5413, 5414, 5423, and 5424. The driver IC 6900 may perform the feedback control of the voltage and current applied to the first coil 5412 and the second coil 5422 through the positions of the second lens 5220 and the third lens 5320 detected by the Hall sensors 5413, 5414, 5423, and 5424.

Hereinafter, an optical apparatus according to a first embodiment of the present invention will be described with reference to the drawings.

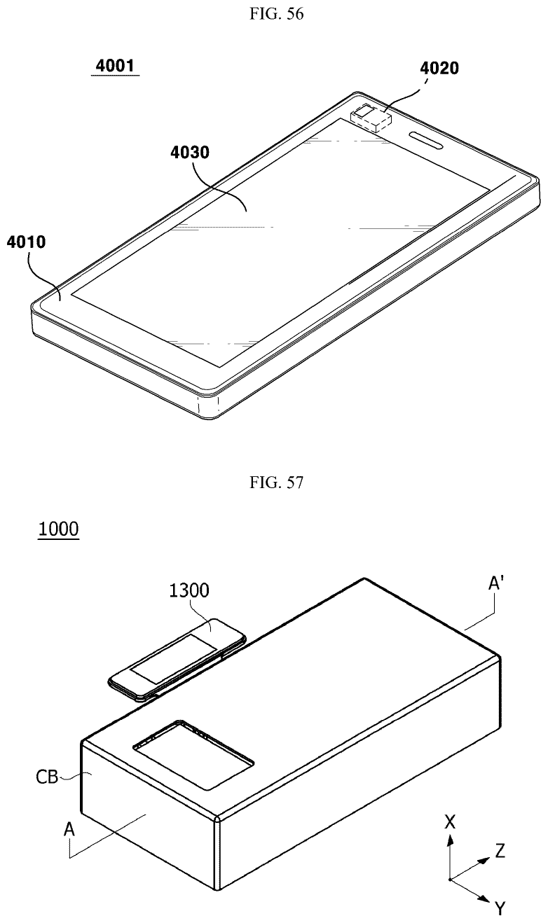

FIG. 56 is a perspective view of an optical apparatus according to a first embodiment of the present invention.

The optical apparatus 4001 may comprise any one or more among a mobile phone, mobile phone, portable terminal, mobile terminal, smart phone, smart pad, portable smart device, digital camera, laptop computer, digital broadcasting terminal, personal digital assistants (PDA), portable multimedia player (PMP), and navigation. The optical apparatus 4001 may comprise any device for photographing images or photos.

The optical apparatus 4001 may comprise a main body 4020. The optical apparatus 4001 may comprise a camera device 4010. The camera device 4010 may be disposed in the main body 4020. The camera device 4010 may photograph a subject. The optical apparatus 4001 may comprise a display 4030. The display 4030 may be disposed in the main body 4020. The display 4030 may output any one or more of a video and an image photographed by the camera device 4010. The display 4030 may be disposed on a first surface of the main body 4020. The camera device 4010 may be disposed on any one or more of a first surface of the main body 4020 and a second surface opposite to the first surface.

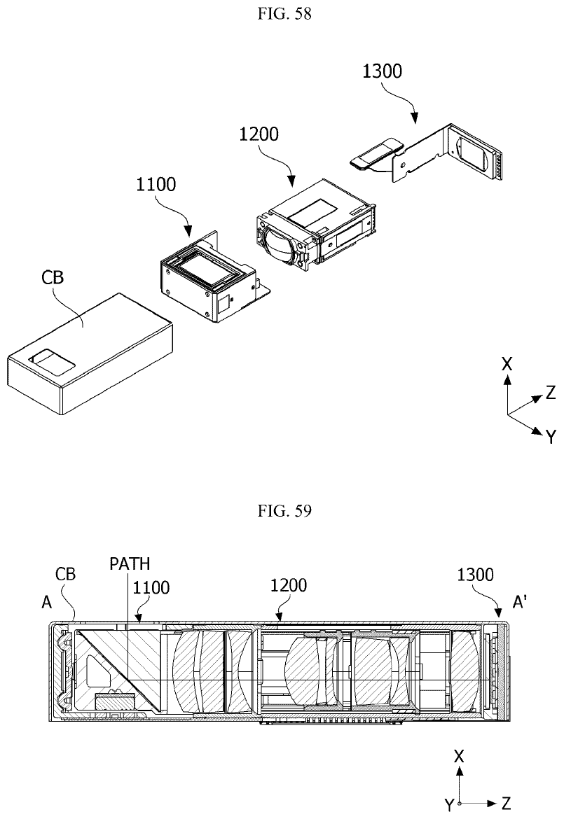

FIG. 57 is a perspective view of a camera module according to a second embodiment of the present invention; FIG. 58 is an exploded perspective view of a camera module according to a second embodiment of the present invention; and FIG. 59 is a view viewed from A-A′ in FIG. 57. Referring to FIGS. 57 and 58, the camera module 1000 according to an embodiment may comprise a cover CB, a first camera actuator 1100, a second camera actuator 1200, and a circuit board 1300. Here, the first camera actuator 1100 may be used as a first actuator, and the second camera actuator 1200 may be interchangeably used as a second actuator.

The cover CB may surround the first camera actuator 1100 and the second camera actuator 1200. The coupling force between the first camera actuator 1100 and the second camera actuator 1200 may be improved by the cover CB.

Furthermore, the cover CB may be made of a material that blocks electromagnetic waves. Accordingly, the first camera actuator 1100 and the second camera actuator 1200 inside the cover CB can be easily protected.

In addition, the first camera actuator 1100 may be an optical image stabilizer (OIS) actuator.

The first camera actuator 1100 may comprise a fixed focal length lens disposed in a predetermined lens barrel (not shown). The fixed focal length lens may also be referred to as “single focal length lens” or “short lens”.

The first camera actuator 1100 may change a path of light. As an example, the first camera actuator 1100 may vertically change a light path through an internal optical member (For example, a mirror). With this configuration, even if the thickness of the mobile terminal is reduced, magnification, auto focusing (AF), and OIS functions can be performed by disposing a lens configuration larger than the thickness of the mobile terminal inside the mobile terminal through a change in the optical path.

The second camera actuator 1200 may be disposed at a rear end of the first camera actuator 1100. The second camera actuator 1200 may be coupled to the first camera actuator 1100. And mutual coupling can be made by various methods.

In addition, the second camera actuator 1200 may be a zoom actuator or an auto focus (AF) actuator. For example, the second camera actuator 1200 may support one or a plurality of lenses and perform an auto focusing function or a zoom function by moving the lenses according to a control signal from a predetermined control unit.

The circuit board 1300 may be disposed at a rear end of the second camera actuator 1200. The circuit board 1300 may be electrically connected to the second camera actuator 1200 and the first camera actuator 1100. In addition, the number of circuit boards 1300 may be plural.

Such a circuit board 1300 may be connected to the second housing of the second camera actuator 1200 and may have an image sensor. Furthermore, a base part comprising a filter may be seated on the circuit board 1300. Descriptions about this will be given later.

A camera module according to an embodiment may comprise a single or a plurality of camera modules. For example, the plurality of camera modules may comprise a first camera module and a second camera module.

And the first camera module may comprise a single or a plurality of actuators. For example, the first camera module may comprise a first camera actuator 1100 and a second camera actuator 1200.

The second camera module may comprise an actuator (not shown) disposed in a predetermined housing (not shown) and capable of driving a lens unit. The actuator may be a voice coil motor, a micro actuator, a silicon actuator, and the like, and may be applied in various ways such as an electrostatic method, a thermal method, a bimorph method, an electrostatic force method, and the like, but is not limited thereto. In addition, in this specification, a camera actuator may be referred to as an actuator or the like. In addition, a camera module composed of a plurality of camera modules may be mounted in various electronic devices such as mobile terminals.

Referring to FIG. 59, a camera module according to an embodiment may comprise a first camera actuator 1100 performing an OIS function and a second camera actuator 1200 performing a zooming function and an AF function.

Light may be incident into the camera module through an opening positioned on an upper surface of the first camera actuator 1100. That is, the light may be incident into the first camera actuator 1100 along an optical axis direction (For example, an X-axis direction), and the light path may be changed in a vertical direction (For example, a Z-axis direction) through the optical member. The light may pass through the second camera actuator 1200 and be incident to the image sensor IS positioned at one end of the second camera actuator 1200 (PATH).

In this specification, the bottom surface means one side surface in a first direction. In addition, the first direction is an X-axis direction in the drawing and may be used interchangeably with a second axis direction. The second direction is a Y-axis direction in the drawing and may be used interchangeably with the first-axis direction. The second direction is a direction perpendicular to the first direction. In addition, a third direction is a Z-axis direction in the drawing, and may be used interchangeably with the third axis direction. It is a direction perpendicular to both the first direction and the second direction. Here, the third direction (Z-axis direction) corresponds to the direction of the optical axis, and the first direction (X-axis direction) and the second direction (Y-axis direction) are directions perpendicular to the optical axis and can be tilted by the second camera actuator. A detailed description of this will be given later.

In addition, in the following description of the second camera actuator 1200, the optical axis direction corresponds to the optical path and is the third direction (Z-axis direction), and will be described below with respect to this.

And, by this configuration, the camera module according to the embodiment can improve the spatial limitations of the first camera actuator and the second camera actuator by changing the light path. That is, the camera module according to the embodiment may expand the light path while minimizing the thickness of the camera module in response to the change in the light path. Furthermore, it should be understood that the second camera actuator may provide a high range of magnification by controlling a focus or the like in an extended light path.

In addition, the camera module according to the embodiment can implement OIS through control of the light path through the first camera actuator, and accordingly, it is possible to minimize the occurrence of decentralization or tilt phenomena so that the best optical characteristics can be obtained.

Furthermore, the second camera actuator 1200 may comprise an optical system and a lens driving unit. For example, in the second camera actuator 1200, at least one or more among a first lens assembly, a second lens assembly, a third lens assembly, and a guide pin may be disposed.

In addition, the second camera actuator 1200 comprises a coil and a magnet to perform a zooming function with high magnification.

For example, the first lens assembly and the second lens assembly may be moving lenses that move through a coil, a magnet, and a guide pin, and the third lens assembly may be a fixed lens, but is not limited thereto. For example, the third lens assembly may perform the function of a focator that forms light at a specific location, and the first lens assembly may perform a variator function of re-forming an image formed in the third lens assembly, which is a light concentrator, at another location. Meanwhile, in the first lens assembly, the distance to the subject or the image distance may change a lot, so that the change in magnification may be large, and the first lens assembly, which is a variable magnification, may play an important role in changing the focal length or magnification of the optical system. On the other hand, the image formed by the first lens assembly, which is a variable magnifier, may be slightly different depending on the location. Accordingly, the second lens assembly may perform a position compensation function for an image formed by the variable magnifier. For example, the second lens assembly may perform a compensator function that serves to accurately form an image formed by the first lens assembly, which is a variable magnifier, at an actual image sensor position. For example, the first lens assembly and the second lens assembly may be driven by electromagnetic force due to an interaction between a coil and a magnet. The above information may be applied to a lens assembly, which will be described later.

Meanwhile, according to the second embodiment of the present invention, when an OIS actuator (For example, a first camera actuator) and an AF or Zoom actuator (For example, a second camera actuator) are disposed, magnetic field interference with an AF or Zoom magnet can be inhibited during OIS driving. Since the driving magnet of the first camera actuator 1100 is disposed separately from the second camera actuator 1200, magnetic field interference between the first camera actuator 1100 and the second camera actuator 1200 can be inhibited. In this specification, OIS may be used interchangeably with terms such as handshake correction, optical image stabilization, optical image correction, and shake correction.

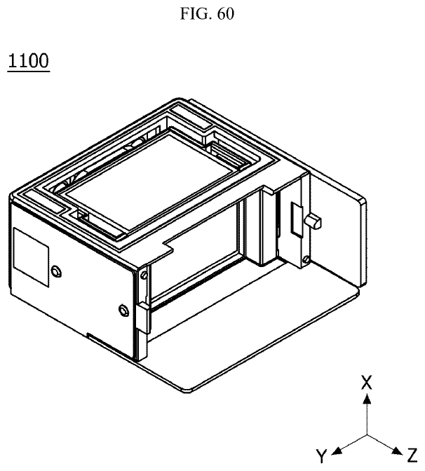

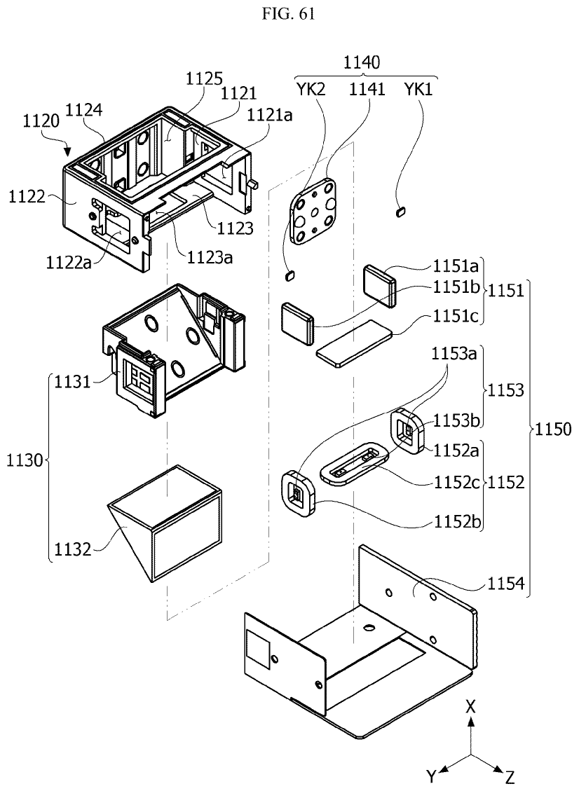

FIG. 60 is a perspective view of a first camera actuator according to a second embodiment of the present invention; and FIG. 61 is an exploded perspective view of a first camera actuator according to a second embodiment of the present invention.

Referring to FIGS. 60 and 61, the first camera actuator 1100 according to an embodiment comprises a shield can (not shown), a first housing 1120, a mover 1130, a rotating part 1140, and a first driving unit 1150.

The mover 1130 may comprise a holder 1131 and an optical member 1132 being seated on the holder 1131. The rotating part 1140 comprises a tilting guide unit 1141 and a first yoke YK1 and a second yoke YK2 that are disposed to be spaced apart from each other with the tilting guide unit 1141 interposed therebetween and have a coupling force. In addition, the first driving unit 1150 comprises a driving magnet 1151 (For example, a first driving magnet), a driving coil 1152 (For example, a first driving coil), a yoke part (not shown), a Hall sensor unit 1153 and a first substrate unit 1154.

A shield can (not shown) may be positioned at an outermost side of the first camera actuator 1100 to surround a rotating part 1140 and a first driving unit 1150, which will be described later.

Such a shield can (not shown) may block or reduce electromagnetic waves generated from the outside. Accordingly, the occurrence of malfunctions in the rotating part 1140 or the first driving unit 1150 may be reduced.

The first housing 1120 may be positioned inside a shield can (not shown). In addition, the first housing 1120 may be positioned inside the first substrate unit 1154, which will be described later. The first housing 1120 may be fastened by being fitted or aligned with a shield can (not shown).

In this specification, as described above, the third direction (Z-axis direction) corresponds to the direction of an optical axis, and the first direction (X-axis direction) and the second direction (Y-axis direction) are directions perpendicular to the optical axis, and may be tilted by the first camera actuator.

The first housing 1120 may comprise a first housing side portion 1121, a second housing side portion 1122, a third housing side portion 1123, and a fourth housing side portion 1124.

The first housing side portion 1121 and the second housing side portion 1122 may be disposed to face each other. In addition, the third housing side portion 1123 and the fourth housing side portion 1124 may be disposed between the first housing side portion 1121 and the second housing side portion 1122.

The third housing side portion 1123 may be in contact with the first housing side portion 1121, the second housing side portion 1122, and the fourth housing side portion 1124. The third housing side portion 1123 may be a bottom surface of the first housing 1120.

Also, the first housing side portion 1121 may comprise a first housing hole 1121a. A first coil 1152a, which will be described later, may be positioned in the first housing hole 1121a.

In addition, the second housing side portion 1122 may comprise a second housing hole 1122a. A second coil 1152b, which will be described later, may be positioned in the second housing hole 1122a.

The first coil 1152a and the second coil 1152b may be coupled to the first substrate unit 1154. As an embodiment, the first coil 1152a and the second coil 1152b may be electrically connected to the first substrate unit 1154 to allow current to flow therethrough. This current is an element of the electromagnetic force that the first camera actuator can tilt with respect to an X-axis.

The third housing side portion 1123 may comprise a third housing hole 1123a. A third coil 1152c, which will be described later, may be positioned in the third housing hole 1123a. The third coil 1152 may be coupled to the first substrate unit 1154. In addition, a current may flow through the third coil 1152c electrically connected to the first substrate unit 1154. This current is an element of the electromagnetic force that the first camera actuator can tilt with respect to a Y-axis.

In addition, the first housing 1120 may comprise an accommodating portion 1125 being formed by the first housing side portion 1121 to the fourth housing side portion 1124. A mover 1130 may be positioned in the accommodating portion 1125.

The mover 1130 comprises a holder 1131 and an optical member 1132 being seated on the holder 1131.

The holder 1131 and the optical member 1132 may be seated in the accommodating portion 1125 of the first housing 1120. The holder 1131 may comprise a first holder outer side surface to a fourth holder outer side surface corresponding to the first housing side portion 1121, the second housing side portion 1122, the third housing side portion 1123, and the fourth housing side portion 1124, respectively. Also, the first driving coil 1152 may be positioned in a seating groove formed on an outer surface of the holder 1131. A detailed description of this will be given later.

The optical member 1132 may be seated on the holder 1131. To this end, the holder 1131 may have a seating surface, and the seating surface may be formed by an accommodating groove. The optical member 1132 may comprise a reflector being disposed therein. However, it is not limited thereto.

Also, the optical member 1132 may reflect light reflected from the outside (For example, an object) into the camera module. In other words, the optical member 1132 may improve the first camera actuator and the spatial limit of the first camera actuator by changing the path of the reflected light. As a result, it should be understood that the camera module may also provide a high range of magnification while minimizing the thickness thereof by extending the light path.

The rotating part 1140 may comprise: a tilting guide unit 1141; a first yoke YK1 having a coupling force with the tilting guide unit 1141; and a second yoke YK2 positioned inside the tilting guide unit 1141 or the housing (particularly, the fourth housing side portion). However, the first yoke YK1 and the second yoke YK2 are positioned inside the mover 1130, the tilting guide unit 1141, and the first housing 1120, so that a coupling force among the first housing 1120, the tilting guide unit 1141, and the mover 1130 may be provided.

The tilting guide unit 1141 may be coupled with the mover 1130 and the first housing 1120, as described above. Such a tilting guide unit 1141 may be disposed adjacent to an optical axis. Thus, the actuator according to the embodiment can easily change the light path according to the tilt of the first and second axes, which will be described later.

The tilting guide unit 1141 may comprise a first protruding portion being disposed spaced apart from each other in a first direction (X-axis direction) and a second protruding portion being disposed spaced apart from each other in a second direction (Y-axis direction). In addition, the first protruding portion and the second protruding portion may be protruded in opposite directions. A detailed description of this will be given later.

The first yoke YK1 may be positioned within the outer side surface of the holder 1131. For example, the first yoke YK1 may be positioned on an outer side surface of the fourth holder of the holder 1131. With this configuration, the tilting guide unit 1141 can be pressed between the holder 1131 and the first housing 1120 by the magnetic force (For example, attractive force) between the first yoke YK1 and the second yoke YK2. Thus, the tilting guide unit 1141 and the holder 1131 in the first housing 1120 may be spaced apart from the bottom surface of the housing in the accommodating portion 1125. That is, the tilting guide unit 1141 and the holder 1131 may be coupled to the first housing 1120. However, as described above, the first yoke YK1 and the second yoke YK2 may be magnets having different or the same polarities, or may be yokes and the like, and may be made of a material having attractive or repulsive force to each other.

The first driving unit 1150 comprises a driving magnet 1151, a driving coil 1152, a yoke part (not shown), a Hall sensor unit 1153, and a first substrate unit 1154. The first driving unit 1150 may move, rotate, or tilt the mover 1130.

The driving magnet 1151 may comprise a plurality of magnets. As an example, the driving magnet 1151 may comprise a first magnet 1151a, a second magnet 1151b, and a third magnet 1151c.

The first magnet 1151a, the second magnet 1151b, and the third magnet 1151c may be positioned on an outer side surface of the holder 1131, respectively. Also, the first magnet 1151a and the second magnet 1151b may be positioned to face each other. The third magnet 1151c may be positioned on the bottom surface of the holder 1131, that is, on an outer side surface of the third holder. A detailed description of this will be given later.

The driving coil 1152 may comprise a plurality of coils. As an embodiment, the driving coil 1152 may comprise a first coil 1152a, a second coil 1152b, and a third coil 1152c.

The first coil 1152a may be positioned to correspond to the first magnet 1151a. That is, the first coil 1152a may face the first magnet 1151a. Accordingly, the first coil 1152a may be positioned in the first housing hole 1121a of the first housing side portion 1121 as described above. In addition, the second coil 1152b may be positioned to correspond to the second magnet 1151b. That is, the second coil 1152b may be disposed to face the second magnet 1151b. Accordingly, the second coil 1152b may be positioned in the second housing hole 1122a of the second housing side portion 1122 as described above.

In addition, the first coil 1152a may be positioned to face the second coil 1152b. That is, the first coil 1152a may be symmetrically positioned with respect to the second coil 1152b in a first direction (X-axis direction). This may be equally applied to the first magnet 1151a and the second magnet 1151b. That is, the first magnet 1151a and the second magnet 1151b may be symmetrically positioned with respect to a first direction (X-axis direction). In addition, the first coil 1152a, the second coil 1152b, the first magnet 1151a, and the second magnet 1151b may be disposed to be overlapped with at least partially in the second direction (Y-axis direction). With this configuration, the X-axis tilting can be accurately performed without tilting to one side by the electromagnetic force between the first coil 1152a and the first magnet 1151a and the electromagnetic force between the second coil 1152b and the second magnet 1151b.

The third coil 1152c may be positioned to correspond to the third magnet 1151c. For example, the third coil 1152c may be positioned in the third housing hole 1123a of the third housing side portion 1123. The third housing hole 1123a may have a different area from the first housing hole and the second housing hole. Accordingly, Y-axis tilting through the third coil 1152c can be easily performed.

Also, the third coil 1152c may be positioned at a bisector between the first coil 1152a and the second coil 1152b. With this configuration, Y-axis tilting can be performed in a balanced manner without tilting to one side by the electromagnetic force being generated by the current flowing through the third coil 1152c.

A yoke part (not shown) may be positioned between the driving magnet 1151 and the holder 1131. The yoke part (not shown) is positioned on an outer side surface of the first holder and an outer side surface of the second holder of the holder 1131 to facilitate coupling of the driving magnet to the holder 1131. For example, a yoke part (not shown) may be disposed in a seating groove positioned on an outer side surface of the holder and may have an attractive force with the driving magnet 1151. That is, the yoke part (not shown) may improve coupling force between the driving magnet 1151 and the holder 1131.

The Hall sensor unit 1153 may comprise a plurality of Hall sensors. As an embodiment, the Hall sensor unit 1153 may comprise a first Hall sensor 1153a and a second Hall sensor 1153b. The first Hall sensor 1153a may be positioned inside or outside the first coil 1152a or the second coil 1152b. The first Hall sensor 1153a may detect a magnetic flux change inside the first coil 1152a or the second coil 1152b. Accordingly, the first Hall sensor 1153a may perform position sensing of the first and second magnets 1151a and 1151b. In addition, the second Hall sensor 1153b may be positioned inside or outside the third coil 1152c. The second Hall sensor 1153b may detect the position of the third coil 1152c. The first camera actuator according to the embodiment may control X-axis or Y-axis tilt through this. The Hall sensor unit or Hall sensor may comprise a plurality of sensors.

The first substrate unit 1154 may be positioned below the first driving unit 1150. The first substrate unit 1154 may be electrically connected to the driving coil 1152 and the Hall sensor unit 1153. For example, current is applied to the driving coil 1152 through the first substrate unit 1154, and accordingly, the mover 1130 may be tilted in an X-axis or a Y-axis. For example, the first substrate unit 1154 may be coupled with the driving coil 1152 and the Hall sensor unit 1153 through SMT. However it is not limited to this method.

The first substrate unit 1154 is positioned between a shield can (not shown) and the first housing 1120 and may be coupled with the shield can and the first housing 1120. The coupling method may be variously made as described above. Also, through the coupling, the driving coil 1152 and the Hall sensor unit 1153 may be positioned within the outer side surface of the first housing 1120.

Such a first substrate unit 1154 may comprise a circuit board such as a rigid printed circuit board (rigid PCB), a flexible printed circuit board (flexible PCB), a rigid printed circuit board (rigid flexible PCB), and the like with wiring patterns that can be electrically connected. However, it is not limited to these types.

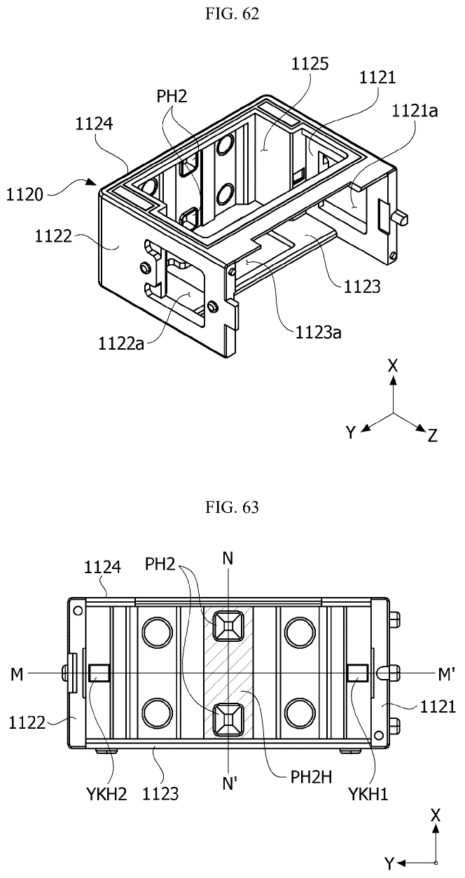

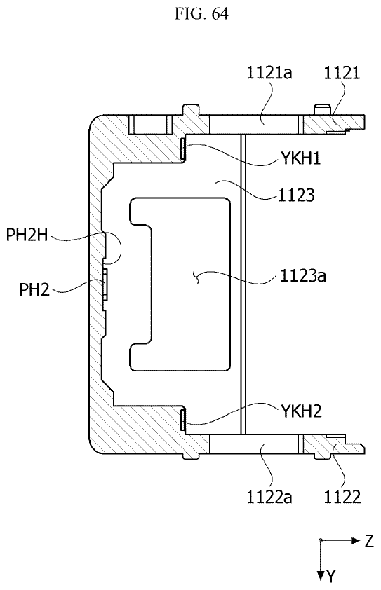

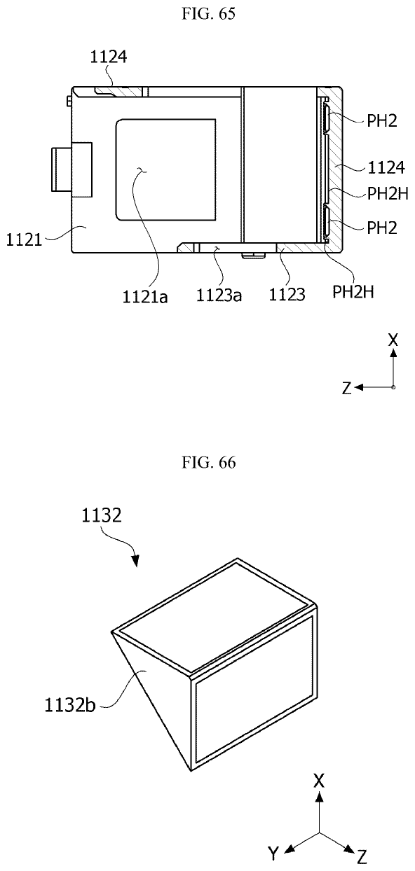

FIG. 62 is a perspective view of a first housing in a first camera actuator according to a second embodiment of the present invention; FIG. 63 is a side view of a first housing in a first camera actuator according to a second embodiment of the present invention; FIG. 64 is a cross-sectional view viewed from M-M′ in FIG. 63; and FIG. 65 is a cross-sectional view viewed from N-N′ in FIG. 63.

Referring to FIG. 62, the first housing 1120 may comprise a first housing side portion 1121, a second housing side portion 1122, a third housing side portion 1123, and a fourth housing side portion 1124.

The first housing side portion 1121 and the second housing side portion 1122 may be disposed to face each other. In addition, the third housing side portion 1123 and the fourth housing side portion 1124 may be disposed between the first housing side portion 1121 and the second housing side portion 1122.

The third housing side portion 1123 may be in contact with the first housing side portion 1121, the second housing side portion 1122, and the fourth housing side portion 1124. The third housing side portion 1123 may be a bottom surface of the first housing 1120.

Also, the first housing side portion 1121 may comprise a first housing hole 1121a. A first coil 1152a, which will be described later, may be positioned in the first housing hole 1121a.

In addition, the second housing side portion 1122 may comprise a second housing hole 1122a. A second coil 1152b, which will be described later, may be positioned in the second housing hole 1122a.

Furthermore, the second housing side portion 1122 or the first housing side portion 1121 may comprise a control element groove. As an embodiment, the second housing side portion 1122 may comprise a control element groove. In addition, a driver, a control element, a processor, and the like electrically connected to the substrate may be positioned in the control element groove. Or, a circuit board of the first camera actuator may be positioned on an outer side surface of the first housing side portion 1121 or the second housing side portion 1122, and the circuit board may be connected to the control element.

Also, the first coil and the second coil may be coupled with the first substrate unit. In an embodiment, the first coil and the second coil may be electrically connected to the first substrate unit so that current may flow. This current is a component of the electromagnetic force that the first camera actuator can tilt with respect to an X-axis.

In addition, the third housing side portion 1123 may be disposed between the first housing side portion 1121 and the second housing side portion 1122. The third housing side portion 1123 may be a bottom portion of the first housing 1120. A third coil is positioned in the third housing hole 1123a of the third housing side portion 1123, and a current flowing through the third coil is an element of electromagnetic force capable of tilting the first camera actuator relative to a Y-axis. In addition, the fourth housing side portion 1124 may comprise second protrusion grooves PH2 being symmetrically disposed with respect to the center.

Looking further at FIGS. 63 to 65, the second protrusion groove PH2 is plural, and the second protruding portion of the tilting guide unit can be seated. In this specification, it is explained that a plurality of first protrusion grooves PH1 is overlapped with each other in a second direction (Y-axis direction), and a plurality of second protrusion grooves is overlapped with each other in a first direction (X-axis direction). However, when the positions of the first protruding portion and the second protruding portion are changed the positions of the first protruding portion and the second protruding portion may also be interchanged corresponding to the positions of the first protruding portion and the second protruding portion. Thus, in the first camera actuator according to an embodiment, the housing and the holder may each comprise a different one of a first protrusion groove in which the first protruding portion is seated and a second protrusion groove in which the second protruding portion is seated.

Furthermore, a second additional groove PH2H surrounding the second protrusion groove PH2 may be positioned outside the second protrusion groove PH2. The second additional groove PH2H may be positioned on an inner side surface of the fourth housing side portion 1124. Furthermore, the second additional groove PH2H may surround the second protrusion groove PH2 positioned inside the fourth housing side portion 1124. With this configuration, a lubricating member for seating the second protruding portion of the tilting guide unit can be positioned inside the second protrusion groove PH2. At this time, a lubricating member (For example, grease) may overflow due to impact between the second protruding portion and the second protrusion groove PH2. The second additional groove PH2H can accommodate the overflowing lubricating member. Thus, even if the lubricating member overflows due to collision, it may not move to the tilting guide unit. Therefore, the tilting guide unit and the housing may not be connected by the lubrication member. Therefore, the rotational driving of the tilting guide unit can be accurately performed without being hindered by the lubrication member.

In addition, the first housing 1120 may comprise an accommodating portion 1125 being formed by the first to fourth housing side portions 1121 to 1124. A mover 1130 may be positioned in the accommodating portion 1125.

Furthermore, the first housing 1120 or the first camera actuator may comprise a yoke groove. The yoke groove may comprise a first yoke groove YKHI and a second yoke groove YKH2. Furthermore, as described above, the yoke part may be disposed in the yoke groove. For example, the first yoke YK1 may be positioned in the first yoke groove YKH1. The second yoke YK2 may be positioned in the second yoke groove YKH2. Accordingly, the first yoke YK1 and the second yoke YK2 may be positioned inside the first housing 1120. In other words, the first yoke YK1 and the second yoke YK2 may be coupled to the first housing 1120.

A first yoke groove YKHI may be positioned inside the first housing hole 1121a of the first housing side portion 1121. A second yoke groove YKH2 may be positioned inside the second housing hole 1122a of the second housing side portion 1122. The first yoke groove YKHI and the second yoke groove YKH2 may be positioned between the first housing hole 1121a and the second housing hole 1122a. Furthermore, the first yoke groove YKHI may not be overlapped with the first housing hole 1121a in an optical axis direction (Z-axis direction). Similarly, the second yoke groove YKH2 may not be overlapped with the second housing hole 1122a in an optical axis direction. Accordingly, the first yoke groove YKH1 may not be overlapped with the first coil in an optical axis direction. Also, the second yoke groove YKH2 may not be overlapped with the second coil in an optical axis direction.

With this configuration, the first yoke may not be overlapped with the first coil along an optical axis direction. Furthermore, the second yoke may not be overlapped with the second coil along an optical axis direction. Accordingly, the influence of the first and second coils from the first and second yokes can be minimized. Thus, accurate tilt driving by the first and second coils can be performed.

Furthermore, a third housing hole 1123a may be positioned between the first yoke groove YKH1 and the second yoke groove YKH2. The first yoke groove YKHI and the second yoke groove YKH2 may be symmetrically disposed with respect to the third housing hole 1123a. Accordingly, the influence of the third coil positioned in the third housing hole 1123a from the first yoke groove YKHI and the second yoke groove YKH2 can be minimized.

Furthermore, the first yoke groove YKHI and the second yoke groove YKH2 may be positioned on an optical axis direction side with respect to the second protrusion groove PH2 or the second additional groove PH2H. Also, the first yoke groove YKHI and the second yoke groove YKH2 may not be overlapped with an optical axis direction with respect to the second protrusion groove PH2 or the second additional groove PH2H.

FIG. 66 is a perspective view of an optical member of a first camera actuator according to a second embodiment of the present invention.

The optical member 1132 may be seated on a holder. The optical member 1132 may be a right angle prism as a reflecting unit, but is not limited thereto. For example, the optical member 1132 may comprise various optical elements that change the path of light.

As an embodiment, the optical member 1132 may have a protrusion (not shown) on a portion of an outer side surface. The optical member 1132 can be easily coupled to the holder through a protrusion (not shown). In addition, the holder may be coupled with the optical member 1132 by having a groove or protrusion.

In addition, the bottom surface 1132b of the optical member 1132 may be seated on a seating surface of the holder. Accordingly, the bottom surface 1132b of the optical member 1132 may correspond to the seating surface of the holder. As an embodiment, the bottom surface 1132b may be made of an inclined surface in the same manner as the holder is seated. Accordingly, it is possible to inhibit the optical member 1132 from being separated from the holder at the same time when the prism moves according to the movement of the holder.

In addition, a groove or protrusion is formed on the bottom surface 1132b of the optical member 1132 and a bonding member is applied so that the optical member 1132 can be coupled with the holder. Or, the holder may be coupled to the optical member 1132 by applying a bonding member to the groove or protrusion of the holder.

In addition, as described above, the optical member 1132 may have a structure capable of reflecting light reflected from the outside (For example, an object) into the camera module. As an embodiment, the optical member 1132 may consist of a single mirror. In addition, the optical member 1132 may improve spatial limitations of the first camera actuator and the second camera actuator by changing the path of the reflected light. As such, it should be understood that the camera module may provide a high range of magnification by extending the light path while minimizing the thickness. In addition, it should be understood that the camera module comprising the camera actuator according to the embodiment may provide a high range of magnification by extending an optical path while minimizing the thickness.

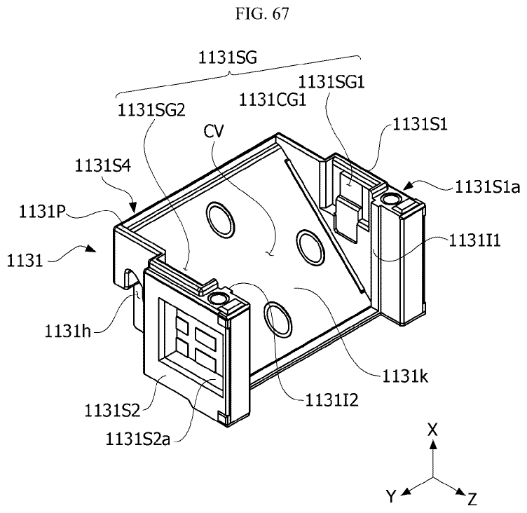

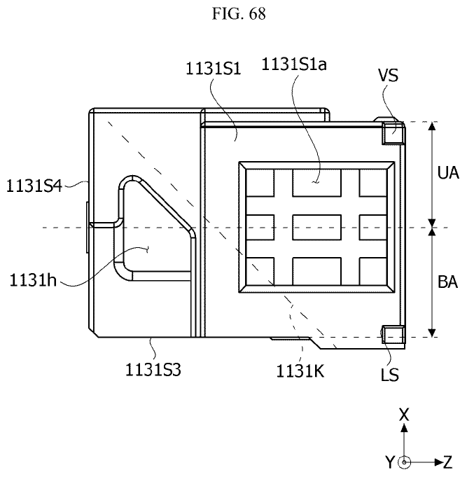

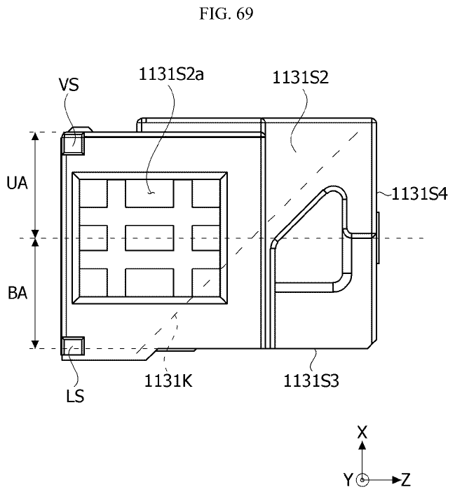

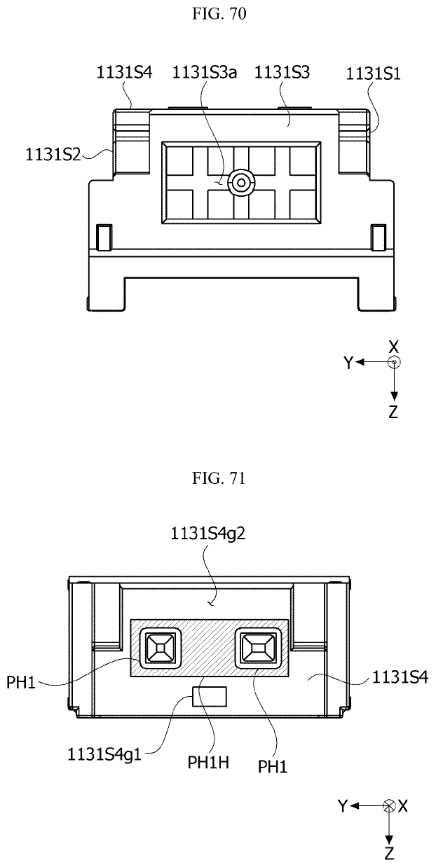

FIG. 67 is a perspective view of a holder according to a second embodiment of the present invention; FIG. 68 is a side view of a holder according to a second embodiment of the present invention; FIG. 69 is another side view of a holder according to a second embodiment of the present invention; FIG. 70 is a bottom view of a holder according to a second embodiment of the present invention; and FIG. 71 is another side view of a holder according to a second embodiment of the present invention.

Referring to FIGS. 67 to 71, the holder 1131 according to an embodiment may comprise a seating surface 1131k on which an optical member is seated. The seating surface 1131k may be an inclined surface. In addition, the holder 1131 may comprise a jaw portion (not shown) on the seating surface 1131k. A jaw portion (not shown) in the holder 1131 may inhibit movement of the optical member 1132. Furthermore, the seating surface 1131k may comprise a plurality of grooves, and a bonding member may be applied to the grooves. Thus, the optical member can be easily coupled to the seating surface 1131k. At this time, the optical member may be bonded to the bonding member at the edge of the seating surface 1131k. Or, the optical member may be coupled with a bonding member inside the holder groove 1131SG of the holder 1131. Accordingly, a bottom surface or a reflective surface of an optical member may be spaced apart from the seating surface 1131k of the holder 1131 by a predetermined distance. For example, the seating surface 1131k of the holder 1131 may have a space apart from the reflective surface of the optical member except for the edge. Also, the holder 1131 according to an embodiment may comprise a cavity CV. The cavity CV may be positioned between a first holder outer side surface 1131S1 and a second holder outer side surface 1131S2, which will be described later. An optical member may be seated in the cavity CV.

The holder 1131 may comprise a holder hole 1131h penetrating at least a portion of the holder 1131 in a second direction (Y-axis direction). The holder hole 1131h is symmetrical with the control element hole in a second direction (Y-axis direction), so that the heat dissipation efficiency of the heat generated from the control element can be enhanced. Furthermore, since the weight of the holder 1131 is reduced by the holder hole 1131h, driving efficiency for an X-axis or a Y-axis tilt of the mover can be enhanced. Furthermore, a space in which the first yoke groove and the second yoke groove are formed may be secured through the holder hole 1131h.

In addition, the holder 1131 may comprise a plurality of outer side surfaces. For example, the holder 1131 may comprise a first holder outer side surface 1131S1, a second holder outer side surface 1131S2, a third holder outer side surface 1131S3, and a fourth holder outer side surface 1131S4.

The first holder outer side surface 1131S1 may be positioned to face the second holder outer side surface 1131S2. That is, the first holder outer side surface 1131S1 may be disposed symmetrically with the second holder outer side surface 1131S2 with respect to a first direction (X-axis direction).

The first holder outer side surface 1131S1 of the first holder may face the side portion 1121 of the first housing. Also, the second holder outer side surface 1131S2 of the second holder may face the second housing side portion 1122.

In addition, the first holder outer side surface 1131S1 may comprise a first seating groove 1131S1a. The second holder outer side surface 1131S2 of the second holder may comprise a second seating groove 1131S2a. The first seating groove 1131S1a and the second seating groove 1131S2a may be disposed symmetrically with respect to the first direction (X-axis direction).

Also, a first magnet may be disposed in the first seating groove 1131S1a, and a second magnet may be disposed in the second seating groove 1131S2a. Corresponding to the positions of the first seating groove 1131S1a and the second seating groove 1131S2a, the first magnet and the second magnet may also be disposed symmetrically with respect to the first direction (X-axis direction).

As described above, due to the positions of the first and second seating grooves and the first and second magnets, the electromagnetic force induced by the magnets is the same on the first holder outer side surface S1231S1 and the second holder outer side surface 1131S2 can be provided on the same axis. For example, the region (For example, the portion with the strongest electromagnetic force) being applied on the first holder outer side surface S1231S1 and the region (For example, the portion with the strongest electromagnetic force) being applied on the second holder outer side surface S1231S2 may be positioned on an axis parallel to the second direction (Y-axis direction). Thus, X-axis tilting can be accurately performed.

The third holder outer side surface 1131S3 is in contact with the first holder outer side surface 1131S1 and the second holder outer side surface 1131S2, and may be an outer side surface extending in the second direction (Y-axis direction) from the first holder outer side surface 1131S1 and the second holder outer side surface 1131S2. In addition, the third holder outer side surface 1131S3 may be positioned between the first holder outer side surface 1131S1 and the second holder outer side surface 1131S2.

The third holder outer side surface 1131S3 may be a bottom surface of the holder 1131. The third holder outer side surface 1131S3 may face the third housing side portion.

In addition, the third holder outer side surface 1131S3 may comprise an extension stopper (not shown) being extended downward. Accordingly, it is possible to set limits on the range in which the holder 1131 moves in an Y-axis tilt or in a first direction (X-axis direction) or moves up and down within the housing, and at the same time, damage and the like caused by the movement of the holder 1131 can be inhibited.

Also, the third holder outer side surface 1131S3 may comprise a third seating groove 1131S3a. A third magnet may be disposed in the third seating groove 1131S3a. For example, the area of the third seating groove 1131S3a may be different from the areas of the first seating groove 1131S1a and the second seating groove 1131S2b. The area of the third seating groove 1131S3amay be larger than the areas of the first seating groove 1131S1a and the second seating groove 1131S2b. Accordingly, rotation in a first direction (X-axis direction) or tilt in a second direction (Y-axis direction) can be easily performed through the third magnet disposed in the third seating groove 1131S3a.

The fourth holder outer side surface 1131S4 is in contact with the first holder outer side surface 1131S1 and the second holder outer side surface 1131S2, and may be an outer side surface being extended in a first direction (X-axis direction) from the third holder outer side surface 1131S3. In addition, the fourth holder outer side surface 1131S4 may be positioned between the first holder outer side surface 1131S1 and the second holder outer side surface 1131S2. The fourth holder outer side surface 1131S4 may be disposed on the third holder outer side surface 1131S3. The fourth holder outer side surface 1131S4 may be positioned to face the first surface of the tilting guide unit.

The fourth holder outer side surface 1131S4 may comprise first protrusion grooves PH1 being disposed spaced apart in a first direction (X-axis direction) about the center of the fourth holder outer side surface. A first protruding portion of the tilting guide unit may be seated in the first protrusion groove PH1. The holder 1131 may be rotated in an X-axis direction or tilted in a Y-axis with respect to the first protruding portion. Furthermore, the holder 1131 may be rotated in a Y-axis direction or tilted in an X-axis with respect to the second protruding portion.

As described above, the number of first protrusion grooves PH1 is plural, and may be overlapped in a second direction (Y-axis direction). Accordingly, when the mover is tilted in a Y-axis tilt or rotated in a first direction (X-axis direction), it can be performed accurately without tilting to one side. As an embodiment, the OIS function can be performed accurately.

Furthermore, a first additional groove PH1H surrounding the first protrusion groove PH1 may be positioned outside the first protrusion groove PH1. The first additional groove PH1H may be positioned on the fourth holder outer side surface 1131S4. Furthermore, the first additional groove PH1H may surround the first protrusion groove PH1 positioned on the fourth holder outer side surface 1131S4. With this configuration, a lubricating member for seating the first protruding portion of the tilting guide unit in the first protrusion groove PH1 may be positioned. At this time, the lubricating member (For example, grease) may overflow due to impact between the second protruding portion and the first protrusion groove PH1. The first additional groove PH1H can accommodate the overflowing lubrication member. Thus, even if the lubricating member overflows due to collision, it may not move to the tilting guide unit. Therefore, the tilting guide unit and the housing may not be connected by the lubrication member. Therefore, the rotational drive of the tilting guide unit can be accurately performed without being hindered by the lubrication member.

Furthermore, the first yoke groove and the second yoke groove may be positioned on an optical axis direction side with respect to the first protrusion groove PH1 or the first additional groove PH1H. Also, the first yoke groove and the second yoke groove may not be overlapped in an optical axis direction with respect to the first protrusion groove PH1 or the first additional groove PH1H.

In addition, the fourth holder outer side surface 1131S4 may further comprise outer side surface grooves being disposed spaced apart from each other in a first direction (X-axis direction) with respect to the first additional groove PH1H. The outer side surface groove may comprise a first outer side surface groove 1131S4g1 and a second outer side surface groove 1131S4g2.

The first outer side surface groove 1131S4g1 is disposed above the first additional groove PH1H, and the second outer side surface groove 1131S4g2 may be disposed below the first additional groove PH1H. That is, the first outer side surface groove 1131S4g1 may be disposed above the second outer side surface groove 1131S4g2.

The first outer side surface groove 1131S4g1 and the second outer side surface groove 1131S4g2 may be disposed at end portions of the fourth holder outer side surface 1131S4 in a vertical direction. With this configuration, the first outer side surface groove 1131S4g1 and the second outer side surface groove 1131S4g2 can avoid the impact between the housing and the holder for the two-axis tilting of the holder 1131. Thus, the reliability of the holder 1131 can be enhanced.

In addition, in the holder 1131 according to the embodiment, the area of the first outer side surface groove 1131S4g1 may be different from the area of the second outer side surface groove 1131S4g2. For example, the area of the first outer side surface groove 1131S4g1 on the plane XY may be smaller than the area of the second outer side surface groove 1131S4g2 on the plane XY. Therefore, the cross-sectional area of the holder 1131 on the plane XY decreases as the holder 1131 moves toward an optical axis with respect to the seating surface 1131k, and the cross-sectional area of the cavity increases toward the optical axis, and therefore, the rigidity, durability, and the like of the holder 1131 according to the area of the outer side surface grooves 1131S4g1 and 1131S4g2 of the fourth holder outer side surface 1131S4 may be maintained.

Furthermore, the holder 1131 according to an embodiment may further comprise stoppers VS and LS. The stopper may come into contact with the first holder outer side surface 1131S1 and the second holder outer side surface 1131S2.

These stoppers may comprise an upper stopper VS being disposed on a bottom surface of the cavity CV and a lower stopper LS being disposed at a lower portion of the bottom surface of the cavity CV. In an embodiment, the bottom surface of the cavity CV may correspond to the seating surface 1131k. That is, the cavity may be surrounded by the first holder outer side surface 1131S1, the second holder outer side surface 1131S2, and the seating surface 1131k.

In the stopper according to an embodiment, each of the upper stopper VS and the lower stopper LS may be positioned at an end portion in a third direction (Z-axis direction) or an optical axis direction in the first holder outer side surface 1131S1 and the second holder outer side surface 1131S2. Furthermore, the upper stopper VS and the lower stopper LS may have the same or different cross-sectional areas or volumes on a plane XZ.

As an embodiment, the upper stopper VS and the lower stopper LS may be disposed spaced apart from each other in a first direction (X-axis direction). As an embodiment, the first holder outer side surface 1131S1 and the second holder outer side surface 1131S2 may comprise an upper region UA and a lower region BA bisected in a first direction (X-axis direction). For example, the upper region UA may be positioned above the lower region BA. The upper stopper VS may be positioned in the upper region UA. That is, the upper stopper VS may be in contact with the upper region UA and overlapped in a second direction (Y-axis direction). Also, the lower stopper LS may be positioned in the lower region BA. In addition, the lower stopper LS may be in contact with the lower region BA and overlapped in the second direction (Y-axis direction). For example, the upper stopper VS may be disposed to be overlapped with the second region S2 and the upper region UA in a second direction (Y-axis direction). Also, the lower stopper VS may be positioned to be overlapped with the second region S2 and the lower region BA in a second direction (Y-axis direction). Accordingly, the upper stopper VS may be overlapped with an optical member in a second direction (X-axis direction).

In addition, as an embodiment, the lower stopper LS may be disposed closer to the third holder outer side surface 1131S3 than the upper stopper VS. And the area being overlapped with the cavity or optical member in a second direction (Y-axis direction) in the upper region UA may be larger than the area being overlapped with the cavity CV or optical member in a second direction (Y-axis direction) in the lower region BA. Accordingly, the amount of deformation due to impact may be greater in the upper region UA than in the lower region BA as it travels toward an end portion. In other words, the amount of deformation due to impact at an end portion of the lower region BA may be smaller than that of the upper region UA.

The upper stopper VS and the lower stopper LS may be extended from end portions of the first holder outer side surface 1131S1 and the second holder outer side surface 1131S2 in directions opposite to the third direction.

In addition, the upper stopper VS and the lower stopper LS may be extended inward or toward the cavity CV. With this configuration, when the holder 1131 tilts in a second direction (Y-axis direction) or tilts in a first direction, damages due to impact between the holder and the housing can be suppressed through the upper stopper VS and the lower stopper LS.

It may comprise a plurality of groove inner side surfaces. For example, the holder 1131 may comprise a first holder inner side surface 1131I1 and a second holder inner side surface 1131I2 being in contact with the cavity CV or the seating surface 1131k.

The first holder inner side surface 1131I1 and the second holder inner side surface 1131I2 may be disposed to face each other in a second direction (Y-axis direction). For example, the first holder inner side surface 1131I1 and the second holder inner side surface 1131I2 may be disposed to face each other without an optical member or in the holder 1131. In addition, a cavity CV may be positioned between the first holder inner side surface 1131I1 and the second holder inner side surface 1131I2.

Furthermore, the holder 1131 according to an embodiment may comprise a holder groove 1131SG. The number of holder grooves 1131SG may be plural, and the prevention portion may be seated. In addition, the holder groove 1131SG may be disposed on at least one of the first holder inner side surface 1131I1 and the second holder inner side surface 1131I2. For example, the holder groove 1131SG may comprise a first holder groove 1131SG1 and a second holder groove 1131SG2. The first holder groove 1131SG1 may be disposed on the first holder inner side surface 1131I1, and the second holder groove 1131SG2 may be disposed on the second holder inner side surface 1131I2.

In addition, the first holder groove 1131SG1 and the second holder groove 1131SG2 may be overlapped in a second direction (Y-axis direction). Also, the first holder groove 1131SG1 and the second holder groove 1131SG2 may be symmetrically disposed with respect to an optical member or a first direction (X-axis direction).

Accordingly, when at least a portion of the prevention portion is positioned in the first holder groove 1131SG1 and the second holder groove 1131SG2, it is possible to inhibit the tilting guide unit from falling out between the housing and the mover by the prevention portion.

The first holder groove 1131SG1 and the second holder groove 1131SG 2 may be disposed in the upper region UA. Thus, the prevention portion of the cover can be easily positioned in the first holder groove 1131SG1 and the second holder groove 1131SG 2.

In addition, the holder according to an embodiment may comprise the holder groove 1131SG and adjacent bonding grooves 1131CG1 and 1131CG2. The bonding grooves 1131CG1 and 1131CG2 may be disposed adjacent to the holder groove 1131SG in an optical axis direction. For example, the bonding grooves 1131CG1 and 1131CG2 may be overlapped with each other at least a portion of the holder groove 1131SG in an optical axis direction.

There may be a plurality of junction grooves according to an embodiment, and may comprise a first bonding groove 1131CG1 and a second bonding groove 1131CG2. Each of the first bonding groove 1131CG1 and the second bonding groove 1131CG2 may be plural. For example, each of the first bonding groove 1131CG1 and the second bonding groove 1131CG2 is symmetrically disposed with respect to a vertical direction or the optical member.

In addition, the first bonding groove 1131CG1 and the second bonding groove 1131CG2 may be disposed on the first holder inner side surface 1131I1 and the second holder inner side surface 1131I2. In addition, the first bonding groove 1131CG1 and the second bonding groove 1131CG2 may be disposed in the upper region UA like the holder groove 1131SG.

The first bonding groove 1131CG1 and the second bonding groove 1131CG2 may be disposed spaced apart from each other in an optical axis direction, and the holder groove 1131SG may be disposed between the first bonding groove 1131CG1 and the second bonding groove 1131CG2.

Also, a bonding member may be applied in the first bonding groove 1131CG1 and the second bonding groove 1131CG2. Accordingly, since the prevention portion in the holder groove 1131SG is in contact with the inner side surface of the holder groove 1131SG, even if an impact is applied to the holder, the coupling between the holder and the optical member can be maintained through the bonding member inside the first and second bonding holes adjacent to the holder groove 1131SG1. Thus, separation between the holder and the optical member can be inhibited.

Furthermore, in the first camera actuator according to an embodiment, the holder 1131 may comprise a holder protruding portion 1131p being extended upward on an upper surface.

The holder protruding portion 1131p may be disposed adjacent to the first bonding groove 1131CG1 and the second bonding groove 1131CG2. For example, the holder protruding portion 1131p may be disposed along edges of the first bonding groove 1131CG1 and the second bonding groove 1131CG2. Accordingly, in the holder protruding portion 1131p, the bonding member applied inside the first bonding groove 1131CG1 and the second bonding groove 1131CG2 may not overflow from the first bonding groove 1131CG1 and the second bonding groove 1131CG2. Furthermore, the holder protruding portion 1131p may operate as a stopper for tilting in a first direction (X-axis direction) or a second direction (Y-axis direction).

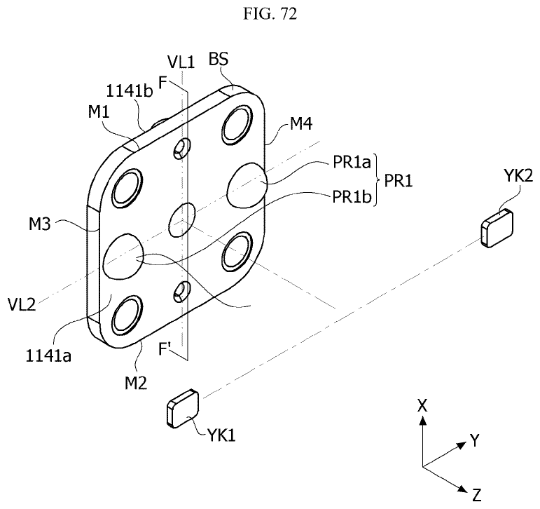

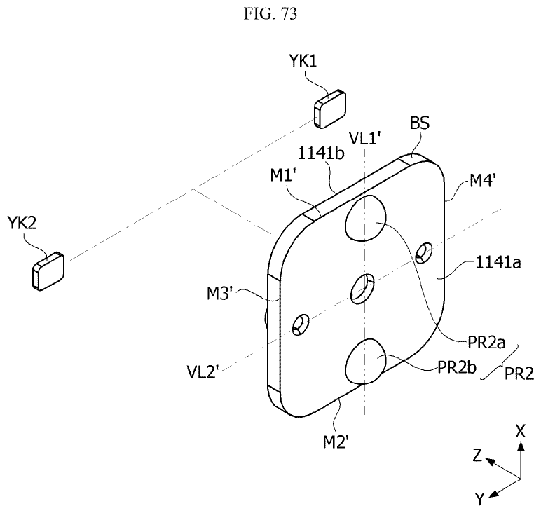

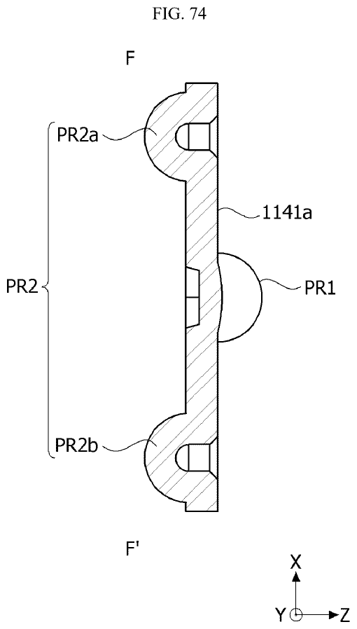

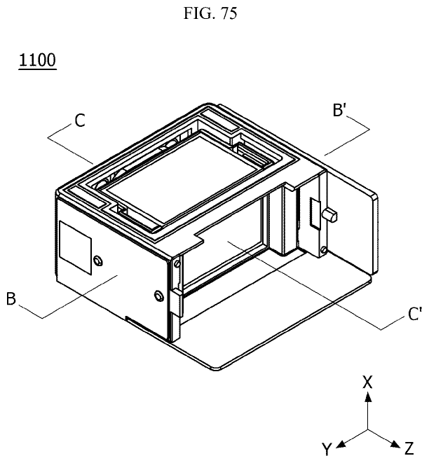

FIG. 72 is a perspective view of a tilting guide unit of a first camera actuator according to a second embodiment of the present invention; FIG. 73 is a perspective view in a direction different from that of FIG. 72; and FIG. 74 is a cross-sectional view viewed from F-F′ in FIG. 72.

Referring to FIGS. 72 to 74, a rotating part 1140 according to an embodiment may comprise a tilting guide unit 1141 and a yoke part. The yoke part may comprise a first yoke YK1 and a second yoke YK2. The first yoke YK1 and the second yoke YK2 may be positioned correspondingly with respect to the tilting guide unit 1141. For example, the guide unit 1141 may be positioned in a region between the first yoke YK1 and the second yoke YK2. In addition, the first yoke YK1 and the second yoke YK2 may provide coupling force among the mover, the tilting guide unit 1141, and the housing by applying the same contents as described above.

First, the tilting guide unit 1141 may comprise: a base BS; a first protruding portion PR1 being protruded from the first surface 1141a of the base BS; and a second protruding portion PR2 being protruded from the second surface 1141b of the base BS. In addition, depending on the structure, the first protruding portion and the second protruding portion may have opposite surfaces, but will be described with reference to the drawings hereinafter. In addition, the first protruding portion PR1 and the second protruding portion PR2 may be formed integrally or separately from the base BS, and as shown in the drawing, the first protruding portion PR1 and the second protruding portion RP2 may have a spherical shape or a hemispherical shape like a ball.

First, the base BS may comprise a first surface 1141a and a second surface 1141b facing the first surface 1141a. That is, the first surface 1141a may be spaced apart from the second surface 1141b in a third direction (Z-axis direction), and it may be an outer side surface facing each other or facing each other inside the tilting guide unit 1141. The first surface 1141a is positioned facing the fourth holder outer side surface (or the fourth housing side portion), and the second surface 1141b may be positioned to face the fourth holder outer side surface (or the fourth housing side portion).

The first surface 1141a and the second surface 1141b may comprise a plurality of holes or grooves, and the weight of the tilting guide unit 1141 may be reduced through the holes or grooves.

The tilting guide unit 1141 may comprise a first protruding portion PR1 being extended to one side on the first surface 1141a. According to an embodiment, the first protruding portion PR1 may be protruded from the first surface 1141a toward the fourth holder outer side surface. The first protruding portion PR1 is plural, and may comprise a first-first protruding portion PR1a and a first-second protruding portion PR1b.

The first-first protruding portion PR1a and the first-second protruding portion PR1b may be positioned side by side in a second direction (Y-axis direction). In other words, the first-first protruding portion PR1a and the first-second protruding portion PR1b may be overlapped in a second direction (Y-axis direction). In addition, in an embodiment, the first-first protruding portion PRla and the first-second protruding portion PR1b may be bisected by a virtual line being extended in a second direction (Y-axis direction).

In addition, the first-first protruding portion PR1a and the first-second protruding portion PR1b have curvatures, and may be, for example, in the shape of a hemisphere. Furthermore, in the present specification, the first protruding portion and the second protruding portion may refer to a hemispherical protrusion or a ball seated in a groove. Also, the first-first protruding portion PR1a and the first-second protruding portion PR1b may be in contact with the first protrusion groove of the holder at a point most spaced apart from the first surface 1141a of the base BS.

In addition, an align groove (not shown) may be positioned on the first surface 1141a. An alignment groove (not shown) may be disposed on one side of the first surface 1141a to provide an assembly position or assembly direction of the tilting guide unit 1141 during an assembly process.

In addition, the tilting guide unit 1141 may comprise a second protruding portion PR2 being extended to one side on the second surface 1141a. According to an embodiment, the second protruding portion PR2 may be protruded toward the fourth housing side portion from the second surface 1141b. The second protruding portion PR2 is plural, and may comprise a second-first protruding portion PR2a and a second-second protruding portion PR2b in an embodiment.

The second-first protruding portion PR2a and the second-second protruding portion PR2b may be positioned side by side in a first direction (X-axis direction). That is, the second-first protruding portion PR2a and the second-second protruding portion PR2b may be overlapped in a first direction (X-axis direction). In addition, in an embodiment, the second-first protruding portion PR2a and the second-second protruding portion PR2b may be bisected by a virtual line being extended in a first direction (X-axis direction).

The second-first protruding portion PR2a and the second-second protruding portion PR2b may have a curvature, and for example, may be in the shape of a hemisphere. Further, the second-first protruding portion PR2a and the second-second protruding portion PR2b maybe in contact with the second protrusion groove of the side portion of the fourth housing at a point spaced apart from the second surface 1141b of the base BS.

The first-first protruding portion PR1a and the first-second protruding portion PR1b may be positioned in a region between the second-first protruding portion PR2a and the second-second protruding portion PR2b. According to an embodiment, the first-first protruding portion PR1a and the first-second protruding portion PR1b may be positioned at the center of the separation space between the second-first protruding portion PR2a and the second-second protruding portion PR2b in a first direction. Due to this configuration, the first camera actuator according to an embodiment may cause the Y-axis tilt angle to have the same range with respect to a Y-axis. In other words, the tilting guide unit 1141 may provide the same range in which the holder can tilt in Y-axis (For example, positive/negative range) with respect to the first-first protruding portion PR1a and the first-second protruding portion PR1b.

In addition, the second-first protruding portion PR2a and the second-second protruding portion PR2b may be positioned in a region between the first-first protruding portion PR1a and the first-second protruding portion PR1b in a second direction. According to an embodiment, the second-first protruding portion PR2a and the second-second protruding portion PR2b may be positioned at the center of the separation space between the first-first protruding portion PR1a and the first-second protruding portion PR1b in a second direction. Due to this configuration, the actuator according to an embodiment may provide the same range in which the holder can tilt in X-axis (For example, positive/negative range) with respect to the X-axis. In other words, the tilting guide unit 1141 may provide the same range in which the holder can tilt in X-axis (For example, positive/negative range) with respect to the second-first protruding portion PR2a and the second-second protruding portion PR2b.

Specifically, the first surface 1141a may comprise a first outer side line M1, a second outer side line M2, a third outer side line M3, and a fourth outer side line M4. The first outer side line M1 and the second outer side line M2 may face each other, and the third outer side line M3 and the fourth outer side line M4 may face each other. Also, a third outer side line M3 and a fourth outer side line M4 may be positioned between the first outer side line M1 and the second outer side line M2. Further, the first outer side line M1 and the second outer side line M2 are perpendicular to a first direction (X-axis direction), but the third outer side line M3 and the fourth outer side line M4 may be perpendicular to a first direction (X-axis direction).

At this time, the first protruding portion PR1 may be positioned on the second virtual line VL2. Here, the first virtual line VL1 is a line that bisects the first outer side line M1 and the second outer side line M2. Also, the second virtual line VL2 is a line that bisects the third outer side line M3 and the fourth outer side line M4. Or, the first and third virtual lines VL1 and VL1′ are lines that bisect the base BS in a second direction (Y-axis direction). The second and fourth virtual lines VL2 and VL2′ are lines that bisect the base BS in a first direction (X-axis direction). Also, the first center point C1 may be an intersection of the first virtual line VL1 and the second virtual line VL2. Or, it may be a point corresponding to the center of gravity according to the shape of the tilting guide unit 1141.

Accordingly, the tilting guide unit 1141 can easily perform Y-axis tilt through the first protruding portion PR1. In addition, since the tilting guide unit 1141 performs the Y-axis tilt with respect to the second virtual line VL2, rotational force can be uniformly applied to the tilting guide unit 1141. Accordingly, the X-axis tilt can be precisely performed and the reliability of the device can be improved.

In addition, the first-first protruding portion PR1a and the first-second protruding portion PR1b may be formed symmetrically with respect to the first virtual line VL1 and the second virtual line VL2. Or, the first-first protruding portion PR1a and the first-second protruding portion PR1b may be symmetrically positioned with respect to the first central point C1. With this configuration, when tilting the Y-axis, the supporting force being supported by the first protruding portion PR1 can be equally applied to the upper and lower sides with respect to the second virtual line VL2. Thus, the reliability of the tilting guide unit can be improved.

In addition, the second surface 1141b may comprise a fifth outer side line M1′, a sixth outer side line M2′, a seventh outer side line M3′, and an eighth outer side line M4′. The fifth outer side line M1′ and the sixth outer side line M2′ may face each other, and the seventh outer side line M3′ and the eighth outer side line M4′ may face each other. The seventh outer side line M3′ and the eighth outer side line M4′ may be positioned between the fifth outer side line MI′ and the sixth outer side line M2′. The fifth outer side line M1′ and the sixth outer side line M2′ are perpendicular to a first direction (X-axis direction), but the seventh outer side line M3′ and the eighth outer side line M4′ may be parallel to a first direction (X-axis direction).

In addition, since the tilting guide unit 1141 performs the X-axis tilt with respect to the third virtual line VL1′, rotational force can be uniformly applied to the tilting guide unit 1141. Accordingly, the X-axis tilt can be precisely performed and the reliability of the device can be improved.

In addition, the second-first protruding portion PR2a and the second-second protruding portion PR2b may be symmetrically disposed on the fourth virtual line VL2′ on the third virtual line VL1′. Or, the second-first protruding portion PR2a and the second-second protruding portion PR2b may be symmetrically positioned with respect to the second central point C1′. With this configuration, when tilting the X-axis, the supporting force being supported by the second protruding portion PR2 can be equally applied to the upper and lower sides of the tilting guide unit with respect to the third virtual line VL1′. Thus, the reliability of the tilting guide unit can be improved. Here, the third virtual line VL1′ is a line that bisects the fifth outer side line MI′ and the sixth outer side line M2′. The fourth virtual line VL2′ is a line that bisects the seventh outer side line M3′ and the eighth outer side line M4′. And the second central point C1′ may be the intersecting point of the third virtual line VL1′ and the fourth virtual line VL2′. Or, it may be a point corresponding to the center of gravity according to the shape of the tilting guide unit 1141.

However, the above configuration is an example, and the tilting guide unit 1141 may be formed in various shapes for X-axis tilt or Y-axis tilt.

Also, the first yoke YK1 and the second yoke YK2 may have the same length in a first direction. For example, the length of the first yoke YK1 in a first direction may be equal to the length of the second yoke YK2 in a first direction. Accordingly, the attractive force between the holder 1131 and the housing may be equally applied to both sides of the tilting guide unit 1141. As a result, the force applied to the tilting guide unit 1141 is uniformly generated with respect to the tilting guide unit, so that rotation by the tilting guide unit can be accurately performed.

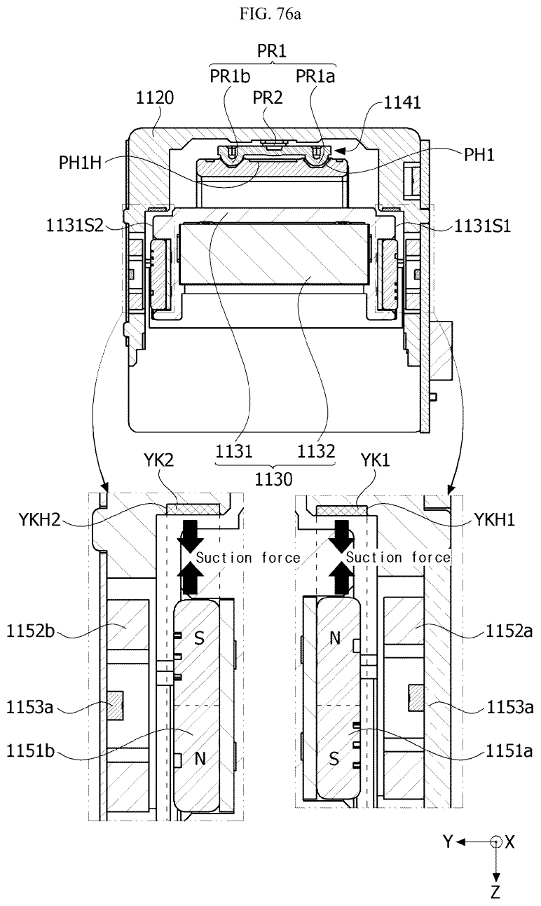

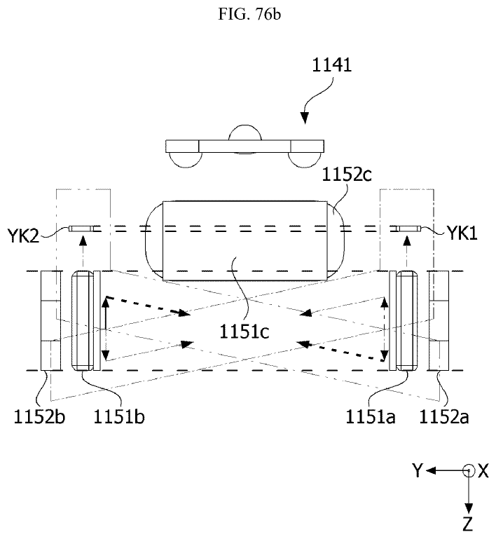

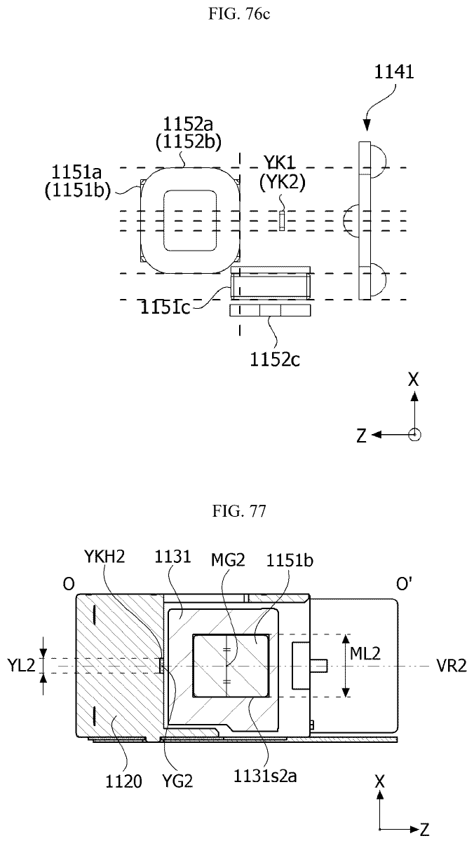

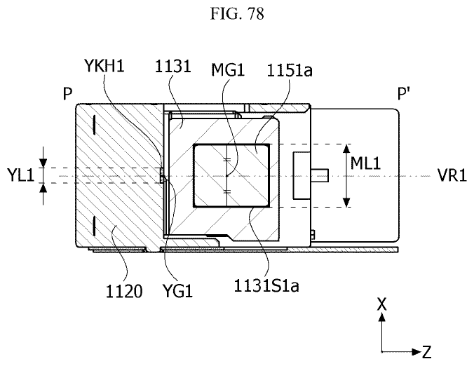

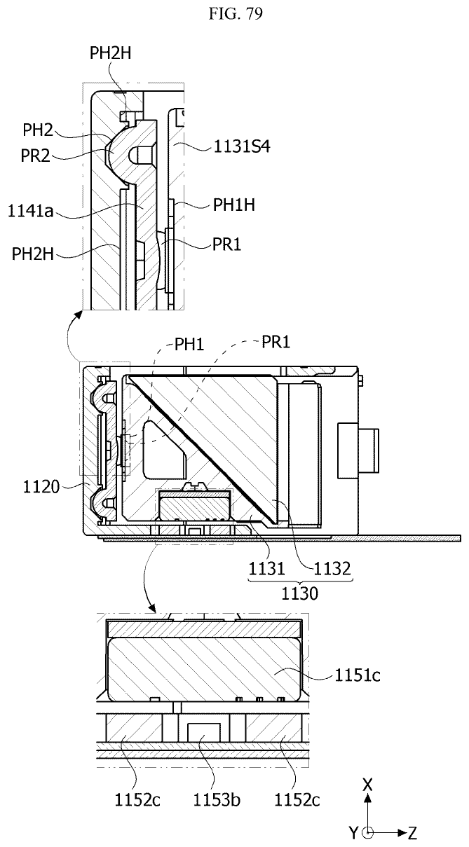

FIG. 75 is a perspective view of a first camera actuator according to a second embodiment of the present invention; FIG. 76a is a view viewed from B-B′ in FIG. 75; FIG. 76b is a plan view of some components of a first camera actuator; FIG. 76c is a side view of a portion of a first camera actuator; FIG. 77 is a view viewed from O-O′ in FIG. 76a; FIG. 78 is a view viewed from P-P′ in FIG. 76a; and FIG. 79 is a view viewed from C-C′ in FIG. 75.

Referring to FIGS. 75 to 79, the first coil 1152a is positioned on the side portion 1121 of the first housing, and the first magnet 1151a may be positioned on the first holder outer side surface 1131S1 of the holder 1131. Accordingly, the first coil 1152a and the first magnet 1151a may be positioned to face each other. The first magnet 1151a may be at least partially overlapped with the first coil 1152a in a second direction (Y-axis direction). Furthermore, the first magnet 1151a may be coupled to a coupling yoke positioned inside the first seating groove of the first holder outer side surface 1131S1. Furthermore, a bonding member may be additionally applied inside the first seating groove. Similarly, the second magnet 1151b may be coupled to a coupling yoke positioned in the second seating groove of the second holder outer side surface 1131S2. In addition, a bonding member may be additionally applied in the second seating groove. This may be equally applied to the third magnet and the third seating groove.

In addition, the second coil 1152b may be positioned on the second housing side portion 1122, and the second magnet 1151b may be positioned on the second holder outer side surface 1131S2 of the holder 1131. Accordingly, the second coil 1152b and the second magnet 1151b may be positioned to face each other. The second magnet 1151b may at least partially be overlapped with the second coil 1152b in a second direction (Y-axis direction).

In addition, the first coil 1152a and the second coil 1152b are overlapped in a second direction (Y-axis direction), and the first magnet 1151a and the second magnet 1151b may be overlapped in a second direction (Y-axis direction). With this configuration, the electromagnetic force applied to the outer side surface of the holder (first holder outer side surface and second holder outer side surface) is positioned on a parallel axis in a second direction (Y-axis direction), so that the X-axis tilt can be performed accurately and precisely.

In addition, the second protruding portions PR2a and PR2b of the tilting guide unit 1141 are positioned inside the second protrusion groove PH2 of the first housing 1120 and may be in contact with the second protrusion groove PH2. Also, when the X-axis tilt is performed, the second protruding portions PR2a and PR2b may be reference axes (or rotation axes) of the tilt. Accordingly, the tilting guide unit 1141 and the mover 1130 may move left and right.

In addition, the contact point between the second protruding portion PR2 and the fourth housing side portion 1124 and the center of the second protrusion groove PH2 may be overlapped in a third direction (Z-axis direction) or may be positioned on an axis parallel to a third direction. Accordingly, the actuator according to an embodiment may enhance the accuracy of X-axis tilt through the second protruding portion PR2.

And, as described above, the first Hall sensor 1153a may be positioned outside for electrical connection and coupling with the substrate unit 1154. Furthermore, the number of Hall sensors may be plural, and may be positioned inside the first to third coils. However, it is not limited to these locations.

In addition, the third coil 1152c may be positioned in the third housing side portion 1123, and the third magnet 1151c may be positioned on the third holder outer side surface 1131S3 of the holder 1131. The third coil 1152c and the third magnet 1151c may be overlapped at least partially in a first direction (X-axis direction). Accordingly, the strength of the electromagnetic force between the third coil 1152c and the third magnet 1151c can be easily controlled.

As described above, the tilting guide unit 1141 may be positioned on the fourth holder outer side surface 1131S4 of the holder 1131.

Further referring to FIGS. 76b and 76c, in a first camera actuator according to an embodiment, yoke parts YK1 and YK2 may be positioned in a region between the tilting guide unit 1141 and any one of the side surface magnets. For example, the yoke may be positioned in a region between the tilting guide unit 1141 and any one of the first magnet 1151a and the second magnet 1151b. As an embodiment, the third yoke 1152c and the third magnet 1152c may be positioned at a lower portion of the first yoke YK1 and the second yoke YK2. Furthermore, the tilting guide unit 1141 may be overlapped with the third magnet 1151c in an optical axis or a third direction (Z-axis direction). The tilting guide unit 1141 may or may not be overlapped with the third coil 1152c in a third direction.

Furthermore, a third magnet 1151c and a third coil 1152c may be positioned between the first yoke YK1 and the second yoke YK2. However, as described above, the third yoke 1152c and the third magnet 1152c may be positioned at a lower portion of the first yoke YK1 and the second yoke YK2. Accordingly, the first yoke YK1 and the second yoke YK2 may not be overlapped with the third yoke 1152c and the third magnet 1152c in a second direction.

Unlike this, each of the first yoke YK1 and the second yoke YK2 may be overlapped with each of the first magnet 1151a and the second magnet 1151b in a third direction in order to form a force (For example, attractive force) with the first magnet 1151a and the second magnet 1151b.

And along the optical axis direction or the third direction (Z-axis direction), the first and second yokes YK1 and YK2 or the third coil (or magnet) may be positioned between the tilting guide unit 1141 and the first and second coils (or first and second magnets).

Furthermore, a first protruding portion of the tilting guide unit may be positioned between the first yoke YK1 and the second yoke YK2. The center of the first protruding portion may be positioned on an axis in the same optical axis direction as the center of the yoke parts YK1 and YK2. For example, the distance between the centers of the yoke parts YK1 and YK2 and the third coil 1152c in a first direction (X-axis direction) can be the same as the distance between the yoke parts YK1 and YK2 and the center of the first protruding portion in a first direction (X-axis direction). Or, the centers of the yoke parts YK1 and YK2 (For example, bisect in a first direction) and the center of the first protruding portion (For example, bisect in a first direction) may be positioned on the same plane YZ.

Furthermore, the first yoke YK1 and the second yoke YK2 do not overlap with the optical member in an optical axis direction or a third direction. For example, a virtual line connecting the first yoke and the second yoke and the optical member may be overlapped. However, the optical member 1132 may be positioned between the first yoke YK1 and the second yoke YK2. In addition, the optical member may be positioned between the first magnet 1151a and the second magnet 1151b and may be overlapped with the first magnet 1151a and the second magnet 1151b in a second direction. This may be equally applied to the first and second coils.

And, as will be described later, OIS implementation can be performed while the mover 1130 is rotated at a second angle θ2 in a Y-axis direction by the second electromagnetic force between the first and second magnets 1151a and 1151b and the first and second coils 1152a and 1152b (Y1->Y1b). At this time, the attractive force between the yoke part YK1 and the first and second magnets 1151a and 1151b may act. Furthermore, there may be a difference in relative force depending on the rotation direction of the mover. For example, when rotating in one direction, a composite force may act on the second magnet in a direction opposite to the direction of an optical axis, and a composite force may act on the first magnet in an optical axis direction. Further, when rotating in the other direction, a composite force may act on the second magnet in a direction of an optical axis, and a composite force may act on the first magnet in a direction opposite to the direction of an optical axis.

Further referring to FIGS. 77 and 78, in the tilting guide unit 1141, the first protruding portion PR1 may be seated in the first protrusion groove PH1 of the fourth holder outer side surface 1131S4. In the tilting guide unit 1141, the second protruding portion PR2 may be seated in the second protrusion groove PH2 of the fourth housing side portion. In addition, an attractive force is generated between the first yoke YK1 and the first magnet 1151a. In addition, an attractive force is generated between the second yoke YK2 and the second magnet 1151b. The attractive force between the yoke and the magnet may be the attractive force between the holder 1131 and the first housing 1120. Accordingly, the tilting guide unit 1141 between the fourth holder outer side surface 1131S4 and the fourth housing side portion may be pressed by the holder 1131 and the first housing 1120. In this way, the position of the tilting guide unit 1141 can be maintained. In other words, even when the tilting guide unit 1141 rotates, the tilting guide unit 1141 may not be dropped off from the holder and the housing. In this way, the first and second magnets 1151a and 1151b may simultaneously provide a driving force for tilting the holder 1131 in an X direction or rotating in the second direction and a suction force between the first and second yokes YK1 and YK2. Thus, the yoke or magnet may not be disposed inside the tilting guide unit 1141 or adjacent to the tilting guide unit 1141. Therefore, it is possible to easily provide a suction force for maintaining the position of the tilting guide unit even without an additional magnet.

As an embodiment, the yoke part may be disposed adjacent to the magnet and not be overlapped with the tilting guide unit 1141. For example, the first yoke YK1 may be disposed adjacent to the first magnet 1151a. Also, the second yoke YK2 may be disposed adjacent to the second magnet 1151b. In addition, the first yoke YK1 and the second yoke YK2 may not be overlapped with the tilting guide unit 1141 along the optical axis direction (Z-axis direction).

Accordingly, the first yoke YK1 and the second yoke YK2 may be disposed outside the tilting guide unit 1141. Furthermore, the first yoke YK1 and the second yoke YK2 may be symmetrically disposed with respect to the tilting guide unit, the optical member 1132, and the holder 1131. With this configuration, the suction force by the first yoke YK1 and the second yoke YK2 can be uniformly applied between the holder 1131 and the first housing 1120. That is, by the first yoke YK1 and the second yoke YK2, the X-axis tilt of the holder 1131 and the optical member 1132 can be accurately achieved without tilting to one side.

Also, the first yoke YK1 and the second yoke YK2 may be positioned between the tilting guide unit 1141 and the first and second magnets 1151a and 1151b. For example, the first yoke YK1 may be positioned in a region between the tilting guide unit 1141 and the first magnet 1151a. The second yoke YK2 may be positioned in a region between the tilting guide unit 1141 and the second magnet 1151b.

The first yoke YK1 may be positioned to correspond to the first magnet 1151a. The second yoke YK2 may also be positioned to correspond to the second magnet 1151b.

As an embodiment, the first yoke YK1 may be overlapped with the first magnet 1151a along an optical axis direction (Z-axis direction). Also, the first yoke YK1 may not be overlapped with the first coil 1152a along an optical axis direction. In other words, the first yoke YK1 may be misaligned with the first coil 1152a in an optical axis direction.

In addition, the second yoke YK2 may be overlapped with the second magnet 1151b along an optical axis direction (Z-axis direction). Also, the second yoke YK2 may not be overlapped with the second coil 1152b along an optical axis direction. In other words, the second yoke YK2 may be misaligned with the second coil 1152b in an optical axis direction.

With this configuration, the first yoke YK1 can minimize interference with the first coil 1152a and provide maximum suction force with the first magnet 1151a. In addition, the second yoke YK2 may also minimize interference with the second coil 1152b and provide maximum suction force with the second magnet 1151b.

Furthermore, the first magnet 1151a and the second magnet 1151b are symmetrically disposed inside the holder 1131, and the first yoke YK1 and the second yoke YK2 may be symmetrically disposed with respect to the holder 1131. Thus, when the tilting guide unit 1141 performs the X-axis tilt, accurate driving can be achieved without tilting to one side.

Furthermore, the centers YG1 and YG2 of the first and second yokes YK1 and YK2 may correspond to the centers MG1 and MG2 of the first and second magnets 1151a and 1151b. For example, the centers YG1 and YG2 of the first yoke YK1 and the second yoke YK2 may pass through the first bisector VR1 in a first direction of the first yoke YK1 or the second yoke YK2. In addition, the centers MG1 and MG2 of the first and second magnets 1151a and 1151b may pass through the second bisector VR2 in a first direction of the first and second magnets 1151a and 1151b.

That is, the first yoke YK1 and the first magnet 1151a may be bisected in a first direction (X-axis direction) with respect to the first bisector VR1. Also, the second yoke YK2 and the second magnet 1151b may be bisected in a first direction (X-axis direction) with respect to the second bisector VR2. Accordingly, the suction force between the first and second yokes YK1 and YK2 and the first and second magnets 1151a and 1151b may not affect the Y-axis tilt.

Furthermore, the lengths YL1 and YL2 of the first and second yokes YK1 and YK2 in a first direction may be different from or identical to the lengths ML1 and ML2 of the first and second magnets 1151a and 1151b in a first direction. As an embodiment, the lengths YL1 and YL2 of the first and second yokes YK1 and YK2 in a first direction may differ from the lengths ML1 and ML2 of the first and second magnets 1151a and 1151b in a first direction. Specifically, the lengths YL1 and YL2 of the first and second yokes YK1 and YK2 in a first direction may be smaller than the lengths ML1 and ML2 of the first and second magnets 1151a and 1151b in a first direction. Accordingly, rotation of the tilting guide unit 1141 and the mover 1130 can be easily performed with respect to the first housing that is fixed.

Furthermore, in a first camera actuator according to an embodiment, the first magnet 1151a and the first yoke YK1 may be disposed between the first coil 1152a and the optical member 1132. Furthermore, the first yoke YK1 and the second yoke YK2 may be disposed outside the optical member 1132. Specifically, the first yoke YK1 and the second yoke YK2 may not be overlapped with the optical member 1132 in an optical axis direction. In other words, the first yoke YK1 and the second yoke YK2 may be misaligned with the optical member 1132 along an optical axis direction.

In addition, the second magnet 1151b and the second yoke YK2 may be disposed between the second coil 1152b and the optical member 1132. Thus, the yoke for generating the suction force may not be positioned on the center of the mover 1130 or the center of the second protrusion groove. Therefore, even if the suction force is non-uniform with respect to the center of the mover 1130 or the center of the second protrusion groove, it is possible to easily adjust the first yoke YK1 and the second yoke YK2.

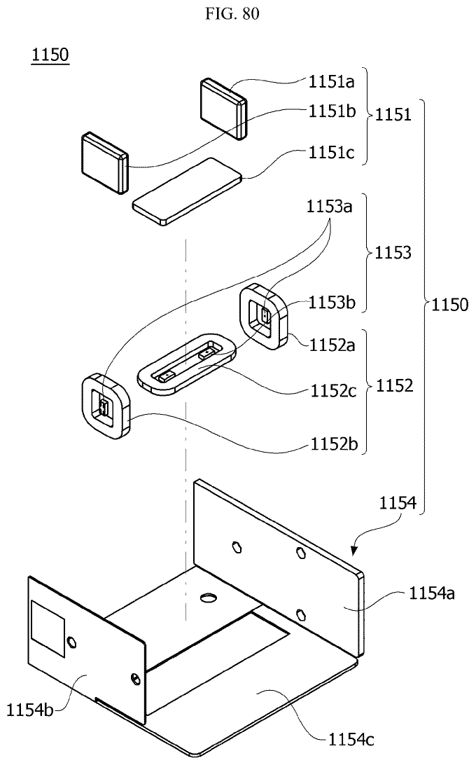

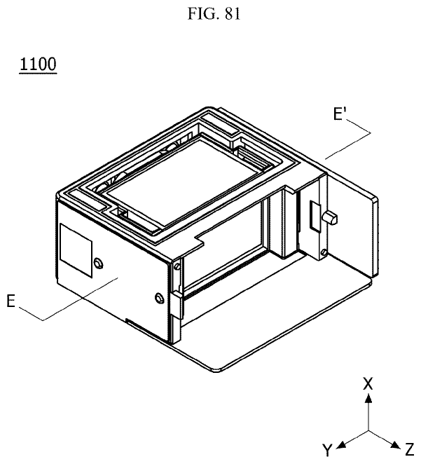

FIG. 80 is a diagram illustrating a first driving unit of a first camera actuator according to a second embodiment of the present invention

Referring to FIG. 80, a first driving unit 1150 comprises a driving magnet 1151, a driving coil 1152, a Hall sensor unit 1153, and a substrate unit 1154.

In addition, as described above, the driving magnet 1151 may comprise a first magnet 1151a, a second magnet 1151b, and a third magnet 1151c providing driving force by electromagnetic force. The first magnet 1151a, the second magnet 1151b, and the third magnet 1151c may be positioned on an outer side surface of the holder 1131, respectively.

In addition, the driving coil 1152 may comprise a plurality of coils. As an embodiment, the driving coil 1152 may comprise a first coil 1152a, a second coil 1152b, and a third coil 1152c.

The first coil 1152a may be positioned facing the first magnet 1151a. Accordingly, the first coil 1152a may be positioned in the first housing hole 1121a of the first housing side portion 1121 as described above. In addition, the second coil 1152b may be positioned facing the second magnet 1151b. Accordingly, the second coil 1152b may be positioned in the second housing hole 1122a of the second housing side portion 1122 as described above.

The first camera actuator according to an embodiment can provide the best optical properties by controlling the rotation of the mover 1130 in a first axis (X-axis direction) or a second axis (Y-axis direction) by the electromagnetic force between the driving magnet 1151 and the driving coil 1152, thereby minimizing the occurrence of a decent or tilt phenomenon when implementing OIS.

In addition, according to embodiment, by implementing OIS through the tilting of the guide unit 1141 of the rotating part 1140 being disposed between the first housing 1120 and the mover 1130, the size limitation of the actuator is resolved, so that an ultra-slim and subminiature camera actuator and a camera module comprising the same can be provided.

The substrate unit 1154 may comprise a first substrate side portion 1154a, a second substrate side portion 1154b, and a third substrate side portion 1154c.

The first substrate side portion 1154a and the second substrate side portion 1154b may be disposed to face each other. Also, the third substrate side portion 1154c may be positioned between the first substrate side portion 1154a and the second substrate side portion 1154b.

In addition, the first substrate side portion 1154a may be positioned between the first housing side portion and the shield can, and the second substrate side portion 1154b may be positioned between the second housing side portion and the shield can. In addition, the third substrate side portion 1154c may be positioned between the third housing side portion and the shield can, and may be a bottom surface of the substrate unit 1154.

The first substrate side portion 1154a may be coupled to and electrically connected to the first coil 1152a. In addition, the first substrate side portion 1154a may be coupled to and electrically connected to the first Hall sensor 1153a.

The second substrate side portion 1154b may be coupled to and electrically connected to the second coil 1152b. In addition, it should be understood that the second substrate side portion 1154b may be coupled to and electrically connected to the first Hall sensor.

The third substrate side portion 1154c may be coupled to and electrically connected to the third coil 1152c. In addition, the third substrate side portion 1154c may be coupled to and electrically connected to the second Hall sensor 1153b.

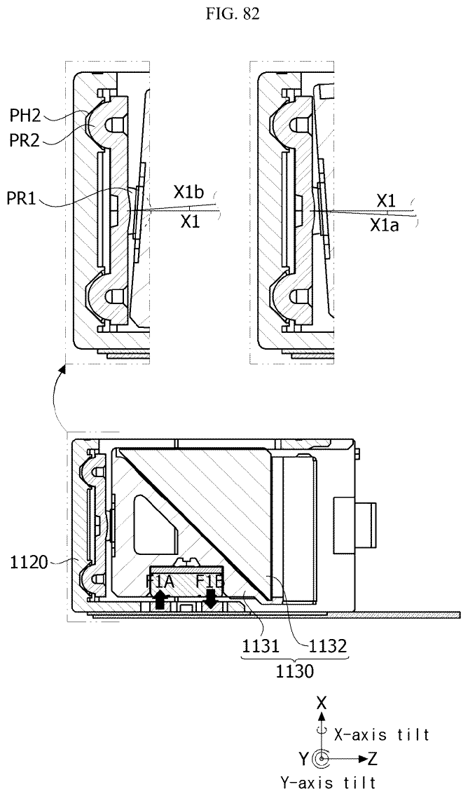

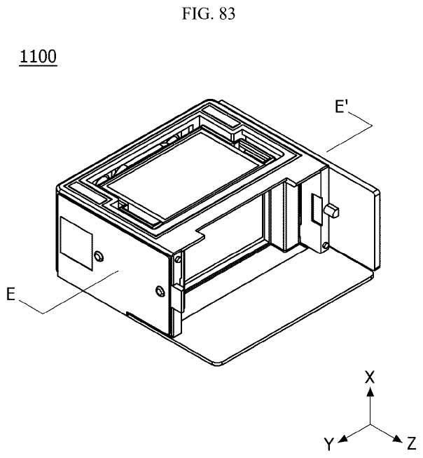

FIG. 81 is a perspective view of a first camera actuator according to a second embodiment of the present invention; and FIG. 82 is a view viewed from D-D′ in FIG. 81.

Referring to FIGS. 81 and 82, Y-axis tilt may be performed. That is, OIS can be implemented by rotating in a first direction (X-axis direction).

As an embodiment, the third magnet 1151c being disposed at a lower portion of the holder 1131 may tilt or rotate the mover 1130 in a first direction (X-axis direction) by forming electromagnetic force with the third coil 1152c.

Specifically, the tilting guide unit 1141, the first housing 1120, and the mover 1130 may be coupled to one another by the first yoke YK1 and the second yoke YK2. In addition, a plurality of first protruding portions PR1 may be spaced apart from each other in a second direction (Y-axis direction) to support the mover 1130. In addition, the tilting guide unit 1141 can be rotated in a first direction (X-axis direction) or tilted along the Y-axis using the first protruding portion PR1 being protruded toward the holder (in particular, the fourth holder outer side surface) as a reference axis (or rotation axis).

For example, OIS may be implemented as the mover 1130 is rotating in an X-axis direction (From X1 to X1a) at a first angle θ1 by the first electromagnetic forces F1A and F1B between the third magnet 1151c disposed in a third seating groove and the third coil unit 1152c disposed on a side portion of the third substrate.

Conversely, OIS may be implemented as the mover 1130 is rotating in an opposite direction to X-axis direction (From X1 to X1b) at a first angle θ1 by the first electromagnetic forces F1A and F1B between the third magnet 1151c disposed in the third seating groove and the third coil unit 1152c disposed on the side portion of the third substrate.

The first angle θ1 may be ±1° to ±3°. However, it is not limited thereto.

Hereinafter, in a first camera actuator according to various embodiments, the electromagnetic force may move the mover by generating force in the direction described, or may move the mover in the direction described even if force is generated in another direction. That is, the direction of the described electromagnetic force means the direction of the force generated by the magnet and the coil to move the mover. For example, the first electromagnetic forces F1A and F1B may act in a third direction or in a direction opposite to the third direction.

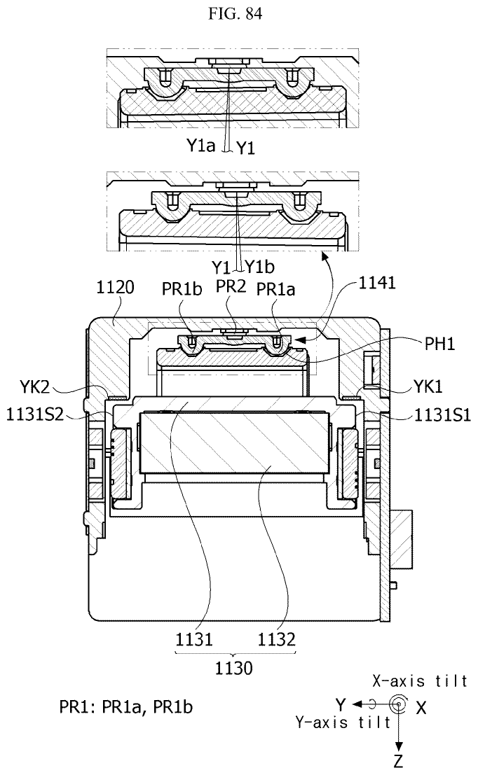

FIG. 83 is a perspective view of a first camera actuator according to a second embodiment of the present invention; and FIG. 84 is a view viewed from E-E′ in FIG. 83.

Referring to FIGS. 83 to 84, OIS implementation may be performed as the mover 1130 is tilting or rotating in a Y-axis direction.

As an embodiment, the first magnet 1151a and the second magnet 1151b being disposed on the holder 1131 form electromagnetic force with the first coil 1152a and the second coil 1152b, respectively, so that the tilting guide unit and the mover 1130 can be tilted or rotated in a second direction (Y-axis).

Components being tilted in a first direction or a second direction in a first camera actuator according to an embodiment may be different from each other.

Specifically, the housing and the mover 1130 may be coupled to each other by the second yoke YK2 inside the tilting guide unit 1141. And, as described above, the plurality of second protruding portions PR2 may be spaced apart in a first direction (X-axis direction) to support the tilting guide unit and the mover 1130. In addition, the second-first protruding portion and the second-second protruding portion may be supported by the first housing 1120 by being in contact with the first housing 1120.

In addition, the tilting guide unit 1141 may rotate or tilt the second protruding portion PR2 being protruded toward the housing 1120 in a first direction (X-axis direction) as a reference axis (or rotation axis).

For example, OIS may be implemented as the mover 1130 is rotating in a Y-axis direction (From Y1 to Yla) at a second angle θ2 by the second electromagnetic forces F2A and F2B between the first and second magnets 1151a and 1151b disposed in the first seating groove and the first and second coil units 1152a and 1152b disposed on the side portions of the first and second substrates. In addition, OIS may be implemented as the mover 1130 is rotating in a Y-axis direction (From Y1 to Y1b) at a second angle θ2 by the second electromagnetic forces F2A and F2B Between the first and second magnets 1151a and 1151b disposed in the first seating groove and the first and second coil units 1152a and 1152b disposed on the side portions of the first and second substrates. The second angle θ2 may be between ±1° and 3°. However, it is not limited thereto.

In addition, as described above, the electromagnetic force by the first and second magnets 1151a and 1151b and the first and second coils 1152a and 1152b may act in a third direction or in a direction opposite to the third direction. For example, electromagnetic force is generated in a third direction (Z-axis direction) in the left side portion of the mover 1130, and may act in an opposite direction to a third direction (Z-axis direction) in the right side portion of the mover 1130. Accordingly, the mover 1130 may rotate with respect to a first direction. Or, it may move along a second direction.

As such, a second actuator according to an embodiment moves the mover 1130 in a first direction (X-axis direction) or a second direction (Y-axis direction) by the electromagnetic force between the driving magnet in the holder and the driving coil being disposed in the first housing. By controlling the rotation, it is possible to minimize the occurrence of a decent or tilt phenomenon when implementing OIS and to provide the best optical characteristics. In addition, as described above, ‘Y-axis tilt’ means rotating or tilting in a first direction (X-axis direction), and ‘X-axis tilt’ means rotating or tilting in a second direction (Y-axis direction).

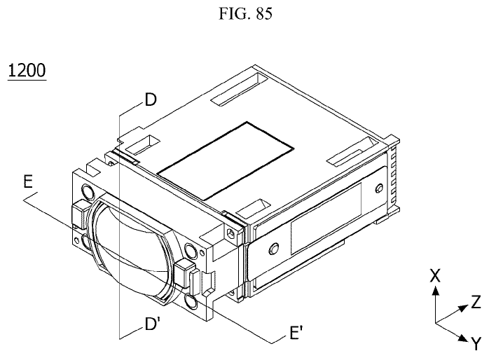

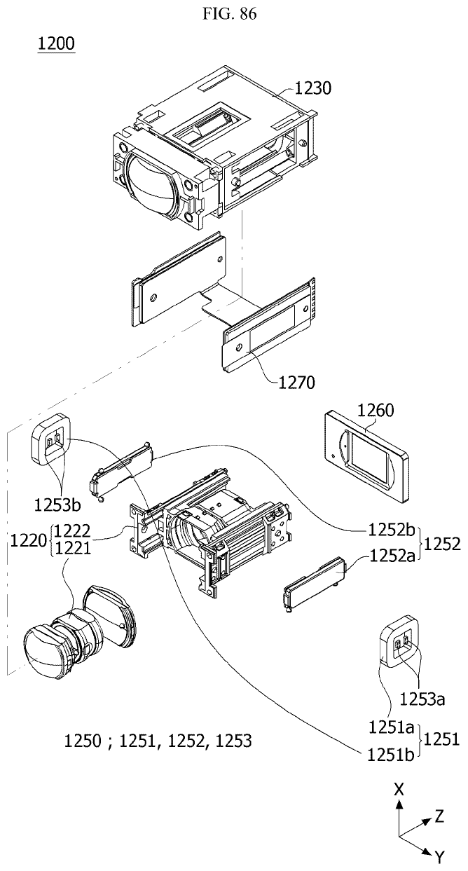

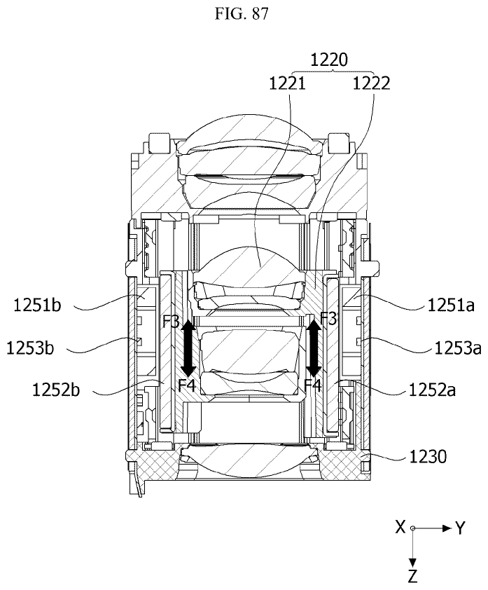

FIG. 85 is a perspective view of a second camera actuator according to a second embodiment of the present invention; FIG. 86 is an exploded perspective view of a second camera actuator according to a second embodiment of the present invention; and FIG. 87 is a cross-sectional view viewed from E-E′ in FIG. 85.

Referring to FIGS. 85 to 87, a second camera actuator 1200 according to an embodiment may comprise a lens unit 1220, a second housing 1230, a second driving unit 1250, a base unit (not shown) and a second substrate unit 1270. Furthermore, the second camera actuator 1200 may further comprise a second shield can (not shown), an elastic part (not shown), and a bonding member (not shown). Furthermore, the second camera actuator 1200 according to the embodiment may further comprise an image sensor IS.

The second shield can (not shown) positioned in one region (For example, outermost) of the second camera actuator 1200, may be positioned to surround components, which will be described later, a lens unit 1220, a second housing 1230, an elastic part (not shown), a second driving unit 1250, a base unit (not shown), a second substrate unit 1270, and an image sensor IS. Such a second shield can (not shown) may block or reduce electromagnetic waves generated from the outside. Accordingly, the occurrence of malfunctions in the second driving unit 1250 may be reduced.

The lens unit 1220 may be positioned in a second shield can (not shown). The lens unit 1220 may move in a third direction (Z-axis direction). Accordingly, the above-described AF function may be performed.

Specifically, the lens unit 1220 may comprise a lens assembly 1221 and a bobbin 1222.

The lens assembly 1221 may comprise one or more lenses. In addition, the number of lens assemblies 1221 may be plural, but will be described below with respect to one.

The lens assembly 1221 is coupled to the bobbin 1222 and may move in a third direction (Z-axis direction) by electromagnetic force generated from the fourth magnet 1252a and the second magnet 1252b coupled to the bobbin 1222.

The bobbin 1222 may comprise an opening region surrounding the lens assembly 1221. Also, the bobbin 1222 may be coupled to the lens assembly 1221 by various methods. In addition, the bobbin 1222 may comprise a groove on a side surface, and may be coupled to the fourth magnet 1252a and the second magnet 1252b through the groove. A bonding member or the like may be applied to the groove.

In addition, the bobbin 1222 may be coupled with an elastic part (not shown) at an upper end and a rear end. Thus, the bobbin 1222 may be supported by an elastic part (not shown) while moving in a third direction (Z-axis direction). That is, while the position of the bobbin 1222 is maintained, it may be maintained in a third direction (Z-axis direction). The elastic part (not shown) may be made of a leaf spring.

The second housing 1230 may be disposed between the lens unit 1220 and a second shield can (not shown). Also, the second housing 1230 may be disposed to surround the lens unit 1220. A hole may be formed in a side portion of the second housing 1230. A fourth coil 1251a and a fifth coil 1251b may be disposed in the hole. The hole may be positioned to correspond to the groove of the bobbin 1222 described above.

The fourth magnet 1252a may be positioned to face the fourth coil 1251a. In addition, the second magnet 1252b may be positioned to face the fifth coil 1251b.

The elastic part (not shown) may comprise a first elastic member (not shown) and a second elastic member (not shown). A first elastic member (not shown) may be coupled to an upper surface of the bobbin 1222. The second elastic member (not shown) may be coupled to a lower surface of the bobbin 1222. In addition, the first elastic member (not shown) and the second elastic member (not shown) may be formed as leaf springs as described above. In addition, the first elastic member (not shown) and the second elastic member (not shown) may provide elasticity for the movement of the bobbin 1222.

The second driving unit 1250 may provide driving forces F3 and F4 for moving the lens unit 1220 in a third direction (Z-axis direction). Such a second driving unit 1250 may comprise a driving coil 1251 and a driving magnet 1252.

The lens unit 1220 may move in a third direction (Z-axis direction) by the electromagnetic force formed between the driving coil 1251 and the driving magnet 1252.

The driving coil 1251 may comprise a fourth coil 1251a and a fifth coil 1251b. The fourth coil 1251a and the fifth coil 1251b may be disposed inside a hole formed in a side portion of the second housing 1230. Also, the fourth coil 1251a and the fifth coil 1251b may be electrically connected to the second substrate unit 1270. Accordingly, the fourth coil 1251a and the fifth coil 1251b may receive current or the like through the second substrate unit 1270.

The driving magnet 1252 may comprise a fourth magnet 1252a and a fifth magnet 1252b. The fourth magnet 1252a and the fifth magnet 1252b may be disposed in the aforementioned groove of the bobbin 1222 and may be positioned to correspond to the fourth coil 1251a and the fifth coil 1251b.

A base unit (not shown) may be positioned between the lens unit 1220 and the image sensor IS. Components such as a filter may be fixed to the base unit (not shown). In addition, a base unit (not shown) may be disposed to surround the image sensor IS. With this configuration, since the image sensor IS is free from foreign substances, the reliability of the device can be improved.

In addition, the second camera actuator may be a zoom actuator or an auto focus (AF) actuator. For example, the second camera actuator may support one or a plurality of lenses and perform an autofocusing function or a zooming function by moving the lens according to a predetermined control signal from a control unit.

And the second camera actuator may be a fixed zoom or continuous zoom. For example, the second camera actuator may provide the movement of the lens assembly 1221.

Furthermore, the second camera actuator may comprise a plurality of lens assemblies. For example, in the second camera actuator, at least one or more among a first lens assembly (not shown), a second lens assembly (not shown), a third lens assembly (not shown), and a guide pin (not shown) may be disposed. In this regard, the above description may be applied. Accordingly, the second camera actuator may perform a high-magnification zooming function through the driving unit. For example, the first lens assembly (not shown) and the second lens assembly (not shown) may be moving lenses that move through a driving unit and a guide pin (not shown), and the third lens assembly (not shown) may be a fixed lens, but is not limited thereto. For example, the third lens assembly (not shown) may perform the function of a focator that forms light at a specific location, and the first lens assembly (not shown) may perform a variator function of re-forming an image formed in a third lens assembly (not shown), which is a focator, to another location. Meanwhile, in the first lens assembly (not shown), the distance to the subject or the image distance may be greatly changed, so that the magnification change may be large, and a first lens assembly (not shown) serving as a variator may play an important role in changing the focal length or magnification of an optical system. Meanwhile, a point formed by a first lens assembly (not shown), which is a variator, may be slightly different depending on a location. Accordingly, the second lens assembly (not shown) may perform a position compensation function for an image formed by the variator. For example, the second lens assembly (not shown) can perform compensator function that serves for accurately imaging the image points imaged in the first lens assembly (not shown), which is a variator, at the actual image sensor position.

The image sensor IS may be positioned inside or outside the second camera actuator. As an embodiment, as illustrated, the image sensor IS may be positioned inside the second camera actuator. The image sensor IS may receive light and convert the received light into an electrical signal. In addition, the image sensor IS may comprise a plurality of pixels in an array form. Also, the image sensor IS may be positioned on an optical axis.

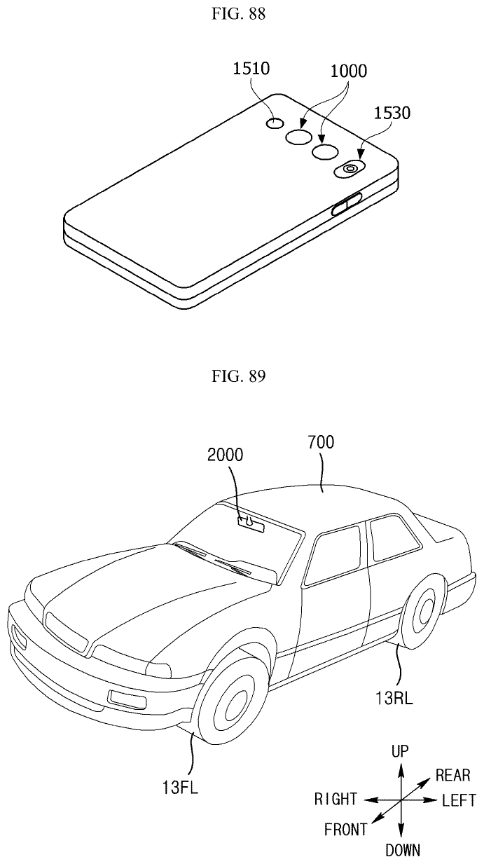

FIG. 88 is a perspective view of a mobile terminal to which a camera module according to a second embodiment of the present invention is applied.

As illustrated in FIG. 88, the mobile terminal 1500 of an embodiment may comprise a camera module 1000, a flash module 1530, and an autofocus device 1510 provided on the rear surface.

The camera module 1000 may comprise an image photographing function and an auto focus function. For example, the camera module 1000 may comprise an auto focus function utilizing images.

The camera module 1000 processes an image frame of a still image or a moving image obtained by an image sensor in a photographing mode or a video call mode.

The processed image frame may be displayed on a prepared display unit and may be stored in a memory. A camera (not shown) may also be disposed on the front surface of the mobile terminal body.

For example, the camera module 1000 may comprise a first camera module 1000 and a second camera module 1000, and the first camera module 1000A may implement OIS along with an AF or zoom function.

The flash module 1530 may comprise a light emitting element emitting light therein. The flash module 1530 may be operated by camera operation of the mobile terminal or user's control. The autofocus device 1510 may comprise one of the packages of a surface light emitting laser device as a light emitting unit.

The autofocus device 1510 may comprise an autofocus function using a laser. The auto-focus device 1510 may be mainly used in a condition in which an auto-focus function using an image of the camera module 1000 is degraded, for example, in proximity of 10 m or less or a dark environment.

The autofocus device 1510 may comprise: a light emitting unit comprising a vertical cavity surface emitting laser (VCSEL) semiconductor device; and a light receiving unit such as a photodiode that converts light energy into electrical energy.

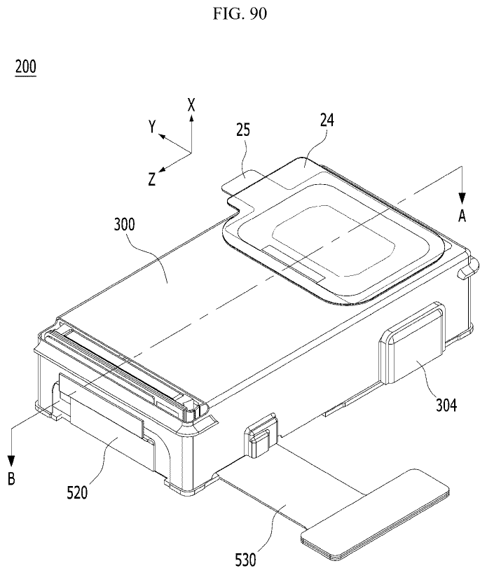

FIG. 89 is a perspective view of a vehicle to which a camera module according to a second embodiment of the present invention is applied.

For example, FIG. 89 is an external view of a vehicle equipped with a vehicle driving assistance device to which the camera module 1000 according to an embodiment is applied.

Referring to FIG. 89, a vehicle 700 of an embodiment may comprise wheels 13FL and 13FR rotating by a power source and a prepared sensor. The sensor may be the camera sensor 2000, but is not limited thereto.

The camera 2000 may be a camera sensor to which the camera module 1000 according to an embodiment is applied. The vehicle 700 of an embodiment may acquire image information through the camera sensor 2000 that photographs a front side image or a peripheral image, determines a lane unidentified situation using the image information, and may create a virtual lane when the lane is not identified.

For example, the camera sensor 2000 may obtain a front side image by photographing the front side of the vehicle 700, and a processor (not shown) may obtain image information by analyzing an object comprised in the front side image.

For example, when objects such as lanes, adjacent vehicles, driving obstacles, and indirect road markings such as median strips, curbs, and roadside trees are photographed in an image photographed by the camera sensor 2000, the processor detects these objects and may comprise them in the image information. At this time, the processor may acquire distance information to the object detected through the camera sensor 2000 to further supplement the image information.

The image information may be information about an object photographed in an image. The camera sensor 2000 may comprise an image sensor and an image processing module.

The camera sensor 2000 may process a still image or moving image being obtained by an image sensor (For example, CMOS or CCD).

The image processing module may process a still image or moving image acquired through an image sensor, extract necessary information, and transmit the extracted information to a processor.

At this time, the camera sensor 2000 may comprise a stereo camera to enhance object measurement accuracy and further secure information such as a distance between the vehicle 700 and the object, but is not limited thereto.

Hereinafter, with reference to the accompanying drawings, a camera device according to an embodiment and an optical apparatus comprising the same will be described as follows. For convenience of description, the camera device according to the embodiment is described using a Cartesian coordinate system (x, y, z), but it may be described using another coordinate system, and the embodiment is not limited thereto. In each diagram, an X-axis and a Y-axis may mean directions perpendicular to a Z-axis, which is the direction of an optical axis OA. In addition, the Z-axis direction, which is the optical axis OA direction, may be referred to as a ‘first direction’, the X-axis direction may be referred to as a ‘second direction’, and the Y-axis direction may be referred to as a ‘third direction’. In addition, the Y-axis may be referred to as a “first axis”, the Y-axis direction may be referred to as a “first axis direction”; the X-axis may be referred to as a “second axis”, and the X-axis direction may be referred to as a “second axis direction”. For example, the optical axis direction may be the direction of the optical axis or a direction parallel to the optical axis.

In addition, the expression “terminal” hereinafter may be expressed by replacing it with a pad, an electrode, or a conductive layer.

In addition, hereinafter, “code value” may be expressed by replacing it with data or a digital value.

In addition, in an embodiment, in the coupling between the protrusion and the hole for coupling the two components with each other, either component may be a coupling protrusion (or coupling hole), and the remaining other side may be a coupling hole (or coupling protrusion) corresponding thereto.

A camera device according to an embodiment may perform a handshake correction function, an auto focusing function, and a zoom function. The ‘handshake correction function’ may be a function of moving the lens in a direction perpendicular to the optical axis direction or tilting the lens with respect to the optical axis to offset vibration (or movement) caused by the user's handshake. In addition, the ‘auto focusing function’ may be a function of automatically focusing on a subject by moving a lens in an optical axis direction according to a distance of the subject in order to obtain a clear image of the subject in the image sensor. The ‘zoom function’ may be a zooming function for taking pictures by increasing or decreasing the magnification of a distant subject through a zoom lens.

Hereinafter, “camera device” may be expressed by replacing it with a “camera”, “camera module”, “imaging device” or “photographing device”.

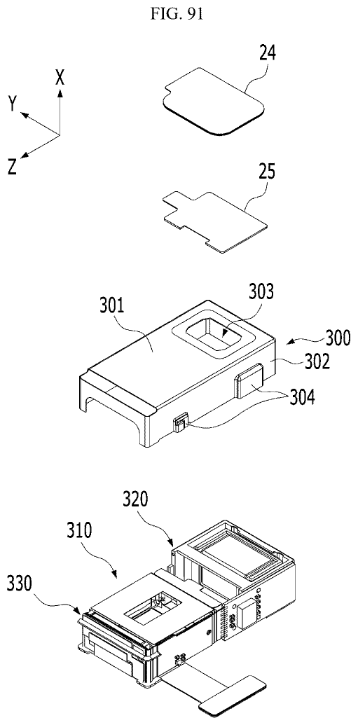

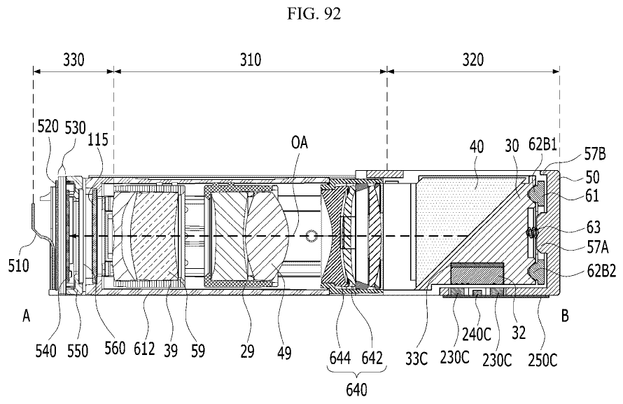

FIG. 90 is a perspective view of a camera device 200 according to a third embodiment of the present invention; FIG. 91 is an exploded perspective view of a camera device 200 of FIG. 90; and FIG. 92 is a cross-sectional view of a camera device in the direction A-B of FIG. 90.

Referring to FIGS. 90 to 92, the camera device 200 may comprise a first actuator 310, a second actuator 320, and an image sensing unit 330.

The second actuator 320 may move the optical member 40, thereby performing an optical image stabilizer (OIS) operation for performing handshake correction, and may be expressed by replacing it with a “second driving unit” or “OIS driving unit”.

The second actuator 320 may change the path of light. For example, the second actuator 320 may comprise an optical member 40 that changes a path of light. The second actuator 320 may be expressed by replacing it with an optical path changing unit.

The first actuator 310 may move the lens assemblies 312 and 313 in a direction of an optical axis, thereby performing an auto focusing and/or zooming function, and may be expressed by replacing it with a “first driving unit” or “AF and zoom driving unit”. The first actuator 310 may be referred to as a “second actuator”, and the second actuator 320 may be referred to as a “first actuator”.

For example, the first actuator 310 may be disposed at a rear end of the second actuator 320 and may be coupled with the second actuator 320. For example, the first actuator 310 may be disposed between the second actuator 320 and the image sensing unit 330.

The image sensing unit 330 receives and detects light passing through the optical member 40 of the second actuator 320 and the lens assemblies 311, 312, and 313 of the first actuator 310 and detects the light to convert it into an electrical signal.

The camera device 200 may further comprise a cover member 300. The cover member 300 may have a box shape comprising an upper plate 301 and a side plate 302 and may have an open lower portion. The cover member 300 may accommodate the first actuator 310, the second actuator 320, and the image sensing unit 330. An opening 303 or a hole exposing the incident surface of the optical member 40 may be formed in the upper plate 301 of the cover member 300.

In addition, the camera device 200 may further comprise a bracket (not shown) for accommodating the first actuator 310, the second actuator 320, and the image sensing unit 330. The bracket may have holes or penetrating holes for accommodating the first actuator 310, the second actuator 320, and the image sensing unit 330. At least one opening may be formed in a side portion or side surface of the bracket.

At least one protrusion 304 being coupled to at least one opening of the bracket may be formed on the side plate 302 of the cover member 300. At least one protrusion 304 may be protruded from the side plate 302 in a direction perpendicular to the optical axis (For example, Y-axis direction).

The cover member 300 may be formed of a metal plate material, but is not limited thereto, and may be formed of a plastic or resin material. In addition, the cover member 300 may be made of a material that blocks electromagnetic waves.

The camera device 200 may further comprise a protective film 24 being disposed on the upper plate 301 of the cover member 300 and covering the opening 303 of the cover member 300. The protective film 24 may be formed of a light-transmitting material, may inhibit foreign substances from entering the camera device 200, and may protect the optical member 40 from impact or the like. In addition, the camera device 200 may further comprise a protective tape 25 being disposed between the protective film 24 and the upper plate 301 and attaching the protective film 24 to the upper plate 301. For example, the protective tape 25 may be formed of a light-transmitting material.

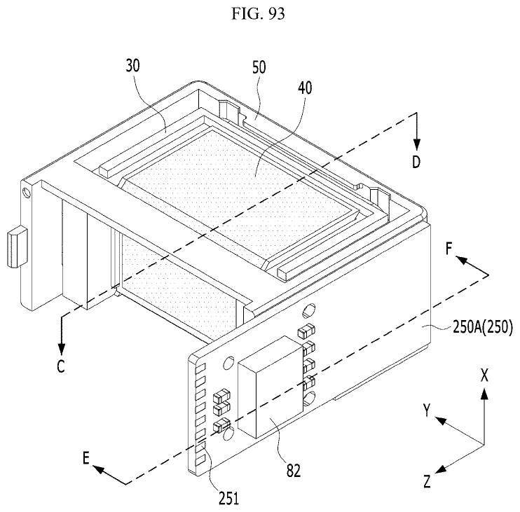

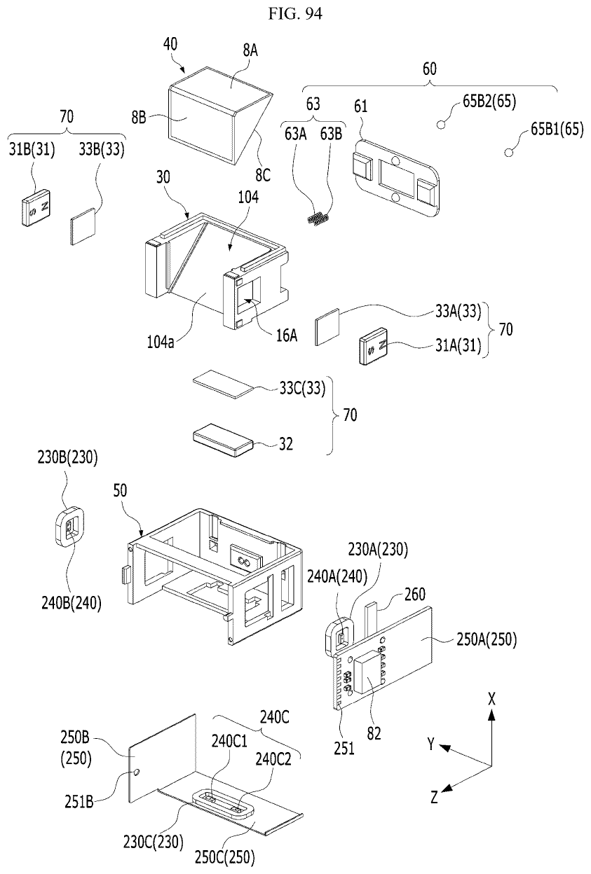

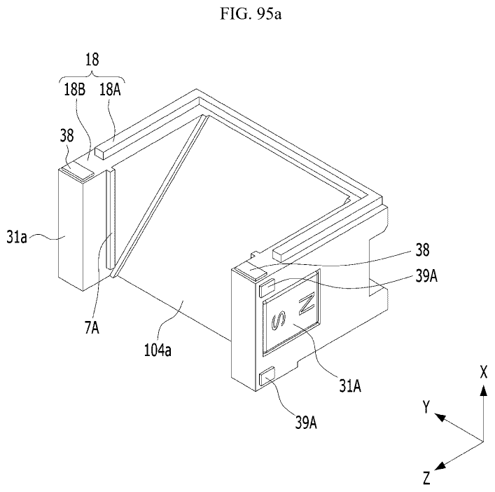

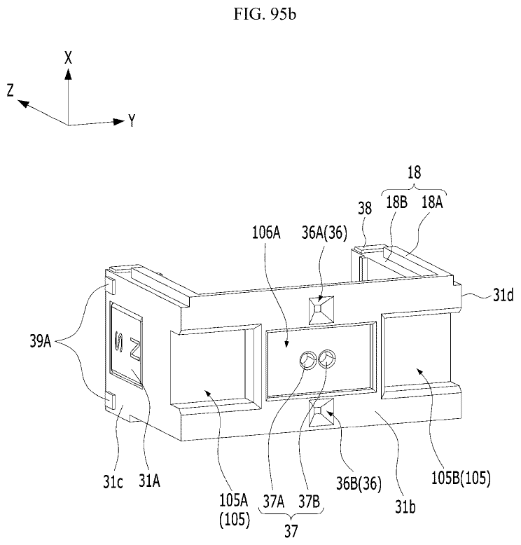

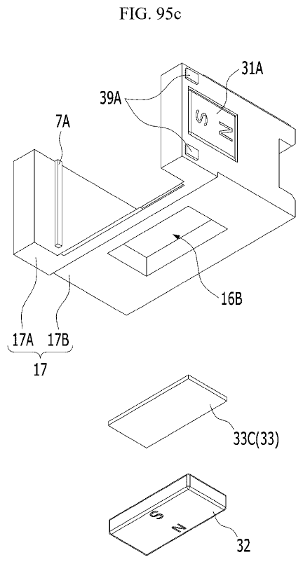

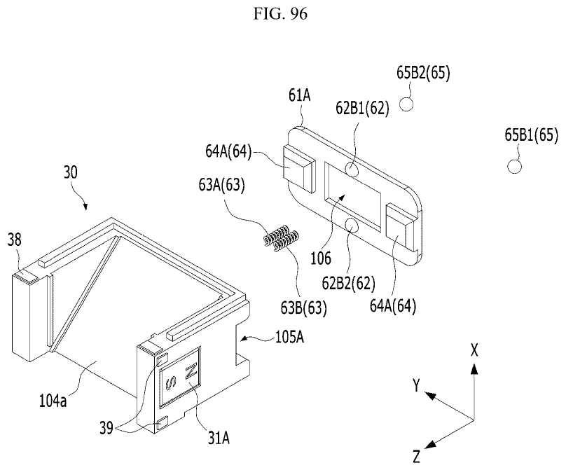

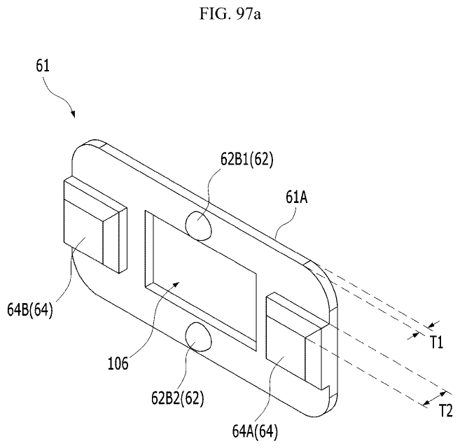

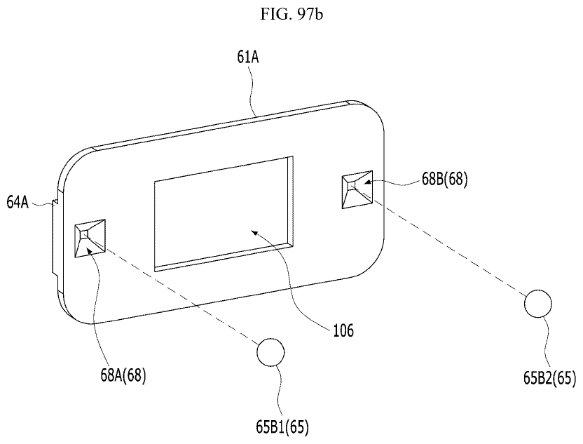

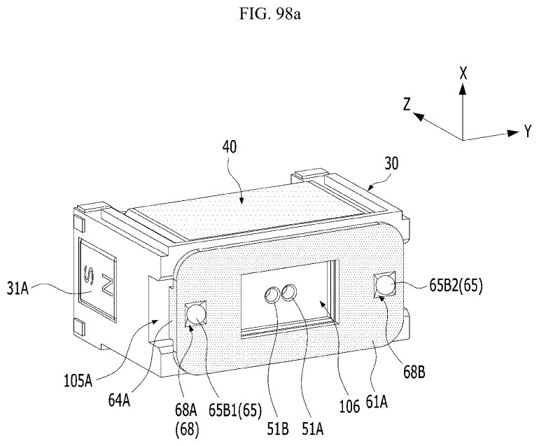

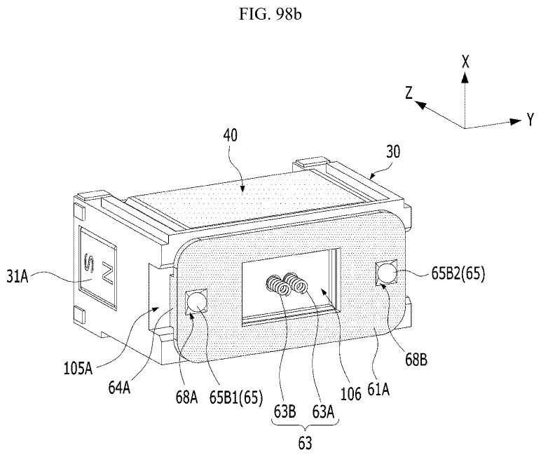

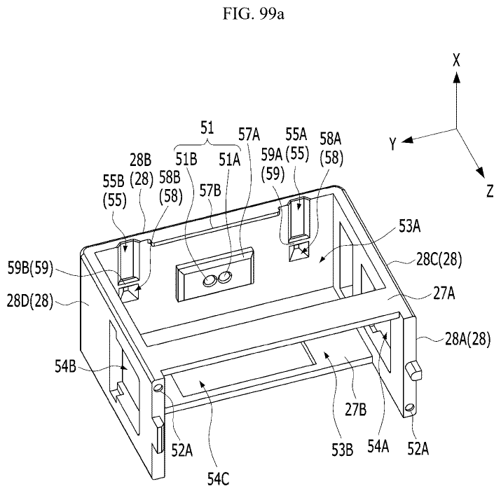

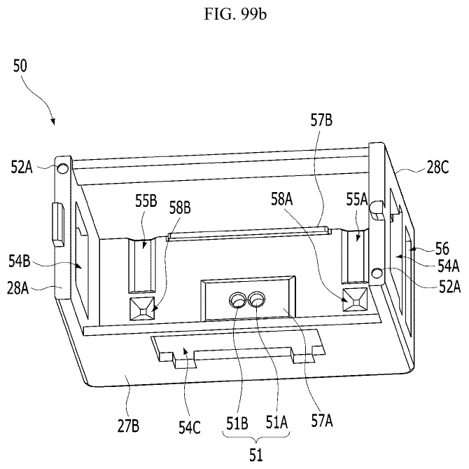

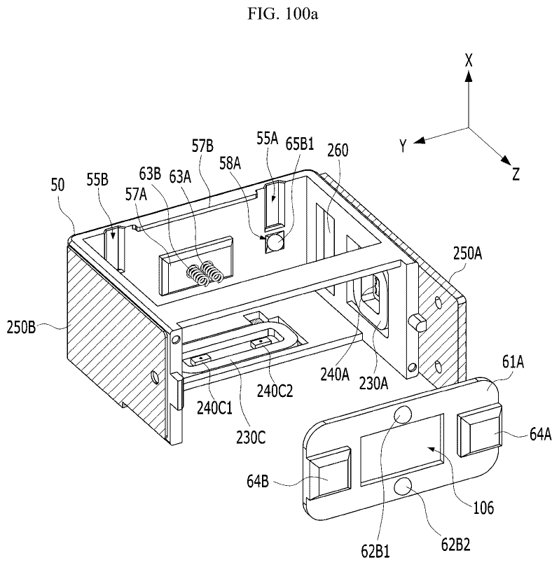

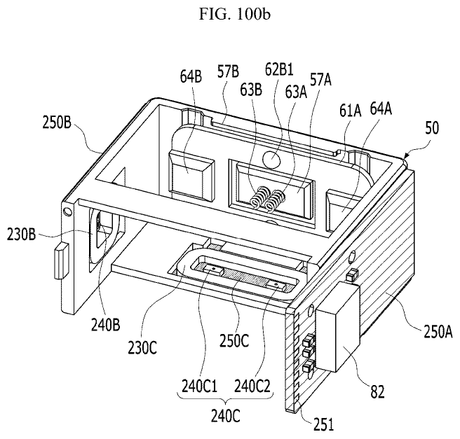

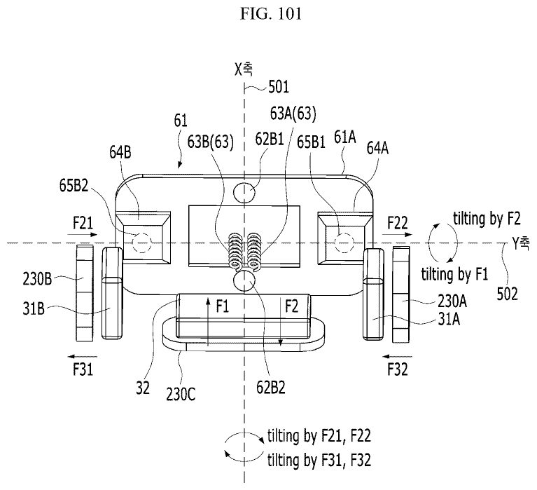

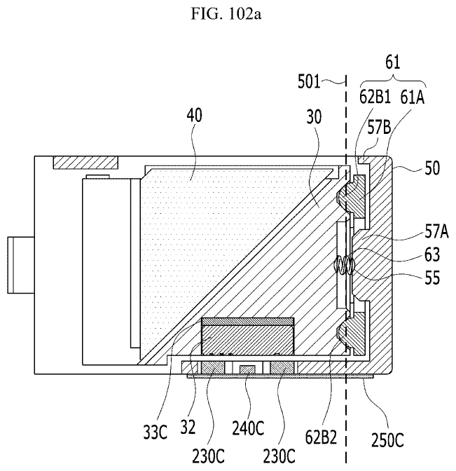

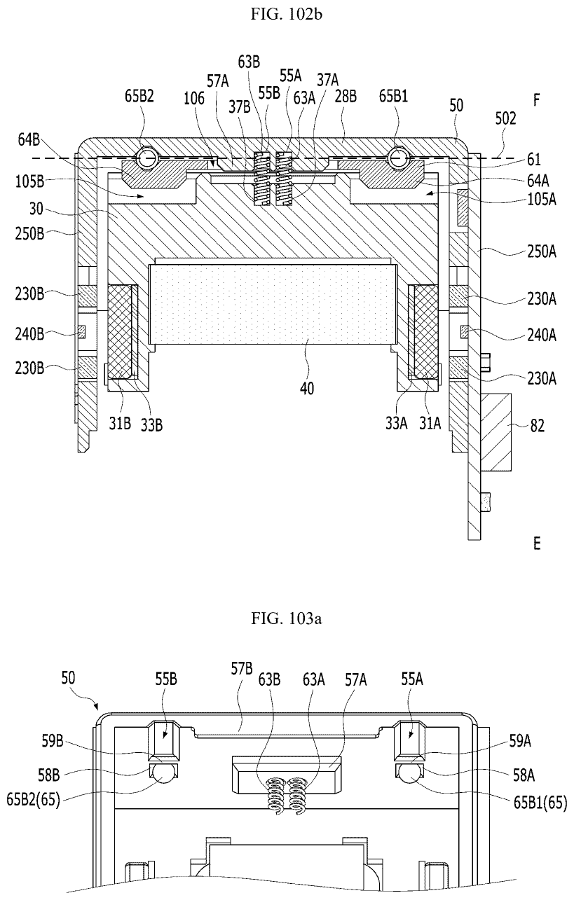

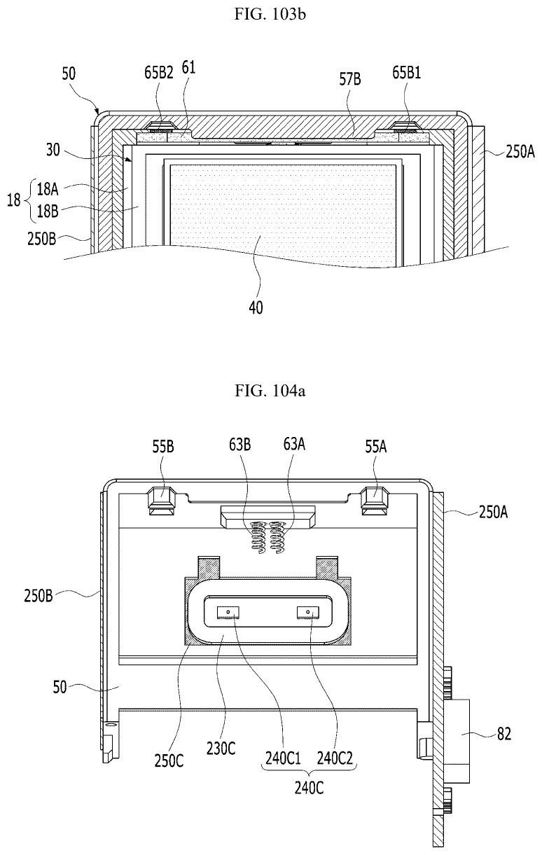

FIG. 93 is a perspective view of the second actuator 320 illustrated in FIG. 90; FIG. 94 is an exploded perspective view of a second actuator 320; FIG. 95a is a front perspective view of a holder 30 of FIG. 94; FIG. 95b is a rear perspective view of a holder 30; FIG. 95c is a bottom perspective view of a holder 30; FIG. 96 is an exploded perspective view of a holder 30, driving plate 61, and elastic member 63; FIG. 97a is a first perspective view of the driving plate 61; FIG. 97b is a second perspective view of a driving plate 61; FIG. 98a is a perspective view of a holder 30, an optical member 40, a driving plate 61, and a rolling member 65; FIG. 98 b is a perspective view of an elastic member 63 coupled to the holder 30 of FIG. 98a; FIG. 99a is a first perspective view of a housing 50; FIG. 99b is a second perspective view of a housing 50; FIG. 100a is a perspective view of a housing 50, a circuit board 250, a coil 230, a position sensor 240, an elastic member 63, a driving plate 61, and a rolling member 65; FIG. 100 b is a perspective view of the driving plate 61 of FIG. 100a coupled to a housing 50; FIG. 101 is a diagram for explaining the movement of the driving plate 61 and the electromagnetic force according to the interaction between the magnets 31A, 31B, and 32 and the first to third coil units 230A to 230C; FIG. 102a is a cross-sectional view of a second actuator 320 in the C-D direction of FIG. 93; FIG. 102b is a cross-sectional view of a second actuator 320 in the E-F direction of FIG. 93; FIG. 103a is an enlarged view of a part of a housing 50, a rolling member 65, and an elastic member; and FIG. 103b is a partially enlarged view of a second actuator 320.

Referring to FIGS. 93 to 103b, the second actuator 320 may comprise an optical member 40 and a second driving unit 70. The optical member 40 may change the path of light so that the light passing through the opening 303 of the cover member 300 is incident to the first actuator 310. The second driving unit 70 may rotate the optical member 40 by a preset angle in a direction perpendicular (For example, the X-axis direction or the Y-axis direction) to the optical axis direction (For example, a Z-axis direction).

The optical member 40 may comprise a reflector capable of changing a traveling direction of light. For example, the optical member 40 may be a prism that reflects light, but is not limited thereto and may be a mirror in another embodiment.

The optical member 40 may be disposed in the holder 30. The optical member 40 may change the light path of the incident light to an optical axis parallel to the central axis (for example, Z-axis) of the lens unit to change the incident light into parallel light; and the parallel light may pass through the first lens assembly 640, the second lens assembly 622, and the third lens assembly 624 to reach the image sensor 540.

Referring to FIG. 94, for example, the optical member 40 may comprise an incident surface 8A and an exit surface 8B, and reflects light incident on the incident surface 8A to exit through the exit surface 8B. For example, the optical member 40 may be a right angle prism comprising an incident surface 8A, a reflective surface 8C, and an exit surface 8B. For example, the interior angle between the incident surface 8A and the exit surface 8B may be a right angle.

In addition, for example, each of the first interior angle between the incident surface 8A and the reflective surface 8C and the second interior angle between the exit surface 8B and the reflective surface 8C may be 30 degrees to 60 degrees. For example, each of the first interior angle and the second interior angle may be 45 degrees, but is not limited thereto. In addition, due to the optical path change by the optical member 40, the thickness of the camera device 200 in a direction perpendicular to the incident surface 8A of the optical member 40 can be reduced, and as a result, the thickness of the mobile device or terminal 200A on which the camera device 200 is mounted may be reduced.

For example, the second actuator 320 comprises a housing 50, a holder 30 being disposed inside the housing 50, an optical member 40 being disposed inside the holder 30, and a support part 60 being disposed between the holder 30 and the housing 50.

Referring to FIGS. 94 and 95a to 95c, the holder 30 may comprise a seating portion 104 on which the optical member 40 is disposed or mounted. The seating portion 104 may have a groove shape and may comprise a mounting surface 104a (or a seating surface) for disposing the reflective surface 8C of the optical member 40. For example, the mounting surface 104a may be an inclined surface inclined with respect to an optical axis direction.

For example, an adhesive for attaching the optical member 40 may be disposed on the mounting surface 104a of the holder 30, and, for example, at least one groove (not shown) may be formed on the mounting surface 104a for accommodating an adhesive.

For example, the holder 30 may comprise: a first opening exposing the incident surface 8A of the optical member 40; and a second opening exposing the exit surface 8B of the optical member 40. For example, the first opening may be disposed on an upper side of the holder 30, and the second opening may be disposed on one side surface (front outer side surface 31a) of the holder 30 facing the lens assembly (For example, 311) of the first actuator 310. The exit surface 8B of the optical member 40 mounted on the holder 30 may be disposed to face the lens assembly 311 of the first actuator 310.

Referring to FIG. 95a, the upper surface 18 of the holder 30 may comprise: a first surface 18A; and a second surface 18B having a step in a second direction (For example, X-axis direction) with the first surface 18A. The first surface 18A may be adjacent to or positioned adjacent to the rear outer side surface 31b of the holder 30, and the second surface 18B may be adjacent to or positioned adjacent to the front outer side surface 31a of the holder 30. The second surface 18B may be positioned lower than the first surface 18A. For example, the second surface 18B may be positioned closer to the lower surface 19 of the holder 30 than the first surface 18A.

Since the second surface 18B has a step difference with the first surface 18A, when the holder 30 tilts in a second direction (for example, the X-axis direction) or rotates by a predetermined angle, the spatial interference between the holder 30 and the housing 50 can be inhibited.

For example, at least one stopper 38 may be formed on an upper surface (For example, the second surface 18B) of the holder 30. The stopper 38 may be a protrusion or protruding portion being protruded upward from an upper surface (For example, a second surface 18B) of the holder 30. For example, a stopper 38 may be formed on an upper surface of each of the first and second side portions of the holder 30. Tilt or rotation of the holder 30 in a second direction may be limited by the stopper 38. For example, the height of the upper surface of the stopper 38 may be lower than or equal to the height of the first surface 18A.

The holder 30 may comprise side portions (or outer side surfaces) 31c and 31d facing each other or positioned opposite to each other. For example, the seating portion 104 may be positioned between the two side portions 31c and 31d of the holder 30. For example, the two side portions 31c and 31d may be positioned opposite or facing each other in a third direction (For example, a Y-axis direction).

For example, the front outer side surface 31a of the holder 30 is referred to as an outer side surface of the first side portion of the holder 30, the rear outer side surface 31b of the holder 30 is referred to as an outer side surface of the second side portion of the holder 30, the side portion 31c of the holder 30 is referred to as a third side portion of the holder 30, and the side portion 31d of the holder 30 is referred to as a fourth side portion 31d of the holder 30.

For example, at least one stopper 39A may be formed on the third and fourth side portions 31c and 31d of the holder 30. The stopper 39A may be a protrusion or protruding portion being protruded from an outer surface of each of the third and fourth side portions 31c and 31d of the holder 30. Tilt or rotation of the holder 30 in a third direction may be limited by the stopper 39A.

The holder 30 may comprise at least one protruding portion 7A being formed on an inner side surface of at least one of the side portions 31 c and 3d. The protruding portion 7A may inhibit the optical member 30 from separating out of the second opening of the holder 30. For example, at least a portion of the exit surface 8B of the optical member 30 may be supported or contacted by the protruding portion 7A of the holder 30.

Referring to FIG. 95c, the lower surface 17 of the holder 30 may comprise: a first surface 17A, and a second surface 17B having a step with the first surface 17A in a second direction (For example, an X-axis direction). The first surface 17A may be adjacent to or adjacent to the front outer side surface 31a of the holder 30, and the second surface 17B may be positioned adjacent to or in contact with the rear outer side surface 31b of the holder 30. The first surface 17A may be positioned lower than the second surface 17B. For example, the second surface 17B may be positioned closer to the upper surface 18 of the holder 30 than the first surface 17A.

Since the second surface 17B of the lower surface 17 of the holder 30 has a step difference with the first surface 17A, When the holder 30 tilts or rotates by a preset angle in a second direction (For example, an X-axis direction), the spatial interference between the holder 30 and the second OIS coil 230C may be inhibited.

The holder 30 may comprise: a first seating groove 16A (see FIG. 94) for disposing or seating the first OIS magnet 31; and a second seating groove 16B (see FIG. 95 c) for disposing or seating the second OIS magnet 32.

For example, the first seating groove 16A may be formed on an outer side surface of each of the third and fourth side portions 31c and 31d of the holder 30. For example, the first seating groove 16A may have a shape of a groove recessed from an outer side surface of each of the third and fourth side portions 31c and 31d of the holder 30.

For example, the second seating groove 16B may be formed on the lower surface 17 (For example, the second surface 17B) of the holder 30. For example, the second seating groove 16B may be in the form of a groove recessed from the lower surface 17 (For example, the second surface 17B) of the holder 30.

Referring to FIG. 95b, the holder 30 may comprise groove 106A being formed on the outer side surface 31b (or rear outer side surface) of the holder 30 so as to correspond to, face, or overlap with the protruding portion 57A of the housing 50. The groove 106A may be disposed at the center of the outer side surface 31b of the holder 30 and may be a shape being recessed from the outer side surface 31b. For example, at least a portion of the protruding portion 57A of the housing 50 may be disposed inside the groove 106A of the holder 30.

In addition, the holder 30 may comprise a groove 105 being formed on the outer side surface 31b (or rear outer side surface) of the holder 30 to correspond to, face, or overlap with the protruding portion 64 of the driving plate 61. For example, the groove 105 may be recessed from the outer side surface 31b of the holder 30.

For example, the holder 30 may comprise: a first groove 105A facing or overlapping with the first protruding portion 64A of the driving plate 61; and a second groove 105B facing or overlapping with the second protruding portion 64B of the driving plate 61. For example, at least a portion of the first protruding portion 64A of the driving plate 61 may be disposed inside the first groove 105A of the holder 30, and at least a portion of the second protruding portion 64B of the driving plate 61 may be disposed inside the second groove 105B of the holder 30. For example, the groove 106A of the holder 30 may be positioned between the first groove 105A and the second groove 105B of the holder 30.

Referring to FIG. 95b, the holder 30 may comprise a groove 36 that corresponds to, faces, or overlaps with a protrusion (or “front protrusion” 62) of the driving plate 61. The groove 36 may be formed on the outer side surface 31b of the holder 30 and may be a shape recessed from the outer side surface 31b of the holder 30. For example, the number of grooves 36 may be the same as the number of protrusions 62 of the driving plate 61, and may be one or more.

For example, the holder 30 may comprise: a first groove 36A corresponding to the first protrusion 62B1 of the driving plate 61; and a second groove 36B corresponding to the second protrusion 62B2 of the driving plate 61.

For example, the two grooves 36A and 36B of the holder 30 may be disposed spaced apart from each other in a second direction. For example, the arrangement direction of the holes 36A and 36B may be the same as the arrangement direction of the protrusions of the driving plate 61. For example, the first groove 36A may comprise a bottom surface and a plurality of side surfaces. For example, each of the plurality of side surfaces of the first groove 36A may have the same area. In another embodiment, the area of at least one of the plurality of side surfaces of the first groove 36A may be different from the area of at least one of the plurality of side surfaces of the first groove 36A. For example, the bottom surface of the first groove 36A may be rectangular or elliptical, but is not limited thereto.

For example, the second groove 36B may comprise a bottom surface and a plurality of side surfaces. The second groove 36B may have the same shape as the first groove 36A. In another embodiment, side surfaces of any one of the first groove and the second groove may be the same, and at least one of the side surfaces of the remaining other one of the first groove and the second groove may have a different area.

The second groove 36B may comprise a bottom surface and a plurality of side surfaces. Each of the plurality of side surfaces of the second groove 36B may have the same shape and, for example, the same area. In FIG. 95b, the number of side surfaces of the second groove 36B is four, but is not limited thereto, and may be five or more in other embodiments. For example, the bottom surface of the second groove 36B may be square or circular, but is not limited thereto.

A protruding portion or a step may be formed around the first groove 36A and the second groove 36B. The protruding portion may be protruded from the rear outer side surface 31b. A lubricant may be disposed between the protrusions 61B1 and 61B2 and the first and second grooves 36A and 36B. The protruding portion formed around the first groove 36A and the second groove 36B can inhibit lubricant from overflowing.

The holder 30 may comprise at least one stopper (not shown) being formed on the rear outer side surface 31b. For example, the stopper of the holder 30 may be in the form of a protrusion or protruding portion being protruded from the rear outer side surface 31b.

The holder 30 may comprise a groove 37 for accommodating or supporting a portion of the elastic member 63. For example, the number of grooves 37 may be the same as the number of elastic units 63A and 63B of the elastic member 63.

For example, the groove 37 may be formed on a bottom surface of the groove 106A of the holder 30. For example, the groove 37 may be a shape recessed from the bottom surface of the groove 106A of the holder 30. For example, the groove 37 may comprise a first groove 37A corresponding to or opposite to the first elastic unit 63A and a second groove 37B corresponding to or opposite to the second elastic unit 63B. For example, the first groove 37A and the second groove 37B may be disposed spaced apart from each other.

In another embodiment, at least one of the groove 106A or the protruding portion 57A of the housing 50 may be omitted, the groove 37 may be a shape recessed from the rear outer side surface 31b of the holder 30, and the groove 51 may be recessed from the inner side surface of the second side portion 28B of the housing 50.

For example, when viewing the rear outer side surface 31b from the front, the groove 37 may be disposed between the two grooves 36A and 36B of the holder 30.

The housing 50 may be disposed inside the cover member 300. For example, an adhesive or a shield member may be disposed between the housing 50 and the cover member 300, and the housing 50 may be coupled or fixed to the cover member 300. The holder 30 may be disposed inside the housing 50. The housing 50 may accommodate the holder 30 therein, and may expose the incident surface 8A and the exit surface 8B of the optical member 40 disposed in the holder 30.

Referring to FIGS. 99a and 99b, for example, the housing 50 may comprise a first opening 53A (or a first hole) for exposing the incident surface 8A of the optical member 40 and a second opening 53B (or a second hole) for exposing the exit surface 8B of the optical member 40.

The housing 50 may comprise an upper portion 27A, a lower portion 27B, and a side portion 28 being disposed between the upper portion 27A and the lower portion 27. For example, a side portion of the housing 50 may comprise a plurality of side portions 28A to 28D.

The upper portion 27A and the lower portion 27B of the housing 50 may face each other in a second direction (For example, an X-axis direction) or may be positioned opposite to each other. For example, the housing 50 may comprise: a first side portion 28A, a second side portion 28B, a third side portion 28C, and a fourth side portion 28D.

28C may be expressed as “first side portion”, 28D may be expressed as “second side portion”, 28B may be expressed as “third side portion”, and 28D may be expressed as “fourth side portion”, and in another embodiment, the side portions of the housing 50 may be expressed in various distinguishable forms.

For example, the first side portion 28A of the housing 50 may be disposed to face or face the lens assembly 311 of the first actuator 310. The first opening 53A may be formed in the upper portion 27A, and the second opening 53B may be formed in the first side portion 28A.

The second side portion 28B may be positioned to face the first side portion 28A in a first direction or at an opposite side of the first side portion 28A. The third side portion 28C and the fourth side portion 28D may be disposed between the first side portion 28A and the second side portion 28D, and positioned to face each other in a third direction (For example, a Y-axis direction) or may be positioned at an opposite side thereof. For example, the third side portion 28C may connect one end of the first side portion 28A and one end of the second side portion 28B, and the fourth side portion 28D may connect the other end of the first side portion 28A and the other end of the second side portion 28B.

For example, the housing 50 may comprise: a first hole 54A being formed in the third side portion 28C to seat or dispose the first OIS coil unit 230A; a second hole 54B being formed in the fourth side portion 28D to seat or dispose the second OIS coil unit 230B; and a third hole 54C being formed in the lower portion 27B to seat or dispose the third OIS coil unit 230C. For example, each of the first to third holes 54A to 54C is in the form of a penetrating hole, but is not limited thereto, and may be in the form of a groove in another embodiment.

In addition, in the third side portion 28C (or the fourth side portion 28D) of the housing 50, a groove 56 (or a penetrating hole) for disposing or seating the second driver 260 may be formed. For example, the groove 56 may be formed spaced apart from the first hole 54A.

In another embodiment, the housing 50 may comprise at least one coupling protrusion (not shown) being formed on at least one of the third side portion 28C, the fourth side portion 28D, and the lower portion 28b, and the circuit board 250 may comprise a hole to be coupled with at least one coupling protrusion.

The second side portion 28B of the housing 50 may comprise a groove 58 that corresponds to, faces, or overlaps with the groove of the driving plate 61 (or the mounting groove 68). The number of grooves 58 may be the same as the number of grooves 68 of the driving plate 61 or the same as the number of rolling members 65.

For example, the housing 50 may comprise two grooves 58A and 58B being formed spaced apart from each other in the second side portion 28B. For example, the two grooves 58A and 58B of the housing 50 may be disposed spaced apart from each other in a third direction. The description of the grooves 36A and 36B of the holder 30 may be applied or inferred to the grooves 58A and 58B of the housing 50.

For example, the protruding portion 57A of the housing 50 may be disposed between two grooves 58A and 58B of the housing 50. In addition, groove 51 of housing 50 may be disposed between two grooves 58A and 58B of housing 50.

For example, the housing 50 may comprise: a groove 58A corresponding to, opposite to, or overlapping with the first groove 68A of the driving plate 61; and a groove 58B corresponding to, opposite to, or overlapping with the second groove 68B of the driving plate 61.

In addition, unlike those shown in the drawings, in another embodiment, the grooves 36A and 36B of the holder 30 may be disposed spaced apart in a third direction (For example, a Y-axis direction), the protrusions 62B1 and 62B2 of the driving plate 61 may be disposed spaced apart from each other in a third direction, the grooves 58A and 58B of the housing 50 may be disposed spaced apart in a second direction (For example, an X-axis direction), and the two elastic units 65B1 and 65B2 may be disposed spaced apart from each other in a second direction.

For example, the housing 50 may comprise a protruding portion 57A formed on the second side portion 28B to correspond to, face, or overlap with the groove 106A of the holder 30 or the opening 106 of the driving plate 61.

Referring to FIG. 99a, for example, the protruding portion 57A may be protruded from an inner side surface of the second side portion 28B of the housing 50 toward the second opening 53B of the first side portion 28A.

The housing 50 may comprise a groove 51 for accommodating or supporting another portion of the elastic member 63. The groove 51 may be formed in the protruding portion 57A of the housing 50. The thickness of the first region of the second side portion 28B of the housing 50 where the protruding portion 57A is formed may be larger than the thickness of the second region of the second side portion 28B of the housing 50 in which the protruding portion 57A is not formed. In this way, by making the thickness of the first region larger than that of the second region, it is possible to secure the depth of the groove 55 for stably supporting the elastic units 63A and 63B, and it is possible to enhance the durability of the housing 50, and as a result, it is possible to inhibit the housing 50 from being broken or damaged by the force being applied from the elastic units 63A and 63B.

For example, the number of grooves 51 may be the same as the number of elastic units 63A and 63B of the elastic member 63. In addition, for example, the shape of the groove 51 may be a shape that is easy to accommodate the elastic units 63A and 63B. For example, when viewing the groove 51 from the front, the groove 51 may have a circular shape, an oval shape, a polygonal shape, for example, a rectangular shape.

For example, the groove 51 may be formed on a side surface of the protruding portion 57A of the housing 50 facing the rear outer side surface 31b of the holder 30. For example, the groove 51 may be a shape recessed into the side surface of the protruding portion 57A of the housing 50.

For example, the groove 51 may comprise a first groove 51A corresponding to or opposite to the first elastic unit 63A and a second groove 51B corresponding to or opposite to the second elastic unit 63B. For example, the first groove 51A and the second groove 51B may be disposed spaced apart from each other.

For example, when viewing the inner side surface of the second side portion 28B of the housing 50 from the front, the protruding portion 57A may be positioned between the two grooves 58A and 58B. In addition, for example, when viewing the inner side surface of the second side portion 28B of the housing 50 from the front, the grooves 55A and 55B may be disposed between the two grooves 58A and 58B of the housing 50.

For example, when viewing the inner side surface of the second side portion 28B of the housing 50 in an optical axis direction (For example, a Z-axis direction), the grooves 55A and 55B of the housing 50 may be overlapped with the opening 106 of the driving plate 61.

In another embodiment, the protruding portion 57A of the housing 50 may be omitted, and the grooves 55A and 55B may be a shape recessed from an inner side surface of the second side portion 28B of the housing 50.

The housing 50 may comprise a guide groove 55. The guide groove 55 may be formed in the second side portion 28B of the housing 50. For example, the guide groove 55 may be formed on an inner side surface of the second side portion 28B of the housing 50. When inserting or placing the rolling member 65 between the groove 58 of the housing 50 and the groove 68 of the driving plate 61, the guide groove 55 may be a passage for guiding insertion or movement of the rolling member 65.

For example, the rolling member 65 can move along the guide groove 55 and can be inserted and disposed in a space between the groove 58 of the housing 50 and the groove 68 of the driving plate 61.

For example, the guide groove 55 may comprise: a first guide groove 55A being disposed on the groove 58A of the housing 50; and a second guide groove 55B being disposed on the groove 58B of the housing 50.

For example, the length of the guide groove 55 in a second direction may be longer than the length of the groove 58 in a second direction. In another embodiment, the length of the guide groove 55 in a second direction may be less than or equal to the length of the groove 58 in a second direction.

An opening may be formed at an upper portion of the guide groove 55 to allow the rolling member 65 to be inserted. For example, the guide groove 55 may comprise an opening that opens from an upper surface of the housing 50. The guide groove 55 may be formed to be formed spaced apart from the groove 58 of the housing 50. For example, at least a portion 59 of the housing 50 may be disposed between the guide groove 55 and the groove 58.

For example, the guide groove 55 may comprise a chamfer shape or the shape of a step. For example, a partition wall 59 may be disposed between the bottom surface of the guide groove 55 and the bottom surface of the groove 58. For example, the housing 50 may comprise: a first partition wall 59A being disposed between the bottom surface of the first guide groove 55A and the bottom surface of the groove 58A; and a second partition wall 59B being disposed between the bottom surface of the second guide groove 55B and the bottom surface of the groove 58B. The partition wall 59 may serve to inhibit the rolling member 65 from being separated from the groove 58 of the housing 50 and the groove 68 of the driving plate 61. In other embodiments, the partition wall 59 may be omitted, and the groove 58 and the guide groove 55 may be connected or communicated with each other.

For example, the thickness of the partition wall 59 or the distance between the bottom surface of the guide groove 55 and the bottom surface of the groove 58 may be smaller than the diameter of the rolling member 65. This is because if the thickness of the partition wall 59 or the distance between the bottom surface of the guide groove 55 and the bottom surface of the groove 58, it may not be easy to insert the rolling member 65 between the groove 58 of the housing 50 and the groove 68 of the driving plate 61. In another embodiment, the guide groove 55 may be connected to or communicate with the groove 58 of the housing 50.

For example, the depth of the groove 58 of the housing 140 may be smaller than the depth of the guide groove 55. The depth of the groove 58 may be the depth of the bottom of the groove 58, and the depth of the guide groove 55A may be the depth of the bottom of the guide groove 55. In another embodiment, the depth of the groove 58 of the housing 140 may be greater than or equal to the depth of the guide groove 55.

For example, the upper surface of the protruding portion 57A may be positioned closer to the bottom surface of the groove 51 of the housing 140 than the inner side surface of the second side portion 28B of the housing 140. In addition, an upper surface of the protruding portion 57A may be positioned closer to an inner side surface of the second side portion 28B of the housing 140 than the bottom surface of the guide groove 55 of the housing 140.

Referring to FIGS. 103a and 103b, the housing 50 may comprise a protruding portion 57B being disposed on the driving plate 61 and being protruded from the second side portion 28B. For example, the protruding portion 57B may be protruded from the inner side surface of the second side portion 28B in an optical axis direction or in a first direction. For example, the protruding portion 57B may be a protruding portion of the upper surface or a portion of the upper end of the second side portion 28B. For example, the protruding portion 57B may be in contact with the upper end of the inner side surface of the second side portion 28B or the upper surface of the second side surface 28B.

The protruding portion 57B may face or overlap with the driving plate 61 in a second direction (for example, an X-axis direction). For example, at least a portion of the protruding portion 57B may face or overlap with the body 61A of the driving plate 61 in a second direction (For example, an X-axis direction). Due to this, the protruding portion 58B can inhibit the driving plate 61 from being separated from the first opening 53A of the housing 50 due to an external impact. The protruding portion 57B may be expressed by replacing it with a “step”, “blocking portion”, “protrusion”, or “separation prevention portion”.

Next, the support part 60 will be described.

The support part 60 is disposed between the holder 30 and the housing 50 and may support the holder 30 against the housing 50. The support part 60 may comprise a drive plate 61 being disposed between the holder 30 and the housing 50. The support part 60 may comprise a rolling member 65 being disposed between the driving plate 61 and the housing 50. In addition, the support part 60 may comprise an elastic member 63 connecting the holder 30 and the housing 50. The driving plate 61 may also be expressed by replacing it with “mover”, “mover plate”, “drive plate”, “plate”, “turn plate”, “tilting plate”, “moving plate”, or “support plate”. The driving plate 61 may be disposed between the holder 30 and the housing 50, at least a portion of the driving plate 61 may be in contact with the holder 30, and at least another portion of the driving plate 61 may be in contact with the housing 50.

For example, the driving plate 61 may be disposed between the rear outer side surface 31b of the holder 30 and the second side portion 28B of the housing 50, and may support the holder 30 against the housing 50.

Referring to FIGS. 97a and 97b, the driving plate 61 may comprise a protrusion 62 being coupled to or in contact with the holder 30. For example, the number of protrusions 62 may be one or more. For example, the driving plate 61 may comprise two protrusions 62B1 and 62B2. For example, the protrusions 61B1 and 61B2 may be arranged spaced apart from each other in a second direction.

At least a portion of the protrusion 62 of the driving plate 61 may be inserted or disposed inside the groove 36 of the holder 30. For example, at least a portion of each of the protrusions 62B1 and 62B2 of the driving plate 61 may be inserted into or disposed in a corresponding one of the grooves 36A and 36B of the holder 30. In another embodiment, the protrusions of the driving plate 61 may be arranged spaced apart in a third direction.

The driving plate 61 may comprise a groove 68 in which the rolling member 65 is disposed. For example, the driving plate 61 may comprise grooves 68A and 68B in which the ball members 65B1 and 65B2 are disposed. For example, the grooves 68A and 68B may be disposed spaced apart in a third direction, and in another embodiment, the grooves of the driving plate for disposing the ball members may be disposed spaced apart in a second direction. The description of the opening 58 of the housing 50 may be applied or inferred to the groove 68 of the driving plate 61.

The driving plate 61 may comprise an opening 106 that corresponds to, opposes, or overlaps with the protruding portion 57A of the housing 50. The opening 106 may be disposed at a position corresponding to the protruding portion 57A of the housing 50 to avoid spatial interference with the protruding portion 57A. In addition, the opening 106 may be formed to avoid spatial interference between the elastic member 63 and the driving plate 61.

For example, the opening 106 of the driving plate 61 may be a penetrating hole. For example, the opening 106 may penetrate through the driving plate 61 in a first direction (Z-axis direction) or an optical axis direction.

For example, at least a portion of the opening 106 of the driving plate 61 may comprise a shape corresponding to that of the protruding portion 57A of the housing 50. For example, the opening 106 may comprise a circular shape, an elliptical shape, a polygonal shape, and a rectangular shape.

For example, each of the length in a horizontal direction and the length in a vertical direction of the opening 106 may be larger than the diameter of protrusion 62B1 or 62B2 of driving plate 61. For example, the length of the opening 106 in a transverse direction may be larger than the length in a transverse direction of the protruding portion 64A or 64B of the driving plate 61. In another embodiment, the length of the opening 106 in a transverse direction may be less than or equal to the length in a transverse direction of the protruding portion 64A or 64B of the driving plate 61.

For example, the length of the opening 106 in a longitudinal direction may be greater than the length of the protruding portion 64A or 64B of the driving plate 61 in a longitudinal direction. In another embodiment, the length of the opening 106 in a longitudinal direction may be smaller than or equal to the length of the protruding portion 64A or 64B of the driving plate 61 in a longitudinal direction.

For example, the opening 106 may be positioned between the protruding portions 64A and 64B of the driving plate 61 and between the protrusions 62B1 and 62B2.

For example, the protrusion 62 may be disposed on the front (or first surface) of the driving plate 61, and the groove 68 may be disposed on a rear surface (or second surface) of the driving plate 61. The rear and front surfaces of the driving plate 61 may be the surfaces being positioned opposite to each other in a first direction or an optical axis direction. For example, the bottom surface of the driving plate 61 may be a surface facing the rear outer side surface 31b of the holder 30, and a rear surface of the driving plate 61 may be a surface facing the inner side surface of the second side portion 28B of the housing 50.

The driving plate 61 may comprise a protruding portion 64 being formed on a front surface (or first surface) of the driving plate 61. The protruding portion 64 may correspond to the groove 68 of the driving plate 61.

Referring to FIG. 97a, since the thickness T1 of the driving plate 61 is too thin to form the groove 68 for accommodating the rolling member 65, a groove 68 having a predetermined depth may be formed by forming the protruding portion 64 on a front surface of the driving plate 61. In addition, the protruding portion 64 may serve to inhibit the region of the driving plate 61 in which the groove 68 is formed from being damaged or deformed by impact. For example, the thickness (or protruding height) of the protruding portion 64 may be greater than the thickness of the body 61A of the driving plate 61. In another embodiment, T2 may be equal to or smaller than T1.

For example, driving plate 61 may comprise: a body 61A; protrusions 62 (62B1 and 62B2) being protruded from a front surface of the body 61A; and a groove 68 being formed on a rear surface of the body 61A.

For example, each of the protrusions 62B1 and 62B2 may have a curved shape, a hemispherical shape, a dome shape, a triangular pyramid shape, a conical shape, or a polyhedral shape, but is not limited thereto.

In another embodiment, instead of the protrusions 62B1 and 62B2, grooves (or front grooves) may be formed on a front surface of the driving plate, and instead of the grooves 36A and 36B, protrusions for coupling with the front groove of the driving plate may be formed on the holder.

For example, the driving plate 61 may be an injection molding product. For example, the driving plate 61 may be made of plastic, resin, or ceramic material. In another embodiment, the driving plate 61 may be made of metal, for example, or SUS material. In addition, the driving plate 61 may be a non-magnetic material. In another embodiment, the driving plate may be a magnetic material.

The rolling member 65 may be disposed between the rear surface of the driving plate 61 and the housing 50, and may come into contact with the driving plate 61 and the housing 50. For example, the rolling member 65 may be a member that performs rolling motion. For example, the rolling member 65 may be a “ball”, a “ball member”, or a “ball bearing”.

At least a part of the rolling member 65 may be in contact with a rear surface of the driving plate 61, and at least another portion of the rolling member 65 may be in contact with an inner side surface of the second side portion 28B of the housing 50.

For example, at least a portion of the rolling member 65 can be inserted or disposed inside the groove 68 of the driving plate 61; and at least another portion of the rolling member 65 may be inserted or disposed inside the groove 58 of the housing 50.

Compared to the protrusions 62B1 and 62B2 of the driving plate 61, since the rolling member 65 performs a rolling motion, the frictional force can be relatively reduced so that the suppression ratio can be increased and the current consumption can be reduced, thereby enhancing the OIS driving performance. For example, the degree of performance of OIS feedback control can be measured by the suppression ratio. For example, the suppression ratio can be defined as the log value (20 log(Y)) of the ratio (Y=OUTPUT/INPUT) of the output signal (For example, OUTPUT) of the OIS position sensor 240 and the input signal (For example, INPUT) applied to the OIS coil 230.

One end of the elastic member 63 may be coupled to the holder 30, and the other end of the elastic member 63 may be coupled to the housing 50. For example, one end of the elastic member 63 may be coupled to the protruding portion 57A of the housing 50, and the other end of the elastic member 63 may be coupled to the second side portion 28B of the holder 30.

For example, one end of the elastic member 63 may be inserted or disposed inside the groove 51 of the housing 50, and may be coupled to or fixed to the groove 51 of the housing 50. The other end of the elastic member 63 may be inserted or disposed inside the groove 37 of the holder 30, and may be coupled with the groove 37 of the holder 30. One end of the elastic member 63 may be coupled to the groove 51 of the housing 50 by an adhesive, and the other end of the elastic member 63 may be coupled to the groove 37 of the holder 30.

The elastic member 63 may be a pulling member that pulls the holder 30 and the housing 50 to each other. For example, the holder 30 may be pressed against the housing 50 by the pulling force of the elastic member 63, and thus the holder 30 may be supported.

The elastic member 63 may comprise at least one elastic unit 63A or 63B. For example, the number of elastic units may be one or more. For example, the elastic member 63 may comprise two elastic units 63A and 63B disposed spaced apart from each other in a third direction. For example, the number of elastic units disposed spaced apart from each other in a third direction may be two or more.

In another embodiment, the elastic member 63 may comprise two elastic units disposed spaced apart from each other in a second direction. For example, the number of elastic units being disposed spaced apart from each other in a second direction may be two or more. In another embodiment, the elastic member may comprise only one elastic unit.

For example, the elastic units 63A and 63B may be springs, coil springs, suspension wires, or leaf springs. For example, the elastic units 63A and 63B may be made of metal.

Referring to FIGS. 98a, 98b, and 100b, at least a portion of the protruding portion 57A of the housing 50 may be inserted or disposed inside the opening 106 of the driving plate 61.

The elastic member 63 may pass through the opening 106 of the driving plate 61. For example, at least a portion of the elastic member 63 in a second direction may overlap with the driving plate 61. For example, the elastic units 63A and 63B may penetrate through the opening 106 of the driving plate 61 or avoid the body 61A of the driving plate 61.

For example, when viewing the driving plate 61 from the front, the elastic member 63 may be disposed inside an outer circumferential surface of the driving plate 61. In addition, when viewing the driving plate 61 from the front, the elastic member 63 may overlap with the opening 106 of the driving plate 61.

Next, the second driving unit 70 will be described.

The second driving unit 70 tilts the holder 30 in a second direction or a third direction or rotates it by a preset angle.

The second driving unit 70 may comprise an OIS magnet 31 and an OIS coil 230. The OIS magnet can be expressed by replacing it with “magnet” or “magnet unit”, and an OIS coil may be expressed by replacing it with a “coil body”, a “coil” or a “coil unit”. In addition, the second driving unit 70 may comprise an OIS position sensor unit 240 and a first substrate unit 250.

The OIS magnet 31 may be disposed on the holder 30. For example, the OIS magnet 31 may comprise the first OIS magnets 31A and 31B and the second OIS magnet 32.

For example, the first OIS magnet may comprise: a first magnet unit 31A being disposed on the third side portion 31c of the holder 30; and a second magnet unit 31B disposed on the fourth side portion 31d of the holder 30. For example, the first magnet unit 31A may face or overlap with the second magnet unit 31B in a third direction. For example, the first magnet unit 31A may be disposed inside the first seating groove 16A of the third side portion 31c of the holder 30, and the second magnet unit 31B may be disposed inside the first seating groove 16A of the fourth side portion 31d of the holder 30.

The second OIS magnet may comprise a third magnet unit 32 being disposed on the lower surface 17 of the holder 30. The third magnet unit 32 may be disposed inside the second seating groove 16B of the holder 30.

Each of the first to third magnet units 31A, 31B, and 32 may be a monopole magnetized magnet having one N pole and one S pole, but is not limited thereto, and in another embodiment, it may be a positively magnetized magnet having two N poles and two S poles. In another embodiment, at least one of the first to third magnet units 31A, 31B, and 32 may be unipolar magnetized magnets, and the others may be bipolar magnetized magnets.

The OIS coil 230 may be disposed in the housing 50. For example, the OIS coil may be disposed corresponding to or facing the OIS magnet 31.

For example, the OIS coil 230 may comprise: first OIS coils 230A and 230B corresponding to, opposite to, or overlapping with the first OIS magnets 31A and 31B in a third direction; and a second OIS coil 230C corresponding to, facing, or overlapping with the second OIS magnet 32 in a second direction.

For example, the first OIS coil may comprise: a first OIS coil unit 230A corresponding to, opposite to, or overlapping with the first magnet unit 31A in a third direction; and a second OIS coil unit 230B corresponding to, facing, or overlapping the second magnet unit 31B in a third direction. For example, the second OIS coil may comprise a third OIS coil unit 230C that corresponds to, faces, or overlaps with the third magnet unit 32 in a second direction.

For example, the first OIS coil unit 230A may be disposed in the third side portion 28C (For example, the first hole 34A) of the housing 50; the second OIS coil unit 230B may be disposed in the fourth side portion 28D (For example, the second hole 54B) of the housing 50; and the third OIS coil unit 230C may be disposed at the lower portion 28B of the housing 50 (For example, the third hole 54C).

For example, the first OIS coil unit 230A may have a closed curve or ring shape comprising a hollow or hole. The first OIS coil unit 230A may be implemented in the form of a coil ring wound in a clockwise or counterclockwise direction with respect to a third axis parallel to the third direction.

The second OIS coil unit 230B may have a closed curve or ring shape comprising a hollow or hole. The second OIS coil unit 230B may be implemented in the form of a coil ring wound in a clockwise or counterclockwise direction with respect to a third axis parallel to the third direction. The third OIS coil unit 230C may have a closed curve or ring shape comprising a hollow or hole. The third OIS coil unit 230C may be implemented in the form of a coil ring wound in a clockwise or counterclockwise direction with respect to a second axis parallel to the second direction.

Referring to FIG. 101, first electromagnetic forces F21, F22, F31, and F32 may be generated by the interaction between the first OIS magnets 31A and 31B and the first OIS coils 230A and 230B. That is, the first electromagnetic force may be generated by the interaction between the first magnet unit 31A and the first OIS coil unit 230A and the interaction between the second magnet unit 31B and the second OIS coil unit 230B. For example, the first-first electromagnetic forces F22 and F32 may be generated by the interaction between the first magnet unit 31A and the first OIS coil unit 230A; the first-second electromagnetic forces F21 and F31 may be generated by the interaction between the second magnet unit 31B and the second OIS coil unit 230B; and the first electromagnetic force may comprise the first-first electromagnetic forces F22 and F32 and the first-second electromagnetic forces F21 and F31.

In addition, the second electromagnetic forces F1 and F2 may be generated by the interaction between the second OIS magnet 32 and the third OIS coil unit 230C.

For example, the OIS moving unit (For example, holder 30) may be tilted with respect to the vertical axis 501 (For example, X-axis) by the first electromagnetic forces F21, F22, F31, and F32. Or, for example, by the first electromagnetic forces F21, F22, F31, and F32, the OIS moving unit (For example, holder 30) may rotate by a predetermined angle using the vertical axis 501 (For example, X-axis) as a rotation axis.

For example, the vertical axis 501 may be a straight line passing through the protrusions 62B1 and 62B2 of the driving plate 61 and parallel to the X-axis. In another embodiment having ball members instead of the protrusions 62B1 and 62B2, the vertical axis 501 may be a straight line passing through the ball member instead of the protrusions 62B1 and 62B2.

For example, the vertical axis 501 may be a straight line passing through the center of the driving plate 61 and parallel to the X-axis. For example, the vertical axis 501 may be expressed as a “first rotation axis”.

The OIS moving unit may be tilted with respect to the horizontal axis 502 (For example, the X-axis) by the second electromagnetic forces F1 and F2. Or, by the second electromagnetic forces F1 and F2, the OIS moving unit may be rotated by a predetermined angle with the horizontal axis 502 (For example, X-axis) as a rotation axis. For example, the horizontal axis 502 may be a straight line passing through the rolling member (For example, the ball members 65B1 and 65B2). For example, the horizontal axis 502 may be a straight line passing through the center of the driving plate 61 and parallel to the Y-axis. For example, the horizontal axis 502 may be expressed as a “second rotation axis”. The horizontal axis 502 and the vertical axis 501 may be perpendicular to each other.

At this time, the OIS movable unit may comprise a holder 30. Or, the OIS movable unit may further comprise, for example, OIS magnets 31A, 31B, and 32 and the yoke 33 being coupled to or mounted on the holder 30. In addition, the OIS movable unit may further comprise a driving plate 61.

In another embodiment, any one of the first and second OIS magnet units 31A and 31B may be omitted, and the OIS coil corresponding to the omitted magnet unit may also be omitted. In another embodiment, the OIS moving unit (For example, the holder 30) may be tilted with respect to the horizontal axis by the electromagnetic force due to the interaction between the first OIS magnets 31A and 31B and the first OIS coils 230A and 230B; and the OIS moving unit (For example, the holder 30) may be tilted with respect to a vertical axis by the electromagnetic force due to the interaction between the second OIS magnet 32 and the third OIS coil unit 230C. The camera device 200 may further comprise yokes 33 (33A, 33B, and 33C) being disposed on the OIS magnets 31 and 32.

For example, the yoke 33 may comprise: a first yoke 33A being disposed in the first magnet unit 31A, a second yoke 33B being disposed in the second magnet unit 31B; and a third yoke 33C being disposed on the third magnet unit 32.

For example, the first yoke 33A may be disposed inside the first seating groove 16A of the third side portion 31c of the holder 30. For example, the first yoke 33A may be disposed inside the first magnet unit 31A. The second yoke 33B may be disposed inside the first seating groove 16A of the fourth side portion 31d of the holder 30. For example, the second yoke 33B may be disposed inside the second magnet unit 31B. The third yoke 33C may be disposed inside the second seating groove 16B of the holder 30. The third yoke 33C may be disposed inside the third magnet unit 32. The first yoke 33A and the second yoke 33B may increase the first electromagnetic force, and the third yoke 33C may increase the second electromagnetic force.

The first substrate unit 250 may be disposed in the housing 50. For example, the first substrate unit 250 may be coupled with the housing 50. The first substrate unit 250 may be electrically connected to the OIS coil 230 and may provide a driving signal to the OIS coil 230.

For example, the first OIS coil unit 230A and the second OIS coil unit 230B may be connected in series to each other, and the first substrate unit 250 may provide a first driving signal to the first and second OIS coil units 230A and 230B connected in series. In addition, the first substrate unit 250 may provide the second driving signal to the third OIS coil unit 230C.

The first substrate unit 250 may comprise: a first circuit board 250A disposed on the third side portion 28C of the housing 50; a second circuit board 250B being disposed on the fourth side portion 28D of the housing 50; and a third circuit board 250C being disposed on the lower portion 27B of the housing 50.

In FIG. 94, although the first circuit board 250A appears to be spaced apart from the third circuit board 250C, the first to third circuit boards 250A to 250C may be one integral board and may be electrically connected to each other. In another embodiment, at least one of the first to third circuit boards may not be integral with the others, and may be electrically connected to each other. The first circuit board 250A may comprise a plurality of terminals 251. The OIS coil units 230A, 230B, and 230C may be electrically connected to the first substrate unit 250.

The first OIS coil unit 230A may be disposed or mounted on the first circuit board 250A, the second OIS coil unit 230B may be disposed or mounted on the second circuit board 250B, and the third OIS coil unit 230C may be disposed or mounted on the third circuit board 250C.

For example, the first OIS coil unit 230A may be disposed or mounted on a first surface of the first circuit board 250A, and a plurality of terminals 251 may be disposed on a second surface of the first circuit board 250A. The first surface of the first circuit board 250A may be a surface facing an outer side surface of the third side portion 28C of the housing 50. The second surface of the first circuit board 250A may be a surface opposite to the first surface of the first circuit board 250A.

The first substrate unit 250 may comprise a bent portion connecting between the second circuit board 250B and the third circuit board 250C and between the first circuit board 250A and the third circuit board 250C. For example, the second OIS coil unit 230B may be disposed or mounted on a first surface of the second circuit board 250B. The first surface of the second circuit board 250B may be a surface facing the outer side surface of the fourth side portion 28C of the housing 50. For example, the third OIS coil unit 230C may be disposed or mounted on a first surface of the third circuit board 250C. The first surface of the third circuit board 250C may be a surface facing an outer surface of the lower portion 28B of the housing 50.

The first substrate unit 250 may comprise at least one of a rigid printed circuit board (Rigid PCB), a flexible printed circuit board (Flexible PCB), and a rigid printed circuit board (Rigid Flexible PCB). In addition, the first substrate unit 250 may comprise a wiring pattern for electrically connecting components disposed on the first to third circuit boards 250A, 250B, and 250C and the plurality of terminals 251.

The camera device 200 may further comprise a gyro sensor 82 being disposed on the first substrate unit 250. For example, the gyro sensor 82 may be a 2-axis, 3-axis, or 5-axis gyro sensor or an angular velocity sensor.

The camera device 200 may further comprise a second driver 260 being disposed on the first substrate unit 250. For example, the second driver 260 may be disposed or mounted on the first circuit board 250A. For example, the second driver 260 may be disposed in the housing 50. For example, the second driver 260 may be disposed or mounted on a first surface of the first circuit board 250A of the housing 50.

The second driver 260 may be electrically connected to the first OIS coils 230A and 230B and the second OIS coil 230C. In addition, the second driver 260 may be electrically connected to the first OIS position sensors 240A and 240B and the second OIS position sensor 240C.

For example, the second driver 260 may provide a driving signal to each of the first OIS position sensors 240A and 240B and the second OIS position sensor 240C, and receive a first output signal of the first OIS position sensors 240A and 240B and a second output signal of the second OIS position sensor 240C.

In addition, for example, the second driver 260 may supply a first driving signal (For example, driving current or driving voltage) to the first OIS coils 230A and 230B, and feedback-control the first driving signal using the first output signals of the first OIS position sensors 240A and 240B.

In addition, For example, the second driver 260 may supply a second driving signal (For example, driving current or driving voltage) to the second OIS coil 230C, and feedback-control the second driving signal using the second output signal of the second OIS position sensor 240C. For example, the second driver 260 may be expressed by replacing it with an “OIS driver”, driver IC”, or “OIS control unit”.

The OIS position sensor unit 240 detects the position of the OIS movable unit in a second direction and/or a third direction according to the movement of the OIS movable unit, and outputs an output signal according to the detected result. The OIS position sensor unit 240 may be expressed by replacing it with a “second position sensor unit”.

The OIS position sensor unit 240 may comprise a plurality of position sensors.

For example, the OIS position sensor unit 240 may comprise first OIS location sensors 240A and 240B and a second OIS position sensor 240C.

At least some of the first OIS position sensors 240A and 240B may correspond to, face, or overlap with the first OIS magnet 31 in a third direction. The first OIS position sensors 240A and 240B may detect the first OIS magnet 31 or the strength of the magnetic field of the first OIS magnet 31.

For example, the first OIS position sensor may comprise: a first sensor 240A being disposed or mounted on a first circuit board 250A; and a second sensor 240B being disposed or mounted on the first substrate 250-1 of the second circuit board 240B. For example, the first sensor 240A may be disposed in a hollow (or hole) of the first OIS coil unit 230A, and the second sensor 240B may be disposed in a hollow (or hole) of the second OIS coil unit 230B. For example, each of the first sensor 240A and the second sensor 240B may be a Hall sensor comprising first and second input terminals and first and second output terminals.

For example, the first and second input terminals of the first sensor 240A and the first and second input terminals of the second sensor 240B may be connected in parallel, and the second driver 260 may supply driving signals or power to first and second input terminals connected in parallel to the first and second sensors 240A and 240B.

For example, the first and second output terminals of the first sensor 240A and the first and second output terminals of the second sensor 240B may be connected in series; a first output signal may be outputted from both ends of the serially connected first and second output terminals of the first and second sensors 240A and 240B; and the first output signal may be transmitted to the second driver 260.

At least a portion of the second OIS position sensor 240C may correspond to, face, or overlap with the second OIS magnet 32 in a second direction. The second OIS position sensor 240C may detect the second OIS magnet 32 or the strength of the magnetic field of the second OIS magnet 32.

For example, the second OIS position sensor 240C may comprise a third sensor 240C1 and a fourth sensor 240C2 being disposed or mounted on the third circuit board 250C. The third sensor 240C1 and the fourth sensor 240C2 may face or overlap with the third OIS magnet 32 in a second direction. For example, the third sensor 240C1 and the fourth sensor 240C2 may be disposed to be spaced apart from each other in a third direction. For example, the third sensor 240C1 and the fourth sensor 240C may be disposed in a hollow (or hole) of the third OIS coil unit 230C.

For example, each of the third sensor 240C1 and the fourth sensor 240C2 may be a Hall sensor comprising first and second input terminals and first and second output terminals.

For example, the first and second input terminals of the third sensor 240C1 and the first and second input terminals of the fourth sensor 240B may be connected in parallel, and the second driver 260 may supply driving signals or power to first and second input terminals connected in parallel to the third and fourth sensors 240C1 and 240C2. For example, the first and second output terminals of the third sensor 240C1 and the first and second output terminals of the fourth sensor 240C2 may be connected in series; a second output signal may be outputted from both ends of the serially connected first and second output terminals of the third and fourth sensors 240C1 and 240C2; and the second output signal may be transmitted to the second driver 260.

In another embodiment, the output terminals of the first and second sensors may be independent of each other without being connected, and may output independent output signals. In addition, the output terminals of each of the third and fourth sensors may be independent of each other without being connected, and may output independent output signals.

In another embodiment, the first OIS position sensor may comprise one position sensor (For example, a Hall sensor or a driver IC comprising a Hall sensor) and may transmit an output of one position sensor to the driver 260.

The second OIS position sensor may comprise one position sensor (for example, a Hall sensor or a driver IC comprising a Hall sensor) and transmit an output of one position sensor to the driver 260.

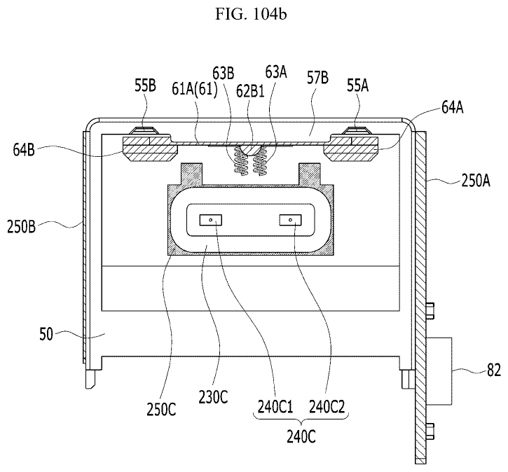

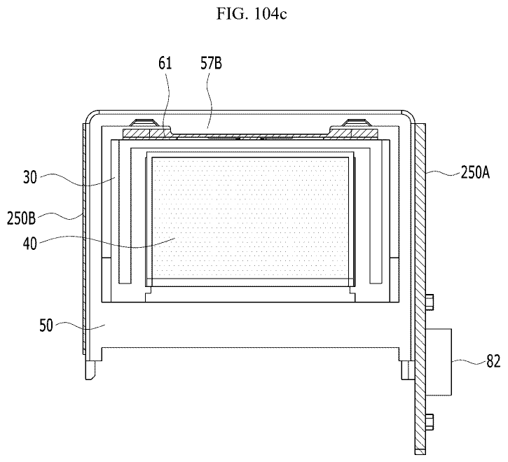

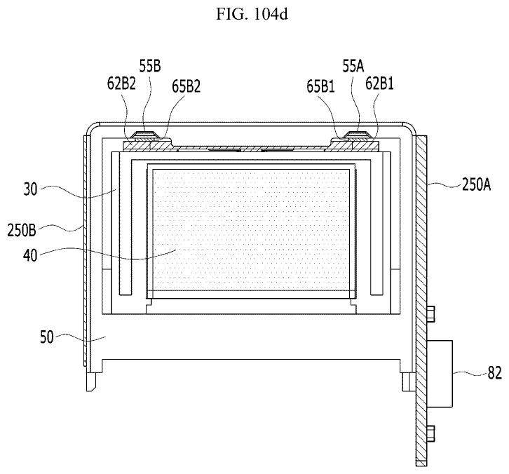

FIGS. 104a to 104d are diagrams for explaining an assembly sequence of the second actuator 320.

Referring to FIG. 104a, the elastic member 63 is coupled to the housing 50 to which the first substrate unit assembly is coupled. At this time, the “first substrate unit assembly” may be the one in which an OIS coil 230, an OIS position sensor 240, a driver 260, and a motion sensor 82 are coupled to or mounted on the first substrate unit 250.

The elastic member 63 is coupled to the housing 50. For example, one end of the elastic member 63 may be coupled to the groove 51 of the housing 50 by an adhesive.

Referring to FIG. 104b, the driving plate 61 is disposed in the housing 50. For example, at least a portion of the protruding portion of the housing 50 may be inserted or disposed inside the opening 106 of the driving plate 61.

Referring to FIG. 104b, the shortest separation distance between the first coil spring 63A and the second coil spring 63B may be smaller than the separation distance between the first guide groove 55A and the second guide groove 55B.

In addition, for example, the shortest separation distance between the first coil spring 63A and the second coil spring 63B may be smaller than the separation distance between the third sensor 240C1 and the fourth sensor 240C2.

In addition, for example, the separation distance between the third sensor 240C1 and the fourth sensor 240C2 may be smaller than the separation distance between the first guide groove 55A and the second guide groove 55B.

In addition, for example, the separation distance between the third sensor 240C1 and the fourth sensor 240C2 may be smaller than the separation distance between the first ball member 65B1 and the second ball member 65B2.

In addition, for example, referring to FIGS. 97a and 97b, the separation distance between the first protrusion 62B1 and the second protrusion 62B2 of the driving plate 61 may be smaller than the separation distance between the first ball member 65B1 and the second ball member 65B2. Referring to FIG. 104c, a “holder assembly” is disposed inside the housing 50 such that the elastic member 63 is coupled with the holder 30. For example, the other end of the elastic member 63 may be coupled to the groove 37 of the holder 30 by an adhesive.

Referring to FIG. 104d, the rolling member 65 is inserted and disposed between the housing 50 and the driving plate 61.

When the rolling member 65 is pushed along the guide groove 55 between the inner side surface of the second side portion 28B of the housing 50 and the rear surface of the driving plate 61, the rolling member 65 may be disposed or seated in the groove 58 of the housing 50 beyond the partition wall 59.

For example, the diameter of the rolling member 65 may be greater than the distance between the guide groove 55 and the rear surface of the driving plate 61. In addition, for example, the diameter of the rolling member 65 may be larger than the distance (for example, the shortest distance) between the groove 68 of the driving plate 61 and the groove 58 of the housing 50. For example, the diameter of the rolling member 65 may be greater than the distance between the bottom of the groove 68 of the driving plate 61 and the bottom of the groove 58 of the housing 50.

When the rolling member 65 continues to move downward along the guide groove 55, the rolling member 65 can be seated or disposed between the groove 58 of the housing 50 and the groove 68 of the driving plate 61 beyond the partition wall 59. The separation of the rolling member 65 out of the groove 58 of the housing 50 can be inhibited by the partition wall 59. The guide groove 55 can minimize damage to the elastic member 63 when the rolling member 65 is assembled, and may serve to inhibit the elastic member 63 from being deformed.

The elastic member 63 can be stretched or expanded by the rolling member 65. The expanded elastic member 63 may generate an elastic restoring force to restore the original shape, and the “holder assembly” may be brought into close contact with the housing 50 by this elastic restoring force. That is, the holder assembly (for example, the holder 30) can press the driving plate 61 and the housing 50 by the elastic restoring force, and due to this, the holder assembly can be supported.

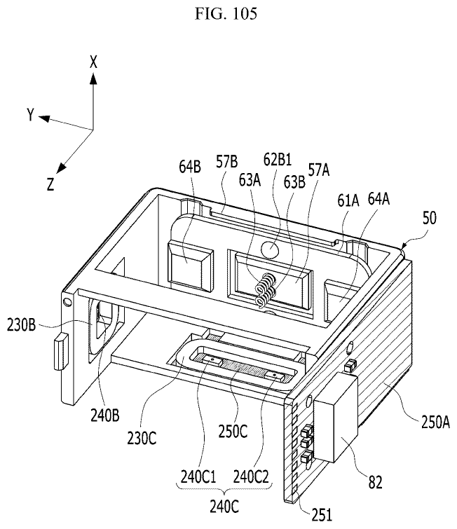

FIG. 105 shows the arrangement of elastic units 63A and 63B according to another embodiment.

Referring to FIG. 105, the elastic member 63 may comprise a plurality of elastic units 63A and 63B. The plurality of elastic units 63A and 63B may be disposed spaced apart from each other in a second direction (X-axis direction). For example, the distance between two neighboring elastic units may be the same. In FIG. 105, the number of elastic units is two, but in other embodiments, the number of elastic units may be three or more.

For example, in another embodiment, the housing 140 may comprise a plurality of rows (For example, two) being formed in the protruding portion 57A and grooves in the form of a matrix with multiple (For example, two) columns, and matrix-shaped elastic members corresponding to the matrix-shaped grooves may be provided.

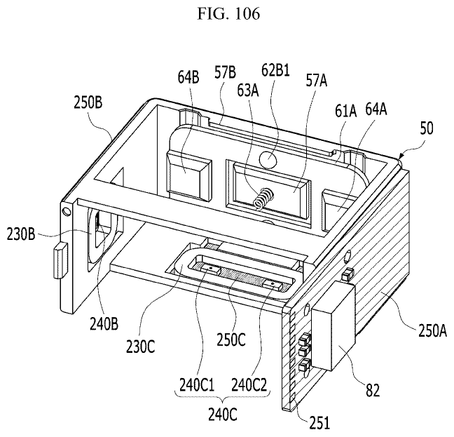

FIG. 106 shows the arrangement of elastic members according to another embodiment. Referring to FIG. 106, the elastic member 63 may comprise only one elastic unit 63A. For example, the elastic unit 63A may be positioned in the center or central region of the protruding portion 57A of the housing 50. In another embodiment, the center of the elastic unit 63A may not match or be aligned with the center of the protruding portion 57A.

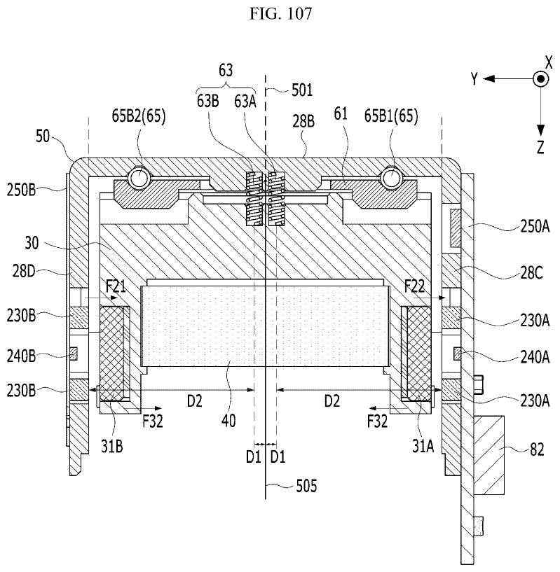

FIG. 107 is a cross-sectional view for explaining a relationship between an arrangement position of an elastic member 63 and an OIS driving force according to an embodiment.

FIGS. 101 and 107, the “holder assembly” can be supported on the housing 50 by the elastic member 63, and the holder assembly can be tilted about the first rotation axis 501 as an axis by the first electromagnetic force F21, F22, F31, and F32 caused by the interaction between the first OIS magnets 31A and 31B and the first OIS coils 230A and 230B.

The moment of the holder assembly is proportional to the separation distance between the source of the elastic restoring force and the source generating the electromagnetic force. For example, the source of the elastic restoring force may be the elastic member 63, and the source generating the electromagnetic force may be the first OIS coils 230A and 230B.

The magnitude of the first electromagnetic force may be reduced to obtain a predetermined moment value when the separation distance between the elastic member 63 and the source generating the electromagnetic force increases. Even with a small electromagnetic force, the holder assembly can be tilted about the first rotation axis 501 as an axis, power consumption for OIS driving can be reduced, and performance of OIS driving can be enhanced.

In order to increase the moment of such a holder assembly, an embodiment has a structure in which the separation distance between the elastic member 63 and the first OIS coils 230A and 230B, which are sources of electromagnetic force, is increased.

For example, the elastic member 63 may be disposed closer to the first rotation axis 501 than to the first OIS coils 230A and 230B. For example, the separation distance between the elastic member 63 and the first rotation axis 501 may be smaller than the separation distance between the elastic member 63 and the first OIS coils 230A and 230B.

For example, the elastic member 63 may be disposed closer to the center of the driving plate 61 than to the first OIS coils 230A and 230B. For example, the separation distance between the center of the elastic member 63 and the driving plate 61 may be smaller than the separation distance between the elastic member 63 and the first OIS coils 230A and 230B.

For example, the elastic member 63 may be disposed closer to the center of the driving plate 61 than the edge or periphery of the driving plate 61. For example, the separation distance between the elastic member 63 and the center of the driving plate 61 may be smaller than the separation distance between the elastic member 63 and the edge or periphery of the driving plate 61.

In FIG. 107, in order to compare the separation distance on the YZ plane, a straight line passing through the first rotation axis 501 and parallel to a first direction (Z-axis direction) is defined as a reference line 505. For example, the reference line 505 may be a straight line parallel to a direction from the second side portion 28B of the housing 50 toward the holder 30 and passing through the center of the driving plate 61. Or, the reference line 505 may be a straight line parallel to a direction from the second side portion 28B of the housing 50 toward the holder 30 and passing through the center of the second side portion 28B of the housing 50. Or, the reference line 505 may be a straight line parallel to a direction from the second side portion 28B of the housing 50 toward the driving plate 61 and passing through the center of the driving plate 61. For example, the reference line 505 may be parallel to an optical axis OA.

The elastic member 63 may be disposed closer to the reference line 505 than the first OIS coils 230A and 230B. For example, the separation distance D1 between the elastic member 63 and the reference line 505 may be smaller than the separation distance D2 between the first OIS coils 230A and 230B and the reference line 505.

For example, D1 may be the distance between the reference line 505 and the center line of the elastic member 63. For example, the center line of the elastic member 63 may be a straight line parallel to a first direction and passing through the center of the elastic member 63 (see dotted lines on the left and right sides of the reference line illustrated in FIG. 107. In another embodiment, D1 may be the shortest separation distance between the reference line 505 and the elastic member 63.

For example, D2 may be a distance between the center line of the first OIS coils 230A and 230B and the elastic member 63. In another embodiment, D2 may be the shortest separation distance between the first OIS coils 230A and 230B and the elastic member 63.

In addition, for example, the shortest separation distance between the first coil spring 63A and the second coil spring 63B may be smaller than the separation distance between the first coil spring 63A and the ball member 65B1.

In addition, for example, the shortest separation distance between the first coil spring 63A and the second coil spring 63B may be smaller than the separation distance between the second coil spring 63B and the ball member 65B2.

In addition, for example, the shortest separation distance between the first coil spring 63A and the second coil spring 63B may be smaller than the separation distance between the first ball member 65B1 and the second ball member 65B2.

The elastic member 63 may be disposed closer to the reference line 505 than the third side portion 28C (or the fourth side portion 28D) of the housing 50. For example, the separation distance between the elastic member 63 and the reference line 505 may be smaller than the separation distance between the third side portion 28C (or the fourth side portion 28D) of the housing 50 and the reference line 505.

The elastic member 63 may be disposed closer to the center line of the housing 50 than the third side portion 28C (or the fourth side portion 28D) of the housing 50. The center line of the housing 50 may be a straight line parallel to a first direction (Z-axis direction) and having the same separation distance from each of the third side portion 28C and the fourth side portion 28D.

The elastic member 63 may be disposed closer to the reference line 505 than the third side portion 31c (or the fourth side portion 31d) of the holder 30. For example, the separation distance between the elastic member 63 and the reference line 505 may be smaller than the separation distance between the third side portion 31c (or the fourth side portion 31d) of the holder 30 and the reference line 505.

The elastic member 63 may be disposed closer to the reference line 505 than the first OIS magnets 31A and 31B. For example, the separation distance between the elastic member 63 and the reference line 505 may be smaller than the separation distance between the first OIS magnets 31A and 31B and the reference line 505.

The elastic member 63 may be disposed adjacent to the first rotation axis 501 for tilting the X-axis of the first actuator 320. The elastic member 63 may serve as a pivot for the X-axis tilting of the holder assembly with reference to the first rotation axis 501.

The holder assembly may be tilted using the protrusions 62B1 and 62B2 of the driving plate 61 as the first rotation axis 501, and this is referred to as “X-axis tilting”. The holder assembly may be tilted using the ball members 65B1 and 65B2 as the second rotation axis 502, and this is referred to as “Y-axis tilting”.

In another embodiment, instead of the protrusions 62B1 and 62B2 of the driving plate 61, a groove corresponding to, facing to, or overlapping with the groove 36 of the holder 30 may be formed on the front surface of the driving plate 61, and a separate ball member may be disposed between the groove 36 of the holder 30 and the groove formed on the front surface of the driving plate 61.

In general, since the frictional force when using a ball member is smaller than the frictional force when using the protrusion of the drive plate, the embodiment uses a separate ball member for Y-axis tilting, or separate ball members for X-axis tilting and Y-axis tilting. By using each of them, power consumption for OIS driving can be reduced and OIS performance can be enhanced. In addition, as described above, the elastic member 63 is disposed away from the first OIS coils 230A and 230B, which are sources of electromagnetic force, and disposed close to the first rotation axis 501, so that the embodiment can reduce power consumption and enhance the performance of OIS driving.

Referring to FIG. 101, in order to increase the moment of the holder assembly for Y-axis tilting, the embodiment has a structure in which the separation distance between the elastic member 63 and the second OIS coil 230C, which is a source of electromagnetic force, is increased.

For example, the elastic member 63 may be disposed closer to the second rotation axis 502 than to the second OIS coils 230A and 230B. For example, a separation distance between the elastic member 63 and the second rotation axis 502 may be smaller than a separation distance between the elastic member 63 and the second OIS coil 230C.

In addition, for example, the elastic member 63 may be disposed closer to the second rotation axis 502 than the second OIS magnet 32. For example, a separation distance between the elastic member 63 and the second rotation axis 502 may be smaller than the separation distance between the elastic member 63 and the second OIS coil 230C.

As described above, by disposing the elastic member 63 away from the second OIS coil 230C, which is a source of electromagnetic force, and disposing it close to the second rotation axis 502, the embodiment can reduce power consumption for driving the OIS and enhance the performance of OIS driving.

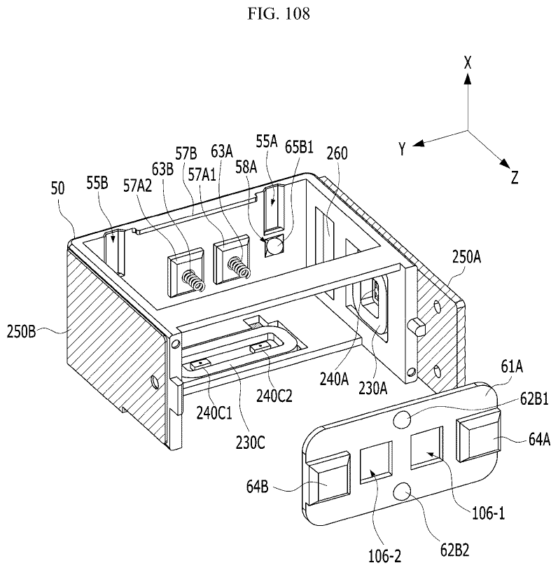

FIG. 108 shows protruding portions 57A1 and 57A2 and a driving plate 611 of the housing 50 according to another embodiment. FIG. 108 may be a modified embodiment of the protruding portion 57A and the driving plate 61 in FIG. 100b.

In FIG. 100b, two elastic units 63A and 63B are disposed on one protruding portion 57, and the drive plate 61 comprises one opening 106 corresponding to one protruding portion 57, however, in FIG. 108, the housing 50 may comprise a plurality of protruding portions 57A1 and 57A2 corresponding to the plurality of elastic units 63A and 63B, respectively. For example, the plurality of protruding portions 57A1 and 57A2 may be disposed spaced apart from each other in a third direction. FIG. 108 illustrates two protruding portions, but in another embodiment, the housing may comprise three or more protruding portions.

In another embodiment, the housing 140 may comprise a plurality of protruding portions being spaced apart in a second direction (X-axis direction), and in each protruding portion, a groove for coupling, inserting, or disposing a portion of one elastic member may also be formed. In another embodiment, the housing 140 may comprise protruding portions in the form of a matrix having a plurality of rows (for example, two) and a plurality of rows (for example, two). Matrix-shaped elastic members corresponding to the protruding portions of the shape may be provided.

A groove into which at least a portion of a corresponding one of the elastic units 63A and 63B is inserted, coupled, or attached may be formed in each of the plurality of protruding portions 57A1 and 57A2.

The driving plate 61 may comprise a plurality of openings 106-1 and 106-2 corresponding to, facing, or overlapping with the plurality of protruding portions 57A1 and 57A2. The number of the plurality of openings 106-1 and 106-2 may be the same as the number of protruding portions 57A1 and 57A2. The plurality of openings 106-1 and 106-2 may be disposed spaced apart from each other in a third direction. Each of the elastic units 63A and 63B may pass through a corresponding any one of the plurality of openings 106-1 and 106-2 of the driving plate 61.

The third embodiment of the present invention shown in FIG. 108 can reduce the opening area of the driving plate 61, thereby increasing the rigidity or durability of the driving plate 61.

In the modified embodiment of FIG. 105, the housing 50 may comprise a plurality of protruding portions being spaced apart in a second direction; the driving plate 61 may comprise a plurality of openings being spaced apart in a second direction and corresponding to a plurality of protruding portions; and the description of FIG. 108 is applied or may be applied mutatis mutandis.

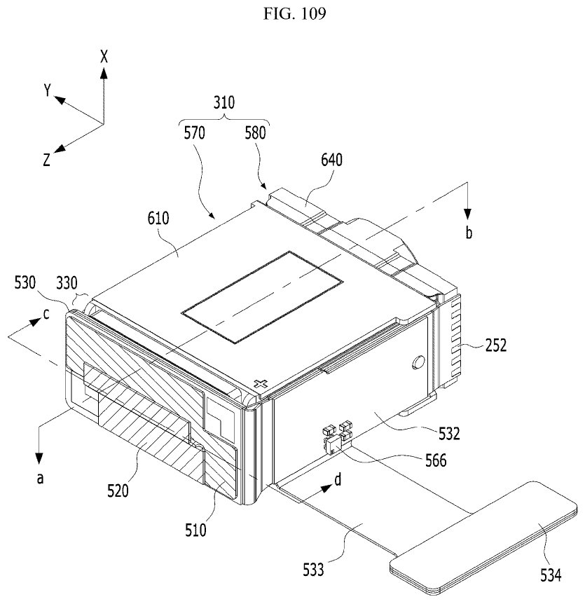

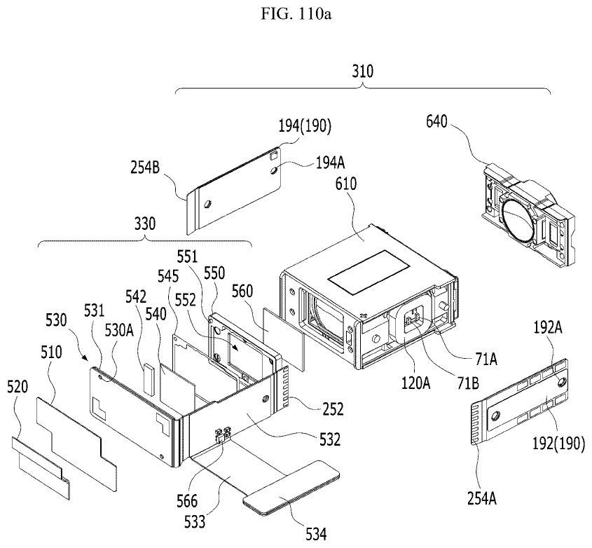

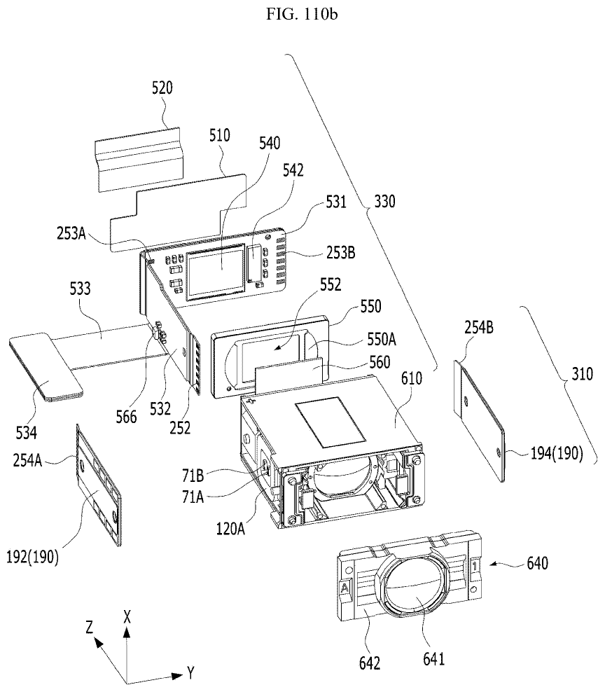

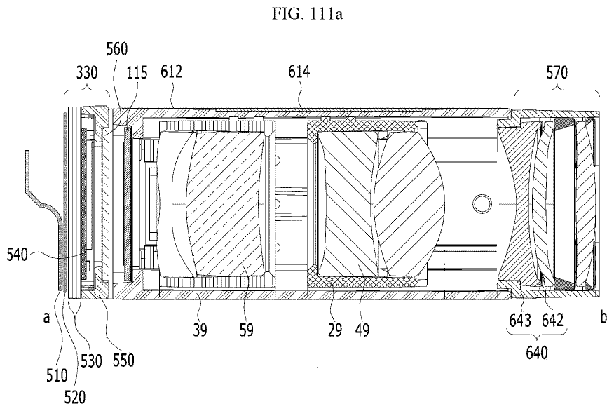

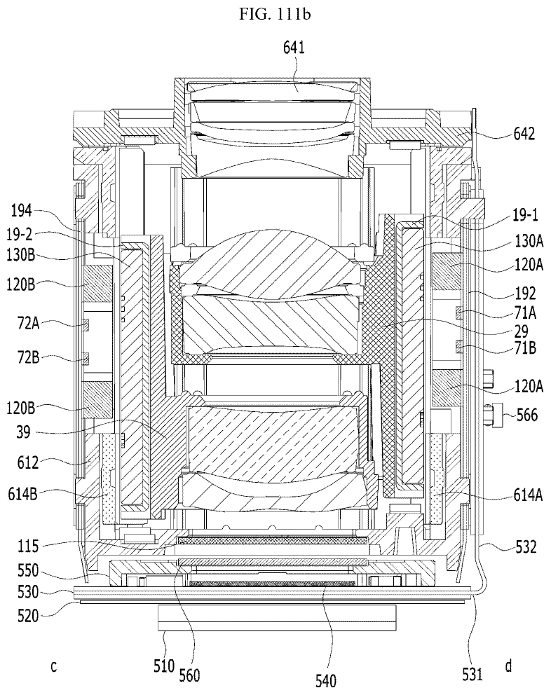

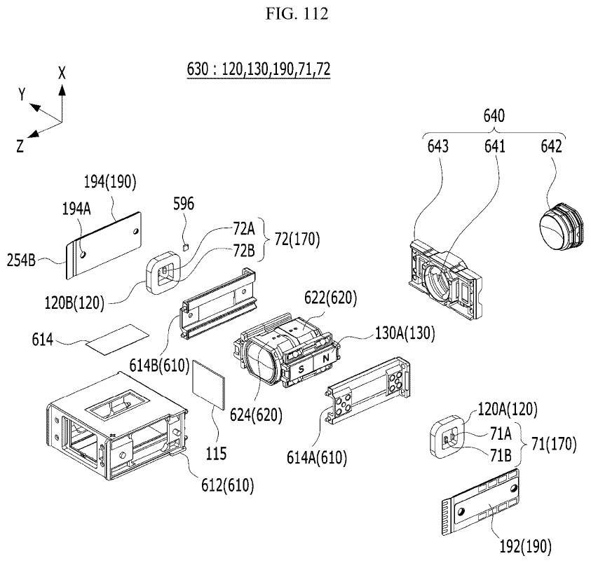

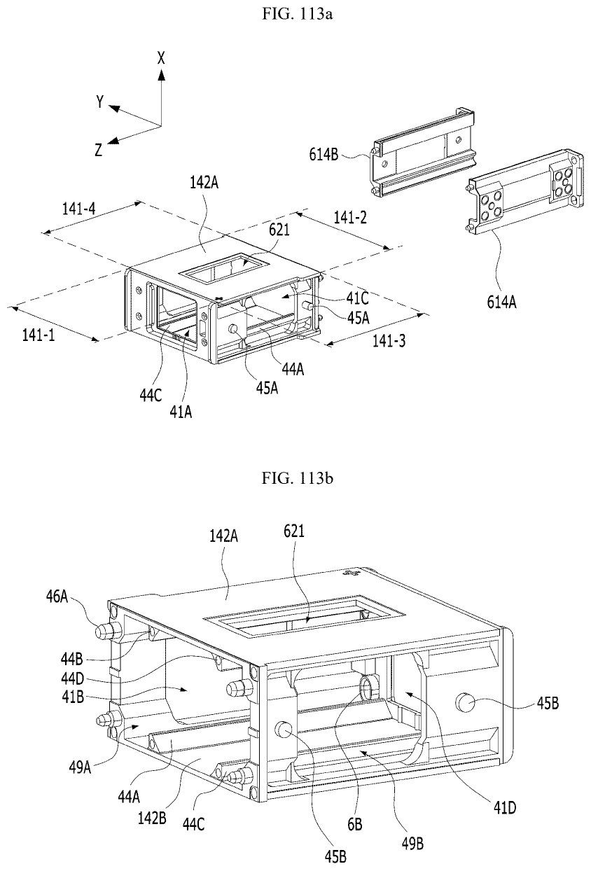

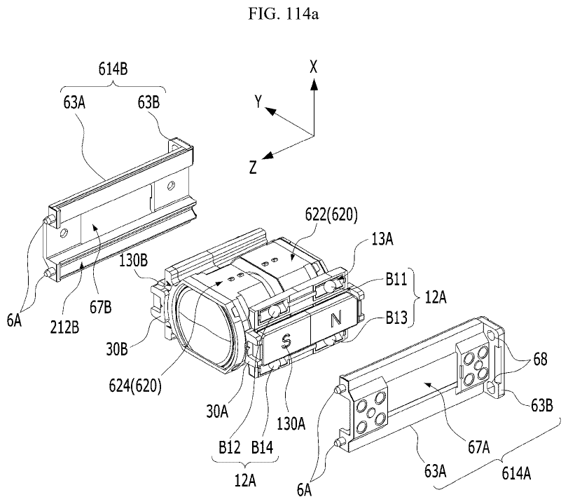

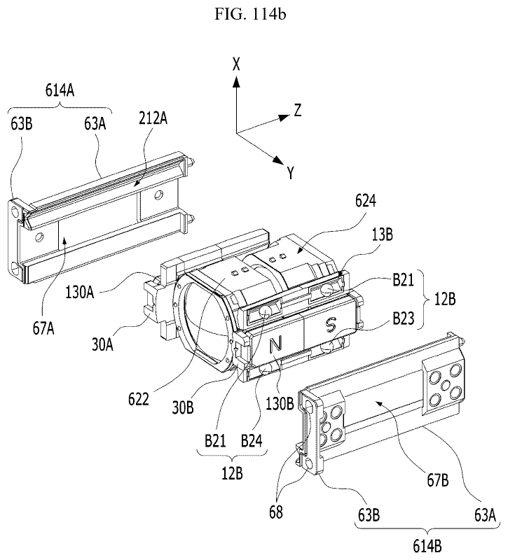

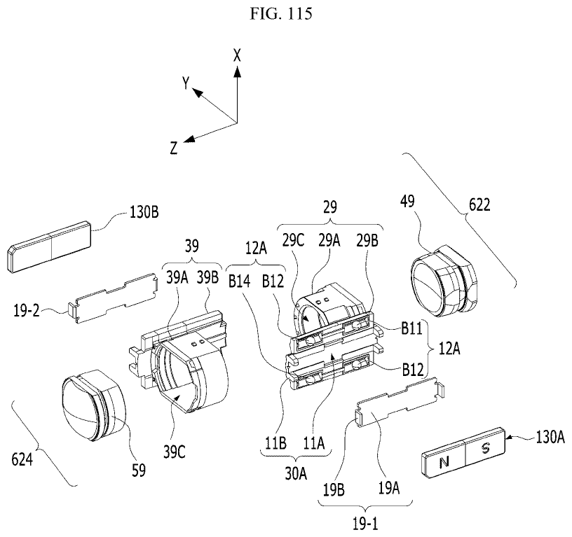

FIG. 109 is a perspective view of a first actuator 310 and an image sensing unit 330 according to a third embodiment of the present invention; FIG. 110a is a first separated perspective view of a first actuator 310 and the image sensing unit 330 of FIG. 109; FIG. 110b is a second separated perspective view of a first actuator 310 and an image sensing unit 330 of FIG. 109; FIG. 111a is a cross-sectional view at line a-b in a first actuator 310 and an image sensing unit 330 of FIG. 109; FIG. 111b is a cross-sectional view at line c-d in a first actuator 310 and an image sensing unit 330 of FIG. 109; FIG. 112 is an exploded perspective view of a first actuator 310; FIG. 113a is an exploded perspective view of a second housing 610; FIG. 113b is a perspective view of a body of a second housing 610; FIG. 114a is a first perspective view of first and second guide units 614A and 614B and a lens part 620; FIG. 114 b is a second perspective view of first and second guide units 614A and 614B and a lens part 620; and FIG. 115 is an exploded perspective view of first and second magnets 130A and 130B and a lens unit 620.

Referring to FIGS. 109 to 115, the first actuator 310 may comprise: a housing 610; a lens unit 620 being disposed inside the housing 610; and a first driving unit 630 that moves the lens unit 620 in a first direction (for example, an optical axis direction or a Z-axis direction).

The lens unit 620 may be expressed by replacing it with a “lens assembly”. For example, the lens unit 620 may comprise a plurality of lens assemblies.

In FIGS. 109 to 115, the lens unit 620 comprises two lens assemblies 622 and 624, but is not limited thereto. For example, the second lens assembly 622 and the third lens assembly 623 may be arranged in a first direction.

The first actuator 310 may further comprise a first lens assembly 640 disposed between the lens unit 620 and the second actuator 320. For example, the first lens assembly 640 may be a fixed lens assembly having a fixed position without moving in an optical axis direction.

The first lens assembly 640 may comprise a first lens array 641 (or a first lens group). For example, the first lens assembly 640 may further comprise a lens barrel 641 being coupled to the first lens array 641. In addition, the first lens assembly 640 may further comprise a third housing 643 being coupled to the lens barrel 641. The third housing 643 may be disposed between the housing 610 and the housing 50 and may be coupled to at least one of the housing 610 and the housing 50.

For example, at least one first coupling hole 643A for coupling with at least one coupling protrusion 46A of the housing 610 may be formed on a front surface of the third housing 643. In addition, a second coupling hole for coupling with at least one coupling protrusion 52A of the housing 50 may be formed on a rear surface of the third housing 643.

The first lens assembly 640 is expressed as being comprised in the first actuator 310, but is not limited thereto, and may be expressed as not being comprised in the first actuator 310. In other embodiments, the first lens assembly 640 may be omitted.

In addition, in another embodiment, any one of 640, 622, and 624 may be expressed as a “first lens assembly”, the other one of 640, 622, and 624 may be expressed as a “second lens assembly”, and the remaining one of 640, 622 and 624 may be expressed as a “third lens assembly”.

For example, in an embodiment, the first lens assembly 640 may be a fixed lens group, and each of the second lens assembly 622 and the third lens assembly 624 may comprise a moving lens group or a lens group.

For example, the first lens assembly 640 may perform a focator function of imaging parallel light at a specific location. In addition, the second lens assembly 622 may perform a variator function of re-imaging an image formed in the first lens assembly 640, which is a focator, in another location. On the other hand, in the second lens assembly 622, the distance to the subject or the image distance is greatly changed so that the magnification can be greatly changed, and the second lens assembly 622, which is a variator, can play an important role in changing the focal length or magnification of the optical system. Meanwhile, a point formed by the second lens assembly 6220, which is a variator, may be slightly different depending on the location.

In addition, the third lens assembly 624 may perform a position compensation function for an image formed by the variator. For example, the third lens assembly 624 may perform a compensator function of accurately forming an image formed by the second lens assembly 622, which is a variator, to a pixel of the image sensor 540.

For example, the second lens assembly 622 may be a zoom lens assembly performing a zooming function, and the third lens assembly 624 may be a focus lens assembly performing a focusing function.

Referring to FIGS. 113a and 113b, the housing 610 may be disposed between the housing 50 and the image sensor unit 330 (for example, the sensor base 550). The housing 610 may also be expressed by replacing it with “base” or a “holder”.

The housing 610 may be disposed inside the cover member 300 and may have a polyhedral (For example, rectangular parallelepiped) shape having a space therein to accommodate the lens unit 620 and the first driving unit 630.

For example, the housing 610 may comprise: an upper portion 142A (or upper plate); a lower portion 142B (or lower plate); and a body 612 comprising a plurality of side portions 141-1 to 141-4 being disposed between the upper portion 142A and the lower portion 142B. The upper portion 142A of the housing 610 may face the upper plate 301 of the cover member 300, and the side portions 141-1 to 141-4 may face the side plate 302 of the cover member 300.

The side portions 141-1 to 141-4 may be expressed by replacing them with “side plates” or “side walls.” For example, the first side portion 141-1 and the second side portion 141-2 may face each other in a first direction or may be positioned opposite to each other, and the third side portion 141-3 and the fourth side portion 141-3 may face each other in a third direction or may be positioned opposite to each other.

A first opening 41A (or a first hole) for exposing one end of the lens unit 620 may be formed in the first side portion 141-1 of the housing 610, and a second opening 41B (or a second hole) for exposing the other end of the lens unit 620 may be formed in the second side portion 141-2 of the housing 610.

In addition, a third opening 41C (or a third hole) for disposing or seating the first coil 120A may be formed in the third side portion 141-3 of the housing 610, and a fourth opening 41C (or a third hole) for disposing or seating the second coil 120B may be formed in the fourth side portion 141-4 of the housing 610. Each of the third and fourth openings 41C and 41D has a penetrating hole shape, but is not limited thereto, and may also have a groove shape.

At least one first coupling protrusion 45A being coupled to the first circuit board 192 of the second substrate unit 190 may be formed on the third side portion 141-3 of the housing 610. For example, at least one first coupling protrusion 45A may be protruded from an outer side surface of the third side portion 141-3.

At least one second coupling protrusion 45B being coupled to the second circuit board 194 of the second substrate unit 190 may be formed on the fourth side portion 141-1 of the housing 610. For example, at least one second coupling protrusion 45B may be protruded from the outer side surface of the fourth side portion 141-4. In addition, at least one third coupling protrusion 46A may be formed on the second side portion 141-2 of the housing 610.

The housing 610 may comprise a first guide unit 614A and a second guide unit 614B. The first guide unit 614A may support and guide the second lens assembly 622 when the lens unit 620 moves by a zooming operation. The second guide unit 614B may support and guide the third lens assembly 624 when the lens unit 620 moves by a zooming operation.

The first guide unit 614A is disposed between the lens unit 620 and the third side portion 141-3, and the second guide unit 614b may be disposed between the lens unit 620 and the fourth side portion 141-4.

For example, the first guide unit 614A may be coupled to the third side portion 141-3 of the housing 610, and the second guide unit 614B may be coupled to the fourth side portion 141-4 of the housing 610.

Referring to FIGS. 114a and 114b, the first guide unit 614A may comprise at least one first guide groove 212A. The second guide unit 614B may comprise at least one second guide groove 212B. Here, the guide groove may be expressed by replacing it with a “rail” or “groove” instead.

For example, each of the first guide unit 614A and the second guide unit 614B may comprise a body 63A and a protruding portion 63B being extended and protruded from the body 63A.

For example, the first guide groove 212A may be formed on an inner side surface of the body 63A of the first guide unit 614A, and the second guide groove 212B may be formed on an inner side surface of the body 63A of the second guide unit 614B. At this time, an inner side surface of the body 63A of each of the first and second guide units 614A and 614B may be a surface facing the lens unit 620.

In FIGS. 114a and 114b, one first guide groove 212A is formed on a lower side of the inner side surface of the body 63A of the first guide unit 614A, and one second guide groove 212B is formed on an upper side of the inner side surface of the body 63A of the guide unit 614B, but is not limited thereto. In another embodiment, a guide groove may be formed on at least one of upper and lower sides of the inner side surface of the body of each of the first and second guide grooves. For example, each of the first and second guide grooves 212A and 212B may be continuously formed from the front end to the rear end of the inner side surface of the body 64A.

The protruding portion 63B of each of the first guide unit 614A and the second guide unit 614B may be protruded by being extended in a direction perpendicular (For example, a third direction) to a direction in which the first and second guide grooves are extended (For example, a first direction). For example, the protruding portion 63B of the first guide unit 614A and the protruding portion 63B of the second guide unit 614B may be protruded in opposite directions. For example, the protruding portion 63B may be formed on a rear surface or rear end of each of the first guide unit 614A and the second guide unit 614B.

At least one hole 68 to be coupled to the rear end of the body 612 of the housing 610 may be formed in the protruding portion 63B of each of the first and second guide units 614A and 614B. For example, the hole 68 of the protruding portion 63B may be coupled with the protrusion 46A of the body 612 of the housing 610. For example, the coupling protrusion 46A may pass through the hole 68 of the protruding portion 63B and be coupled to the first coupling hole 643A of the third housing 643.

At least one coupling protrusion 6A being coupled to the body 612 of the housing 610 may be formed on the front surface or front end of each of the first guide unit 614A and the second guide unit 614B. For example, on an inner surface of the body 612 of the housing 610, a coupling hole 6B being coupled with the coupling protrusion 6A of the first and second guide units 614A and 614B may be formed (see FIG. 105B).

Referring to FIG. 113b, guide protrusions 44A to 44D for guiding the first and second guide units 614A and 614B may be formed on an inner surface of the body 612 of the housing 610. For example, the first guide protrusion 44A may be disposed on an inner surface of the lower portion 142B of the housing 610, and the second guide protrusion 44B may be disposed on an inner surface of the upper portion 142A of the housing 610 to correspond to the first guide protrusion 44A in a second direction. The first guide unit 614A may be disposed inside the space 49A between the first and second guide protrusions 44A and 44B and the third side portion 141-3 of the housing 610.

In addition, for example, the third guide protrusion 44C may be disposed on an inner surface of the lower portion 142B of the housing 610, and the fourth guide protrusion 44D may be disposed on an inner surface of the upper portion 142A of the housing 610 to correspond to the third guide protrusion 44C in a second direction. The second guide unit 614B may be disposed in the space 49B between the third and fourth guide protrusions 44C and 44D and the fourth side portion 141-4 of the housing 610.

The first and second guide units 614A and 614B can be stably coupled to the body of the housing 610 by the first to fourth guide protrusions 44A to 44D, and may inhibit the first and second guide units 614A and 614B from being separated from their original positions or from colliding with the lens unit 620 due to an impact or the like.

The first guide unit 614A may have a first opening 67A (or hole) corresponding to, facing, or overlapping with the first magnet 130A. For example, the first opening 67A may be positioned between the first magnet 130A and the first coil 120A.

The second guide unit 614B may have a second opening 67B (or hole) corresponding to, facing, or overlapping with the second magnet 130B. For example, the first opening 67B may be positioned between the second magnet 130B and the second coil 120B. The electromagnetic force due to the interaction between the first magnet 130A and the first coil 120A and the electromagnetic force due to the interaction between the second magnet 130B and the second coil 120B can be increased by the first and second openings 67A and 67B.

In FIGS. 113a and 113b, although the first and second guide units 614A and 614B and the body 612 of the housing 610 are formed as separate injection molding materials, and the separate objects are coupled with each other, but is not limited to this. In another embodiment, the first and second guide units may be formed as a single injection molding material with the body of the second housing.

An opening 621 exposing a portion of the lens unit 620 may be formed in the upper portion 142A of the body 612 of the housing 610, and the housing 610 may further comprise a cover 614 covering the opening 621. In other embodiments, the opening 621 may not be formed and the cover 614 may be omitted.

The lens unit 620 may comprise a second lens assembly 622 moving along the first guide unit 614A and a third lens assembly 624 moving along the second guide unit 614B.

Referring to FIGS. 114a, 114b, and 115, the second lens assembly 622 may comprise a first lens holder 29 and a second lens array 49 (or a second lens group) being disposed in the first lens holder 29. A lens holder may be expressed by replacing it with a “bobbin”.

The second lens array 49 may comprise a single lens or a plurality of lenses.

The first lens holder 29 may comprise a first lens barrel 29A on which the second lens array 49 is disposed and a first support portion 29B being coupled to the first lens barrel 29A. For example, the first lens barrel 29A may have a barrel shape and may comprise an opening 29C (or a hole) through which the second lens array 49 is coupled.

A first side surface (or first surface) of the first support portion 29B may be coupled to the first lens barrel 29A. The first support portion 29B may correspond to, face, or overlap with the body 63A of the first guide unit 614A in a third direction.

A first seating portion 30A for disposing or seating the first magnet 130A may be formed on a second side surface (or second surface) of the first support portion 29B. The second side surface (or second surface) of the first support portion 29B may be a surface facing the first guide unit 614A, and may be a surface opposite to a first side surface (or first surface) of the first support portion 29B.

For example, the first seating portion 30A may comprise: a first seating surface 11A being formed in one region (for example, a central region) of the second side surface (or second surface) of the first support portion 29B; and at least one first support protrusion 11B being protruded from the first seating surface 11A. In FIG. 107, the first seating portion 30A comprises four first support protrusions being formed at four corners of the second side surface of the first support portion 29B, and the four first support protrusions may support the first magnet 130A. In another embodiment, the number of first support protrusions of the first seating portion may be one or two or more.

The first support portion 29B may comprise at least one first groove 13A (or first guide groove) for accommodating at least a portion of the first rolling member 12A. For example, the at least one first groove 13A may correspond to, face, or overlap with the at least one first guide groove 212A of the first guide unit 614A.

For example, two first grooves being spaced apart from each other may be formed on the seating surface 11A of the first seating portion 30A, and two first grooves being spaced apart from each other may be formed below the seating surface 11B. In another embodiment, two grooves formed above or below the seating surface 11B may be connected to each other to form one groove. For example, the number of grooves may match the number of balls B11 to B14, but is not limited thereto.

The third lens assembly 624 may comprise a second lens holder 39 and a third lens array 59 (or a third lens group) being disposed in the second lens holder 39. The third lens array 59 may comprise a single lens or a plurality of lenses.

A plurality of lenses comprised in each of the second and third lens arrays 49 and 59 may be sequentially disposed or arranged in a first direction. For example, each of the second and third lens arrays 49 and 59 may comprise various types of optical lenses. For example, each of the second and third lens arrays 49 and 59 may comprise at least one of a front lens having positive power and a rear lens having negative power.

The distance between the second lens group and the third lens group in an optical axis direction may be varied by the first driving unit 630.

The second lens holder 39 may comprise a second lens barrel 39A on which the third lens array 59 is disposed and a second support portion 39B being coupled to the second lens barrel 39A. For example, the second lens barrel 39A may have a barrel shape and may comprise an opening 39C (or a hole) through which the second lens array 49 is coupled.

A first side surface (or first surface) of the second support portion 39B may be coupled to the second lens barrel 39A. The second support portion 39B may correspond to, face, or overlap with the body 63A of the second guide unit 614B in a third direction.

A second seating portion 30B for disposing or seating the second magnet 130B may be formed on a second side surface (or second surface) of the second support portion 39B. The second side surface (or second surface) of the second support portion 39B may be a surface facing the second guide unit 614B, and may be a surface opposite to the first side surface (or first surface) of the second support portion 39B.

For example, the second seating portion 30B may comprise: a second seating surface being formed in one region (for example, the central region) of the second side surface (or second surface) of the second support portion 39B; and at least one second support protrusion being protruded from the second seating surface. Description of the first seating surface 11A and the first support protrusion 11B of the first support portion 29B may be applied or applied mutatis mutandis to the second seating surface and the second support protrusion of the second support portion 29B. The second support portion 39B may comprise at least one second groove 13B (or second guide groove) for accommodating at least a portion of the second rolling member 12B. For example, the at least one second groove 13B may correspond to, face, or overlap with the at least one second guide groove 212B of the second guide unit 614B. Description of the first groove 13A of the first support portion 30A may be applied or applied mutatis mutandis to the second groove 13B of the second support portion 30B.

Each of the first and second guide grooves 212A and 212B and the first and second grooves 13A and 13B may have a V or U shape, but is not limited thereto, and may be a shape in which two or more points come into contact with the balls B11 to B14 and B21 to B24. By the first and second guide grooves 212A and 212B and the first and second grooves 13A and 13B, when the second and third lens assemblies 622 and 624 move, decenter or tilt may be inhibited. Due to this, since the alignment between the pluralities of lens arrays is well matched, the change in the angle of view or defocusing is inhibited so that the image quality or resolution of the camera device 200 can be remarkably enhanced.

The first actuator 310 may further comprise rolling members 12A and 12B being disposed between the housing 610 and the lens unit 620. For example, the rolling members 12A and 12B may be disposed between the guide units 614A and 614B of the housing 610 and the grooves 13A and 13B of the support portions 39A and 39B of the lens unit 620.

A rolling member may be expressed by replacing it with a “ball member”, “ball” or “ball bearing.” For example, the rolling members 12A and 12B may comprise at least one ball.

The rolling members 12A and 12B may be in contact with the housing 610 and the lens unit 620 and may support the lens unit 620. When the lens unit 620 moves in a first direction, the rolling members 12A and 12B perform a rolling motion between the lens unit 620 and the housing 610, thereby reducing the friction between the lens unit 620 and the housing 610. That is, by the rolling motion of the rolling members 12A and 12B, the lens unit 620 becomes in contact with the rolling members 12A and 12B, and may be moved in a first direction along the first and second guide units 614A and 614B.

For example, the rolling member may comprise a first rolling member 12A and a second rolling member 12B. The first rolling member 12A may be disposed between the first guide unit 614A of the housing 610 and the second lens assembly 622 (for example, the first support portion 29B). The second rolling member 12B may be disposed between the second guide unit 614B of the housing 610 and the third lens assembly 624 (for example, the second support portion 39B). The first rolling member 12A may comprise a plurality of balls B11 to B14, and the second rolling member 12B may comprise a plurality of balls B21 to B24. Each of the balls B11 to B14 and B221 to B24 may be made of metal, plastic, or resin, but is not limited thereto. Each of the balls B11 to B14 and B221 to B24 may have a circular shape and may have a diameter of a sufficient size to support the movement of the lens unit 620.

Next, the first driving unit 630 will be described.

The first driving unit 630 may move the second lens assembly 622 in a first direction and may move the third lens assembly 624 in a first direction. For example, the first driving unit 630 may move at least one lens group, for example, the second lens group or the third lens group, in a first direction or an optical axis direction.

The first driving unit 630 may comprise a magnet 130 being disposed in the lens unit 620 and a coil 120 being disposed in the housing 610. For example, the magnet 130 may comprise a first magnet 130A being disposed in the second lens assembly 622 and a second magnet 130B being disposed in the third lens assembly 624.

For example, the first magnet 130A may be disposed in the first lens holder 29 of the second lens assembly 622, and the second magnet 130B may be disposed in the second lens holder 39 of the third lens assembly 624. For example, the first magnet 130A may be disposed in the first seating portion 30A of the first support portion 29B of the first lens holder 29, and the second magnet 130B may be disposed in the second seating portion 30B of the second support portion 39B of the second lens holder 39.

For example, each of the first and second magnets 130A and 130B may be a monopole magnetized magnet comprising one N pole and one S pole. In another embodiment, each of the first and second magnets 130A and 130B may be a two pole magnetized magnet comprising two N poles and two S poles.

The coil 120 may comprise: a first coil 120A that corresponds to, faces, or overlaps with the first magnet 130A in a third direction and is disposed in the third side portion 142-3 of the housing 610; and a second coil 120B that corresponds to, faces, or overlaps with the second magnet 130B in a third direction and is disposed in the fourth side portion 142-4 of the housing 610.

For example, each of the first coil 120A and the second coil 120B may have a closed curve or ring shape having a hollow (or hole). For example, each of the first coil 120A and the second coil 120B may be coiled in a clockwise or counterclockwise direction with respect to (or centered on) a third axis parallel to a third direction.

For example, the N pole and S pole of the first magnet 130A may be disposed to face the first coil 120A and the N pole and S pole of the second magnet 130B may be disposed to face the second coil 120B. For example, the hollow or hole of each of the first and second coils 120A and 120B may face the first and second magnets 130A and 130B in a third direction.

A first driving signal (For example, a first current) may be applied to the first coil 120A, and a second driving signal (For example, a second current) may be applied to the second coil 120B.

The first lens assembly 622 may be moved in a first direction by the electromagnetic force generated by the interaction between the first coil 120A and the first magnet 130A. In addition, the second lens assembly 624 may be moved in a first direction by the electromagnetic force generated by the interaction between the second coil 120B and the second magnet 130B.

The movement of each of the first lens assembly 622 and the second lens assembly 624 may be controlled by controlling the first driving signal and the second driving signal. As the movement of each of the first lens assembly 622 and the second lens assembly 624 is controlled, the position (or displacement) of each of the first lens assembly 622 and the second lens assembly 624 may be controlled, and due to this, zooming and auto focusing of the camera device 200 may be performed.

Referring to FIG. 115, the first driving unit 630 may further comprise a first yoke 19-1 being disposed on the first lens holder 29 and a second yoke 19-2 being disposed on the second lens holder 39. The first yoke 19-1 may increase the electromagnetic force due to the interaction between the first magnet 130A and the first coil 120A, and the second yoke 19-2 may increase electromagnetic force due to interaction between the second magnet 130B and the second coil 120B. A driving force for moving the lens unit 620 may be enhanced by the first and second yokes 19-1 and 19-2, thereby reducing power consumption.

For example, the first yoke 19-1 may be disposed between the first magnet 130A and the first lens holder 29, and the second yoke 19-2 may be disposed between the second magnet 130B and the second lens holder 39. For example, the first yoke 19-1 may be disposed in the first seating portion 30A of the first support portion 29B, and the second yoke 19-2 may be disposed in the second seating portion 30B of the second support portion 39B.

For example, the first yoke 19-1 may comprise: a first portion 19A facing the first magnet 130A in a third direction and being disposed on the first seating surface 11A; and a second portion 19B being extended from at least one of one end and the other end of the first portion 19A. For example, the second part 19B may comprise: a second-first portion supporting one end of the first magnet 130A; and a second-second portion supporting the other end of the first magnet 130A.

The first driving unit 630 may further comprise a second substrate unit 190 being electrically connected to the first coil 120A and the second coil 120B. For example, the second substrate unit 190 may be a printed circuit board.

The second substrate unit 190 may be disposed in the housing 610. For example, the second substrate unit 190 may comprise: a first circuit board 192 being disposed on the third side portion 142-3 of the housing; and a second circuit board 194 being disposed on the fourth side portion 142-4 of the housing 610. For example, the first circuit board 192 may comprise at least one hole 192A for coupling with at least one first coupling protrusion 45A of the housing 610, and the second circuit board 194 may comprise at least one hole 194A to be coupled with at least one second coupling protrusion 45B of the housing 610.

The first coil 120A may be disposed or mounted on a first surface of the first circuit board 192. At this time, the first surface of the first circuit board 192 may be a surface facing the third side portion 142-3 of the housing 610 in a third direction. The second coil 120B may be disposed or mounted on a first surface of the second circuit board 194. At this time, the first surface of the second circuit board 194 may be a surface facing the fourth side portion 142-4 of the housing 610 in a third direction.

The first circuit board 192 may be electrically connected to the first coil 120A. For example, two pads being electrically connected to the first coil 120A may be formed on the first surface of the first circuit board 192. In addition, the first circuit board 192 may comprise a plurality of terminals 254A. For example, the plurality of terminals 254A may be formed on a second surface of the first circuit board 192. For example, the second surface of the first circuit board 192 may be the opposite surface of the first surface of the first circuit board 192. For example, two terminals among the plurality of terminals 254A may be electrically connected to two pads of the first circuit board 192 being connected to the first coil 120A, and may be electrically connected to the first coil 120A.

The second circuit board 194 may be electrically connected to the second coil 120B. For example, two pads being electrically connected to the second coil 120B may be formed on a first surface of the second circuit board 194. In addition, the second circuit board 194 may comprise a plurality of terminals 254B.

For example, the plurality of terminals 254b may be formed on a second surface of the second circuit board 194. For example, the second surface of the second circuit board 194 may be the opposite surface of the first surface of the circuit board 192. Although the terminal 254b cannot be seen in detail in FIG. 112, terminals 254B may be formed on a second surface of the second circuit board 194 in the same form as the terminals 254a of the first circuit board 192.

For example, two among the plurality of terminals 254B may be electrically connected to two pads of the second circuit board 194 being connected to the second coil 120B, and may be electrically connected to the second coil 120B.

The second driving unit 70 may comprise a first position sensor unit 170 for performing feedback driving for precise zooming and AF operations.

The first position sensor unit 170 may comprise: a first position sensor unit 71 for detecting the position or displacement of the second lens assembly 622; and a second position sensor unit 72 for detecting the position or displacement of the third lens assembly 624.

For example, the first position sensor unit 71 may be disposed or mounted on the first circuit board 192 and may be electrically connected to the first circuit board 192. The second position sensor unit 72 may be disposed or mounted on the second circuit board 194 and may be electrically connected to the second circuit board 194.

For example, the first position sensor unit 71 may be disposed or mounted on a first surface of the first circuit board 192, and the second position sensor unit 72 may be disposed or mounted on a first surface of the second circuit board 194. For example, the first position sensor unit 71 may be disposed in a hollow of the first coil 120A, and the second position sensor unit 72 may be disposed in a hollow of the second coil 120B.

For example, the first position sensor unit 71 may face or overlap with the first magnet 130A in a third direction. For example, the first position sensor unit 71 may be disposed at an opposite side of the first magnet 130A.

The strength of the magnetic field of the first magnet 130A may be detected. For example, the first position sensor unit 71 may detect the movement of the first magnet 130A in an optical axis direction.

The second position sensor unit 72 may face or overlap with the second magnet 130B in a third direction. For example, the second position sensor unit 72 may be disposed at an opposite side of the second magnet 130B.

The strength of the magnetic field of the second magnet 130B may be detected. For example, the second position sensor unit 72 may detect the movement of the second magnet 130B in an optical axis direction.

For example, the first position sensor unit 71 may comprise a first sensor 71A and a second sensor 71B. For example, each of the first and second sensors 71A and 71B may be a Hall sensor. For example, the first sensor 71A and the second sensor 71B may be disposed spaced apart from each other in a first direction.

For example, the second position sensor unit 72 may comprise a third sensor 72A and a fourth sensor 72B. For example, each of the third and fourth sensors 72A and 72B may be a Hall sensor. For example, the third sensor 72A and the fourth sensor 72B may be disposed spaced apart from each other in a first direction.

In FIG. 112, each of the first position sensor unit 71 and the second position sensor unit 72 comprises two sensors, but in another embodiment, each of the first position sensor unit and the second position sensor unit may comprise one sensor, and at this time, one sensor may be a Hall sensor or a driver IC containing a Hall sensor.

The camera device 200 may comprise a memory 596 being disposed in the second substrate unit 190. For example, the memory 596 may be a non-volatile memory, for example, an electrically erasable PROM (EEPROM).

For example, the memory 596 may be disposed or mounted on the second circuit board 194 and may be electrically connected to the second circuit board 194. For example, the memory 596 may store data necessary for driving the driving unit. At this time, driving unit may comprise at least one of the first driving unit 630 and the second driving unit 70. For example, the memory 596 may store at least one of: data of the first position sensor unit 71 corresponding to the movement range of the second lens group; and data of the second position sensor unit 72 corresponding to the movement range of the third lens group.

At this time, the data of the first position sensor unit 71 may be data (or reference code value) related to the output of the first position sensor unit 71 corresponding to the movement range of the second lens group acquired through calibration. In addition, the data of the second position sensor unit 72 may be data (or reference code value) related to the output of the second position sensor unit 72 corresponding to the movement range of the third lens group acquired through calibration.

In addition, the memory 596 may store data of the first OIS position sensors 240A and 240B corresponding to the second axis (X-axis) tilting range of the OIS movable unit. At this time, the data of the first OIS position sensor 240A and 240B may be a reference code value related to the output of the first OIS position sensors 240A and 240B corresponding to the tilting range of the second axis (X-axis) of the OIS movable unit obtained through calibration.

In addition, the memory 596 may store data of the second OIS position sensor 240C corresponding to the third axis (Y-axis) tilting range of the OIS movable unit. At this time, the data of the second OIS position sensor 240C may be a reference code value related to the output of the second OIS position sensor 240C corresponding to the third axis (Y-axis) tilting range of the OIS movable unit obtained through calibration. For example, the memory 596 may be electrically connected to at least one terminal among the plurality of terminals 254B of the second circuit board 194.

The camera device 200 may further comprise a temperature sensor 566 being disposed on the second substrate unit 190. For example, the temperature sensor 566 measures the camera device 200 or the temperature around the camera device 200 and may output temperature information according to the measured result.

Referring to FIG. 112, the first actuator 310 may further comprise a glass 115 being disposed in front of the lens unit 620. For example, the glass 115 may be disposed inside the housing 610 to cover the first opening 41A of the housing 610, protect the lens unit 620, and inhibit foreign substances from entering the second housing.

The image sensing unit 330 may comprise an image sensor 540 for receiving and detecting light passing through the optical member 40 of the second actuator 320 and the lens assemblies 311, 312, and 313 of the first actuator 310 and converting the detected light into an electrical signal. For example, the image sensor 540 may comprise an imaging region for detecting light. Here, the imaging region may be expressed by replacing it with an effective region, a light-receiving region, or an active area. For example, an imaging region may comprise a number of pixels from which an image is formed.

The image sensing unit 330 may comprise a third substrate unit 530 being electrically connected to the image sensor 540. The third substrate unit 530 may be disposed spaced apart from the housing 610. For example, the third substrate unit 530 may be expressed by replacing it with a sensor substrate unit.

With respect to the housing 610, the first substrate unit 250 may be disposed in front of the housing 610, and the third substrate unit 530 may be disposed in the rear of the housing 610, and the second substrate unit 190 may be disposed at the side of the housing 610.

For example, the second substrate unit 190 may be disposed on a first side (for example, left or right) of the housing 610. For example, the first circuit board 192 may be disposed on a first side of the housing 610, and the second circuit board 192 may be disposed on a third side of the housing 610. The third substrate unit 530 may be disposed on a second side (for example, rear) of the housing 610. In addition, the first substrate unit 250 may be disposed on a fourth side of the housing 610. The first side and the third side may be positioned opposite each other, and the second side and the fourth side may be positioned opposite each other.

The third substrate unit 530 may comprise a first substrate 531 on which the image sensor 540 is disposed or mounted. For example, the image sensor 540 may be disposed on a first surface of the first substrate 531, and the first surface of the first substrate 531 may be a surface facing the first actuator 310 or the lens unit 620. The first substrate 531 may be expressed by replacing it with a “sensor substrate”.

The first substrate 531 may comprise a plurality of first terminals 253A and a plurality of second terminals 253B. For example, the plurality of first terminals 253A may be disposed between the image sensor 540 and the first end portion of the first substrate 531, and the plurality of second terminals 253B may be disposed between the image sensor 540 and the second end portion of the first substrate 531. The first end portion may be positioned at an opposite side of the second end portion.

For example, the plurality of first terminals 253A may correspond to, face, or overlap with the plurality of terminals 254A of the first circuit board 192 in a first direction, and may be electrically connected to the plurality of terminals 254A of the first circuit board 192 by solder or conductive adhesive.

For example, to facilitate solder bonding, the end portion (or first end) or terminal portion of the first circuit board 192 where the plurality of terminals 254A are formed may comprise a bent or curved portion. For example, the terminal portion of the first circuit board 192 on which the plurality of terminals 254A are formed may be an inwardly curved or bent inclined portion.

For example, the plurality of second terminals 253B may correspond to, face, or overlap with the plurality of terminals 254B of the second circuit board 194 in a first direction, and may be electrically connected to the plurality of terminals 254B of the second circuit board 194 by solder or conductive adhesive.

For example, to facilitate solder bonding, the end portion (or first end) or terminal portion of the second circuit board 194 on which the plurality of terminals 254B is formed may comprise a bent or curved portion. For example, the terminal portion of the second circuit board 194 on which the plurality of terminals 254B is formed may be an inwardly curved or bent inclined portion.

The third substrate unit 530 may comprise a second substrate 532 being connected to the first substrate 531 and extended in a first direction. The second substrate 532 may comprise a plurality of terminals 252. The first substrate unit 250 may be electrically connected to the third substrate unit 530. For example, the plurality of terminals 252 of the second substrate 532 may be electrically connected to the plurality of terminals 251 of the first circuit board 250A of the first substrate unit 250 by a conductive adhesive or solder.

For example, referring to FIGS. 109, 110a, and 110b, the second board 532 may be disposed to face the first circuit board 192 in a third direction, and may be disposed on a second surface of the first circuit board 192. For example, the third substrate unit 530 may comprise a bent portion between the first substrate 532 and the second substrate 532.

The third substrate unit 530 may comprise a connector 534 comprising a port or socket for electrical connection with an external device. For example, the port or socket may be formed on at least one of an upper portion (upper surface) or a lower portion (lower surface) of the connector.

In addition, the third substrate unit 530 may further comprise a third substrate 533 connecting the second substrate 532 and the connector 534 to each other. The third substrate unit 530 may be a printed circuit board. For example, each of the first to third substrates 531, 532, and 533 may comprise at least one of a rigid substrate and a flexible substrate.

In another embodiment, at least one of the second board 532 and the connector 534 may be omitted, and the port or socket may be formed on the first board. In another embodiment, the port or socket may be formed on at least one of the first to third substrates.

The image sensing unit 330 may further comprise a first driver 542 disposed on the third substrate unit 530. The first driver 542 may be disposed or mounted on the first board 531. For example, the first driver 542 may be disposed between the image sensor 540 and the plurality of second terminals 253B. Each of the first driver 542 and the second driver 260 may be expressed by replacing it with a “control unit”. In addition, for example, each of the first and second drivers 542 and 260 may comprise a storage unit or memory.

The third substrate unit 530 may comprise a circuit element, a passive element, an active element, or a circuit pattern.

The image sensing unit 330 may further comprise: a sensor base 550 being disposed between the third substrate unit 530 and the first actuator; and a filter 560 being disposed on sensor base 550. For example, the sensor base 550 may be disposed between the first substrate 531 of the third substrate unit 530 and the housing 610.

The sensor base 550 may be coupled, attached, or fixed to the first surface of the first substrate 531 by the adhesive 545. A lower portion or lower surface of the sensor base 550 may be coupled to a first surface of the first substrate 531 by the adhesive 545.

For example, at least one coupling protrusion 551 may be formed on a bottom surface or a lower end of the sensor base 550, and at least one hole 530A for coupling with at least one coupling protrusion 551 may be formed in the first substrate 531.

The sensor base 550 may comprise a seating portion 550A for disposing or seating the filter 610 thereon. For example, the seating portion 550A may be formed on a first surface of the sensor base 550. The first surface of the sensor base 550 may be a surface facing the housing 610 in a first direction. For example, the seating portion 500A may be in the form of a recess, cavity, or hole depressed from the first surface of the sensor base 550, but is not limited thereto. In another embodiment, the seating portion may be in the form of a protruding portion being protruded from the first surface of the sensor base 550. The sensor base 550 may be expressed by replacing it with a “holder”.

The filter 560 is disposed on the seating portion 550A of the sensor base 550. For example, the seating portion 550A of the sensor base 550 may comprise an inner side surface and a bottom surface, and the filter 560 may be disposed on the bottom surface of the seating portion 500A of the sensor base 550.

The sensor base 550 may comprise an opening 552 (or a penetrating hole) so that light passing through the filter 560 may be incident to the image sensor 540. The opening 552 may correspond to, face, or overlap with the image sensor 550 (for example, an imaging region). For example, the opening 552 may be formed on the bottom surface of the seating portion 550A. The area of the opening 552 may be smaller than the area of the upper or lower surface of the filter 560, but is not limited thereto.

The filter 560 may serve to block light of a specific frequency band from entering the image sensor 540 from light passing through the lens unit 620. For example, the filter 560 may be an infrared cut filter, but is not limited thereto. For example, the filter 560 may be disposed parallel to an X-Y plane perpendicular to the first direction. For example, the filter 560 may be attached to a bottom surface of the seating portion 550A of the sensor base 550 by an adhesive member (not shown) such as UV epoxy. The filter 560 and the image sensor 540 may be disposed spaced apart from each other so as to face each other in a first direction.

The image sensing unit 330 may further comprise a reinforcing member 510 being disposed on the third substrate unit 530. For example, the reinforcing material 510 may be disposed on a second surface of the first substrate 531, and the second surface of the first substrate 531 may be a surface opposite to the first surface of the first substrate 531.

The reinforcing member 510 may be formed of a conductive material having high thermal conductivity, for example, a metal material. For example, the reinforcing material 510 may be formed of SUS, aluminum, or the like, but is not limited thereto.

In addition, the reinforcing member 510 may also serve as a ground to protect the camera device 200 from electrostatic discharge protection (ESD) by being electrically connected to the ground terminal of the third substrate unit 530.

The image sensing unit 330 may further comprise a heat dissipation member 520 disposed on or attached to the reinforcing member 510. For example, the heat dissipation member 52 may be attached to at least one of the first substrate 531 and the reinforcing member 510 and may perform a heat dissipation function.

The third embodiment of the present invention of FIGS. 109 to 115 comprises a zoom lens assembly 622 performing a zoom function and a focus lens assembly 624 performing an auto focus function, but in other embodiments, the zoom lens assembly 622 may be omitted and may comprise a focus lens assembly 624. For example, the first actuator according to another embodiment may be a fixed zoom actuator that performs an auto focus function.

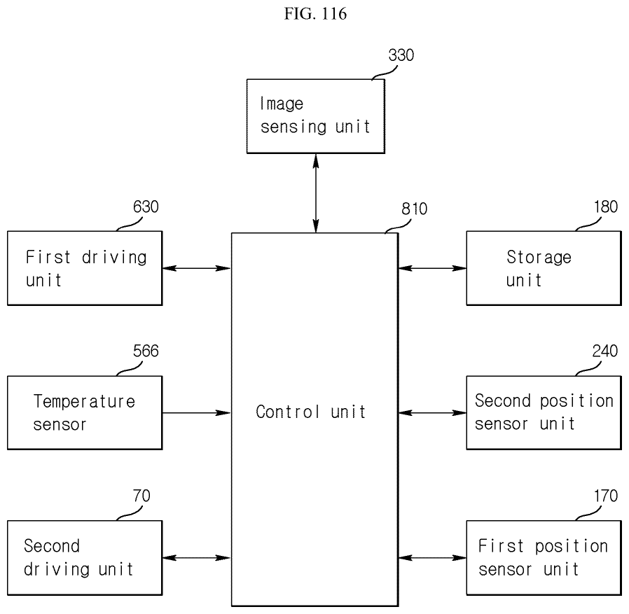

FIG. 116 is a functional block diagram of a camera device 200 according to a third embodiment of the present invention.

Referring to FIG. 116, the camera device 200 may comprise: a first driving unit 630; a second driving unit 70; a first position sensor unit 170; a second position sensor unit 240; a storage unit 180; an image sensing unit 600; and a control unit 810.

The first driving unit 630 receives the first driving signal, applies the received first driving signal to the first coil 120A, and moves the second lens assembly 622 in a first direction by the interaction between the first coil 120A and the first magnet 130A.

In addition, the first driving unit 630 receives the second driving signal, applies the received second driving signal to the second coil 120B, and moves the third lens assembly 624 in a first direction by the interaction between the second coil 120B and the second magnet 130B.

The second driving unit 70 receives the first OIS driving signal, applies the received first OIS driving signal to the first OIS coils 230A and 230B, and rotates the OIS moving unit (For example, holder 30) by the interaction between the first OIS coils 230A and 230B and the first OIS magnets 31A and 31B by a preset angle about the second axis (For example, X-axis) as a rotation axis.

In addition, the second driving unit 70 receives the second OIS driving signal, applies the received second OIS driving signal to the second OIS coil 230C, and rotates the OIS moving unit (For example, holder 30) by the interaction between the second OIS coil 230C and the second OIS magnet 32 by a preset angle about the third axis (For example, Y-axis) as a rotation axis.

The second driving unit 70 can be moved by the movement of the holder 30 coupled with the optical member 40 on a plane (For example, XY-plane) in which the path of light incident to the optical member 40 is perpendicular to a first axis (optical axis or Z-axis), and accordingly, an image being formed on the image sensor 540 can be moved in a X-axis direction or/and the Y-axis direction. That is, by controlling the movement of the holder 30, in an embodiment, blurring of an image or shaking of a video caused by shaking of a camera device when photographing an image or photographing a video by a user's handshake can be corrected.

The first position sensor unit 170 receives the first driving signal DI1 and supplies the received first driving signal DI1 to the first sensor 71A and the second sensor 71B. The first position sensor unit 170 receives the second driving signal DI2 and supplies the received second driving signal DI2 to the third sensor 72A and the fourth sensor 72B.

The first position sensor unit 170 detects the displacement of the second lens assembly 622 and outputs a first output signal V1 according to the detection result. In addition, the first position sensor unit 170 detects the displacement of the third lens assembly 624 and outputs a second output signal V2 according to the detection result.

The second position sensor unit 240 supplies a driving signal to each of the first sensor 240A, the second sensor 240B, and the second OIS position sensor 240C of the first OIS position sensor.

The first OIS position sensors 240A and 240B may detect the displacement of the holder 30 in a third axis direction and output an output signal according to the detected result. The second OIS position sensor 240C may detect the displacement of the holder 30 in a second axis direction and output an output signal according to the detected result.

The storage unit 180 stores data required to operate the camera device 200. The storage unit 180 may be expressed by replacing it with a “memory” instead. For example, the storage unit 180 may store information on a zoom position and a focus position for each distance from a subject. For example, the storage unit 180 may store the first reference code value (or data) of the first output signal V1 of the first position sensor unit 71 corresponding to the movement range (or stroke range or displacement) of the second lens assembly 622. In addition, the storage unit 180 may store the second reference code value (or data) of the second output signal V2 of the second position sensor unit 72 corresponding to the movement range (or stroke range or displacement) of the third lens assembly 624. The first and second reference code values may be values previously stored in the storage unit 180 through calibration.

The storage unit 180 may be a separate component from the control unit 810, but is not limited thereto, and may be comprised in the control unit 810 in another embodiment. For example, the storage unit 180 may be comprised in at least one of the first driver 542 and the second driver 260.

For example, the camera device 200 may be accurately focused based on the target position of the second lens assembly 622 and the target position of the third lens assembly 624.

The image sensing unit 330 may comprise an image sensor 540 that converts light reflected from a subject into an electrical signal. For example, the image sensor 540 may comprise a light receiving unit that receives light and converts it into an electrical signal, and an analog-to-digital converter that converts the converted electrical signal into a digital signal. In addition, for example, the image sensor 540 may further comprise an image signal processor that performs signal processing on digital signals.

The control unit 810 controls the overall operation of the camera device 200. For example, in order to provide an anti-shake function, an auto focus function, and a magnification function, the control unit 200 may control the first position sensor unit 170 and the second position sensor unit 240 and may drive the driving unit 630 and the second driving unit 70. For example, the control unit 810 may comprise a first driver 542 and a second driver 260. For example, each of the first driver 542 and the second driver 260 may comprise at least one of an analog-to-digital converter, an amplifier, a PID controller, or a memory.

The first driver 542 receives an output signal of the first position sensor unit 170, generates a first code value according to a result of analog-to-digital conversion of the received output signal, and may control the driving signal being applied to the first coil 120 of the first driving unit 630 based on the result of comparing the generated first code value and the first target value. For example, the first target value may be a reference code value corresponding to a target zoom position of the second lens assembly 622.

The second driver 260 receives output signals of the first OIS position sensors 240A and 240B of the second position sensor unit 240, generates a second code value according to a result of analog-to-digital conversion of the received output signal, and may control the first driving signal being applied to the first OIS coils 230A and 230B of the second driving unit 70 based on the result of comparing the generated second code value and the second target value.

In addition, the second driver 260 receives the output signal of the second OIS position sensor 240C of the second position sensor unit 240, generates a third code value according to the result of analog-to-digital conversion of the received output signal, and may control the second driving signal being applied to the second OIS coil 230C of the second driving unit 70 based on the result of comparing the generated third code value and the third target value.

For example, the second target value may be a reference code value (or data) related to the output of the first OIS position sensors 240A and 240B corresponding to the target tilting position of the second axis (X-axis) of the OIS movable unit of the second actuator 320. In addition, for example, the third target value may be a reference code value (or data) for the output of the second OIS position sensor 240C corresponding to a third axis (Y-axis) tilting position of the OIS movable unit of the second actuator 320. The reference code value (or data) for the output of each of the first OIS position sensors 240A and 240B and the second OIS position sensor 240C may be preset through calibration and stored in the storage unit 180.

The camera device 200 may further comprise a temperature sensor 566 for temperature compensation. The temperature sensor 566 may output temperature information according to a result of measuring the temperature of the camera device 200.

Temperature information of the temperature sensor 566 may be used for temperature compensation for a focusing operation of the third lens assembly 624. For example, the storage unit 180 may store a compensation value corresponding to temperature information.

For example, since the second lens assembly 622 responsible for zooming moves according to the magnification set by a user, it may perform the temperature compensation for the third lens assembly 624 responsible for auto focusing in a state (or condition) in which the position of the second lens assembly 622 is fixed.

In addition, for example, the control unit 810 receives temperature information from the temperature sensor 566, acquires a compensation value for temperature compensation corresponding to the received temperature information, and a driving signal of the second coil 120B of the third lens assembly 624 may be controlled based on the acquired compensation value. Due to this, in an embodiment, an accurate auto focusing operation reflecting temperature compensation can be performed.

In addition, the camera device 200 according to an embodiment forms an image of an object in space using reflection, refraction, absorption, interference, diffraction, and the like, which are characteristics of light, and may be comprised in an optical apparatus (optical instrument) aimed at increasing the visual power of the eye, recording and reproducing an image by a lens, or optical measurement, propagation or transmission of an image, and the like. For example, the optical apparatus according to an embodiment is a mobile phone, a mobile phone, a smart phone, a portable smart device, a digital camera, a laptop computer, a digital broadcasting terminal, a personal digital assistants (PDA), a portable multimedia player (PMP), navigation, and the like, but is not limited thereto, and any device for photographing images or photos is possible.

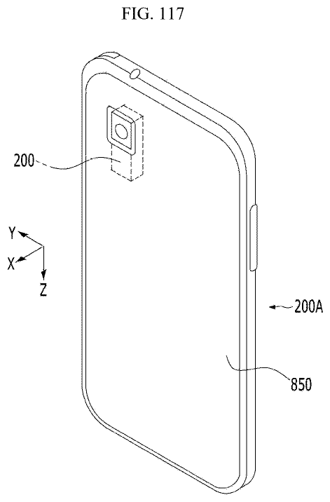

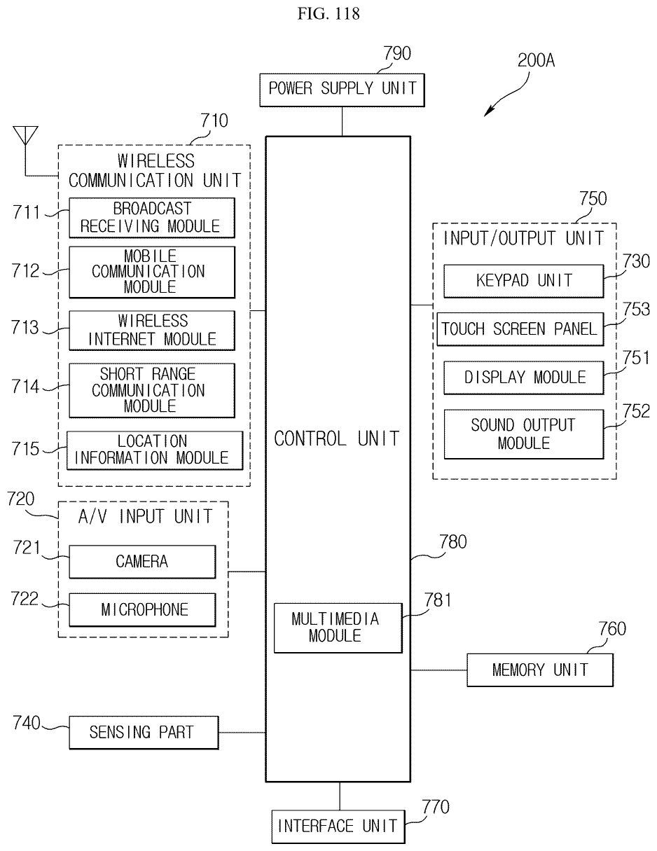

FIG. 117 is a perspective view of an optical apparatus 200A according to a third embodiment of the present invention; and FIG. 118 illustrates a configuration diagram of the optical apparatus 200A illustrated in FIG. 117.

Referring to FIGS. 117 and 118, an optical apparatus 200A, hereinafter referred to as a portable “terminal”, may comprise: a body 850; a wireless communication unit 710; an A/V input unit 720; a sensing unit 740; an input/output unit 750; a memory unit 760; an interface unit 770; a control unit 780; and a power supply 790.

The body 850 is in the form of a bar, but is not limited thereto, and may be of various structures such as slide type, folder type, swing type, swivel type, and the like in which two or more sub-bodies are coupled to be relatively movable.

The wireless communication unit 710 may comprise one or more modules enabling wireless communication between the terminal 200A and a wireless communication system or between the terminal 200A and a network in which the terminal 200A is positioned. For example, the wireless communication unit 710 can be configured to comprise a broadcast reception module 711, a mobile communication module 712, a wireless Internet module 713, a short-range communication module 714, and a location information module 715.

The A/V input unit 720 is for audio signal or video signal input, and may comprise a camera 721, a microphone 722, and the like.

The camera 721 may comprise the camera device 200 according to an embodiment.

The sensing unit 740 may generate a sensing signal for controlling the operation of the terminal 200A by detecting the current state of the terminal 200A, such as the open/closed state of the terminal 200A, the location of the terminal 200A, whether or not there is a user contact, the direction of the terminal 200A, and the acceleration/deceleration of the terminal 200A. For example, when the terminal 200A is in the form of a slide phone, whether the slide phone is opened or closed may be detected. In addition, it is responsible for sensing functions related to whether or not power is supplied to the power supply unit 790, and whether or not the interface unit 770 is connected to an external device.

The input/output unit 750 is for generating an input or output related to visual, auditory, or tactile sense. The input/output unit 750 may generate input data for controlling the operation of the terminal 200A and, in addition, may display information processed by the terminal 200A.

The input/output unit 750 may comprise a keypad unit 730, a display module 751, a sound output module 752, and a touch screen panel 753. The keypad unit 730 may generate input data by keypad input.

The display module 751 may comprise a plurality of pixels whose color changes according to an electrical signal. For example, the display module 751 may comprise at least one among a liquid crystal display, a thin film transistor liquid crystal display, an organic light emitting diode, a flexible display, and a 3D display.

The audio output module 752 outputs audio data received from the wireless communication unit 710 in a call signal reception mode, a call mode, a recording mode, a voice recognition mode, or a broadcast reception mode, or may output audio data stored in the memory unit 760.

The touch screen panel 753 may convert a change in capacitance generated due to a user's touch on a specific area of the touch screen into an electrical input signal.

The memory unit 760 may store programs for processing and controlling the control unit 780, and may temporarily store an input/output data (For example, phone book, message, audio, still image, photo, video, and the like). For example, the memory unit 760 may store an image photographed by the camera 721, for example, a photo or video.

The interface unit 770 serves as a passage through which an external device connected to the terminal 200A is connected. The interface unit 770 receives data from an external device or receives power and transmits it to each component inside the terminal 200A, or transmits data inside the terminal 200A to an external device. For example, the interface unit 770 comprises a wired/wireless headset port, an external charger port, a wired/wireless data port, a memory card port, a port connecting a device having an identification module, an audio input/output (I/O) port, a video input/output (I/O) port, an earphone port, and the like.

The control unit 780 may control overall operations of the terminal 200A. For example, the control unit 780 may perform related control and processing for voice calls, data communications, video calls, and the like.

The control unit 780 may comprise a multimedia module 781 for playing multimedia. The multimedia module 781 may be implemented inside the control unit 780 or may be implemented separately from the control unit 780.

The control unit 780 may perform pattern recognition processing capable of recognizing a handwriting input or a drawing input performed on the touch screen as a character and an image, respectively.

The power supply unit 790 may receive external power or internal power under the control of the control unit 780 to supply power required for operation of each component.

The camera device 200 is disposed on the body 850 of the portable terminal 200A so that the incident surface 8A of the optical member 40 may be disposed parallel to one surface (For example, the rear or front surface) of the body 850. For example, the second actuator 320, the first actuator 310, and the image sensing unit 330 may be arranged from the upper end to the lower end of the body 850 of the portable terminal 200A. In another embodiment, the camera device may be rotated 90 degrees in the arrangement of FIG. 117. That is, the second actuator 320, the first actuator 310, and the image sensing unit 330 may be arranged in a direction from the first side surface of the body 850 of the portable terminal 200A to the second side surface. Through this arrangement, when the camera device 200 is mounted on the portable device 200A, space limitations can be reduced and the degree of freedom in the design of the portable device can be enhanced.

Although the first to third embodiments of the present invention have been separately described above, some components of the first to third embodiments may be replaced with each other. That is, some components of the first embodiment may be replaced with corresponding components of one or more of the second and third embodiments. Some components of the second embodiment may be replaced with a corresponding one or more of the first embodiment and the third embodiment. Some components of the third embodiment may be replaced with corresponding components of one or more of the first and second embodiments.

Although the embodiment of the present invention has been described above with reference to the accompanying drawings, those of ordinary skill in the art to which the present invention belongs will understand that the present invention may be embodied in other specific forms without changing the technical spirit or essential features thereof. Therefore, it should be understood that the embodiments described above are illustrative in all respects and not restrictive.

1. A reflective member driving device comprising:
a housing;
a holder disposed in the housing;
a reflective member disposed on the holder;
a moving plate disposed between the housing and the holder;
a coil and a magnet configured to move the holder with respect to the housing; and
an elastic member connecting the housing and the holder,
wherein the moving plate is disposed on a first portion of the housing, and
wherein the elastic member is disposed at an opposite side of the moving plate from the first portion of the housing and directly coupled to the holder.

2. The reflective member driving device of claim 1, wherein the housing comprises a first surface facing a first direction,
wherein the holder comprises a protruding portion protruding in the first direction, and
wherein the elastic member is coupled to the first surface of the housing and the protruding portion of the holder.

3. The reflective member driving device of claim 2, wherein the protruding portion of the holder is protruded to an opposite side of the moving plate from the first portion of the housing.

4. The reflective member driving device of claim 1, wherein the elastic member comprises an outer portion coupled to the housing, an inner portion coupled to the holder, and a connecting portion connecting the outer portion and the inner portion,
wherein an optical axis of a light incident on the reflective member is a first optical axis,
wherein an optical axis of a light emitted from the reflective member is a second optical axis, and
wherein the inner portion is disposed further inward than the outer portion at a cross section cut by an imaginary plane comprising the first optical axis and the second optical axis.

5. The reflective member driving device of claim 4, wherein, in the cross section, the inner portion is disposed further outward than the moving plate.

6. The reflective member driving device of claim 2, wherein the housing comprises a hole penetrating the housing in the first direction, and
wherein the protruding portion of the holder passes through the hole of the housing.

7. The reflective member driving device of claim 2, wherein the protruding portion of the holder comprises a first protruding portion disposed at one side of the first portion of the housing and a second protruding portion disposed at the other side of the first portion of the housing, and
wherein the elastic member is coupled with each of the first protruding portion and the second protruding portion.

8. The reflective member driving device of claim 7, wherein the first protruding portion of the holder comprises a first surface facing the first direction and a protrusion formed on the first surface of the first protruding portion, and
wherein the elastic member comprises a hole coupled with the protrusion.

9. The reflective member driving device of claim 8, wherein the protrusion of the first protruding portion of the holder comprises a first protrusion and a second protrusion spaced apart from each other, and
wherein the elastic member comprises a first portion coupled with the first protrusion, a second portion coupled with the second protrusion, and a third portion connecting the first portion and the second portion.

10. A reflective member driving device comprising:
a housing;
a holder disposed in the housing;
a reflective member disposed on the holder;
a moving plate disposed between the housing and the holder;
a coil and a magnet configured to move the holder with respect to the housing; and
an elastic member connecting the housing and the holder,
wherein the moving plate is pressed between the holder and the housing by the elastic member.

11. The reflective member driving device of claim 7, wherein the first protruding portion comprises a portion overlapped with the first portion of the housing in a direction in which the first protruding portion faces the second protruding portion.

12. The reflective member driving device of claim 2, wherein the elastic member is configured to pull the holder in the first direction.

13. The reflective member driving device of claim 1, comprising a substrate disposed with the coil,
wherein the housing comprises a first housing disposed with the substrate and a second housing comprising the first portion of the housing, and
wherein the second housing is formed as a separate member from the first housing and coupled with the first housing.

14. The reflective member driving device of claim 1, wherein the moving plate is pressed between the holder and the housing by the elastic member.

15. A camera device comprising:
a printed circuit board;
an image sensor disposed on the printed circuit board;
the reflective member driving device of claim 1; and
a lens disposed in an optical path formed by the reflective member of the reflective member driving device and the image sensor.

16. An optical apparatus comprising:
a main body;
the camera device of claim 15 disposed on the main body; and
a display disposed on the main body and configured to output any one or more of a video or an image photographed by the camera device.

17. A reflective member driving device comprising:
a housing;
a holder disposed in the housing;
a reflective member disposed on the holder;
a moving plate disposed between the housing and the holder;
a coil and a magnet configured to move the holder with respect to the housing; and
an elastic member coupled with the housing and the holder,
wherein the housing comprises a first surface facing a first direction,
wherein the holder comprises a protruding portion protruding more than the moving plate in the first direction, and
wherein the elastic member is coupled with the first surface of the housing and the protruding portion of the holder.

18. The reflective member driving device of claim 17, wherein the protruding portion of the holder comprises two protruding portions,
wherein the moving plate is disposed between the two protruding portions, and
wherein the elastic member connects the two protruding portions of the holder and the housing.

19. The reflective member driving device of claim 18, wherein the housing comprises a hole through which the two protruding portions of the holder pass.

20. The reflective member driving device of claim 17, wherein the moving plate is pressed between the holder and the housing by the elastic member.
